(19) United States
(12) Patent Application Publication
(10) Pub. No.: US 2009/0215613 A1
(43) Pub. Date: Aug. 27, 2009

(54) Yttrium Compositions And Methods of Making the Same

(75) Inventor: Alfred Hagemeyer, Rheine (DE)

Correspondence Address: DERICK E. ALLEN (28217);ARMSTRONG TEASDALE LLP, ONE METROPOLITAN SQUARE, SUITE 2600, ST. LOUIS, MO, 63102-2740, US

(73) Assignee: Symyx Technologies, Inc., Sunnyvale, CA (US)

(21) Appl. No.: 11/913,381

(22) Filed: Nov. 1, 2007

Related U.S. Application Data
(63) Continuation of application No. PCT/US06/16878, filed on May 2, 2006.
(60) Provisional application No. 60/677,137, filed on May 2, 2005.

(51) Int. Cl. B01J 23/10; C07F 5/00; B01J 23/26; B01J 23/28; B01J 23/30; B01J 23/34; B01J 23/44; B01J 23/42; B01J 23/755; B01J 23/745; B01J 23/75; B01J 23/02; B01J 23/72; B01J 23/52; B01J 23/14; B01J 23/20

(52) U.S. Cl. 502/304; 502/355; 534/16; 502/302; 502/320; 502/322; 502/305; 502/324; 502/333; 502/334; 502/335; 502/336; 502/332; 502/341; 502/346; 502/344; 502/352; 502/349; 502/354

(57) ABSTRACT

The present invention is directed to yttrium compositions and methods for making such metal oxide compositions, specifically, metal oxide compositions having high surface area, high metal/metal oxide content, and/or thermal stability with inexpensive and easy to handle materials.

### CROSS REFERENCE TO RELATED APPLICATIONS

This application is a 35 U.S.C. §371 application of PCT/US2006/167878, filed on May 2, 2006 which claims priority to U.S. Provisional Patent Application No. 60/677,137, filed on May 2, 2005, the disclosures of both of which are incorporated by reference.

### FIELD OF THE INVENTION

The present invention generally relates to metal oxide materials and methods of making those materials, and specifically, to porous metal oxide materials having high surface areas and methods of making those materials.

### BACKGROUND OF INVENTION

Porous metal and metal oxide catalysts or catalyst supports are used for a wide variety of reactions, such as hydrogenations, dehydrogenations, reductions and oxidations. These materials typically either have a high metal or metal oxide content (e.g., greater than 70% by weight) and a low surface area, or a higher surface area and a lower metal content. Metal and/or metal oxide materials with lower surface areas do not typically react as efficiently as higher surface area materials. In order to increase surface area these materials are typically supported on a high surface area carrier, or support, which are typically inert, and/or are combined with a binder. The additional materials may provide higher surface area, but they do not contribute to the activity/selectivity of the metal/metal oxide catalyst.

A variety of synthesis techniques have been used to provide metal oxide materials. These techniques include conventional precipitation, the Pechini, or citrate process, and a variety of sol-gel techniques.

Typical precipitation methods utilize stable, acidic metal salts in solution. The solution is combined with a base that increases the pH of the metal salt solution and destabilizes the metal salts to form metal hydroxides and/or metal carbonates that precipitate out of the solution. This reaction results in counter-anions of the metal salt, such as nitrates or chlorides, and the counter-cations of the base, such as Na, K, or NH4 being present.

After the precipitation, it is usually desirable to remove the ions from the base and the salt by washing, usually with a solvent such as water. However, this does not typically remove all of the impurities. The precipitate is still typically contaminated with ˜0.5% of an ion from the base. The particle size of the precipitate is usually big enough (micron-sized) to allow filtering and isolation of the powder. If the powder is washed several times to remove most of the ions and reduce the ion content to 50-100 ppm the powder typically no longer sediments, but floats, thus making filtration difficult as the filter is typically clogged by the nanosized particles, which are difficult to isolate.

In order to avoid the ion contamination issue, precipitation with urea or hydrazine (which both decompose into volatiles upon boiling the solution) have been found to give comparable results to the use of other bases, such as NaOH or Na₂CO₃. Hydrazine or urea can be advantageous, since the precipitation agent is almost completely removed leaving little or no counter-cations. Hydrazine decomposes upon boiling into nitrogen, hydrogen and water, and the anion of the metal precursor (such as a chloride) is also removed from the system as a volatile gas, such as (HCl). Urea breaks down to ammonia and CO₂ with the ammonia released being the actual base/precipitation agent thus forming NH₄C₁ or NH₄NO₃ salts that may partly evaporate and partly reside in the solution.

However, there is little to no practical or economically viable application for these systems since hydrazine is toxic and not a desirable chemical to work with. Moreover, the solutions have to be heated to about 90° C. or refluxed during precipitation and aging thus adding to the energy cost. Furthermore, in applications where high surface areas are desired, precipitation methods have been found to produce porous materials with BET surface areas significantly less than those achieved by sol-gel methods.

The Pechini, or citrate method, as described in U.S. Pat. No. 3,330,697 to Pechini, involves combining a metal precursor with water, citric acid and a polyhydroxyalcohol, such as ethylene glycol. The components are combined into a solution which is then heated to remove the water. A viscous oil remains after heating. The oil is then heated to a temperature that polymerizes the citric acid and ethyleneglycol by polycondensation, resulting in a solid resin. The resin is a matrix of the metal atoms bonded through oxygen to the organic radicals in a cross-linked network. The resin is then calcined at a temperature above 500° C. to burn off the polymer matrix, leaving a porous metal oxide.

The Pechini method is advantageous in that it utilizes components that are inexpensive and easy to handle. However, the method results in materials having BET surface areas substantially lower than those materials created using precipitation and sol-gel methods.

Typical sol gel methods utilize metal alkoxide precursors in organic solvents with an aqueous inorganic acid, such as nitric acid or hydrochloric acid. The inorganic acid acts as a catalyst allowing the water to hydrolyze the metal alkoxide bonds in a hydrolysis reaction by protonation, forming a metal hydroxide and an alcohol. Subsequent condensation reactions involving the metal hydroxide units reacting with other metal hydroxide units or remaining metal alkoxides result in the metal molecules bridging, and water and alcohol being created. As the number of bridged metal molecules increases, agglomeration occurs, forming irregular agglomerates and eventually growing into a 3-dimensional amorphous polymer network, or a gel. The remaining water and alcohol, which is a neutral non-ionic unreactive organic solvent, is evaporated from the system leaving little to no traces of the former metal counter-anion behind. The gel is then calcined, resulting in a porous, solid metal oxide.

While the current sol-gel processes produce porous metal oxide materials having surface areas superior to those produced by precipitation and the Pechini method, there are several drawbacks. The alkoxide precursors used are typically expensive, flammable and difficult and dangerous to handle. Also, the inorganic acids used to catalyze the reaction, while also dangerous, are not totally removed from the system, resulting in impurities, such as nitrate or chloride contaminants. While there is no way to remove the chloride completely, the nitrates may be eliminated by decomposition at high temperatures, such as those greater than 450° C. Such temperatures may be too high for some materials, resulting in diminished surface areas.

Thus, what is needed are porous metal/metal oxide materials having high surface areas.

What is also needed is a method to make porous metal metal/metal oxide materials having high surface areas that utilizes inexpensive materials that are easy to handle.

The following examples illustrate the principles and advantages of the invention.

### SUMMARY OF INVENTION

Briefly, therefore, the present invention is directed to compositions and methods for making metal oxide compositions, specifically, metal oxide compositions having high surface area, high metal/metal oxide content, and/or thermal stability with inexpensive and easy to handle materials. The present invention is directed to methods of making metal and/or metal oxide compositions, such as supported or unsupported catalysts. The method includes combining a metal precursor with an organic dispersant, such as an organic acid to form a mixture and calcining the mixture at a temperature of at least 250° C. for a period of time sufficient to form a metal oxide material, specifically for at least 1 hour. The present invention is directed to metal compositions having high metal oxide content, high BET surface area, and/or thermal stability.

The present invention is directed to solid yttrium oxide compositions and methods of making the compositions. The compositions preferably have high yttrium oxide content and BET surface areas that are novel over state of the art materials. The methods for making the compositions of the invention produce high surface area, high yttrium oxide content compositions, using relatively inexpensive and easy to handle materials.

In one embodiment, the present invention is directed to a solid composition (such as a supported or unsupported catalyst) that is at least about 50% yttrium oxide by weight and has a BET surface area of at least 70 square meters per gram. In one embodiment, the composition is a porous solid, wherein 10% of the pores are greater than 10 nm. In another embodiment, the composition has an essential absence of Europium. In another embodiment, the composition consists essentially of carbon and at least about 50% yttrium oxide. In other embodiments, the compositions in the embodiments described above include an additional metal other than yttrium.

In another embodiment, the present invention is directed to methods of making solid yttrium oxide compositions, such as supported or unsupported catalysts. The method includes combining a yttrium precursor with an organic dispersant, such as an organic acid and optionally water to form a mixture and calcining the for a time sufficient to form a solid, such as at least one hour. In one embodiment, the organic acid includes no more than one carboxylic group and at least one carbonyl or hydroxyl group. In another embodiment, the organic acid includes two carboxylic groups and a carbonyl group. In another embodiment, the acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

It is considered and understood that the many features and aspects of the embodiments described herein can be combined with each other.

Other features and advantages of the present invention will be in part apparent to those skilled in art and in part pointed out hereinafter. All references cited in the instant specification are incorporated by reference for all purposes. Moreover, as the patent and non-patent literature relating to the subject matter disclosed and/or claimed herein is substantial, many relevant references are available to a skilled artisan that will provide further instruction with respect to such subject matter

### DESCRIPTION OF THE DRAWINGS

FIG. 1 shows X-ray powder diffraction (XRD) data for the sample prepared in Example 46.

FIG. 2 shows XRD data for the sample prepared in Example 47.

FIG. 3 shows XRD data for the sample prepared in Example 48.

FIG. 4 shows XRD data for the sample prepared in Example 49.

### DETAILED DESCRIPTION OF THE INVENTION

In the present invention, methods for making metal compositions are disclosed. The methods may use inexpensive and/or easy to handle materials, and may also have high BET surface areas, high metal or metal oxide content and/or thermal stability.

By “thermally stable” it is intended to mean that the BET surface area of the composition decreases by not more than 10% when heated at 350° C. for 2 hours.

By “BET surface area” it is intended to means the surface area of the composition as calculated using BET methods. The BET (Brunauer, Emmet, and Teller) theory is a well known model used to determine surface area. Samples are typically prepared by heating while simultaneously evacuating or flowing gas over the sample to remove the liberated impurities. The prepared samples are then cooled with liquid nitrogen and analyzed by measuring the volume of gas (typically N₂ or Kr) adsorbed at specific pressures.

The metal oxides and mixed metal oxides made by methods of the invention have important applications as catalysts, catalyst carriers, sorbents, sensors, actuators, gas diffusion electrodes, pigments, and as coatings and components in the semiconductor, electroceramics and electronics industries.

### Overall Methods and Materials

In general, the methods of the invention are used to make metal or metal oxide compositions that are superior as unbound and/or unsupported as well as supported catalysts compared to known supported and unsupported metal and metal oxide catalyst formulations which typically utilize large amounts of binders such as silica, alumina, aluminum or chromia. The lower content or the absence of a binder or support (which is often unselective) and the high purity (e.g. high metal/metal oxide content and essential absence of Na, K and Cl and other ionic impurities) and/or the high surface areas achievable by methods of the invention, as well as the materials utilized in the methods, provide improvements over materials made by and used in current methods. The productivity in terms of weight of material per volume of solution per unit time can be higher for the method of the invention as compared to present sol-gel or precipitation techniques since highly concentrated solutions ˜1M can be used as starting material. Moreover, no washing or aging steps are required by the method.

The present invention is thus directed to methods for making metal-containing compositions that comprise metal and/or metal oxide, specifically methods that utilize inexpensive materials that are easy to handle.

### Methods

The methods of the invention are useful for making single metal/metal oxide compositions, binary systems, ternary systems, quaternary systems and other higher ordered systems. As will be shown below, by appropriate selection of materials, there are literally millions of metal/metal oxide compositions that can be made utilizing the methods of the invention.

In one embodiment, the method includes mixing a metal precursor with an organic dispersant, such as an organic acid, and water (either as a separate component or present in an aqueous organic acid, base or other type of organic dispersant) to form a mixture, and heating (e.g., calcining) the mixture. This method is typically utilized for metal precursors that are at least partially soluble in water, such as various metal acetates.

In another embodiment, the method includes mixing a metal precursor with an organic acid and optionally water to form a mixture, and heating (e.g., calcining) the mixture. In one embodiment, this method is typically utilized for metal precursors that are not soluble or barely soluble in water, but are at least partially soluble in the organic acid, such as various metal acetates, various metal hydroxides, various metal 2,4-pentanedionates (acac), and various metal carbonates. In another embodiment, the method may also be utilized for metal precursors that are at least partially soluble in the organic acid, regardless of their solubility in water.

In one embodiment, this method is also utilized for metal precursors that are not soluble or barely soluble in water and the organic acid. The mixtures in this embodiment are typically slurries or suspensions (although a very small amount of the metal precursor (typically >1%) may be dissolved in the acid/water). The mixture is formed into a gel prior to calcination. This is accomplished by agitating (e.g., stirring) the mixture for a period of time at a temperature sufficient to form a gel. In one embodiment, the mixture is agitated at room temperature. In another embodiment, the mixture is heated during agitation, which can decrease the amount of time required to form a gel.

In another embodiment, the method includes forming a mixture of the metal precursor in an organic solvent and water (either as part of an aqueous acid (organic or inorganic) or as a separate component which can be added alone or in conjunction with a liquid or solid organic acid (e.g., ketoglutaric acid)), and heating (e.g., calcining) the mixture. This method is typically utilized for metal precursors that are at least partially soluble in the organic solvent and not soluble in water or the organic acid. In one embodiment, the metal precursor and the organic solvent are combined to form a solution. The resulting solution is then combined with water, more specifically, aqueous ketoglutaric acid, to form a mixture which is then calcined. In embodiments in which an organic acid is added to the metal precursor/organic solvent combination, the organic acid is different than the organic solvent (which may also be an organic acid. Without wishing to be bound by theory, it is believed that gelation is induced by hydrolysis of the organic solvent/metal precursor solution. Organic solvents dissolve many metal salts by chelating with high solubility. The complex formed is then hydrolyzed to a metal oxide/hydroxide gel by water/acid addition (to protonate and thereby split off the existing ligand (e.g., acac ligand)) if the metal salt is not soluble in water or acid. In one embodiment, the organic solvent is one of acac, glycol, formic acid, acetic acid, propylene glycol, glycerol, ethylenediamine, ethanolamine, lactic acid, pyruvic acid, propionic acid, butyric acid, valeric acid, hexanoic acid, cyclohexanecarboxylic acid, cyclopentanecarboxylic acid, dimethylbutyric acid, and combinations thereof, more specifically formic acid, acetic acid, ethylene glycol, propylene glycol and acac.

Depending on the types and volumes of dispersant (e.g., organic solvent/organic acid/water) in the mixture, single or two phase systems may be formed. In the case of a two phase system, one phase is typically the metal complex and the organic solvent and the other phase is water and/or the organic acid, which is typically hydrophobic. In one embodiment, the two phase mixture is agitated (e.g., shaken) to combine the two phases. After settling, this results in a first phase (e.g., a liquid phase) which includes the organic solvent and metal complexes of the metal and solvent, and a second phase (e.g., a gel phase), which includes the metal oxide/hydroxide. The first phase can be decanted off or otherwise separated prior to heating. This provides the advantage of reducing the amount of residual organics to be removed during calcination, as opposed to the typical sol gel route in which the alkoxide in alcohol systems are single phase and the solvent has to be completely evaporated. In one embodiment, an additional organic solvent that is immiscible in water, such as methylisobutylketone (MIBK), toluene, or xylene, can be added to the two phase system prior to or after agitation. The addition of the organic solvent that is immiscible in water creates a sharp interface between the phases which allows for easier separation to isolate the gel.

In other embodiments, organic dispersants other than organic acids can be utilized. For example, non-acidic dispersants with at least two functional groups, such as dialdehydes (glyoxal) and ethylene glycol have been found to form pure and/or high surface area metal-containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

In another embodiment, as an alternative to starting from acidic solutions, metal precursors, such as metal hydroxides (e.g., nickel hydroxide) and metal nitrates (e.g., cerium nitrate) can be mixed with organic bases. Bases such as ammonia, tetraalkylammonium hydroxide, organic amines and aminoalcohols can be used as dispersants. The resulting basic solutions, slurries, and/or suspensions can then be aged at room temperature or by slow evaporation followed by calcinations (or other means of low temperature detemplation). Specifically, the bases used within the scope of the invention are purely organic, and non-alkaline metal-containing bases.

Mixed-metal oxide compositions can also be made by the methods of the invention by including more than one metal precursor in the mixture.

The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi stage calcination as described below.

In another embodiment, the method includes evaporating the mixture to dryness or providing the dry metal precursor and calcining the dry component to form a solid metal oxide. Specifically, the metal precursor is a metal carboxylate, more specifically, metal glyoxylate, metal ketoglutarate, metal oxalacetate, or metal diglycolate.

In another embodiment, high surface area metal oxides can be prepared by dry decomposition of dry metal salt powders, such as acetates, formats, oxalates, citrates hydroxides, acacs and chlorides. Some noteworthy metals that can attain high surface areas by dry decomposition include, but are not limited to: high surface area cobalt oxide from Co formate, and Co citrate, high surface area yttrium oxide from Y acetate, high surface area iron oxide from Fe oxalate and ammonium Fe oxalate, high surface area cerium oxide from Ce acetate, high surface area ruthenium oxide from Ru chloride, high surface are Sn oxide from Sn acetate, and rare earth oxides from their corresponding acetates, including Dy, Ho, Er and Tm.

The heating of the resulting mixture is typically a calcination, which may be conducted in an oxygen-containing atmosphere or in the substantial absence of oxygen, e.g., in an inert atmosphere or in vacuo. The inert atmosphere may be any material which is substantially inert, e.g., does not react or interact with the material. Suitable examples include, without limitation, nitrogen, argon, xenon, helium or mixtures thereof. Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 200° C. to 850° C., specifically from 250° C. to 500° C. more specifically from 250° C. to 400° C., more specifically from 300° C. to 400° C., and more specifically from 300° C. to 375° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

In some embodiments it may be desirable to reduce all or a portion of the metal oxide material to a reduced (elemental) metal for a reaction of interest. The metal oxide materials of the invention can be partially or entirely reduced by reacting the metal oxide containing material with a reducing agent, such as hydrazine or formic acid, or by introducing, a reducing gas, such as, for example, ammonia, hydrogen sulfide or hydrogen, during or after calcination. In one embodiment, the metal oxide material is reacted with a reducing agent in a reactor by flowing a reducing agent through the reactor. This provides a material with a reduced (elemental) metal surface for carrying out the reaction of interest.

As an alternative to calcination, the material can detemplated by oxidation of the organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

### Materials

The major component of the composition made by methods of the invention is preferably a metal oxide. The composition can, however, also include various amounts of elemental metal and/or metal-containing compounds, such as metal salts. The metal oxide is an oxide of metal where metal is in an oxidation state other than the fully-reduced, elemental M^{o} state, including oxides of metal where metal has an oxidation state, for example, of M⁺², M⁺³, or a partially reduced oxidation state. The total amount of metal oxide present in the composition is at least about 25% by weight on a molecular basis. More specifically, compositions of the present invention include at least 35% metal and/or metal oxide, more specifically at least 50%, more specifically at least 60%, more specifically at least 70%, more specifically at least 75%, more specifically at least 80%, more specifically at least 85%, more specifically at least 90%, and more specifically and at least 95% metal and/or metal oxide by weight.

In one embodiment, the methods of the invention are utilized to make a material comprising a compound having the formula (I):

M¹ₐM²_{b}M³_{c}M⁴_{d}M⁵ₑO_{f} (I),

where, M¹, M², M³, M⁴, M⁵, a, b, c, d, e and f are described below, and can be grouped in any of the various combinations and permutations of preferences, some of which are specifically set forth herein.

In formula I, “M¹” “M²” “M³” “M⁴” and “M⁵” individually each represent a metal such as an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically each metal is individually selected from Ni, Ti, Pt, Pd, Mo, Cr, Cu, Au, Sn, Mn, Mo, V, In, Ru, Mg, Ba, Fe, Ta, Nb, Co, Hf, W, Y, Zn, Ga, Ge, As, Zr, V, R, Ag, Ce, Al, Si, La, or a compound containing one or more of such element(s), and more specifically, Y, Ce, Nb, Co, Ni, Cu, Ru, In, Mo, V and Sn.

In formula I, a+b+c+d+e=1. The letter “a” represents a number ranging from about 0.1 to about 1.0 The letters “b” “c” “d” and “e” individually represent a number ranging from about 0 to about 0.9, more specifically from about 0 to about 0.7, and more specifically from about 0 to about 0.5.

In formula I, “O” represents oxygen, and “f” represents a number that satisfies valence requirements. In general, “f” is based on the oxidation states and the relative atomic fractions of the various metal atoms of the compound of formula I (e.g., calculated as one-half of the sum of the products of oxidation state and atomic fraction for each of the metal oxide components).

The mixtures formed in the methods of the invention comprise the metal precursor, and various combinations of water the organic acid and the organic solvent. In one embodiment, the mixture preferably has an essential absence of any organic solvent, (such as alcohols) other than the organic acid (which may or may not be a solvent depending on the metal precursor). In another embodiment, the mixture preferably has an essential absence of citric acid. In yet another embodiment, the mixture has an essential absence of any organic solvent other than the organic acid (which may or may not be a solvent depending on the metal precursor), other than the organic acid, and citric acid.

The organic dispersants (e.g., acids) used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, or imino, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, oxalic acid, oxalacetic acid, and more specifically, glyoxylic acid or ketoglutaric acid.

In another embodiment the organic acid used in methods of the invention is selected from the group consisting of α-hydroxo monoacids, α-carbonyl monoacids, α-keto acids, keto diacids and combinations thereof.

The metal precursors used in the methods of the invention are selected from the group consisting of metal acetate, metal hydroxide, metal carbonate, metal nitrate, metal 2,4-pentanedionate (acac), metal formate, metal chloride, metal oxalate, the metal in the metallic state, metal oxide, metal carboxylates, and combinations thereof, more specifically metal acetate, metal hydroxide or metal carbonate. In one embodiment, the metal precursor is a metal carboxylate selected from the group consisting of metal glyoxylate, metal ketoglutarate, metal oxalate and metal diglycolate and metal oxalacetate. The metal precursors utilized in the methods described herein are selected based on their solubility and compatibility with the other components of the mixtures. For example, in embodiments in which the metal precursors are at least partially soluble in water, metal precursors, such as various metal acetates are utilized, and in embodiments in which the metal precursors are at least partially soluble in an organic solvent such as 2,4-pentanedionate, various metal 2,4-pentanedionates can be utilized. The metal in the metal precursor is an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the metal is one of Ni, Ti, Pt, Pd, Mo, Cr, Cu, Au, Sn, Mn, In, Ru, Mg, Ba, Fe, Ta, Nb, Co, Hf, W, Y, Zn, Ga, Ge, As, Zr, V, R, Ag, Ce, Al, Si, Bi, V, La, and more specifically, Y, Ce, Nb, Co, Ni, Cu, Ru, Bi, La, Mo, V, In and Sn.

Without wishing to be bound by theory, it is believed that the metal and the organic acid react to form a metal-conjugated polymer in the mixture. In contrast to the Pechini method, in which it is believed the metals form chelates with citric acid, and a polyalcohol establishes linkages between the chelates by a polyesterification reaction resulting in an organic matrix in which the metal ions are entrapped via grafting to the polymer, the method of the present invention is believed to produce a polymeric backbone which includes the metal ions as part of that backbone through the polymerization of the organic acid. It is believed that this results in higher surface area metal oxides after calcinations as opposed to those materials achieved using the Pechini method.

The ratio of mmols of acid to mmols metal can vary from about 10:1 to about 1:10, more specifically from about 7:1 to about 1:5, more specifically from about 5:1 to about 1:4, and more specifically from about 3:1 to about 1:3.

In one embodiment, the compositions of the invention can also include carbon. The amount of carbon in the compositions is typically less than 75% by weight. More specifically, the compositions of the invention have between about 0.01% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the as prepared compositions of the invention have an essential absence of N, Na, S, K and/or Cl.

In another embodiment, the compositions of the invention contain less than 10%, specifically less than 5%, more specifically less than 3%, and more specifically less than 1% water.

The compositions can include other components as well, such as diluents, binders and/or fillers, as desired in connection with the reaction system of interest.

In one embodiment, the compositions of the invention are thermally stable.

In one embodiment, the compositions of the invention are porous solids, having a wide range of pore diameters.

In one embodiment, the materials are fairly amorphous. That is, the materials are less than 80% crystalline, specifically, less than 60% crystalline and more specifically, less than 50% crystalline.

### Uses

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The methods of the invention are typically used to make solid catalysts that can be used in a reactor, such as a three phase reactor with a packed bed (e.g., a trickle bed reactor), a fixed bed reactor (e.g., a plug flow reactor), a fluidized or moving bed reactor, a two or three phase batch reactor, or a continuous stirred tank reactor. The compositions can also be used in a slurry or suspension.

In one embodiment, the methods of the invention are used to make a bulk metal or mixed metal oxide material. In another embodiment, the methods of the invention are used to make a support or carrier on which other materials are impregnated. In one embodiment, the compositions made by the methods of the invention have thermal stability and high surface areas with an essential absence of silica, alumina, aluminum or chromia. In still another embodiment, the compositions made by methods of the invention are supported on a carrier, (e.g., a supported catalyst). In embodiments where the composition is a supported catalyst, the support utilized may contain one or more of the metals (or metalloids) of the catalyst. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

Preferred embodiments of the invention include:

Embodiment 1: A method for making a composition comprising a metal oxide, the method comprising:
forming a mixture comprising a metal precursor and an organic acid, wherein the organic acid is selected from the group consisting of:
   a) acids comprising a single carboxylic group and at least one additional functional group selected from the group consisting of carbonyl and hydroxyl;
   b) acids comprising two carboxylic groups and a carbonyl group;
   c) acids selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, and
   d) acids selected from the group consisting of α-hydroxo monoacids, α-carbonyl monoacids, α-keto acids, keto diacids and combinations thereof, and
heating the mixture at a temperature of at least 250° C. for at least 1 hour to form a metal oxide.

Embodiment 2: A method for making a composition comprising a metal oxide, the method comprising:
a) forming a mixture comprising a metal precursor and a carboxylic acid comprising at least two functional groups, the mixture having an essential absence of any alcohol, and
b) heating the mixture at a temperature of at least 250° C. for at least 1 hour to form a metal oxide.

Embodiment 3: A method for making a composition comprising a metal oxide, the method comprising:
a) forming a mixture comprising a metal precursor and an organic acid, the mixture having an essential absence of any polyalcohol and citric acid, and
b) heating the mixture at a temperature of at least 250° C. to form a metal oxide.

Embodiment 4: A method for making a composition comprising a metal oxide, the method comprising:
a) forming a mixture comprising a metal precursor and an organic acid,
b) reacting the metal precursor and the organic acid to form a metal-conjugated polymer in the mixture, and
c) heating the mixture at a temperature of at least 250° C. for at least 1 hour to form a metal oxide.

Embodiment 5: The method of embodiment 4 wherein the metal precursor and the organic acid are reacted to form a polymer comprising metal carboxylates.

Embodiment 6: The method of embodiment 1, wherein the organic acid comprises a single carboxylic group and at least one additional functional group selected from the group consisting of carbonyl and hydroxyl.

Embodiment 7: The method of embodiment 1, wherein the organic acid comprises two carboxylic groups and a carbonyl group.

Embodiment 8: The method of embodiment 1, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 9: The method of embodiment 1, wherein the organic acid is selected from the group consisting of α-hydroxo monoacids, α-carbonyl monoacids, α-keto acids, keto diacids and combinations thereof.

Embodiment 10: The method of embodiment 1, wherein the organic acid is a bidentate chelating agent.

Embodiment 11: The method of any of embodiments 1-10, the mixture further comprising water.

Embodiment 12: The method of any of embodiments 1-11, the mixture having an essential absence of organic solvent other than the organic acid.

Embodiment 13: The method of any of embodiments 1-11, the mixture further comprising an organic solvent different from the organic acid.

Embodiment 14: The method of embodiment 13, wherein the organic solvent is selected from the group consisting of 2,4-pentanedionate, ethylene glycol, propylene glycol, formic acid, acetic acid and combinations thereof.

Embodiment 15: The method of any of embodiments 1-14, further comprising evaporating a portion of the mixture for a period of time sufficient for the mixture to form a gel prior to heating.

Embodiment 16: The method any of embodiments 1-14, further comprising heating the mixture at a temperature less than 250° C. for a period of time sufficient for the mixture to form a gel prior to heating at the temperature of at least 250° C.

Embodiment 17: The method of any of embodiments 1-16, wherein the metal precursor is selected from the group consisting of metal acetate, metal hydroxide, metal carbonate, metal nitrate, metal 2,4-pentanedionate, metal formate, metal chloride, the metal in the metallic state, metal oxide, metal acac, metal carboxylate and combinations thereof.

Embodiment 18: The method of embodiment 17, wherein the metal precursor is selected from the group consisting of metal hydroxide, metal acetate and metal carbonate.

Embodiment 19: The method of any of embodiments 1-18, wherein the metal precursor is at least partially soluble in water.

Embodiment 20: The method of any of embodiments 1-18, wherein the metal precursor is not soluble in water.

Embodiment 21: The method of any of embodiments 1-20, wherein the metal precursor is at least partially soluble in the organic acid.

Embodiment 22: The method of embodiments 13 or 14, wherein the metal precursor is at least partially soluble in the organic solvent.

Embodiment 23: The method of any of embodiments 1-22, wherein the mixture is heated at a temperature of at least 300° C.

Embodiment 24: The method of any of embodiments 1-22, wherein the mixture is heated at a temperature of at least 350° C.

Embodiment 25: The method of embodiment 3, wherein the mixture is heated for at least 1 hour.

Embodiment 26: The method of any of embodiments 1-25, wherein the mixture is heated for at least 2 hours.

Embodiment 27: The method of any of embodiments 1-6 and 8-26, wherein the organic acid is glyoxylic acid.

Embodiment 28: The method of any of embodiments 1-5 and 7-26, wherein the organic acid is ketoglutaric acid.

Embodiment 29: The method of any of embodiments 1-28, wherein the mixture comprises a combination of glyoxylic and ketoglutaric acid.

Embodiment 30: The method of any of embodiments 1-29, wherein the metal oxide is a solid.

Embodiment 31: The method of any of embodiments 1-30, further comprising at least partially reducing the metal oxide to a metal.

Embodiment 32: The method of embodiment 31, wherein the reduction step comprises flowing hydrogen or ammonia gas over the metal oxide for a period of time sufficient to reduce the metal oxide to the metal.

Embodiment 33: The method of embodiment 31, wherein the reduction step comprises combining the metal oxide with hydrazine or formic acid for a period of time sufficient to reduce the metal oxide to the metal.

Embodiment 34: The method of any of embodiments 1-29, wherein the metal oxide is selected from the group consisting of oxides of transition metals, main group metals, metalloids, rare earth metals and combinations thereof.

Embodiment 35: The method of any of embodiments 1-11 and 13-34, wherein the mixture comprises a hydrophobic solvent.

Embodiment 36: The method of embodiment 35, wherein the hydrophobic solvent is methylisobutylketone.

Embodiment 37: A method of making a solid metal oxide composition, the method comprising:
mixing a metal precursor with water to form a solution;
adding an organic acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof to the solution to form a mixture; and
calcining the mixture at a temperature of at least 250° C. for at least 1 hour.

Embodiment 38: The method of embodiment 37, wherein the metal precursor is a metal acetate.

Embodiment 39: A method of making a solid metal oxide composition, the method comprising:
mixing a metal precursor with an organic acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid, aqueous versions of said acids and combinations thereof to form a solution; and calcining the solution at a temperature of at least 250° C. for at least 1 hour.

Embodiment 40: The method of embodiment 39, wherein the metal precursor is a metal acetate, a metal hydroxide or a metal carbonate.

Embodiment 41: A method of making a solid metal oxide composition, the method comprising:
mixing a metal precursor with a liquid selected from the group consisting of water, ketoglutaric acid, glyoxylic acid, pyruvic acid, lactic acid, glycolic acid, oxalacetic acid, diglycolic acid, oxalic acid, tartaric acid, malonic acid, succinic acid, glutaric acid, and combinations thereof to form a slurry or suspension; and
calcining the mixture at a temperature of at least 250° C. for at least 1 hour.

Embodiment 42: The method of embodiment 41, wherein the metal precursor is not substantially soluble in the liquid.

Embodiment 43: A method of making a solid metal oxide composition, the method comprising:
mixing a metal precursor with an organic solvent to form a solution;
adding a liquid different from the organic solvent, selected from the group consisting of water, ketoglutaric acid, glyoxylic acid, pyruvic acid, lactic acid, glycolic acid, oxalacetic acid, diglycolic acid, oxalic acid, tartaric acid, malonic acid, succinic acid, glutaric acid, and combinations thereof to the solution to form a mixture; and calcining the mixture at a temperature of at least 250° C. for at least 1 hour.

Embodiment 44: The method of embodiment 43, wherein the organic solvent is selected from the group consisting of 2,4-pentanedionate, ethylene glycol, formic acid, acetic acid and combinations thereof.

Embodiment 45: The method of either of embodiments 43 or 44, wherein the metal precursor is a metal acetate or metal 2,4-pentanedionate that is at least partially soluble in the organic solvent.

Embodiment 46: The method of any of embodiments 43-45, wherein the organic solvent is 2,4-pentanedionate and the metal precursor is metal 2,4-pentanedionate.

Embodiment 47: The method of any of embodiments 43-46, wherein the liquid is selected from the group consisting of water, ketoglutaric acid, glyoxylic acid and combinations thereof.

Embodiment 48: The method of any of embodiments 43-47, wherein the mixture is at least two phases.

Embodiment 49: The method of embodiment 48, further comprising shaking agitating the mixture prior to calcination.

Embodiment 50: The method of embodiment 49, further comprising removing the top phase after the agitation step and prior to calcination.

Embodiment 51: The method of any of embodiments 43-50, further comprising adding methylisobutylketone to the mixture prior to calcination.

Embodiment 52: A method of making a solid metal oxide composition, the method comprising:
providing a metal carboxylate; and
calcining the metal carboxylate at a temperature of at least 250° C.

Embodiment 53: The method of embodiment 52, wherein the metal carboxylate is calcined for at least one hour.

Embodiment 54: The method of embodiments 51 or 52, wherein the metal carboxylate is selected from the group consisting of metal glyoxylate, metal ketoglutarate, metal oxalate and metal diglycolate.

Embodiment 55: The method of any of embodiments 51-53, wherein the metal carboxylate is provided as a powder.

Embodiment 56: The method of any of embodiments 51-53, wherein the metal carboxylate is provided in a gel.

Embodiment 57: The method of any of embodiments 51-53, wherein the metal carboxylate is provided in a solution.

Embodiment 58: The method of any of embodiments 50-52, wherein the metal carboxylate is provided in a suspension or slurry.

### Nickel

In the present invention, nickel compositions having high BET surface areas, high nickel or nickel oxide content and/or thermal stability are disclosed.

The metal oxides and mixed metal oxides of the invention have important applications as catalysts, catalyst carriers, sorbents, sensors, actuators, gas diffusion electrodes, pigments, and as coatings and components in the semiconductor, electroceramics and electronics industries.

In general, the nickel/nickel oxide compositions of the invention are novel and inventive as unbound and/or unsupported as well as supported catalysts compared to known supported and unsupported nickel and nickel oxide catalyst formulations utilizing large amounts of binders such as silica, alumina, aluminum or chromia. The compositions of the inventions are potentially superior to known formulations both in terms of activity (compositions of the invention have higher surface area with a higher nickel metal and/or nickel oxide content) and in terms of selectivity (e.g. for hydrogenations, reductions and oxidations). The lower content or the absence of a binder/support (which is often unselective) and the high purity (i.e. high nickel/nickel oxide content and essential absence of Na, K and Cl and other impurities) achievable by methods of the invention provide improvements over state of the art compositions and methods. The productivity in terms of weight of material per volume of solution per unit time is much higher for the method of the invention as compared to present sol-gel or precipitation techniques since highly concentrated solutions ˜1M can be used as starting material. Moreover, no washing or aging steps are required by the method.

The present invention is thus directed to nickel-containing compositions that comprise nickel and/or nickel oxide. Furthermore, the compositions of the present invention may comprise carbon or additional components that act as binders, promoters, stabilizers, or co-metals.

In one embodiment of the invention, the nickel composition comprises Ni metal, a Ni oxide, or mixtures thereof. In another embodiment, the compositions of the invention comprise (i) nickel or a nickel-containing compound (e.g., nickel oxide) and (ii) one or more additional metal, oxides thereof, salts thereof, or mixtures of such metals or compounds. In one embodiment, the additional metal is an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the additional metal is one of Ti, Pt, Pd, Mo, Cr, Cu, Au, Sn, Mn, In, Ru, Mg, Ba, Fe, Ta, Nb, Co, Hf, W, Y, Zn, Zr, Ce, Al, La, Si, or a compound containing one or more of such element(s), more specifically Mn, Mo, W, Cr, In, Sn, Ru, Co or a compound containing one or more of such element(s). The concentrations of the additional components are such that the presence of the component would not be considered an impurity. For example, when present, the concentrations of the additional metals or metal containing components (e.g., metal oxides) are at least about 0.1, 0.5, 1, 2, 5, or even 10 molecular percent by weight.

The major component of the composition typically comprises a Ni oxide. The major component of the composition can, however, also include various amounts of elemental Ni and/or Ni-containing compounds, such as Ni salts. The Ni oxide is an oxide of nickel where nickel is in an oxidation state other than the fully-reduced, elemental Ni^{o} state, including oxides of nickel where nickel has an oxidation state of Ni⁺², Ni⁺3, or a partially reduced oxidation state. The total amount of nickel and/or nickel oxide (NiO, Ni₂O₃ or a combination) present in the composition is at least about 25% by weight on a molecular basis. More specifically, compositions of the present invention include at least 35% nickel and/or nickel oxide, more specifically at least 50%, more specifically at least 60%, more specifically at least 70%, more specifically at least 75%, more specifically at least 80%, more specifically at least 85%, more specifically at least 90%, and more specifically at least 95% nickel and/or nickel oxide by weight. In one embodiment, the nickel/nickel oxide component of the composition is at least 30% nickel oxide, more specifically at least 50% nickel oxide, more specifically at least 75% nickel oxide, and more specifically at least 90% nickel oxide by weight. As noted below, the nickel/nickel oxide component can also have a support or carrier functionality.

The one or more minor component(s) of the composition preferably comprise an element selected from the group consisting of Ti, Pt, Pd, Mo, Cr, Cu, Au, Sn, Mn, In, Ru, Mg, Ba, Fe, Ta, Nb, Co, Hf, W, Y, Zn, Zr, Ce, Al, Si, La or a compound containing one or more of such element(s), such as oxides thereof and salts thereof, or mixtures of such elements or compounds. The minor component(s) more preferably comprises of one or more of Mn, Mo, W, Cr, In, Sn, Ru, Co, oxides thereof, salts thereof, or mixtures of the same. In one embodiment, the minor component(s) are preferably oxides of one or more of the minor-component elements, but can, however, also include various amounts of such elements and/or other compounds (e.g., salts) containing such elements. An oxide of such minor-component elements is an oxide thereof where the respective element is in an oxidation state other than the fully-reduced state, and includes oxides having an oxidation states corresponding to known stable valence numbers, as well as to oxides in partially reduced oxidation states. Salts of such minor-component elements can be any stable salt thereof, including, for example, chlorides, nitrates, carbonates and acetates, among others. The amount of the oxide form of the particular recited elements present in one or more of the minor component(s) is at least about 5%, preferably at least about 10%, preferably still at least about 20%, more preferably at least about 35%, more preferably yet at least about 50% and most preferable at least about 60%, in each case by weight relative to total weight of the particular minor component. As noted below, the minor component can also have a support or carrier functionality.

In one embodiment, the minor component consists essentially of one element selected from the group consisting of Ti, Pt, Pd, Mo, Cr, Cu, Au, Sn, Mn, In, Ru, Mg, Ba, Fe, Ta, Nb, Co, Hf, W, Y, Zn, Zr, Ce, Al, Si, La, or a compound containing the element. In another embodiment, the minor component consists essentially of two elements selected from the group consisting of Ti, Pt, Pd, Mo, Cr, Cu, Au, Sn, Mn, In, Ru, Mg, Ba, Fe, Ta, Nb, Co, Hf, W, Y, Zn, Zr, Ce, Al, Si, La or a compound containing one or more of such elements.

Thus, in one specific embodiment of the compound shown in formula I, the composition of the invention is a material comprising a compound having the formula (II):

NiₐM²_{b}M³_{c}M⁴_{d}M⁵ₑO_{f} (II),

where, Ni is nickel, O is oxygen and M², M³, M⁴, M⁵, a, b, c, d, e and f are as described above for formula I, and more specifically below, and can be grouped in any of the various combinations and permutations of preferences.

In formula II, “M²” “M³” “M⁴” and “M⁵”, individually each represent a metal such as an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically, “M²” “M³” “M⁴” and “M⁵” individually each represent a metal selected from Ti, Pt, Pd, Mo, Cr, Cu, Au, Sn, Mn, In, Ru, Mg, Ba, Fe, Ta, Nb, Co, Hf, W, Y, Zn, Zr, Ce, Al, Si and La, and more specifically Mn, Mo, W, Cr, In, Sn, Ru and Co.

In formula II, a+b+c+d+e=1. The letter “a” represents a number ranging from about 0.5 to about 1.00, specifically from about 0.6 to about 0.90, more specifically from about 0.7 to about 0.9, and even more specifically from about 0.7 to about 0.8 The letters “b” “c” “d” and “e” individually represent a number ranging from about 0 to about 0.2, specifically from about 0.04 to about 0.2, and more specifically from about 0.04 to about 0.1.

In formula II, “O” represents oxygen, and “f” represents a number that satisfies valence requirements. In general, “f” is based on the oxidation states and the relative atomic fractions of the various metal atoms of the compound of formula II (e.g., calculated as one-half of the sum of the products of oxidation state and atomic fraction for each of the metal oxide components).

In one mixed-metal oxide embodiment, where, with reference to formula II, “c” “d” and “e” are zero, the catalyst material can comprise a compound having the formula II-A:

Ni₃M²_{b}O_{f} (II-A),

where Ni is nickel, O is oxygen, and where “a”, “M²”, “b” and “f” are as defined above.

In another embodiment, where, with reference to formula II, “b” “c” “d” and “e” are zero, the catalyst material can comprise a compound having the formula II-B:

NiₐO_{f} (II-B),

where Ni is nickel, O is oxygen, and where “a” and “f” are as defined above.

In one embodiment, the compositions of the invention can also include carbon. The amount of carbon in the compositions is typically less than 75% by weight. More specifically, the compositions of the invention have between about 0.1% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the as prepared compositions of the invention have an essential absence of N, Na, S, K and/or Cl.

In another embodiment, the compositions of the invention contain less than 10%, specifically less than 5%, more specifically less than 3%, and more specifically less than 1% water.

The compositions can include other components as well, such as diluents, binders and/or fillers, as desired in connection with the reaction system of interest.

In one embodiment, the compositions of the invention are typically a high surface area porous solid. Specifically, the BET surface area of the composition is from about 50 to about 500 m²/g, more specifically from about 90 to about 500 m²/g, more specifically from about 100 to about 500 m²/g, more specifically from about 10 to about 500 m²/g, more specifically from about 120 to about 500 m²/g, more specifically from about 150 to about 500 m²/g, more specifically from about 175 to about 500 m²/g, more specifically from about 200 to about 500 m²/g, more specifically from about 225 to about 500 m²/g, more specifically from about 250 to about 500 m²/g , more specifically from about 275 to about 500 m²/g , more specifically from about 300 to about 500 m²/g, and more specifically from about 325 to about 500 m²/g.

In one embodiment, the compositions of the invention are thermally stable.

In one embodiment, the compositions of the invention are porous solids, having a wide range of pore diameters. In one embodiment, at least 10%, and specifically at least 20% of the pores of the composition of the invention have a pore diameter greater than 20 nm. Additionally, at least 10%, specifically at least 20% and more specifically at least 30% of the pores of the composition have a pore diameter less than 12 nm, specifically less than 8 nm, and more specifically less than 6 nm.

In one embodiment, the materials are fairly amorphous. That is, the materials are less than 80% crystalline, specifically, less than 60% crystalline and more specifically, less than 50% crystalline.

In one embodiment, the composition of the invention is a bulk metal or mixed metal oxide material. In another embodiment, the composition is a support or carrier on which other materials are impregnated. In one embodiment, the compositions of the invention have thermal stability and high surface areas with an essential absence of silica, alumina, aluminum or chromia. In still another embodiment, the composition is supported on a carrier, (e.g., a supported catalyst). In embodiments where the composition is a supported catalyst, the support utilized may contain one or more of the metals (or metalloids) of the catalyst, including nickel. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus, the support may act as both an active catalyst component and a support material for the catalyst. Alternatively, the support may have only minor amounts of a metal making up the catalyst such that the catalyst may be formed by combining all desired components on the support.

In embodiments where the composition of the invention is a supported catalyst, the catalyst can further comprise, in addition to one or more of the aforementioned compounds or compositions, a solid support or carrier. The support can be a porous support, with a pore size typically ranging, without limitation, from about 2 nm to about 100 nm and with a surface area typically ranging, without limitation, from about 5 m²/g to about 300 m²/g. The particular support or carrier material is not narrowly critical, and can include, for example, a material selected from the group consisting of silica, alumina, zeolite, activated carbon, titania, zirconia, magnesia, niobia, zeolites and clays, among others, or mixtures thereof. Preferred support materials include titania, zirconia, alumina or silica. In some cases, where the support material itself is the same as one of the preferred components (e.g., Al₂O₃ for Al as a minor component), the support material itself may effectively form a part of the catalytically active material. In other cases, the support can be entirely inert to the reaction of interest.

The nickel compositions of the present invention are made by a novel method that results in high surface area nickel/nickel oxide materials. In one embodiment, method includes mixing a nickel precursor with an organic dispersant, such as an organic acid and water to form a mixture, and calcining the mixture. According to one approach for preparing a mixed-metal oxide composition of the invention, the mixture also includes a metal precursor other than a nickel precursor.

The mixture comprises the nickel precursor and the organic acid. In one embodiment, the mixture preferably has an essential absence of any organic solvent other then the organic acid (which may or may not be a solvent for the nickel precursor), such as alcohols. In another embodiment, the mixture preferably has an essential absence of citric acid. In another embodiment, the mixture preferably has an essential absence of citric acid and organic solvents other than the organic acid.

The organic acids used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, or imino, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, oxalic acid, oxalacetic acid, and more specifically, glyoxylic acid or ketoglutaric acid.

The nickel precursor used in the method of the invention is selected from the group consisting of nickel acetate, nickel hydroxide, nickel carbonate, nickel nitrate, nickel 2,4-pentanedionate, nickel formate, nickel oxide, nickel metal, nickel chloride, nickel carboxylate and combinations thereof, specifically, nickel hydroxide, nickel acetate and nickel carbonate. Specific nickel carboxylates include nickel oxalate, nickel ketoglutarate, nickel citrate, nickel tartarate, nickel malate, nickel lactate and nickel glyoxylate.

The ratio of mmols of acid to mmols metal can vary from about 10:1 to about 1:10, more specifically from about 7:1 to about 1:5, more specifically from about 5:1 to about 1:4, and more specifically from about 3:1 to about 1:3.

Mixed-metal oxide compositions can also be made by the methods of the invention by including more than one metal precursor in the mixture.

Water may also be present in the mixtures described above. The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi stage calcination as described below.

In another embodiment, the method includes evaporating the mixture to dryness or providing the dry nickel precursor and calcining the dry component to form a solid nickel oxide. Specifically, the nickel precursor is a nickel carboxylate, more specifically, nickel glyoxylate, nickel ketoglutarate, nickel oxalacetate, or nickel diglycolate.

In another embodiment, as an alternative to starting from acidic solutions, nickel precursors can be mixed with bases. Bases such as ammonia, tetraalkylammonium hydroxide, organic amines and aminoalcohols can be used as dispersants. The resulting basic solutions can then be aged at room temperature or by slow evaporation and calcinations (or other means of low temperature detemplation).

In other embodiments, dispersants other than organic acids can be utilized. For example, non-acidic dispersants with at least two functional groups, such as dialdehydes (glyoxal) and ethylene glycol have been found to form pure and/or high surface area nickel-containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

The heating of the resulting mixture is typically a calcination, which may be conducted in an oxygen-containing atmosphere or in the substantial absence of oxygen, e.g., in an inert atmosphere or in vacuo. The inert atmosphere may be any material which is substantially inert, e.g., does not react or interact with the material. Suitable examples include, without limitation, nitrogen, argon, xenon, helium or mixtures thereof. Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 200° C. to 850° C., specifically from 250° C. to 500° C. more specifically from 250° C. to 400° C., more specifically from 300° C. to 400° C., and more specifically from 300° C. to 375° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

In some embodiments it may be desirable to reduce all or a portion of the nickel oxide material to a reduced (elemental) nickel for a reaction of interest. The nickel oxide materials of the invention can be partially or entirely reduced by reacting the nickel oxide containing material with a reducing agent, such as hydrazine or formic acid, or by introducing, a reducing gas, such as, for example, ammonia or hydrogen, during or after calcination. In one embodiment, the nickel oxide material is reacted with a reducing agent in a reactor by flowing a reducing agent through the reactor. This provides a material with a reduced (elemental) nickel surface for carrying out the reaction of interest.

As an alternative to calcination, the material can detemplated by oxidation of all organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The compositions of the invention are typically solid catalysts, and can be used in a reactor, such as a three phase reactor with a packed bed (e.g., a trickle bed reactor), a fixed bed reactor (e.g., a plug flow reactor), a fluidized or moving bed reactor, a two or three phase batch reactor, or a continuous stirred tank reactor. The compositions can also be used in a slurry or suspension.

Preferred embodiments of the invention, thus, further include:

Embodiment 59: A composition comprising at least about 70% nickel metal or a nickel oxide by weight, the composition being a porous solid composition having a BET surface area of at least 120 square meters per gram wherein at least 10% of the pores have a diameter greater than 20 nm.

Embodiment 60: A composition comprising at least about 80% nickel metal or a nickel oxide by weight, the composition being a porous solid composition, having a BET surface area of at least 100 square meters per gram and being thermally stable with respect to the BET surface area of the composition decreasing by not more than 10% when heated at 350° C. for 2 hours, wherein at least 10% of the pores have a diameter greater than 20 nm.

Embodiment 61: A composition consisting essentially of carbon and at least about 25% nickel metal or a nickel oxide, the composition being a porous solid composition having a BET surface area of at least 90 square meters per gram, wherein at least 10% of the pores have a diameter greater than 20 nm.

Embodiment 62: A composition comprising a metal other than nickel and at least about 70% nickel metal or a nickel oxide by weight, the composition being a porous solid composition having a BET surface area of at least 120 square meters per gram, wherein at least 10% of the pores have a diameter greater than 20 nm.

Embodiment 63: A composition comprising a metal other than nickel and at least about 80% nickel metal or a nickel oxide by weight, the composition being a porous solid composition, having a BET surface area of at least 100 square meters per gram and being thermally stable with respect to the BET surface area of the composition decreasing by not more than 10% when heated at 350° C. for 2 hours, wherein at least 10% of the pores have a diameter greater than 20 nm.

Embodiment 64: A composition consisting essentially of carbon and at least about 25% nickel metal or a nickel oxide, the composition being a porous solid composition having a BET surface area of at least 90 square meters per gram, wherein at least 10% of the pores have a diameter greater than 20 nm.

Embodiment 65: The composition of embodiments 59, 61, 62 or 64, wherein the composition comprises at least 75% nickel metal or the nickel oxide by weight.

Embodiment 66: The composition of embodiments 59, 61, 62 or 64, wherein the composition comprises at least 80% nickel metal or the nickel oxide by weight.

Embodiment 67: The composition of any of embodiments 59-64, wherein the composition comprises at least 85% nickel metal or the nickel oxide by weight.

Embodiment 68: The composition of any of embodiments 59-64, wherein the composition comprises at least 90% nickel metal or the nickel oxide by weight.

Embodiment 69: The composition of any of embodiments 59-64, wherein the composition comprises at least 95% nickel metal or the nickel oxide by weight.

Embodiment 70: The composition of embodiments 60, 61, 63 or 64, wherein the composition has a BET surface area of at least 110 square meters per gram.

Embodiment 71: The composition of embodiment 70, wherein the composition has a BET surface area of at least 120 square meters per gram.

Embodiment 72: The composition of any of embodiments 59-71, wherein the BET surface area is between about 150 square meters per gram and 500 square meters per gram.

Embodiment 73: The composition of embodiment 72, wherein the BET surface area is at least 175 square grams per meter.

Embodiment 74: The composition of embodiment 72, wherein the BET surface area is at least 200 square meters per gram.

Embodiment 75: The composition of embodiment 72, wherein the BET surface area is at least 225 square meters per gram.

Embodiment 76: The composition of embodiment 72, wherein the BET surface area is at least 250 square meters per gram.

Embodiment 77: The composition of embodiment 72, wherein the BET surface area is at least 275 square meters per gram.

Embodiment 78: The composition of any of embodiments 59-77, wherein the nickel oxide is NiO.

Embodiment 79: The composition of any of embodiments 59-77, wherein the nickel oxide is Ni₂O₃.

Embodiment 80: The composition of any of embodiments 59-77, wherein the nickel oxide is a combination of NiO and Ni₂O₃.

Embodiment 81: The composition of any of embodiments 59-80, comprising between about 0.01% and about 20% carbon by weight.

Embodiment 82: The composition of embodiment 81, wherein the composition comprises between about 0.5% and about 10% carbon by weight.

Embodiment 83: The composition of embodiment 81, wherein the composition comprises between about 1.0% and about 5% carbon by weight.

Embodiment 84: The composition of embodiment 81, wherein the composition comprises between about 0.01% and about 0.5% carbon by weight.

Embodiment 85: The composition of any of embodiments 59, 60, 62, 63 and 65-84, wherein the composition has an essential absence of silica, alumina, aluminum or chromia.

Embodiment 86: The composition of any of embodiments 59-85, wherein the composition is a catalyst.

Embodiment 87: The composition of any of embodiments 59, 60, 61, and 63-86, wherein the composition is thermally stable with respect to the BET surface area of the composition decreasing by not more than 10% when heated at 350° C. for 2 hours.

Embodiment 88: The composition of any of embodiments 59-87, wherein the nickel metal or nickel oxide is at least 30% nickel oxide.

Embodiment 89: The composition of embodiment 88, wherein the nickel metal or nickel oxide is at least 50% nickel oxide.

Embodiment 90: The composition of embodiment 88, wherein the nickel metal or nickel oxide is at least 75% nickel oxide.

Embodiment 91: The composition of embodiment 88, wherein the nickel metal or nickel oxide is at least 90% nickel oxide.

Embodiment 92: The composition of any of embodiments 88-91, wherein the nickel oxide is NiO.

Embodiment 93: The composition of any of embodiments 59, 60, 65-82 and 83-92, further comprising a component selected from the group consisting of Mg, Al, Ba, Cr, Mn, Fe, Co, Cu, Zr, Nb, Mo, Ru, Pd, In, Sn, La, Ta, W, Pt, Au, Ce their oxides, and combinations thereof.

Embodiment 94: The composition of embodiments 62 or 63, wherein the metal other than nickel is selected from the group consisting of Mg, Al, Ba, Cr, Mn, Fe, Co, Cu, Zr, Nb, Mo, Ru, Pd, In, Sn, La, Ta, W, Pt, Au, Ce their oxides, and combinations thereof.

Embodiment 95: The composition of any of embodiments 59-94 in a reactor

Embodiment 96: The composition of embodiment 95, wherein the reactor is a three phase reactor with a packed bed.

Embodiment 97: The composition of embodiment 95, wherein the reactor is a trickle bed reactor.

Embodiment 98: The composition of embodiment 95, wherein the reactor is a fixed bed reactor.

Embodiment 99: The composition of embodiment 95, wherein the reactor is a plug flow reactor.

Embodiment 100: The composition of embodiment 95, wherein the reactor is a fluidized bed reactor.

Embodiment 101: The composition of embodiment 95, where the reactor is a two or three phase batch reactor.

Embodiment 102: The composition of embodiment 101, wherein the reactor is a continuous stirred tank reactor.

Embodiment 103: The composition of any of embodiments 59-94 in a slurry or suspension.

Embodiment 104: The composition of any of embodiments 59-94, made by a process comprising:

mixing a nickel precursor with an organic acid and water to form a mixture; and

calcining the mixture at a temperature of at least 250° C. for at least 1 hour.

Embodiment 105: The composition of embodiment 104, wherein the process further comprises evaporating a portion of the mixture for a period of time sufficient for the mixture to form a gel prior to calcination.

Embodiment 106: The composition of embodiment 104, wherein the process further comprises heating the mixture for a period of time sufficient for the mixture to form a gel prior to calcination.

Embodiment 107: The composition of any of embodiments 104-106, wherein in the process, the organic acid comprises a carboxyl group.

Embodiment 108: The composition of any of embodiments 104-107, wherein in the process, the organic acid comprises no more than one carboxylic group and at least one functional group selected from the group consisting of hydroxyl and carbonyl.

Embodiment 109: The composition of any of embodiments 104-107, wherein in the process, the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 110: The composition of any of embodiments 104-107, wherein in the process, the organic acid is ketoglutaric acid.

Embodiment 111: The composition of any of embodiments 104-107, wherein in the process, the organic acid is selected from the group consisting of glyoxylic acid, ketoglutaric acid and combinations thereof.

Embodiment 112: The composition of any of embodiments 104-111, wherein in the process, the nickel precursor is selected from the group consisting of nickel acetate, nickel hydroxide, nickel carbonate, nickel nitrate, nickel 2,4-pentanedionate, nickel formate, nickel oxalate, nickel chloride and combinations thereof.

Embodiment 113: The composition of any of embodiments 104-112, wherein in the process, the mixture is calcined at a temperature of at least 300° C.

Embodiment 114: The composition of any of embodiments 104-112, wherein in the process, the mixture is calcined at a temperature of at least 350° C.

Embodiment 115: The composition of any of embodiments 104-114, wherein in the process, the mixture is calcined for at least 2 hours.

Embodiment 116: The composition of any of embodiments 104-114, wherein in the process, the mixture is calcined for at least 4 hours.

Embodiment 117: The composition of any of embodiments 104-116, wherein in the process, the mixture has an essential absence of organic solvents other than the organic acid.

Embodiment 118: The composition of any of embodiments 104-117, wherein in the process, the mixture has an essential absence of citric acid.

Embodiment 119: A method for making a composition, the method comprising:

mixing a nickel precursor with an organic acid and water to form a mixture, the organic acid comprising no more than one carboxylic group and at least one functional group selected from the group consisting of carbonyl and hydroxyl; and

calcining the mixture at a temperature of at least 250° C. for at least 1 hour.

Embodiment 120: The method of embodiment 119, further comprising evaporating a portion of the mixture for a period of time sufficient for the mixture to form a gel prior to calcination.

Embodiment 121: The method of embodiment 120, further comprising heating the mixture for a period of time sufficient for the mixture to form a gel prior to calcination.

Embodiment 122: The method of any of embodiments 119-121, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid, and combinations thereof.

Embodiment 123: The method of embodiment 122, wherein the organic acid is glyoxylic acid.

Embodiment 124: The method of any of any of embodiments 119-123, wherein the nickel precursor is selected from the group consisting of nickel acetate, nickel hydroxide, nickel carbonate, nickel nitrate, nickel 2,4-pentanedionate, nickel formate, nickel oxalate, nickel chloride and combinations thereof.

Embodiment 125: The method of any of embodiments 119-124, wherein the mixture is calcined at a temperature of at least 300° C.

Embodiment 126: The method of any of embodiments 119-124, wherein the mixture is calcined at a temperature of at least 350° C.

Embodiment 127: The method of any of embodiments 119-126, wherein the mixture is calcined for at least 2 hours.

Embodiment 128: The method of any of embodiments 119-126, wherein the mixture is calcined for at least 4 hours.

Embodiment 129: The method of any of embodiments 119-128, wherein the mixture has an essential absence of organic solvents other than the organic acid.

Embodiment 130: The method of any of embodiments 119-129, wherein the mixture has an essential absence of citric acid.

Embodiment 131: A method for making a composition, the method comprising:

mixing a nickel precursor with an organic acid and water to form a mixture, the organic acid comprising two carboxylic groups and a carbonyl group; and

calcining the mixture at a temperature of at least 250° C. for at least 1 hour.

Embodiment 132: The method of embodiment 131, further comprising evaporating a portion of the mixture for a period of time sufficient for the mixture to form a gel prior to calcination.

Embodiment 133: The method of embodiment 131, further comprising heating the mixture for a period of time sufficient for the mixture to form a gel prior to calcination.

Embodiment 134: The method of any of embodiments 131-133, wherein the organic acid comprises no more than two carboxylic groups.

Embodiment 135: The method of any of embodiments 131-133, wherein the organic acid comprises no more than one carbonyl group.

Embodiment 136: The method of any of embodiments 131-135, wherein the organic acid is ketoglutaric acid.

Embodiment 137: The method of any of embodiments 131-136, wherein the nickel precursor is selected from the group consisting of nickel acetate, nickel hydroxide, nickel carbonate, nickel nitrate, nickel 2,4-pentanedionate, nickel formate, nickel oxalate nickel chloride and combinations thereof.

Embodiment 138: The method of any of embodiments 131-137, wherein the mixture is calcined at a temperature of at least 300° C.

Embodiment 139: The method of any of embodiments 131-137, wherein the mixture is calcined at a temperature of at least 350° C.

Embodiment 140: The method of any of embodiments 131-139, wherein the mixture is calcined for at least 2 hours.

Embodiment 141: The method of any of embodiments 131-139, wherein the mixture is calcined for at least 4 hours.

Embodiment 142: The method of any of embodiments 131-141, wherein the mixture has an essential absence of organic solvents other than the organic acid.

Embodiment 143: The method of any of embodiments 131-142, wherein the mixture has an essential absence of citric acid.

Embodiment 144: A method for making a composition, the method comprising:

mixing a nickel precursor with an acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture; and

calcining the mixture at a temperature of at least 250° C. for at least 1 hour.

Embodiment 145: The method of embodiment 144, further comprising evaporating a portion of the mixture for a period of time sufficient for the mixture to form a gel prior to calcination.

Embodiment 146: The method of embodiment 144, further comprising heating the mixture for a period of time sufficient for the mixture to form a gel prior to calcination.

Embodiment 147: The method of any of embodiments 144-146, wherein the mixture comprises water.

Embodiment 148: The method of any of embodiments 144-147, wherein the nickel precursor is selected from the group consisting of nickel acetate, nickel hydroxide, nickel carbonate, nickel nitrate, nickel 2,4-pentanedionate, nickel formate, nickel oxalate, nickel chloride and combinations thereof.

Embodiment 149: The method of any of embodiments 144-148, wherein the mixture is calcined at a temperature of at least 300° C.

Embodiment 150: The method of any of embodiments 144-148, wherein the mixture is calcined at a temperature of at least 350° C.

Embodiment 151: The method of any of embodiments 144-150, wherein the mixture is calcined for at least 2 hours.

Embodiment 152: The method of any of embodiments 144-150, wherein the mixture is calcined for at least 4 hours.

Embodiment 153: The method of any of embodiments 144-152, wherein the mixture has an essential absence of organic solvents other than the organic acid.

Embodiment 154: The method of any of embodiments 144-153, wherein the mixture has an essential absence of citric acid.

Embodiment 155: The method of any of embodiments 144-154, wherein the mixture comprises a combination of glyoxylic and ketoglutaric acid.

Embodiment 156: A composition comprising nickel glyoxylate.

Embodiment 157: The composition of embodiment 156, wherein the composition is a solution.

Embodiment 158: The composition of embodiment 156, wherein the composition is a precursor to make a solid nickel containing material.

Embodiment 159: The composition of embodiment 158, wherein the material is a catalyst.

Embodiment 160: A composition comprising nickel ketoglutarate.

Embodiment 161: The composition of embodiment 160, wherein the composition is a solution.

Embodiment 162: The composition of embodiment 160, wherein the composition is a precursor to make a solid nickel containing material.

Embodiment 163: The composition of embodiment 163, wherein the material is a catalyst.

Embodiment 164: A method of forming a nickel glyoxylate, the method comprising mixing nickel hydroxide with aqueous glyoxylic acid.

Embodiment 165: A method of forming a nickel ketoglutarate, the method comprising mixing nickel hydroxide with aqueous ketoglutaric acid.

### Cobalt

In the present invention, cobalt compositions having high BET surface areas, high cobalt or cobalt oxide content and/or thermal stability are disclosed.

The metal oxides and mixed metal oxides of the invention have important applications as catalysts, catalyst carriers, sorbents, sensors, actuators, gas diffusion electrodes, pigments, in magnetic applications, such as in magnetic storage devices, and as coatings and components in the semiconductor, electroceramics and electronics industries.

In general, the cobalt/cobalt oxide compositions of the invention are novel and inventive as unbound and/or unsupported as well as supported catalysts compared to known supported and unsupported cobalt and cobalt oxide catalyst formulations utilizing large amounts of binders such as silica, alumina, aluminum or chromia. In one embodiment, the compositions of the inventions are superior to known formulations both in terms of activity (compositions of the invention have higher surface area with a higher cobalt metal and/or cobalt oxide content) and in terms of selectivity (e.g. for hydrogenations, reductions and oxidations). The lower content or the absence of a binder/support (which is often unselective) and the high purity (i.e. high cobalt/cobalt oxide content and essential absence of Na, S, K and Cl and other impurities) achievable by methods of the invention provide improvements over state of the art compositions and methods. The productivity in terms of weight of material per volume of solution per unit time is much higher for the method of the invention as compared to present sol-gel or precipitation techniques since highly concentrated solutions ˜1M can be used as starting material. Moreover, no washing or aging steps are required by the method.

The present invention is thus directed to cobalt-containing compositions that comprise cobalt and/or cobalt oxide. Furthermore, the compositions of the present invention may comprise carbon or additional components that act as binders, promoters, stabilizers, or co-metals.

In one embodiment of the invention, the cobalt composition comprises Co metal, a Co oxide, or mixtures thereof. In another embodiment, the compositions of the invention comprise (i) cobalt or a cobalt-containing compound (e.g., cobalt oxide) and (ii) one or more additional metal, oxides thereof, salts thereof, or mixtures of such metals or compounds. In one embodiment, the additional metal is an alkali metal, alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the additional metal is one of Ti, Pt, Pd, Mo, Cr, Cu, Au, Sn, Mn, In, Ru, Mg, Ba, Fe, Ta, Nb, Ni, Hf, W, Y, Zn, Zr, Ce, Al, La, Si, Ag, Re, V or a compound containing one or more of such element(s), more specifically Mn, Mo, W, Cr, In, Sn, Ru, Ni, Ce, Zr, Y, Ag, Fe, Pt, or a compound containing one or more of such element(s). The concentrations of the additional components are such that the presence of the component would not be considered an impurity. For example, when present, the concentrations of the additional metals or metal containing components (e.g., metal oxides) are at least about 0.1, 0.5, 1, 2, 5, or even 10 molecular percent or more by weight.

The major component of the composition typically comprises a Co oxide. The major component of the composition can, however, also include various amounts of elemental Co and/or Co-containing compounds, such as Co salts. The Co oxide is an oxide of cobalt where cobalt is in an oxidation state other than the fully-reduced, elemental Co^{o} state, including oxides of cobalt where cobalt has an oxidation state of Co⁺², Co⁺³, or a partially reduced oxidation state. The total amount of cobalt and/or cobalt oxide (CoO, CO₂O₃, CO₃O₄ or a combination) present in the composition is at least about 25% by weight on a molecular basis. More specifically, compositions of the present invention include at least 35% cobalt and/or cobalt oxide, more specifically at least 50%, more specifically at least 60%, more specifically at least 70%, more specifically at least 75%, more specifically at least 80%, more specifically at least 85%, more specifically at least 90%, and more specifically at least 95% cobalt and/or cobalt oxide by weight. In one embodiment, the cobalt/cobalt oxide component of the composition is at least 30% cobalt oxide, more specifically at least 50% cobalt oxide, more specifically at least 75% cobalt oxide, and more specifically at least 90% cobalt oxide by weight. As noted below, the cobalt/cobalt oxide component can also have a support or carrier functionality.

The one or more minor component(s) of the composition preferably comprise an element selected from the group consisting of Ti, Pt, Pd, Mo, Cr, Cu, Au, Sn, Mn, In, Ru, Mg, Ba, Fe, Ta, Nb, Ni, Hf, W, Y, Zn, Zr, Ce, Al, La, Si, Ag, Re, V, or a compound containing one or more of such element(s), such as oxides thereof and salts thereof, or mixtures of such elements or compounds. The minor component(s) more preferably comprises of one or more of Mn, Mo, W, Cr, In, Sn, Ru, Ni, Ce, Zr, Y, Ag, Fe, Pt, oxides thereof, salts thereof, or mixtures of the same. In one embodiment, the minor component(s) are preferably oxides of one or more of the minor-component elements, but can, however, also include various amounts of such elements and/or other compounds (e.g., salts) containing such elements. An oxide of such minor-component elements is an oxide thereof where the respective element is in an oxidation state other than the fully-reduced state, and includes oxides having an oxidation states corresponding to known stable valence numbers, as well as to oxides in partially reduced oxidation states. Salts of such minor-component elements can be any stable salt thereof, including, for example, chlorides, nitrates, carbonates and acetates, among others. The amount of the oxide form of the particular recited elements present in one or more of the minor component(s) is at least about 5%, preferably at least about 10%, preferably still at least about 20%, more preferably at least about 35%, more preferably yet at least about 50% and most preferable at least about 60%, in each case by weight relative to total weight of the particular minor component. As noted below, the minor component can also have a support or carrier functionality.

In one embodiment, the minor component consists essentially of one element selected from the group consisting of Ti, Pt, Pd, Mo, Cr, Cu, Au, Sn, Mn, In, Ru, Mg, Ba, Fe, Ta, Nb, Ni, Hf, W, Y, Zn, Zr, Ce, Al, La, Si, Ag, Re, V, or a compound containing the element, more specifically Mn, Mo, W, Cr, In, Sn, Ru, Ni, Ce, Zr, Y, Ag, Fe, Pt, or a compound containing the element. In another embodiment, the minor component consists essentially of two elements selected from the group consisting of Ti, Pt, Pd, Mo, Cr, Cu, Au, Sn, Mn, In, Ru, Mg, Ba, Fe, Ta, Nb, Ni, Hf, W, Y, Zn, Zr, Ce, Al, La, Si, Ag, Re, V, or a compound containing one or more of such elements, more specifically Mn, Mo, W, Cr, In, Sn, Ru, Ni, Ce, Zr, Y, Ag, Fe, Pt, or a compound containing the element.

Thus, in one specific embodiment of the compound shown in formula I, the composition of the invention is a material comprising a compound having the formula (III):

CoₐM²_{b}M³_{c}M⁴_{d}M⁵ₑO_{f} (III),

where, Co is cobalt, O is oxygen and M², M³, M⁴, M⁵, a, b, c, d, e and f are as described above in formula I, and more specifically below, and can be grouped in any of the various combinations and permutations of preferences.

In formula III, “M²” “M³” “M⁴” and “M⁵” individually each represent a metal such as an alkali metal, an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically, “M²” “M³” “M⁴” and “M⁵” individually each represent a metal selected from Ti, Pt, Pd, Mo, Cr, Cu, Au, Sn, Mn, In, Ru, Mg, Ba, Fe, Ta, Nb, Ni, Hf, W, Y, Zn, Zr, Ce, Al, La, Si, Ag, Re, V and more specifically Mn, Mo, W, Cr, In, Sn, Ru, Ni, Ce, Zr, Y, Ag, Fe and Pt.

In formula III, a+b+c+d+e=1. The letter “a” represents a number ranging from about 0.2 to about 1.00, specifically from about 0.4 to about 0.90, more specifically from about 0.5 to about 0.9, and even more specifically from about 0.7 to about 0.8. The letters “b” “c” “d” and “e” individually represent a number ranging from about 0 to about 0.5, specifically from about 0.04 to about 0.2, and more specifically from about 0.04 to about 0.1.

In formula III, “O” represents oxygen, and “f” represents a number that satisfies valence requirements. In general, “e2” is based on the oxidation states and the relative atomic fractions of the various metal atoms of the compound of formula III (e.g., calculated as one-half of the sum of the products of oxidation state and atomic fraction for each of the metal oxide components).

In one mixed-metal oxide embodiment, where, with reference to formula III, “c” “d” and “e” are zero, the catalyst material can comprise a compound having the formula III-A:

CoₐM²_{b}O_{f} (III-A),

where Co is cobalt, O is oxygen, and where “a”, “M²”, “b” and “f” are as defined above.

In another embodiment, where, with reference to formula III, “b” “c” “d” and “e” are zero, the catalyst material can comprise a compound having the formula III-B:

COₐO_{f} (III-B),

where Co is cobalt, O is oxygen, and where “a” and “f” are as defined above.

In one embodiment, the compositions of the invention can also include carbon. The amount of carbon in the compositions is typically less than 75% by weight. More specifically, the compositions of the invention have between about 0.01% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the compositions of the invention have an essential absence of Na, S, K and Cl.

In another embodiment, the compositions have less than 10% water, specifically, less than 5% water, more specifically less than 3% water, more specifically less than 1% water, and more specifically less than 0.5% water.

The compositions can include other components as well, such as diluents, binders and/or fillers, as desired in connection with the reaction system of interest.

In one embodiment, the compositions of the invention are typically a high surface area porous solid. Specifically, the BET surface area of the composition is from about 50 to about 500 m²/g, more specifically from about 90 to about 500 m²/g, more specifically from about 100 to about 500 m²/g, more specifically from about 100 to about 300 m²/g, more specifically from about 110 to about 250 m²/g, more specifically from about 120 to about 200 m²/g, more specifically from about 130 to about 200 m²/g, more specifically from about 140 to about 200 m²/g, more specifically from about 150 to about 200 m²/g, and more specifically from about 160 to about 200 m²/g. In another embodiment, the BET surface area of the composition is at least about 100 m²/g, more specifically at least about 110 m²/g, more specifically at least about 120 m²/g, more specifically at least about 130 m²/g, more specifically at least about 140 M²/g, more specifically at least about 150 m²/g, and more specifically at least about 155 m²/g.

In one embodiment, the compositions of the invention are thermally stable.

In one embodiment, the compositions of the invention are porous solids, having a wide range of pore diameters. In one embodiment, at least 10%, more specifically at least 20% and more specifically at least 30% of the pores of the composition of the invention have a pore diameter greater than 10 nm, more specifically greater than 15 nm, and more specifically greater than 20 nm. Additionally, at least 10%, specifically at least 20% and more specifically at least 30% of the pores of the composition have a pore diameter less than 12 nm, specifically less than 10 nm, more specifically less than 8 nm and more specifically less than 6 nm.

In one embodiment, the total pore volume (the cumulative BJH pore volume between 1.7 nm and 300 nm diameter) is greater than 0.10 ml/g, more specifically, greater than 0.15 ml/g, more specifically, greater then 0.175 ml/g, more specifically, greater then 0.20 ml/g, more specifically, greater then 0.25 ml/g, more specifically, greater then 0.30 ml/g, more specifically, greater then 0.35 ml/g, more specifically, greater then 0.40 ml/g, more specifically, greater then 0.45 ml/g, and more specifically, greater then 0.50 ml/g.

In one embodiment, the materials are fairly amorphous. That is, the materials are less than 80% crystalline, specifically, less than 60% crystalline and more specifically, less than 50% crystalline.

In one embodiment, the composition of the invention is a bulk metal or mixed metal oxide material. In another embodiment, the composition is a support or carrier on which other materials are impregnated. In one embodiment, the compositions of the invention have thermal stability and high surface areas with an essential absence of silica, alumina, aluminum or chromia. In still another embodiment, the composition is supported on a carrier, (e.g., a supported catalyst). In another embodiment, the composition comprises both the support and the catalyst. In embodiments where the composition is a supported catalyst, the support utilized may contain one or more of the metals (or metalloids) of the catalyst, including cobalt. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

In embodiments where the composition of the invention is a supported catalyst, the one or more of the aforementioned compounds or compositions can be located on a solid support or carrier. The support can be a porous support, with a pore size typically ranging, without limitation, from about 2 nm to about 100 nm and with a surface area typically ranging, without limitation, from about 5 m²/g to about 1500 m²/g. The particular support or carrier material is not narrowly critical, and can include, for example, a material selected from the group consisting of silica, alumina, zeolite, activated carbon, titania, zirconia, magnesia, ceria, tin oxide, niobia, zeolites and clays, among others, or mixtures thereof. Preferred support materials include titania, zirconia, alumina or silica. In some cases, where the support material itself is the same as one of the preferred components (e.g., Al₂O₃ for Al as a minor component), the support material itself may effectively form a part of the catalytically active material. In other cases, the support can be entirely inert to the reaction of interest.

The cobalt compositions of the present invention are made by a novel method that results in pure and/or high surface area cobalt/cobalt oxide materials. In one embodiment, the method includes mixing a cobalt precursor with an organic acid and water to form a mixture, and calcining the mixture. According to one approach for preparing a mixed-metal oxide composition of the invention, the mixture also includes a metal precursor other than a cobalt precursor.

The mixture comprises the cobalt precursor and the organic acid. In one embodiment, the mixture preferably has an essential absence of any organic solvent other then the organic acid (which may or may not be a solvent for the cobalt precursor), such as alcohols. In another embodiment, the mixture preferably has an essential absence of citric acid. In another embodiment, the mixture preferably has an essential absence of citric acid and organic solvents other than the organic acid.

The organic acids used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, imino, hydrazine, oxime or hydroxylamine groups, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, and oxalic acid, oxalacetic acid, and more specifically, glyoxylic acid and ketoglutaric acid.

The cobalt precursor used in the method of the invention is selected from the group consisting of cobalt acetate, cobalt hydroxide, cobalt carbonate, cobalt nitrate, cobalt 2,4-pentanedionate, cobalt formate, cobalt oxide, cobalt metal, cobalt chloride, cobalt alkoxide, cobalt perchlorate, cobalt carboxylate, and combinations thereof, specifically, cobalt hydroxide, cobalt acetate and cobalt carbonate. Specific cobalt carboxylates include cobalt oxalate, cobalt ketoglutarate, cobalt citrate, cobalt tartrate, cobalt malate, cobalt lactate , cobalt gluconate, cobalt glycine and cobalt glyoxylate.

Mixed-metal oxide compositions can also be made by the methods of the invention by including more than one metal precursor in the mixture.

The ratio of mmols of acid to mmols metal can vary from about 10:1 to about 1:10, more specifically from about 7:1 to about 1:5, more specifically from about 5:1 to about 1:4, and more specifically from about 3:1 to about 1:3.

Water may also be present in the mixtures described above. The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi stage calcination as described below.

In another embodiment, the method includes evaporating the mixture to dryness or providing the dry cobalt precursor and calcining the dry component to form a solid cobalt oxide. Specifically, the cobalt precursor is a cobalt carboxylate, more specifically, cobalt glyoxylate, cobalt ketoglutarate, cobalt oxalacetate, cobalt diglycolate, or cobalt oxalate.

In another embodiment, as an alternative to starting from acidic solutions, cobalt precursors can be mixed with bases. Bases such as ammonia, tetraalkylammonium hydroxide, organic amines and aminoalcohols can be used as dispersants. The resulting basic solutions can then be aged at room temperature or by slow evaporation and calcinations (or other means of low temperature detemplation).

In other embodiments, dispersants other than organic acids can be utilized. For example, non-acidic dispersants with at least two functional groups, such as dialdehydes (glyoxal) and ethylene glycol have been found to form pure and/or high surface area cobalt-containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

The heating of the resulting mixture is typically a calcination, which may be conducted in an oxygen-containing atmosphere or in the substantial absence of oxygen, e.g., in an inert atmosphere or in vacuo. The inert atmosphere may be any material which is substantially inert, e.g., does not react or interact with the material. Suitable examples include, without limitation, nitrogen, argon, xenon, helium or mixtures thereof. Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 150° C. to 850° C., specifically from 200° C. to 500° C. more specifically from 200° C. to 400° C., more specifically from 250° C. to 400° C., and more specifically from 275° C. to 375° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

In some embodiments it may be desirable to reduce all or a portion of the cobalt oxide material to a reduced (elemental) cobalt for a reaction of interest. The cobalt oxide materials of the invention can be partially or entirely reduced by reacting the cobalt oxide containing material with a reducing agent, such as hydrazine or formic acid, or by introducing, a reducing gas, such as, for example, ammonia or hydrogen, during or after calcination. In one embodiment, the cobalt oxide material is reacted with a reducing agent in a reactor by flowing a reducing agent through the reactor. This provides a material with a reduced (elemental) cobalt surface for carrying out the reaction of interest.

As an alternative to calcination, the material can be detemplated by the oxidation of organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The compositions of the invention are typically solid catalysts, and can be used in a reactor, such as a three phase reactor with a packed bed (e.g., a trickle bed reactor), a fixed bed reactor (e.g., a plug flow reactor), a fluidized or moving bed reactor, a honeycomb, a two or three phase batch reactor, or a continuous stirred tank reactor. The compositions can also be used in a slurry or suspension.

Preferred embodiments of the invention, thus, further include:

Embodiment 166: A composition comprising at least about 50% cobalt metal or a cobalt oxide by weight, the composition being a porous solid composition having a BET surface area of at least 90 square meters per gram wherein at least 10% of the pores have a diameter greater than 10 nm.

Embodiment 167: A composition comprising at least about 50% cobalt metal or a cobalt oxide by weight, the composition being a porous solid composition, having a BET surface area of at least 90 square meters per gram and having an essential absence of sulfate.

Embodiment 168: A composition consisting essentially of carbon and at least about 50% cobalt metal or a cobalt oxide, the composition being a porous solid composition having a BET surface area of at least 90 square meters per gram, wherein at least 10% of the pores have a diameter greater than 10 nm.

Embodiment 169: The composition of embodiments 166 or 167, further comprising a metal other than cobalt.

Embodiment 170: The composition of any of embodiments 166-169, wherein the composition comprises at least 60% cobalt metal or the cobalt oxide by weight.

Embodiment 171: The composition of any of embodiments 166-169, wherein the composition comprises at least 70% cobalt metal or the cobalt oxide by weight.

Embodiment 172: The composition of any of embodiments 166-169, wherein the composition comprises at least 75% cobalt metal or the cobalt oxide by weight.

Embodiment 173: The composition of any of embodiments 166-169, wherein the composition comprises at least 80% cobalt metal or the cobalt oxide by weight.

Embodiment 174: The composition of any of embodiments 166-169, wherein the composition comprises at least 85% cobalt metal or the cobalt oxide by weight.

Embodiment 175: The composition of any of embodiments 166-169, wherein the composition comprises at least 90% cobalt metal or the cobalt oxide by weight.

Embodiment 176: The composition of any of embodiments 166-169, wherein the composition comprises at least 95% cobalt metal or the cobalt oxide by weight.

Embodiment 177: The composition of any of embodiments 166-176, wherein the composition has a BET surface area of at least 100 square meters per gram.

Embodiment 178: The composition of any of embodiments 166-176, wherein the composition has a BET surface area of at least 110 square meters per gram.

Embodiment 179: The composition of any of embodiments 166-178, wherein the BET surface area is between about 120 square meters per gram and 200 square meters per gram.

Embodiment 180: The composition of any of embodiments 166-179, wherein the BET surface area is at least 120 square grams per meter.

Embodiment 181: The composition of any of embodiments 166-179, wherein the BET surface area is at least 130 square meters per gram.

Embodiment 182: The composition of any of embodiments 166-179, wherein the BET surface area is at least 140 square meters per gram.

Embodiment 183: The composition of any of embodiments 166-179, wherein the BET surface area is at least 150 square meters per gram.

Embodiment 184: The composition of any of embodiments 166-179, wherein the BET surface area is at least 155 square meters per gram.

Embodiment 185: The composition of any of embodiments 166-184, wherein the cobalt oxide is CoO.

Embodiment 186: The composition of any of embodiments 166-184, wherein the cobalt oxide is Co2O3.

Embodiment 187: The composition of any of embodiments 166-184, wherein the cobalt oxide is Co3O4.

Embodiment 188: The composition of any of embodiments 166-184, wherein the cobalt oxide is a combination of CoO, Co2O3 and Co3O4.

Embodiment 189: The composition of any of embodiments 166-188, comprising between about 0.01% and about 20% carbon by weight.

Embodiment 190: The composition of embodiment 189, wherein the composition comprises between about 0.5% and about 10% carbon by weight.

Embodiment 191: The composition of embodiment 189, wherein the composition comprises between about 1.0% and about 5% carbon by weight.

Embodiment 192: The composition of embodiment 189, wherein the composition comprises between about 0.01% and about 0.5% carbon by weight.

Embodiment 193: The composition of any of embodiments 166, 167, and 169-192, wherein the composition has an essential absence of silica, alumina, aluminum or chromia.

Embodiment 194: The composition of any of embodiments 166, and 168-193, wherein the composition has an essential absence of sulfate.

Embodiment 195: The composition of any of embodiments 166-194, wherein the composition has an essential absence of sodium.

Embodiment 196: The composition of any of embodiments 166-195, wherein the composition is a catalyst.

Embodiment 197: The composition of any of embodiments 166-196, wherein the composition is thermally stable with respect to the BET surface area of the composition decreasing by not more than 10% when heated at 350° C. for 2 hours.

Embodiment 198: The composition of any of embodiments 166-197, wherein the cobalt metal or cobalt oxide is at least 30% cobalt oxide.

Embodiment 199: The composition of embodiment 198, wherein the cobalt metal or cobalt oxide is at least 50% cobalt oxide.

Embodiment 200: The composition of embodiment 198, wherein the cobalt metal or cobalt oxide is at least 75% cobalt oxide.

Embodiment 201: The composition of embodiment 198, wherein the cobalt metal or cobalt oxide is at least 90% cobalt oxide.

Embodiment 202: The composition of any of embodiments 198-201, wherein the cobalt oxide is CoO.

Embodiment 203: The composition of any of embodiments 166, 167 and 170-202, further comprising a component selected from the group consisting of Mg, Al, Ba, Cr, Mn, Fe, Ni, Cu, Zr, Nb, Mo, Ru, Pd, In, Sn, La, Ta, W, Pt, Au, Ce, Ag, Re, V, their oxides, and combinations thereof.

Embodiment 204: The composition of embodiment 169, wherein the metal other than cobalt is selected from the group consisting of Mg, Al, Ba, Cr, Mn, Fe, Ni, Cu, Zr, Nb, Mo, Ru, Pd, In, Sn, La, Ta, W, Pt, Au, Ce, Ag, Re, V their oxides, and combinations thereof.

Embodiment 205: The composition of any of embodiments 166-204, wherein the composition is an unsupported material.

Embodiment 206: The composition of any of embodiments 166-204, wherein the composition is on a support.

Embodiment 207: The composition of any of embodiments 167-206, wherein the composition is a porous solid wherein at least 10% of the pores have a diameter greater than 10 nm.

Embodiment 208: The composition of any of embodiments 166-207, wherein at least 10% of the pores have a diameter greater than 15 nm.

Embodiment 209: The composition of any of embodiments 166-208, wherein at least 10% of the pores have a diameter greater than 20 nm.

Embodiment 210: The composition of any of embodiments 166-209, wherein at least 20% of the pores have a diameter greater than 20 nm.

Embodiment 211: The composition of any of embodiments 166-210, wherein at least 30% of the pores have a diameter greater than 20 nm.

Embodiment 212: The composition of any of embodiments 166-211, wherein at least 10% of the pores have a diameter less than 10 nm.

Embodiment 213: The composition of any of embodiments 166-212, wherein at least 20% of the pores have a diameter less than 10 nm.

Embodiment 214: The composition of any of embodiments 166-213 in a reactor.

Embodiment 215: The composition of embodiment 214, wherein the reactor is a three phase reactor with a packed bed.

Embodiment 216: The composition of embodiment 214, wherein the reactor is a trickle bed reactor.

Embodiment 217: The composition of embodiment 214, wherein the reactor is a fixed bed reactor.

Embodiment 218: The composition of embodiment 214, wherein the reactor is a plug flow reactor.

Embodiment 219: The composition of embodiment 214, wherein the reactor is a fluidized bed reactor.

Embodiment 220: The composition of embodiment 214, where the reactor is a two or three phase batch reactor.

Embodiment 221: The composition of embodiment 214, wherein the reactor is a continuous stirred tank reactor.

Embodiment 222: The composition of embodiment 214, wherein the reactor is a honeycomb.

Embodiment 223: The composition of any of embodiments 166-213 in a slurry or suspension.

Embodiment 224: The composition of any of embodiments 166-213, made by a process comprising:

mixing a cobalt precursor with an organic acid and water to form a mixture; and

calcining the mixture at a temperature of at least 250° C. for at least 1 hour.

Embodiment 225: The composition of embodiment 224, wherein the process further comprises evaporating a portion of the mixture for a period of time sufficient for the mixture to form a gel prior to calcination.

Embodiment 226: The composition of embodiment 224, wherein the process further comprises heating the mixture for a period of time sufficient for the mixture to form a gel prior to calcination.

Embodiment 227: The composition of any of embodiments 224-226, wherein in the process, the organic acid comprises a carboxyl group.

Embodiment 228: The composition of any of embodiments 224-227, wherein in the process, the organic acid comprises no more than one carboxylic group and at least one functional group selected from the group consisting of hydroxyl and carbonyl.

Embodiment 229: The composition of any of embodiments 224-228, wherein in the process, the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid, and combinations thereof.

Embodiment 230: The composition of any of embodiments 224-229, wherein in the process, the organic acid is ketoglutaric acid.

Embodiment 231: The composition of any of embodiments 224-230, wherein in the process, the organic acid is selected from the group consisting of glyoxylic acid, ketoglutaric acid and combinations thereof.

Embodiment 232: The composition of any of embodiments 224-231, wherein in the process, the cobalt precursor is selected from the group consisting of cobalt acetate, cobalt hydroxide, cobalt carbonate, cobalt nitrate, cobalt 2,4-pentanedionate, cobalt formate, cobalt oxalate, cobalt chloride, cobalt tartrate, cobalt lactate, cobalt citrate and combinations thereof.

Embodiment 233: The composition of any of embodiments 224-232, wherein in the process, the mixture is calcined at a temperature of at least 275° C.

Embodiment 234: The composition of any of embodiments 224-232, wherein in the process, the mixture is calcined at a temperature of at least 300° C.

Embodiment 235: The composition of any of embodiments 224-234, wherein in the process, the mixture is calcined for at least 2 hours.

Embodiment 236: The composition of any of embodiments 224-235, wherein in the process, the mixture is calcined for at least 4 hours.

Embodiment 237: The composition of any of embodiments 224-236, wherein in the process, the mixture has an essential absence of organic solvents other than the organic acid.

Embodiment 238: The composition of any of embodiments 224-237, wherein in the process, the mixture has an essential absence of citric acid.

Embodiment 239: A method for making a composition, the method comprising:

mixing a cobalt precursor with an organic acid and water to form a mixture, the organic acid comprising no more than one carboxylic group and at least one functional group selected from the group consisting of carbonyl and hydroxyl;

forming a gel; and

calcining the mixture at a temperature of at least 250° C. for a time sufficient to form a solid.

Embodiment 240: The method of embodiment 239, wherein the gel forming step comprises evaporating a portion of the mixture for a period of time sufficient for the mixture to form the gel prior to calcination.

Embodiment 241: The method of embodiment 239, wherein the gel forming step comprises heating the mixture for a period of time sufficient for the mixture to form the gel prior to calcination.

Embodiment 242: The method of any of embodiments 239-241, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 243: The method of embodiment 239-242, wherein the organic acid is glyoxylic acid.

Embodiment 244: The method of any of any of embodiments 239-243, wherein the cobalt precursor is selected from the group consisting of cobalt acetate, cobalt hydroxide, cobalt carbonate, cobalt nitrate, cobalt 2,4-pentanedionate, cobalt formate, cobalt oxalate, cobalt chloride, cobalt tartrate, cobalt lactate, cobalt citrate and combinations thereof.

Embodiment 245: The method of any of embodiments 239-244, wherein the mixture is calcined at a temperature of at least 275° C.

Embodiment 246: The method of any of embodiments 239-245, wherein the mixture is calcined at a temperature of at least 300° C.

Embodiment 247: The method of any of embodiments 239-246, wherein the mixture is calcined for at least 1 hour.

Embodiment 248: The method of any of embodiments 239-247, wherein the mixture is calcined for at least 2 hours.

Embodiment 249: The method of any of embodiments 239-248, wherein the mixture is calcined for at least 4 hours.

Embodiment 250: The method of any of embodiments 239-249, wherein the mixture has an essential absence of organic solvents other than the organic acid.

Embodiment 251: The method of any of embodiments 239-250, wherein the mixture has an essential absence of citric acid.

Embodiment 252: A method for making a composition, the method comprising:

mixing a cobalt precursor with an organic acid and water to form a mixture, the organic acid comprising two carboxylic groups and a carbonyl group; and

calcining the mixture at a temperature of at least 250° C. for a time sufficient to form a solid.

Embodiment 253: The method of embodiment 252, further comprising evaporating a portion of the mixture for a period of time sufficient for the mixture to form a gel prior to calcination.

Embodiment 254: The method of embodiment 252, further comprising heating the mixture for a period of time sufficient for the mixture to form a gel prior to calcination.

Embodiment 255: The method of any of embodiments 252-254, wherein the organic acid comprises no more than two carboxylic groups.

Embodiment 256: The method of any of embodiments 252-255, wherein the organic acid comprises no more than one carbonyl group.

Embodiment 257: The method of any of embodiments 252-256, wherein the organic acid is ketoglutaric acid.

Embodiment 258: The method of any of embodiments 252-257, wherein the cobalt precursor is selected from the group consisting of cobalt acetate, cobalt hydroxide, cobalt carbonate, cobalt nitrate, cobalt 2,4-pentanedionate, cobalt formate, cobalt oxalate cobalt chloride, cobalt tartrate, cobalt lactate, cobalt citrate and combinations thereof.

Embodiment 259: The method of any of embodiments 252-258, wherein the mixture is calcined at a temperature of at least 275° C.

Embodiment 260: The method of any of embodiments 252-259, wherein the mixture is calcined at a temperature of at least 300° C.

Embodiment 261: The method of any of embodiments 252-260, wherein the mixture is calcined for at least 1 hour.

Embodiment 262: The method of any of embodiments 252-261, wherein the mixture is calcined for at least 2 hours.

Embodiment 263: The method of any of embodiments 252-262, wherein the mixture is calcined for at least 4 hours.

Embodiment 264: The method of any of embodiments 252-263, wherein the mixture has an essential absence of organic solvents other than the organic acid.

Embodiment 265: The method of any of embodiments 252-264, wherein the mixture has an essential absence of citric acid.

Embodiment 266: A method for making a composition, the method comprising:

mixing a cobalt precursor with an acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture;

forming a gel; and

calcining the gel at a temperature of at least 250° C. for at least 1 hour.

Embodiment 267: The method of embodiment 266, wherein the gel forming step comprises evaporating a portion of the mixture for a period of time sufficient for the mixture to form the gel prior to calcination.

Embodiment 268: The method of embodiment 266, wherein the gel forming step comprises heating the mixture for a period of time sufficient for the mixture to form a gel prior to calcination.

Embodiment 269: The method of any of embodiments 266-268, wherein the mixture comprises water.

Embodiment 270: The method of any of embodiments 266-269, wherein the cobalt precursor is selected from the group consisting of cobalt acetate, cobalt hydroxide, cobalt carbonate, cobalt nitrate, cobalt 2,4-pentanedionate, cobalt formate, cobalt oxalate, cobalt chloride, cobalt tartrate, cobalt lactate, cobalt citrate and combinations thereof.

Embodiment 271: The method of any of embodiments 266-270, wherein the gel is calcined at a temperature of at least 275° C.

Embodiment 272: The method of any of embodiments 266-271, wherein the gel is calcined at a temperature of at least 300° C.

Embodiment 273: The method of any of embodiments 266-272, wherein the gel is calcined for at least 2 hours.

Embodiment 274: The method of any of embodiments 266-273, wherein the gel is calcined for at least 4 hours.

Embodiment 275: The method of any of embodiments 266-274, wherein the mixture has an essential absence of organic solvents other than the organic acid.

Embodiment 276: The method of any of embodiments 266-275, wherein the mixture has an essential absence of citric acid.

Embodiment 277: The method of any of embodiments 266-276, wherein the mixture comprises a combination of glyoxylic and ketoglutaric acid.

Embodiment 278: A composition comprising cobalt glyoxylate.

Embodiment 279: The composition of embodiment 278, wherein the composition is a solution.

Embodiment 280: The composition of embodiments 279 or 279, wherein the composition is a precursor to make a solid cobalt containing material.

Embodiment 281: The composition of embodiment 280, wherein the material is a catalyst, a catalyst component, or a catalytic material.

Embodiment 282: A composition comprising cobalt ketoglutarate.

Embodiment 283: The composition of embodiment 282, wherein the composition is a solution.

Embodiment 284: The composition of embodiments 282 or 283, wherein the composition is a precursor to make a solid cobalt containing material.

Embodiment 285: The composition of embodiment 284, wherein the material is a catalyst.

Embodiment 286: A method of forming a cobalt glyoxylate, the method comprising mixing cobalt hydroxide with aqueous glyoxylic acid.

Embodiment 287: A method of forming a cobalt ketoglutarate, the method comprising mixing cobalt hydroxide with aqueous ketoglutaric acid.

### Yttrium

In the present invention, yttrium compositions having high BET surface areas, and high yttrium oxide content are disclosed.

The metal oxides and mixed metal oxides of the invention have important applications as catalysts, catalyst carriers, sorbents, sensors, actuators, gas diffusion electrodes, pigments, fillers, binders, ceramic superconductors, garnets, as coatings and components in the semiconductor, electroceramics and electronics industries, in optical devices and lasers such as luminescent, fluorescent and phosphorescent materials, in high temperature protective coatings, high temperature ceramic service materials, stabilizers in mixed metal oxide formulations, and as (oxygen and/or electrical) conductors in solid oxide fuel cells.

In general, the yttrium oxide compositions of the invention are novel and inventive as unbound and/or unsupported as well as supported catalysts and as carriers compared to known supported and unsupported yttrium oxide catalyst formulations utilizing large amounts of binders such as silica, alumina, aluminum or chromia. In one embodiment, the compositions of the inventions are superior to known formulations both in terms of activity (compositions of the invention have higher surface area with a higher yttrium oxide content) and in terms of selectivity (e.g. for hydrogenations, reductions and oxidations). The lower content or the absence of a binder/support (which is often unselective) and the high purity (i.e. high yttrium oxide content and essential absence of Na, S, K and Cl and other impurities) achievable by methods of the invention provide improvements over state of the art compositions and methods. The productivity in terms of weight of material per volume of solution per unit time is much higher for the method of the invention as compared to present sol-gel or precipitation techniques since highly concentrated solutions ˜1M can be used as starting material. Moreover, no washing or aging steps are required by the method.

The present invention is thus directed to yttrium-containing compositions that comprise yttrium oxide. Furthermore, the compositions of the present invention may comprise carbon or additional components that act as binders, promoters, stabilizers, or co-metals.

In one embodiment of the invention, the yttrium composition comprises Y oxide (Y₂O₃). In another embodiment, the compositions of the invention comprise (i) a yttrium-containing compound (e.g., yttrium oxide, yttrium carbonate, and combinations thereof) and (ii) one or more additional metal, oxides thereof, salts thereof, or mixtures of such metals or compounds. In one embodiment, the additional metal is an alkali metal, alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the additional metal is one of Ti, Pt, Pd, Mo, Cr, Cu, Au, Sn, Mn, In, Ru, Mg, Ba, Fe, Ta, Nb, Ni, Hf, W, Co, Zn, Zr, Ce, Al, Si, a rare earth metal or a compound containing one or more of such element(s), more specifically Zr, Cu, Ba, Al, Mn, Mo, W, Cr, In, Sn, Ru, Co, Ce, Ni, La, Nd, or a compound containing one or more of such element(s), and more specifically, Zr, Ba, Cu, Al, La, Nd or a compound containing one or more of such element(s). The concentrations of the additional components are such that the presence of the component would not be considered an impurity. For example, when present, the concentrations of the additional metals or metal containing components (e.g., metal oxides) are at least about 0.1, 0.5, 1, 2, 5, or even 10 molecular percent or more by weight.

The major component of the composition typically comprises Y oxide. The major component of the composition can, however, also include various amounts of elemental Y and/or Y-containing compounds, such as Y salts. The Y oxide is an oxide of yttrium where yttrium is in an oxidation state other than the fully-reduced, elemental Y^{o} state, including oxides of yttrium where yttrium has an oxidation state of +3. The total amount of yttrium and/or yttrium oxide present in the composition is at least about 25% by weight on a molecular basis. More specifically, compositions of the present invention include at least 35% yttrium oxide, more specifically at least 50%, more specifically at least 60%, more specifically at least 70%, more specifically at least 75%, more specifically at least 80%, more specifically at least 85%, more specifically at least 90%, and more specifically at least 95% yttrium oxide by weight. In one embodiment, the yttrium oxide component of the composition is at least 30% yttrium oxide, more specifically at least 50% yttrium oxide, more specifically at least 75% yttrium oxide, and more specifically at least 90% yttrium oxide by weight. As noted below, the yttrium oxide component can also have a support or carrier functionality.

The one or more minor component(s) of the composition preferably comprise an element selected from the group consisting of Ti, Pt, Pd, Mo, Cr, Cu, Au, Sn, Mn, In, Ru, Mg, Ba, Fe, Ta, Nb, Ni, Hf, W, Co, Zn, Zr, Ce, Al, Si, a rare earth metal, or a compound containing one or more of such element(s), such as oxides thereof and salts thereof, or mixtures of such elements or compounds. The minor component(s) more preferably comprises of one or more of Zr, Cu, Ba, Al, Mn, Mo, W, Cr, In, Sn, Ru, Co, Ce, Ni, La and Nd, oxides thereof, salts thereof, or mixtures of the same, and more specifically, Zr, Ba, Cu, Al, Nd, oxides thereof, salts thereof, or mixtures of the same. In one embodiment, the minor component(s) are preferably oxides of one or more of the minor-component elements, but can, however, also include various amounts of such elements and/or other compounds (e.g., salts) containing such elements. An oxide of such minor-component elements is an oxide thereof where the respective element is in an oxidation state other than the fully-reduced state, and includes oxides having an oxidation states corresponding to known stable valence numbers, as well as to oxides in partially reduced oxidation states. Salts of such minor-component elements can be any stable salt thereof, including, for example, chlorides, nitrates, carbonates and acetates, among others. The amount of the oxide form of the particular recited elements present in one or more of the minor component(s) is at least about 5%, preferably at least about 10%, preferably still at least about 20%, more preferably at least about 35%, more preferably yet at least about 50% and most preferable at least about 60%, in each case by weight relative to total weight of the particular minor component. As noted below, the minor component can also have a support or carrier functionality.

In one embodiment, the minor component consists essentially of one element selected from the group consisting of Ti, Pt, Pd, Mo, Cr, Cu, Au, Sn, Mn, In, Ru, Mg, Ba, Fe, Ta, Nb, Ni, Hf, W, Co, Zn, Zr, Ce, Al, Si, a rare earth metal, or a compound containing the element. In another embodiment, the minor component consists essentially of two elements selected from the group consisting Ti, Pt, Pd, Mo, Cr, Cu, Au, Sn, Mn, In, Ru, Mg, Ba, Fe, Ta, Nb, Ni, Hf, W, Co, Zn, Zr, Ce, Al, Si, a rare earth metal, or a compound containing one or more of such elements.

Thus, in one specific embodiment of the compound shown in formula I, the composition of the invention is a material comprising a compound having the formula (IV):

YₐM²_{b}M³_{c}M⁴_{d}M⁵ₑO_{f} (IV),

where, Y is yttrium, O is oxygen and M², M³, M⁴, M⁵, a, b, c, d, e and f are described above for formula I, and more specifically below, and can be grouped in any of the various combinations and permutations of preferences.

In formula IV, “M²” “M³” “M⁴” and “M⁵”, individually each represent a metal such as an alkali metal, an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically, “M²” “M³” “M⁴” and “M⁵” individually each represent a metal selected from Ti, Pt, Pd, Mo, Cr, Cu, Au, Sn, Mn, In, Ru, Mg, Ba, Fe, Ta, Nb, Ni, Hf, W, Co, Zn, Zr, Ce, Al, Si and a rare earth metal, and more specifically Zr, Cu, Ba, Al, Mn, Mo, W, Cr, In, Sn, Ru, Co, Ce, Ni, La and Nd, and more specifically, Zr, Ba, Cu, Al, and Nd. In one embodiment, the composition has an essential absence of Eu.

In formula IV, a+b+c+d+e=1. The letter “a” represents a number ranging from about 0.2 to about 1.00, specifically from about 0.4 to about 0.90, more specifically from about 0.5 to about 0.9, and even more specifically from about 0.7 to about 0.8. The letters “b” “c” “d” and “e”, individually represent a number ranging from about 0 to about 0.5, specifically from about 0.04 to about 0.2, and more specifically from about 0.04 to about 0.1. In formula IV, “O” represents oxygen, and “f” represents a number that satisfies valence requirements. In general, “f” is based on the oxidation states and the relative atomic fractions of the various metal atoms of the compound of formula IV (e.g., calculated as one-half of the sum of the products of oxidation state and atomic fraction for each of the metal oxide components).

In one mixed-metal oxide embodiment, where, with reference to formula IV, “c” “d” and “e” are zero, the catalyst material can comprise a compound having the formula IV-A:

YₐM²_{b}O_{f} (IV-A),

where Y is yttrium, O is oxygen, and where “a”, “M²”, “b” and “f” are as defined above.

In another embodiment, where, with reference to formula IV, “b” “c” “d” and “e” are zero, the catalyst material can comprise a compound having the formula IV-B:

YₐO_{f} (IV-B),

where Y is yttrium, O is oxygen, and where a and f are as defined above.

In one embodiment, the yttrium compositions of the invention can also include carbon. The amount of carbon in the compositions is typically less than 75% by weight. More specifically, the compositions of the invention have between about 0.01% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the yttrium compositions of the invention have an essential absence of Na, S, K and Cl, more specifically an absence of Na, S and K.

In another embodiment, the compositions have less than 10% water, specifically, less than 5% water, more specifically less than 3% water, more specifically less than 1% water, and more specifically less than 0.5% water.

The compositions can include other components as well, such as diluents, binders and/or fillers, as desired in connection with the reaction system of interest.

In one embodiment, the compositions of the invention are typically a high surface area porous solid. Specifically, the BET surface area of the composition is from about 50 to about 500 m²/g, more specifically from about 110 to about 220 m²/g. In another embodiment, the BET surface area of the composition is at least about 70 m²/g, more specifically at least about 100 m²/g, more specifically at least about 110 m²/g, more specifically at least about 120 m²/g, more specifically at least about 130 m²/g, more specifically at least about 140 m²/g, more specifically at least about 150 m²/g, more specifically at least about 160 m²/g, more specifically at least about 175 m²/g, more specifically at least about 200 m²/g, and more specifically from about 215 m²/g.

In one embodiment, the compositions of the invention are thermally stable.

In one embodiment, the compositions of the invention are porous solids, having a wide range of pore diameters. In one embodiment, at least 10%, more specifically at least 20% and more specifically at least 30% of the pores of the composition of the invention have a pore diameter greater than 10 nm, more specifically greater than 15 nm, and more specifically greater than 20 nm. Additionally, at least 10%, specifically at least 20% and more specifically at least 30% of the pores of the composition have a pore diameter less than 12 nm, specifically less than 10 nm, more specifically less than 8 nm and more specifically less than 6 nm.

In one embodiment, the total pore volume (the cumulative BJH pore volume between 1.7 nm and 300 nm diameter) is greater than 0.10 ml/g, more specifically, greater than 0.15 ml/g, more specifically, greater then 0.175 ml/g, more specifically, greater then 0.20 ml/g, more specifically, greater then 0.25 ml/g, more specifically, greater then 0.30 ml/g, more specifically, greater then 0.35 ml/g, more specifically, greater then 0.40 ml/g, more specifically, greater then 0.45 ml/g, and more specifically, greater then 0.50 ml/g.

In one embodiment, the materials are fairly amorphous. That is, the materials are less than 80% crystalline, specifically, less than 60% crystalline and more specifically, less than 50% crystalline.

In one embodiment, the composition of the invention is a bulk metal or mixed metal oxide material. In another embodiment, the composition is a support or carrier on which other materials are impregnated. In one embodiment, the compositions of the invention have thermal stability and high surface areas with an essential absence of silica, alumina, aluminum or chromia. In still another embodiment, the composition is supported on a carrier, (for example, a supported catalyst). In another embodiment, the composition comprises both the support and the catalyst. In embodiments where the composition is a supported catalyst, the support utilized may contain one or more of the metals (or metalloids) of the catalyst, including yttrium. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

In embodiments where the composition of the invention is a supported catalyst, the one or more of the aforementioned compounds or compositions can be located on a solid support or carrier. The support can be a porous support, with a pore size typically ranging, without limitation, from about 2 nm to about 100 nm and with a surface area typically ranging, without limitation, from about 5 m²/g to about 1500 m²/g. The particular support or carrier material is not narrowly critical, and can include, for example, a material selected from the group consisting of silica, alumina, zeolite, activated carbon, titania, zirconia, ceria, magnesia, niobia, zeolites and clays, among others, or mixtures thereof. Preferred support materials include titania, zirconia, alumina or silica. In some cases, where the support material itself is the same as one of the preferred components (e.g., Al₂O₃ for Al as a minor component), the support material itself may effectively form a part of the catalytically active material. In other cases, the support can be entirely inert to the reaction of interest.

The yttrium compositions of the present invention are made by a novel method that results in high surface area yttrium/yttrium oxide materials. In one embodiment, method includes mixing a yttrium precursor with an organic acid and water to form a mixture, and calcining the mixture. According to one approach for preparing a mixed-metal oxide composition of the invention, the mixture also includes a metal precursor other than a yttrium precursor.

The mixture comprises the yttrium precursor and the organic acid. In one embodiment, the mixture preferably has an essential absence of any organic solvent other then the organic acid (which may or may not be a solvent for the yttrium precursor), such as alcohols. In another embodiment, the mixture preferably has an essential absence of citric acid. In another embodiment, the mixture preferably has an essential absence of citric acid and organic solvents other than the organic acid.

The organic acids used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, or imino, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, and oxalic acid, oxalacetic acid, and more specifically, glyoxylic acid and ketoglutaric acid.

The yttrium precursor used in the method of the invention is selected from the group consisting of yttrium acetate, yttrium hydroxide, yttrium carbonate, yttrium nitrate, yttrium 2,4-pentanedionate, yttrium formate, yttrium oxide, yttrium metal, yttrium chloride, yttrium alkoxides, yttrium perchlorate, yttrium carboxylate and combinations thereof, specifically, yttrium hydroxide, yttrium acetate and yttrium carbonate. Specific yttrium carboxylates include yttrium oxalate, yttrium ketoglutarate, yttrium citrate, yttrium tartrate, yttrium malate, yttrium lactate and yttrium glyoxylate.

The ratio of mmols of acid to mmols metal can vary from about 10:1 to about 1:10, more specifically from about 7:1 to about 1:5, more specifically from about 5:1 to about 1:4, and more specifically from about 3:1 to about 1:3.

Mixed-metal oxide compositions can also be made by the methods of the invention by including more than one metal precursor in the mixture.

Water may also be present in the mixtures described above. The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi stage calcination as described below.

In another embodiment, the method includes evaporating the mixture to dryness or providing the dry yttrium precursor and calcining the dry component to form a solid yttrium oxide. Specifically, the yttrium precursor is a yttrium carboxylate, more specifically, yttrium glyoxylate, yttrium ketoglutarate, yttrium oxalacetate, or yttrium diglycolate.

In another embodiment, as an alternative to starting from acidic solutions, yttrium precursors can be mixed with bases. Bases such as ammonia, tetraalkylammonium hydroxide, organic amines and aminoalcohols can be used as dispersants. The resulting basic solutions can then be aged at room temperature or by slow evaporation and calcinations (or other means of low temperature detemplation).

In other embodiments, dispersants other than organic acids can be utilized. For example, non-acidic dispersants with at least two functional groups, such as dialdehydes (glyoxal) and ethylene glycol have been found to form pure and/or high surface area yttrium-containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

The heating of the resulting mixture is typically a calcination, which may be conducted in an oxygen-containing atmosphere or in the substantial absence of oxygen, e.g., in an inert atmosphere or in vacuo. The inert atmosphere may be any material which is substantially inert, e.g., does not react or interact with the material. Suitable examples include, without limitation, nitrogen, argon, xenon, helium or mixtures thereof. Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 200° C. to 850° C., specifically from 250° C. to 500° C. more specifically from 250° C. to 450° C., more specifically from 300° C. to 425° C., and more specifically from 350° C. to 400° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

As an alternative to calcination, the material can detemplated by the oxidation of organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The compositions of the invention are typically solid catalysts, and can be used in a reactor, such as a three phase reactor with a packed bed (e.g., a trickle bed reactor), a fixed bed reactor (e.g., a plug flow reactor), a honeycomb, a fluidized or moving bed reactor, a two or three phase batch reactor, or a continuous stirred tank reactor. The compositions can also be used in a slurry or suspension.

Preferred embodiments of the invention, thus, further include:

Embodiment 288: A composition comprising at least about 50% yttrium oxide by weight, the composition being a porous solid composition having a BET surface area of at least 70 square meters per gram wherein at least 10% of the pores have a diameter greater than 10 nm.

Embodiment 289: A composition comprising at least about 50% yttrium oxide by weight, the composition being a porous solid composition, having a BET surface area of at least 100 square meters per gram and having an essential absence of Europium.

Embodiment 290: A composition consisting essentially of carbon and at least about 50% yttrium oxide by weight, the composition being a porous solid composition having a BET surface area of at least 100 square meters per gram.

Embodiment 291: The composition of embodiments 288 or 289, further comprising a metal other than yttrium.

Embodiment 292: The composition of any of embodiments 288-291, wherein the composition comprises at least 60% yttrium oxide by weight.

Embodiment 293: The composition of any of embodiments 288-291, wherein the composition comprises at least 70% yttrium oxide by weight.

Embodiment 294: The composition of any of embodiments 288-291, wherein the composition comprises at least 75% yttrium oxide by weight.

Embodiment 295: The composition of any of embodiments 288-291, wherein the composition comprises at least 80% yttrium oxide by weight.

Embodiment 296: The composition of any of embodiments 288-291, wherein the composition comprises at least 85% yttrium oxide by weight.

Embodiment 297: The composition of any of embodiments 288-291, wherein the composition comprises at least 90% yttrium oxide by weight.

Embodiment 298: The composition of any of embodiments 288-291, wherein the composition comprises at least 95% yttrium oxide by weight.

Embodiment 299: The composition of embodiment 288, wherein the composition has a BET surface area of at least 100 square meters per gram.

Embodiment 300: The composition of any of embodiments 288-299, wherein the composition has a BET surface area of at least 110 square meters per gram.

Embodiment 301: The composition of any of embodiments 288-300, wherein the BET surface area is between about 110 square meters per gram and 220 square meters per gram.

Embodiment 302: The composition of any of embodiments 288-301, wherein the BET surface area is at least 120 square grams per meter.

Embodiment 303: The composition of any of embodiments 288-301, wherein the BET surface area is at least 130 square meters per gram.

Embodiment 304: The composition of any of embodiments 288-301, wherein the BET surface area is at least 140 square meters per gram.

Embodiment 305: The composition of any of embodiments 288-301, wherein the BET surface area is at least 150 square meters per gram.

Embodiment 306: The composition of any of embodiments 288-301, wherein the BET surface area is at least 160 square meters per gram.

Embodiment 307: The composition of any of embodiments 288-301, wherein the BET surface area is at least 175 square meters per gram.

Embodiment 308: The composition of any of embodiments 288-301, wherein the BET surface area is at least 200 square meters per gram.

Embodiment 309: The composition of any of embodiments 288-301, wherein the BET surface area is at least 215 square meters per gram.

Embodiment 310: The composition of any of embodiments 288-309, comprising between about 0.01% and about 20% carbon by weight.

Embodiment 311: The composition of embodiment 310, wherein the composition comprises between about 0.05% and about 10% carbon by weight.

Embodiment 312: The composition of embodiment 310, wherein the composition comprises between about 0.1% and about 5% carbon by weight.

Embodiment 313: The composition of embodiment 310, wherein the composition comprises between about 0.01% and about 0.5% carbon by weight.

Embodiment 314: The composition of any of embodiments 288, 289, and 291-313, wherein the composition has an essential absence of silica, alumina, aluminum or chromia.

Embodiment 315: The composition of any of embodiments 288, and 291-314, wherein the composition has an essential absence of Europium.

Embodiment 316: The composition of any of embodiments 288-315, wherein the composition has an essential absence of S, Na, and K.

Embodiment 317: The composition of any of embodiments 288-316, wherein the composition is a catalyst.

Embodiment 318: The composition of any of embodiments 288-317, wherein the composition is thermally stable with respect to the BET surface area of the composition decreasing by not more than 10% when heated at 400° C. for 2 hours.

Embodiment 319: The composition of any of embodiments 288-318, wherein the yttrium metal or yttrium oxide is at least 30% yttrium oxide.

Embodiment 320: The composition of embodiment 319, wherein the yttrium metal or yttrium oxide is at least 50% yttrium oxide.

Embodiment 321: The composition of embodiment 319, wherein the yttrium metal or yttrium oxide is at least 75% yttrium oxide.

Embodiment 322: The composition of embodiment 319, wherein the yttrium metal or yttrium oxide is at least 90% yttrium oxide.

Embodiment 323: The composition of any of embodiments 288, 289 and 292-322, further comprising a component selected from the group consisting of Mg, Al, Ba, Cr, Mn, Fe, Ni, Co, Cu, Zr, Nb, Mo, Ru, Pd, In, Sn, Ta, W, Pt, Au, Ce, rare earth metals, their oxides, and combinations thereof.

Embodiment 324: The composition of embodiment 291, wherein the metal other than yttrium is selected from the group consisting of Mg, Al, Ba, Cr, Mn, Fe, Ni, Co, Cu, Zr, Nb, Mo, Ru, Pd, In, Sn, Ta, W, Pt, Au, Ce, rare earth metals, their oxides, and combinations thereof.

Embodiment 325: The composition of any of embodiments 288-324, wherein the composition is an unsupported material.

Embodiment 326: The composition of any of embodiments 288-325, wherein the composition is on a support.

Embodiment 327: The composition of embodiments 288-325, further comprising a support

Embodiment 328: The composition of any of embodiments 289-327, wherein the composition is a porous solid wherein at least 10% of the pores have a diameter greater than 10 nm.

Embodiment 329: The composition of any of embodiments 289-328, wherein at least 10% of the pores have a diameter greater than 15 nm.

Embodiment 330: The composition of any of embodiments 289-329, wherein at least 10% of the pores have a diameter greater than 20 nm.

Embodiment 331: The composition of any of embodiments 289-330, wherein at least 20% of the pores have a diameter greater than 20 nm.

Embodiment 332: The composition of any of embodiments 289-331, wherein at least 30% of the pores have a diameter greater than 20 nm.

Embodiment 333: The composition of any of embodiments 289-332, wherein at least 10% of the pores have a diameter less than 10 nm.

Embodiment 334: The composition of any of embodiments 289-333, wherein at least 20% of the pores have a diameter less than 10 nm.

Embodiment 335: The composition of any of embodiments 289-334 in a reactor.

Embodiment 336: The composition of embodiment 335, wherein the reactor is a three phase reactor with a packed bed.

Embodiment 337: The composition of embodiment 335, wherein the reactor is a trickle bed reactor.

Embodiment 338: The composition of embodiment 335, wherein the reactor is a fixed bed reactor or honeycomb.

Embodiment 339: The composition of embodiment 335, wherein the reactor is a plug flow reactor.

Embodiment 340: The composition of embodiment 335, wherein the reactor is a fluidized bed reactor.

Embodiment 341: The composition of embodiment 335, where the reactor is a two or three phase batch reactor.

Embodiment 342: The composition of embodiment 335, wherein the reactor is a continuous stirred tank reactor.

Embodiment 343: The composition of any of embodiments 289-335 in a slurry or suspension.

Embodiment 344: The composition of any of embodiments 289-335, made by a process comprising:

mixing a yttrium precursor with an organic acid and water to form a mixture; and

calcining the mixture at a temperature of at least 250° C. for a time period sufficient to form a solid.

Embodiment 345: The composition of embodiment 344, wherein the process further comprises evaporating a portion of the mixture for a period of time sufficient for the mixture to form a gel prior to calcination.

Embodiment 346: The composition of embodiment 344, wherein the process further comprises heating the mixture for a period of time sufficient for the mixture to form a gel prior to calcination.

Embodiment 347: The composition of any of embodiments 344-346, wherein in the process, the organic acid comprises a carboxyl group.

Embodiment 348: The composition of any of embodiments 344-347, wherein in the process, the organic acid comprises no more than one carboxylic group and at least one functional group selected from the group consisting of hydroxyl and carbonyl.

Embodiment 349: The composition of any of embodiments 344-348, wherein in the process, the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 350: The composition of any of embodiments 344-349, wherein in the process, the organic acid is ketoglutaric acid.

Embodiment 351: The composition of any of embodiments 344-350, wherein in the process, the organic acid is selected from the group consisting of glyoxylic acid, ketoglutaric acid and combinations thereof.

Embodiment 352: The composition of any of embodiments 344-351, wherein in the process, the yttrium precursor is selected from the group consisting of yttrium acetate, yttrium hydroxide, yttrium carbonate, yttrium nitrate, yttrium 2,4-pentanedionate, yttrium alkoxide, yttrium formate, yttrium oxalate, yttrium chloride, yttrium perchlorate, yttrium oxide, yttrium metal and combinations thereof,

Embodiment 353: The composition of any of embodiments 344-352, wherein in the process, the mixture is calcined at a temperature of at least 350° C.

Embodiment 354: The composition of any of embodiments 344-352, wherein in the process, the mixture is calcined at a temperature of at least 375° C.

Embodiment 355: The composition of any of embodiments 344-354, wherein in the process, the mixture is calcined for at least 1 hour.

Embodiment 356: The composition of any of embodiments 344-354, wherein in the process, the mixture is calcined for at least 2 hours.

Embodiment 357: The composition of any of embodiments 344-354, wherein in the process, the mixture is calcined for at least 4 hours.

Embodiment 358: The composition of any of embodiments 344-357, wherein in the process, the mixture has an essential absence of organic solvents other than the organic acid.

Embodiment 359: The composition of any of embodiments 344-358, wherein in the process, the mixture has an essential absence of citric acid.

Embodiment 360: A method for making a composition, the method comprising:

mixing a yttrium precursor with an organic acid and water to form a mixture, the organic acid comprising no more than one carboxylic group and at least one functional group selected from the group consisting of carbonyl and hydroxyl;

forming a gel; and

calcining the mixture at a temperature of at least 250° C. for a time sufficient to form a solid.

Embodiment 361: The method of embodiment 360, wherein the gel forming step comprises evaporating a portion of the mixture for a period of time sufficient for the mixture to form the gel prior to calcination.

Embodiment 362: The method of embodiment 360, wherein the gel forming step comprises heating the mixture for a period of time sufficient for the mixture to form the gel prior to calcination.

Embodiment 363: The method of any of embodiments 360-362, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof,

Embodiment 364: The method of embodiment 360-363, wherein the organic acid is glyoxylic acid.

Embodiment 365: The method of any of any of embodiments 360-364, wherein the yttrium precursor is selected from the group consisting of yttrium acetate, yttrium hydroxide, yttrium alkoxide, yttrium carbonate, yttrium nitrate, yttrium 2,4-pentanedionate, yttrium formate, yttrium oxalate, yttrium chloride, yttrium metal, yttrium perchlorate, yttrium oxide and combinations thereof.

Embodiment 366: The method of any of embodiments 360-365, wherein the mixture is calcined at a temperature of at least 350° C.

Embodiment 367: The method of any of embodiments 360-365, wherein the mixture is calcined at a temperature of at least 375° C.

Embodiment 368: The method of any of embodiments 360-367, wherein the mixture is calcined for at least 1 hour.

Embodiment 369: The method of any of embodiments 360-367, wherein the mixture is calcined for at least 2 hours.

Embodiment 370: The method of any of embodiments 360-367, wherein the mixture is calcined for at least 4 hours.

Embodiment 371: The method of any of embodiments 360-370, wherein the mixture has an essential absence of organic solvents other than the organic acid.

Embodiment 372: The method of any of embodiments 360-371, wherein the mixture has an essential absence of citric acid.

Embodiment 373: A method for making a composition, the method comprising:

mixing a yttrium precursor with an organic acid and water to form a mixture, the organic acid comprising two carboxylic groups and a carbonyl group; and

calcining the mixture at a temperature of at least 250° C. for a time sufficient to form a solid.

Embodiment 374: The method of embodiment 373, further comprising evaporating a portion of the mixture for a period of time sufficient for the mixture to form a gel prior to calcination.

Embodiment 375: The method of embodiment 373, further comprising heating the mixture for a period of time sufficient for the mixture to form a gel prior to calcination.

Embodiment 376: The method of any of embodiments 373-375, wherein the organic acid comprises no more than two carboxylic groups.

Embodiment 377: The method of any of embodiments 373-376, wherein the organic acid comprises no more than one carbonyl group.

Embodiment 378: The method of any of embodiments 373-377, wherein the organic acid is ketoglutaric acid.

Embodiment 379: The method of any of embodiments 373-378, wherein the yttrium precursor is selected from the group consisting of yttrium acetate, yttrium hydroxide, yttrium carbonate, yttrium nitrate, yttrium 2,4-pentanedionate, yttrium formate, yttrium oxalate, yttrium chloride, yttrium perchlorate, yttrium oxide, yttrium metal, yttrium alkoxide, and combinations thereof.

Embodiment 380: The method of any of embodiments 373-379, wherein the mixture is calcined at a temperature of at least 300° C.

Embodiment 381: The method of any of embodiments 373-379, wherein the mixture is calcined at a temperature of at least 350° C.

Embodiment 382: The method of any of embodiments 373-381, wherein the mixture is calcined for at least 1 hour.

Embodiment 383: The method of any of embodiments 373-381, wherein the mixture is calcined for at least 2 hours.

Embodiment 384: The method of any of embodiments 373-381, wherein the mixture is calcined for at least 4 hours.

Embodiment 385: The method of any of embodiments 373-384, wherein the mixture has an essential absence of organic solvents other than the organic acid.

Embodiment 386: The method of any of embodiments 373-385, wherein the mixture has an essential absence of citric acid.

Embodiment 387: A method for making a composition, the method comprising:

mixing a yttrium precursor with an acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture;

forming a gel; and

calcining the gel at a temperature of at least 250° C. for at least 1 hour.

Embodiment 388: The method of embodiment 387, wherein the gel forming step comprises evaporating a portion of the mixture for a period of time sufficient for the mixture to form the gel prior to calcination.

Embodiment 389: The method of embodiment 387, wherein the gel forming step comprises heating the mixture for a period of time sufficient for the mixture to form a gel prior to calcination.

Embodiment 390: The method of any of embodiments 387-389, wherein the mixture comprises water.

Embodiment 391: The method of any of embodiments 387-390, wherein the yttrium precursor is selected from the group consisting of yttrium acetate, yttrium hydroxide, yttrium carbonate, yttrium nitrate, yttrium 2,4-pentanedionate, yttrium formate, yttrium oxalate, yttrium chloride, yttrium oxide, yttrium perchlorate, yttrium metal, yttrium alkoxide, and combinations thereof.

Embodiment 392: The method of any of embodiments 387-391, wherein the gel is calcined at a temperature of at least 350° C.

Embodiment 393: The method of any of embodiments 387-391, wherein the gel is calcined at a temperature of at least 375° C.

Embodiment 394: The method of any of embodiments 387-393, wherein the gel is calcined for at least 2 hours.

Embodiment 395: The method of any of embodiments 387-393, wherein the gel is calcined for at least 4 hours.

Embodiment 396: The method of any of embodiments 387-395, wherein the mixture has an essential absence of organic solvents other than the organic acid.

Embodiment 397: The method of any of embodiments 387-396, wherein the mixture has an essential absence of citric acid.

Embodiment 398: The method of any of embodiments 387-397, wherein the mixture comprises a combination of glyoxylic and ketoglutaric acid.

Embodiment 399: A composition comprising yttrium glyoxylate.

Embodiment 400: The composition of embodiment 399, wherein the composition is a solution.

Embodiment 401: The composition of embodiments 399 or 400, wherein the composition is a precursor to make a solid yttrium containing material.

Embodiment 402: The composition of embodiment 401, wherein the material is a catalyst.

Embodiment 403: A composition comprising yttrium ketoglutarate.

Embodiment 404: The composition of embodiment 403, wherein the composition is a solution.

Embodiment 405: The composition of embodiments 403 or 404, wherein the composition is a precursor to make a solid yttrium containing material.

Embodiment 406: The composition of embodiment 405, wherein the material is a catalyst.

Embodiment 407: A method of forming a yttrium glyoxylate, the method comprising mixing yttrium hydroxide with aqueous glyoxylic acid.

Embodiment 408: A method of forming a yttrium ketoglutarate, the method comprising mixing yttrium hydroxide with aqueous ketoglutaric acid.

Embodiment 409: A method of forming a yttrium ketoglutarate, the method comprising mixing yttrium acetate with aqueous ketoglutaric acid.

### Ruthenium

In the present invention, ruthenium compositions having high BET surface areas, high ruthenium or ruthenium oxide content, and/or thermal stability are disclosed.

The metal oxides and mixed metal oxides of the invention have important applications as catalysts, catalyst carriers, sorbents, sensors, actuators, porous catalytic electrode materials (e.g. for the oxidation of chloride to molecular chlorine or in fuel cells), pigments, and as coatings and components in the semiconductor, electroceramics and electronics industries, in particular for the manufacture of resistor pastes, high energy battery (substitution of RuO₂ by high surface area mixed Ru oxides), and as hybrid capacitors for high power applications.

In general, the ruthenium/ruthenium oxide compositions of the invention are novel and inventive as unbound and/or unsupported as well as supported catalysts and as carriers compared to known supported and unsupported ruthenium and ruthenium oxide catalyst formulations utilizing large amounts of binders such as silica, alumina, aluminum or chromia. In one embodiment, the compositions of the inventions are superior to known formulations both in terms of activity (compositions of the invention have higher surface area with a higher ruthenium metal and/or ruthenium oxide content) and in terms of selectivity (e.g. for hydrogenations, reductions and oxidations). The lower content or the absence of a binder/support (which is often unselective) and the high purity (i.e. high ruthenium/ruthenium oxide content and essential absence of Na, S, K and Cl and other impurities) achievable by methods of the invention provide improvements over state of the art compositions and methods. The productivity in terms of weight of material per volume of solution per unit time is much higher for the method of the invention as compared to present sol-gel or precipitation techniques since highly concentrated solutions ˜1M can be used as starting material. Moreover, no washing or aging steps are required by the method.

The present invention is thus directed to ruthenium-containing compositions that comprise ruthenium and/or ruthenium oxide. Furthermore, the compositions of the present invention may comprise carbon or additional components that act as binders, promoters, stabilizers, or co-metals.

In one embodiment of the invention, the ruthenium composition comprises Ru metal, Ru oxide (such as RuO₂ and RuO₄), or mixtures thereof, In another embodiment, the compositions of the invention comprise (i) ruthenium or a ruthenium-containing compound (e.g., ruthenium oxide) and (ii) one or more additional metal, oxides thereof, salts thereof, or mixtures of such metals or compounds. In one embodiment, the additional metal is an alkali metal, alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the additional metal is one of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ce, Al, La, Si, or a compound containing one or more of such element(s), more specifically Pt, Pd, Rh, Ir, Ag, Mn, Mo, W, Cr, In, Sn, Y, Co, Ce, Ni, Cu, Fe, Zr and more specifically Pt, Ir, Ag, Co, Ni, Cu, Fe, Sn, Ce, Zr, or a compound containing one or more of such element(s). The concentrations of the additional components are such that the presence of the component would not be considered an impurity. For example, when present, the concentrations of the additional metals or metal containing components (e.g., metal oxides) are at least about 0.1, 0.5, 1, 2, 5, or even 10 molecular percent or more by weight.

The major component of the composition typically comprises Ru oxide. The major component of the composition can, however, also include various amounts of elemental Ru and/or Ru-containing compounds, such as Ru salts. The Ru oxide is an oxide of ruthenium where ruthenium is in an oxidation state other than the fully-reduced, elemental Ru^{o} state, including oxides of ruthenium where ruthenium has an oxidation state of Ru⁺⁴, Ru⁺⁸, or a partially reduced oxidation state. The total amount of ruthenium and/or ruthenium oxide (RuO₂,RuO₄, or a combination) present in the composition is at least about 25% by weight on a molecular basis. More specifically, compositions of the present invention include at least 35% ruthenium and/or ruthenium oxide, more specifically at least 50%, more specifically at least 60%, more specifically at least 70%, more specifically at least 75%, more specifically at least 80%, more specifically at least 85%, more specifically at least 90%, and more specifically at least 95% ruthenium and/or ruthenium oxide by weight. In one embodiment, the ruthenium/ruthenium oxide component of the composition is at least 30% ruthenium oxide, more specifically at least 50% ruthenium oxide, more specifically at least 75% ruthenium oxide, and more specifically at least 90% ruthenium oxide by weight. As noted below, the ruthenium/ruthenium oxide component can also have a support or carrier functionality.

The one or more minor component(s) of the composition preferably comprise an element selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ce, Al, La, Si, or a compound containing one or more of such element(s), such as oxides thereof and salts thereof, or mixtures of such elements or compounds. The minor component(s) more specifically comprises of one or more of Pt, Pd, Rh, Ir, Ag, Mn, Mo, W, Cr, In, Sn, Y, Co, Ce, Ni, Cu, Fe, Zr, oxides thereof, salts thereof, or mixtures of the same and more specifically Pt, Ir, Ag, Co, Ni, Cu, Fe, Sn, Ce, Zr, oxides thereof, salts thereof, or mixtures of the same. In one embodiment, the minor component(s) are preferably oxides of one or more of the minor-component elements, but can, however, also include various amounts of such elements and/or other compounds (e.g., salts) containing such elements. An oxide of such minor-component elements is an oxide thereof where the respective element is in an oxidation state other than the fully-reduced state, and includes oxides having an oxidation states corresponding to known stable valence numbers, as well as to oxides in partially reduced oxidation states. Salts of such minor-component elements can be any stable salt thereof, including, for example, chlorides, nitrates, carbonates and acetates, among others. The amount of the oxide form of the particular recited elements present in one or more of the minor component(s) is at least about 5%, preferably at least about 10%, preferably still at least about 20%, more preferably at least about 35%, more preferably yet at least about 50% and most preferable at least about 60%, in each case by weight relative to total weight of the particular minor component. As noted below, the minor component can also have a support or carrier functionality.

In one embodiment, the minor component consists essentially of one element selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ce, Al, La, Si, or a compound containing the element. In another embodiment, the minor component consists essentially of two elements selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ce, Al, La, Si, or a compound containing one or more of such elements.

Thus, in one specific embodiment of the compound shown in formula I, the composition of the invention is a material comprising a compound having the formula (V):

RuₐM²_{b}M³_{c}M⁴_{d}M⁵ₑO_{f} (V),

where, Ru is ruthenium, O is oxygen and M², M³, M⁴, M⁵, a, b, c, d, e and f are described above for formula I, and more specifically below, and can be grouped in any of the various combinations and permutations of preferences.

In formula V, “M²” “M³” “M⁴” and “M⁵” individually each represent a metal such as an alkali metal, an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically, “M²” “M³” “M⁴” and “M⁵” individually each represent a metal selected from Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ce, Al, La and Si, and more specifically Pt, Pd, Rh, Ir, Ag, Mn, Mo, W, Cr, In, Sn, Y, Co, Ce, Ni, Cu, Fe and Zr, and more specifically Pt, Ir, Ag, Co, Ni, Cu, Fe, Sn, Ce, and Zr.

In formula V, a+b+c+d+e=1. The letter “a” represents a number ranging from about 0.2 to about 1.00, specifically from about 0.4 to about 0.90, more specifically from about 0.5 to about 0.9, and even more specifically from about 0.7 to about 0.8 The letters “b” “c” “d” and “e” individually represent a number ranging from about 0 to about 0.5, specifically from about 0.04 to about 0.2, and more specifically from about 0.04 to about 0.1.

In formula V, “O” represents oxygen, and “f” represents a number that satisfies valence requirements. In general, “f” is based on the oxidation states and the relative atomic fractions of the various metal atoms of the compound of formula V (e.g., calculated as one-half of the sum of the products of oxidation state and atomic fraction for each of the metal oxide components).

In one mixed-metal oxide embodiment, where, with reference to formula V, “c” “d” and “e” are zero, the catalyst material can comprise a compound having the formula V-A:

RuₐM²_{b}O_{f} (V-A),

where Ru is ruthenium, O is oxygen, and where “a”, “M²”, “b” and “f” are as defined above.

In another embodiment, where, with reference to formula V, “b” “c” “d” and “e” are zero, the catalyst material can comprise a compound having the formula V-B:

RuₐO_{f} (V-B),

where Ru is ruthenium, O is oxygen, and where “a” and “f” are as defined above.

In one embodiment, the ruthenium compositions of the invention can also include carbon. The amount of carbon in the ruthenium compositions is typically less than 75% by weight. More specifically, the ruthenium compositions of the invention have between about 0.01% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the ruthenium compositions of the invention have an essential absence of Na, S, K and Cl.

In another embodiment, the ruthenium compositions of the invention contain less than 10%, specifically less than 5%, more specifically less than 3%, and more specifically less than 1% water.

The ruthenium compositions can include other components as well, such as diluents, binders and/or fillers, as desired in connection with the reaction system of interest.

In one embodiment, the ruthenium compositions of the invention are typically a high surface area porous solid. Specifically, the BET surface area of the ruthenium composition is from about 30 m²/g to about 220 m²/g, more specifically from about 50 m²/g to about 200 m²/g, more specifically from about 75 m²/g to about 190 m²/g, and more specifically from about 90 m²/g to about 180 m²/g. In another embodiment, the BET surface area is at least about 30 m²/g, more specifically at least about 40 m²/g, more specifically at least about 50 m²/g, more specifically at least about 60 m²/g, more specifically at least about 70 m²/g, more specifically at least about 80 m²/g, more specifically at least about 90 m²/g, more specifically at least about 100 m²/g, more specifically at least about 110 m²/g, more specifically at least about 120 m²/g, more specifically at least about 130 m²/g, more specifically at least about 140 m²/g, more specifically at least about 150 m²/g, more specifically at least about 160 m²/g, and more specifically at least about 170 m²/g.

In one embodiment, the ruthenium compositions of the invention are thermally stable.

In one embodiment, the ruthenium compositions of the invention are porous solids, having a wide range of pore diameters. In one embodiment, at least 10%, more specifically at least 20% and more specifically at least 30% of the pores of the composition of the invention have a pore diameter greater than 10 nm, more specifically greater than 15 nm, and more specifically greater than 20 nm. Additionally, at least 10%, specifically at least 20% and more specifically at least 30% of the pores of the composition have a pore diameter less than 12 nm, specifically less than 10 nm, more specifically less than 8 nm and more specifically less than 6 nm.

In one embodiment, the total pore volume (the cumulative BJH pore volume between 1.7 nm and 300 nm diameter) is greater than 0.10 ml/g, more specifically, greater than 0.15 ml/g, more specifically, greater then 0.175 ml/g, more specifically, greater then 0.20 ml/g, more specifically, greater then 0.25 ml/g, more specifically, greater then 0.30 ml/g, more specifically, greater then 0.35 ml/g, more specifically, greater then 0.40 ml/g, more specifically, greater then 0.45 ml/g, and more specifically, greater then 0.50 ml/g.

In one embodiment, the ruthenium materials are fairly amorphous. That is, the materials are less than 80% crystalline, specifically, less than 60% crystalline and more specifically, less than 50% crystalline.

In one embodiment, the ruthenium composition of the invention is a bulk metal or mixed metal oxide material. In another embodiment, the composition is a support or carrier on which other materials are impregnated. In one embodiment, the compositions of the invention have thermal stability and high surface areas with an essential absence of silica, alumina, aluminum or chromia. In still another embodiment, the composition is supported on a carrier, (such as a supported catalyst). In another embodiment, the composition comprises both the support and the catalyst. In embodiments where the composition is a supported catalyst, the support utilized may contain one or more of the metals (or metalloids) of the catalyst, including ruthenium. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

In embodiments where the ruthenium composition of the invention is a supported catalyst, the one or more of the aforementioned compounds or compositions can be located on a solid support or carrier. The support can be a porous support, with a pore size typically ranging, without limitation, from about 0.5 nm to about 300 nm and with a surface area typically ranging, without limitation, from about 5 m²/g to about 1500 m²/g. The particular support or carrier material is not narrowly critical, and can include, for example, a material selected from the group consisting of silica, alumina, zeolite, activated carbon, titania, zirconia, ceria, tin oxide, magnesia, niobia, zeolites and clays, among others, or mixtures thereof. Preferred support materials include titania, zirconia, ceria, tin oxide, alumina or silica. In some cases, where the support material itself is the same as one of the preferred components (e.g., Al₂O₃ for Al as a minor component), the support material itself may effectively form a part of the catalytically active material. In other cases, the support can be entirely inert to the reaction of interest.

The ruthenium compositions of the present invention are made by a novel method that results in high surface area ruthenium/ruthenium oxide materials. In one embodiment, method includes mixing a ruthenium precursor with an organic acid and water to form a mixture, and calcining the mixture. According to one approach for preparing a mixed-metal oxide composition of the invention, the mixture also includes a metal precursor other than a ruthenium precursor.

The mixture comprises the ruthenium precursor and the organic acid. In one embodiment, the mixture preferably has an essential absence of any organic solvent other then the organic acid (which may or may not be a solvent for the ruthenium precursor), such as alcohols. In another embodiment, the mixture preferably has an essential absence of citric acid. In another embodiment, the mixture preferably has an essential absence of citric acid and organic solvents other than the organic acid.

The organic acids used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, or imino, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, and oxalic acid, oxalacetic acid, and more specifically, glyoxylic acid and ketoglutaric acid.

The ruthenium precursor used in the method of the invention is selected from the group consisting of ruthenium acetate, ruthenium oxoacetate, ruthenium nitrosylacetate, ruthenium hydroxide, ruthenium nitrosylhydroxide, ruthenium nitrate, ruthenium nitrosyInitrate, ruthenium 2,4-pentanedionate, ruthenium formate, ruthenium nitrosylformate, ruthenium oxide, ruthenium metal, ruthenium chloride, ruthenium nitrosylchloride, ruthenium carbonyl, ruthenium red, ruthenium oxychloride, ruthenocene, chloropentaammineruthenium chloride, hexaammineruthenium chloride, dichlorotricarbonylruthenium, ruthenium carboxylate and combinations thereof, specifically, ruthenium nitrosylhydroxide, ruthenium nitrosylacetate and ruthenium 2,4-pentanedionate. Specific ruthenium carboxylates include ruthenium oxalate, ruthenium ketoglutarate, ruthenium citrate, ruthenium tartrate, ruthenium malate, ruthenium lactate and ruthenium glyoxylate.

The ratio of mmols of acid to mmols metal can vary from about 10:1 to about 1:10, more specifically from about 7:1 to about 1:5, more specifically from about 5:1 to about 1:4, and more specifically from about 3:1 to about 1:3.

Mixed-metal oxide compositions can also be made by the methods of the invention by including more than one metal precursor in the mixture.

Water may also be present in the mixtures described above. The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi stage calcination as described below.

In another embodiment, the method includes evaporating the mixture to dryness or providing the dry ruthenium precursor and calcining the dry component to form a solid ruthenium oxide. Specifically, the ruthenium precursor is a ruthenium carboxylate, more specifically, ruthenium glyoxylate, ruthenium ketoglutarate, ruthenium oxalacetate, or ruthenium diglycolate.

In another embodiment, as an alternative to starting from acidic solutions, ruthenium precursors can be mixed with bases. Bases such as ammonia, tetraalkylammonium hydroxide, organic amines and aminoalcohols can be used as dispersants. The resulting basic solutions can then be aged at room temperature or by slow evaporation and calcinations (or other means of low temperature detemplation).

In other embodiments, dispersants other than organic acids can be utilized. For example, non-acidic dispersants with at least two functional groups, such as dialdehydes (glyoxal) and ethylene glycol have been found to form pure and/or high surface area ruthenium -containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

The heating of the resulting mixture is typically a calcination, which may be conducted in an oxygen-containing atmosphere or in the substantial absence of oxygen, e.g., in an inert atmosphere or in vacuo. The inert atmosphere may be any material which is substantially inert, e.g., does not react or interact with the material. Suitable examples include, without limitation, nitrogen, argon, xenon, helium or mixtures thereof. Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 200° C. to 850° C., specifically from 250° C. to 500° C. more specifically from 250° C. to 400° C., more specifically from 300° C. to 400° C., and more specifically from 300° C. to 375° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

In some embodiments it may be desirable to reduce all or a portion of the ruthenium oxide material to a reduced (elemental) ruthenium for a reaction of interest. The ruthenium oxide materials of the invention can be partially or entirely reduced by reacting the ruthenium oxide containing material with a reducing agent, such as hydrazine or formic acid, or by introducing, a reducing gas, such as, for example, ammonia or hydrogen, during or after calcination. In one embodiment, the ruthenium oxide material is reacted with a reducing agent in a reactor by flowing a reducing agent through the reactor. This provides a material with a reduced (elemental) ruthenium surface for carrying out the reaction of interest.

As an alternative to calcination, the material can detemplated by the oxidation of organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The ruthenium compositions of the invention are typically solid catalysts, and can be used in a reactor, such as a three phase reactor with a packed bed (e.g., a trickle bed reactor), a fixed bed reactor (e.g., a plug flow reactor), a honeycomb, a fluidized or moving bed reactor, a two or three phase batch reactor, or a continuous stirred tank reactor. The compositions can also be used in a slurry or suspension.

Preferred embodiments of the invention, thus, further include:

Embodiment 410: A composition comprising at least about 50% ruthenium metal or a ruthenium oxide by weight and less than 5% water, the composition being a porous solid composition having a BET surface area of at least 30 square meters per gram and an essential absence of Na and Cl.

Embodiment 411: A composition comprising at least about 50% ruthenium metal or a ruthenium oxide by weight and less than 5% water, the composition being a porous solid composition, having a BET surface area of at least 30 square meters per gram, wherein the composition is thermally stable with respect to the BET surface area of the composition decreasing by not more than 10% when heated at 350° C. for 2 hours.

Embodiment 412: A composition consisting essentially of carbon and at least about 50% ruthenium metal or a ruthenium oxide by weight and less than 5% water, the composition being a porous solid composition having a BET surface area of at least 30 square meters per gram.

Embodiment 413: A composition comprising at least about 50% ruthenium metal or a ruthenium oxide by weight, the composition being a porous solid composition having a BET surface area of at least 140 square meters per gram

Embodiment 414: The composition of embodiments 410, 411 or 413, further comprising a metal other than ruthenium.

Embodiment 415: The composition of any of embodiments 410-414, wherein the composition comprises at least 60% ruthenium metal or the ruthenium oxide by weight.

Embodiment 416: The composition of any of embodiments 410-414, wherein the composition comprises at least 70% ruthenium metal or the ruthenium oxide by weight.

Embodiment 417: The composition of any of embodiments 410-414, wherein the composition comprises at least 75% ruthenium metal or the ruthenium oxide by weight.

Embodiment 418: The composition of any of embodiments 410-414, wherein the composition comprises at least 80% ruthenium metal or the ruthenium oxide by weight.

Embodiment 419: The composition of any of embodiments 410-414, wherein the composition comprises at least 85% ruthenium metal or the ruthenium oxide by weight.

Embodiment 420: The composition of any of embodiments 410-414, wherein the composition comprises at least 90% ruthenium metal or the ruthenium oxide by weight.

Embodiment 421: The composition of any of embodiments 410-414, wherein the composition comprises at least 95% ruthenium metal or the ruthenium oxide by weight.

Embodiment 422: The composition of any of embodiments 410-412 and 414-421, wherein the composition has a BET surface area of at least 40 square meters per gram.

Embodiment 423: The composition of any of embodiments 410-412 and 414-421, wherein the composition has a BET surface area of at least 50 square meters per gram.

Embodiment 424: The composition of any of embodiments 410-412 and 414-423, wherein the BET surface area is between about 30 square meters per gram and 110 square meters per gram.

Embodiment 425: The composition of any of embodiments 410-412 and 414-424, wherein the BET surface area is at least 60 square grams per meter.

Embodiment 426: The composition of any of embodiments 410-412 and 414-421, wherein the BET surface area is at least 70 square meters per gram.

Embodiment 427: The composition of any of embodiments 410-412 and 414-421, wherein the BET surface area is at least 80 square meters per gram.

Embodiment 428: The composition of any of embodiments 410-412 and 414-421, wherein the BET surface area is at least 90 square meters per gram.

Embodiment 429: The composition of any of embodiments 410-428, wherein the BET surface area is at least 100 square meters per gram.

Embodiment 430: The composition of any of embodiments 410-412 and 425-429, wherein the BET surface area is between about 50 square meters per gram and about 110 square meters per gram.

Embodiment 431: The composition of any of embodiments 410-412 and 427-429, wherein the BET surface area is between about 75 square meters per gram and about 110 square meters per gram.

Embodiment 432: The composition of any of embodiments 410-412 and 428-429, wherein the BET surface area is between about 90 square meters per gram and about 110 square meters per gram.

Embodiment 433: The composition of any of embodiments 410-432, comprising between about 0.01% and about 20% carbon by weight.

Embodiment 434: The composition of embodiment 433, wherein the composition comprises between about 0.5% and about 10% carbon by weight.

Embodiment 435: The composition of embodiment 433, wherein the composition comprises between about 1.0% and about 5% carbon by weight.

Embodiment 436: The composition of embodiment 433, wherein the composition comprises between about 0.01% and about 0.5% carbon by weight.

Embodiment 437: The composition of any of embodiments 410, 411 and 413-436, wherein the composition has an essential absence of silica, alumina, aluminum or chromia.

Embodiment 438: The composition of any of embodiments 411-437, wherein the composition has an essential absence of Na and Cl.

Embodiment 439: The composition of any of embodiments 410-438, wherein the composition has an essential absence of S and K.

Embodiment 440: The composition of any of embodiments 410-439, wherein the composition is a catalyst.

Embodiment 441: The composition of any of embodiments 410 and 412-440, wherein the composition is thermally stable with respect to the BET surface area of the composition decreasing by not more than 10% when heated at 350° C. for 2 hours.

Embodiment 442: The composition of any of embodiments 410-441, wherein the ruthenium metal or ruthenium oxide is at least 30% ruthenium oxide.

Embodiment 443: The composition of embodiment 442, wherein the ruthenium metal or ruthenium oxide is at least 50% ruthenium oxide.

Embodiment 444: The composition of embodiment 442, wherein the ruthenium metal or ruthenium oxide is at least 75% ruthenium oxide.

Embodiment 445: The composition of embodiment 442, wherein the ruthenium metal or ruthenium oxide is at least 90% ruthenium oxide.

Embodiment 446: The composition of any of embodiments 410, 411 and 414-445, further comprising a component selected from the group consisting of Mg, Al, Ba, Cr, Mn, Fe, Ni, Co, Cu, Zr, Nb, Mo, Y, Pd, In, Sn, La, Ta, W, Pt, Au, Ce, Zr, Ir, Ag their oxides, and combinations thereof.

Embodiment 447: The composition of embodiment 413, wherein the metal other than ruthenium is selected from the group consisting of Mg, Al, Ba, Cr, Mn, Fe, Ni, Co, Cu, Zr, Nb, Mo, Y, Pd, In, Sn, La, Ta, W, Pt, Au, Ce, Zr, Ir, Ag their oxides, and combinations thereof.

Embodiment 448: The composition of any of embodiments 410-447, wherein the composition is an unsupported material.

Embodiment 449: The composition of any of embodiments 410-448, wherein the composition is on a support.

Embodiment 450: The composition of any of embodiments 410-449, further comprising a support.

Embodiment 451: The composition of any of embodiments 410-450, wherein the composition is a support.

Embodiment 452: The composition of any of embodiments 410-451, wherein the composition is a porous solid wherein at least 10% of the pores have a diameter greater than 10 nm.

Embodiment 453: The composition of any of embodiments 410-452, wherein at least 10% of the pores have a diameter greater than 15 nm.

Embodiment 454: The composition of any of embodiments 410-453, wherein at least 10% of the pores have a diameter greater than 20 nm.

Embodiment 455: The composition of any of embodiments 410-454, wherein at least 20% of the pores have a diameter greater than 20 nm.

Embodiment 456: The composition of any of embodiments 410-455, wherein at least 30% of the pores have a diameter greater than 20 nm.

Embodiment 457: The composition of any of embodiments 410-456, wherein at least 10% of the pores have a diameter less than 10 nm.

Embodiment 458: The composition of any of embodiments 410-457, wherein at least 20% of the pores have a diameter less than 10 nm.

Embodiment 459: The composition of any of embodiments 410-458 in a reactor.

Embodiment 460: The composition of embodiment 459, wherein the reactor is a three phase reactor with a packed bed.

Embodiment 461: The composition of embodiment 459, wherein the reactor is a trickle bed reactor.

Embodiment 462: The composition of embodiment 459, wherein the reactor is a fixed bed reactor.

Embodiment 463: The composition of embodiment 459, wherein the reactor is a plug flow reactor.

Embodiment 464: The composition of embodiment 459, wherein the reactor is a fluidized bed reactor.

Embodiment 465: The composition of embodiment 459, where the reactor is a two or three phase batch reactor.

Embodiment 466: The composition of embodiment 459, wherein the reactor is a continuous stirred tank reactor.

Embodiment 467: The composition of any of embodiments 410-458 in a slurry or suspension.

Embodiment 468: The composition of any of embodiments 410-458, made by a process comprising:

mixing a ruthenium precursor with an organic acid and water to form a mixture; and

calcining the mixture at a temperature of at least 250° C. for a time period sufficient to form a solid.

Embodiment 469: The composition of embodiment 468, wherein the process further comprises evaporating a portion of the mixture for a period of time sufficient for the mixture to form a gel prior to calcination.

Embodiment 470: The composition of embodiment 468, wherein the process further comprises heating the mixture for a period of time sufficient for the mixture to form a gel prior to calcination.

Embodiment 471: The composition of any of embodiments 468-470, wherein in the process, the organic acid comprises a carboxyl group.

Embodiment 472: The composition of any of embodiments 468-471, wherein in the process, the organic acid comprises no more than one carboxylic group and at least one functional group selected from the group consisting of hydroxyl and carbonyl.

Embodiment 473: The composition of any of embodiments 468-472, wherein in the process, the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 474: The composition of any of embodiments 468-473, wherein in the process, the organic acid is ketoglutaric acid.

Embodiment 475: The composition of any of embodiments 468-474, wherein in the process, the organic acid is selected from the group consisting of glyoxylic acid, ketoglutaric acid and combinations thereof.

Embodiment 476: The composition of any of embodiments 468-475, wherein in the process, the ruthenium precursor is selected from the group consisting of ruthenium acetate, ruthenium nitrosylacetate, ruthenium hydroxide, ruthenium nitrosylhydroxide, ruthenium nitrate, ruthenium nitrosyInitrate, ruthenium 2,4-pentanedionate, ruthenium formate, ruthenium nitrosylformate, ruthenium oxide, ruthenium metal, ruthenium chloride, ruthenium nitrosylchloride, ruthenium carbonyl, ruthenium red, ruthenium oxychloride, ruthenocene, chloropentaammineruthenium chloride, hexaammineruthenium chloride, dichlorotricarbonylruthenium, ruthenium carboxylate and combinations thereof.

Embodiment 477: The composition of any of embodiments 468-476, wherein in the process, the mixture is calcined at a temperature of at least 300° C.

Embodiment 478: The composition of any of embodiments 468-476, wherein in the process, the mixture is calcined at a temperature of at least 350° C.

Embodiment 479: The composition of any of embodiments 468-478, wherein in the process, the mixture is calcined for at least 1 hour.

Embodiment 480: The composition of any of embodiments 468-478, wherein in the process, the mixture is calcined for at least 2 hours.

Embodiment 481: The composition of any of embodiments 468-478, wherein in the process, the mixture is calcined for at least 4 hours.

Embodiment 482: The composition of any of embodiments 468-481, wherein in the process, the mixture has an essential absence of organic solvents other than the organic acid.

Embodiment 483: The composition of any of embodiments 468-482, wherein in the process, the mixture has an essential absence of citric acid.

Embodiment 484: A method for making a composition, the method comprising:

mixing a ruthenium precursor with an organic acid and water to form a mixture, the organic acid comprising no more than one carboxylic group and at least one functional group selected from the group consisting of carbonyl and hydroxyl;

forming a gel; and

calcining the mixture at a temperature of at least 250° C. for a time sufficient to form a solid.

Embodiment 485: The method of embodiment 484, wherein the gel forming step comprises evaporating a portion of the mixture for a period of time sufficient for the mixture to form the gel prior to calcination.

Embodiment 486: The method of embodiment 484, wherein the gel forming step comprises heating the mixture for a period of time sufficient for the mixture to form the gel prior to calcination.

Embodiment 487: The method of any of embodiments 484-486, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 488: The method of embodiment 484-487, wherein the organic acid is glyoxylic acid.

Embodiment 489: The method of any of any of embodiments 484-488, wherein the ruthenium precursor is selected from the group consisting of ruthenium acetate, ruthenium nitrosylacetate, ruthenium hydroxide, ruthenium nitrosylhydroxide, ruthenium nitrate, ruthenium nitrosyInitrate, ruthenium 2,4-pentanedionate, ruthenium formate, ruthenium nitrosylformate, ruthenium oxide, ruthenium metal, ruthenium chloride, ruthenium nitrosylchloride, ruthenium carbonyl, ruthenium red, ruthenium oxychloride, ruthenocene, chloropentaammineruthenium chloride, hexaammineruthenium chloride, dichlorotricarbonylruthenium, ruthenium carboxylate and combinations thereof.

Embodiment 490: The method of any of embodiments 484-489, wherein the mixture is calcined at a temperature of at least 300° C.

Embodiment 491: The method of any of embodiments 484-490, wherein the mixture is calcined at a temperature of at least 350° C.

Embodiment 492: The method of any of embodiments 484-491, wherein the mixture is calcined for at least 1 hour.

Embodiment 493: The method of any of embodiments 484-492, wherein the mixture is calcined for at least 2 hours.

Embodiment 494: The method of any of embodiments 484-493, wherein the mixture is calcined for at least 4 hours.

Embodiment 495: The method of any of embodiments 484-494, wherein the mixture has an essential absence of organic solvents other than the organic acid.

Embodiment 496: The method of any of embodiments 484-494, wherein the mixture has an essential absence of citric acid.

Embodiment 497: A method for making a composition, the method comprising:

mixing a ruthenium precursor with an organic acid and water to form a mixture, the organic acid comprising two carboxylic groups and a carbonyl group; and

calcining the mixture at a temperature of at least 250° C. for a time sufficient to form a solid.

Embodiment 498: The method of embodiment 497, further comprising evaporating a portion of the mixture for a period of time sufficient for the mixture to form a gel prior to calcination.

Embodiment 499: The method of embodiment 497, further comprising heating the mixture for a period of time sufficient for the mixture to form a gel prior to calcination.

Embodiment 500: The method of any of embodiments 497-499, wherein the organic acid comprises no more than two carboxylic groups.

Embodiment 501: The method of any of embodiments 497-500, wherein the organic acid comprises no more than one carbonyl group.

Embodiment 502: The method of any of embodiments 497-501, wherein the organic acid is ketoglutaric acid.

Embodiment 503: The method of any of embodiments 497-502, wherein the ruthenium precursor is selected from the group consisting of ruthenium acetate, ruthenium nitrosylacetate, ruthenium hydroxide, ruthenium nitrosylhydroxide, ruthenium nitrate, ruthenium nitrosyInitrate, ruthenium 2,4-pentanedionate, ruthenium formate, ruthenium nitrosylformate, ruthenium oxide, ruthenium metal, ruthenium chloride, ruthenium nitrosylchloride, ruthenium carbonyl, ruthenium red, ruthenium oxychloride, ruthenocene, chloropentaammineruthenium chloride, hexaammineruthenium chloride, dichlorotricarbonylruthenium, ruthenium carboxylate and combinations thereof.

Embodiment 504: The method of any of embodiments 497-503, wherein the mixture is calcined at a temperature of at least 300° C.

Embodiment 505: The method of any of embodiments 497-504, wherein the mixture is calcined at a temperature of at least 350° C.

Embodiment 506: The method of any of embodiments 497-505, wherein the mixture is calcined for at least 1 hour.

Embodiment 507: The method of any of embodiments 497-506, wherein the mixture is calcined for at least 2 hours.

Embodiment 508: The method of any of embodiments 497-507, wherein the mixture is calcined for at least 4 hours.

Embodiment 509: The method of any of embodiments 497-508, wherein the mixture has an essential absence of organic solvents other than the organic acid.

Embodiment 510: The method of any of embodiments 497-509, wherein the mixture has an essential absence of citric acid.

Embodiment 511: A method for making a composition, the method comprising:
mixing a ruthenium precursor with an acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture;
forming a gel; and
calcining the gel at a temperature of at least 250° C. for at least 1 hour.

Embodiment 512: The method of embodiment 511, wherein the gel forming step comprises evaporating a portion of the mixture for a period of time sufficient for the mixture to form the gel prior to calcination.

Embodiment 513: The method of embodiment 511, wherein the gel forming step comprises heating the mixture for a period of time sufficient for the mixture to form a gel prior to calcination.

Embodiment 514: The method of any of embodiments 511-513, wherein the mixture comprises water.

Embodiment 515: The method of any of embodiments 511-514, wherein the ruthenium precursor is selected from the group consisting of ruthenium acetate, ruthenium nitrosylacetate, ruthenium hydroxide, ruthenium nitrosylhydroxide, ruthenium nitrate, ruthenium nitrosyInitrate, ruthenium 2,4-pentanedionate, ruthenium formate, ruthenium nitrosylformate, ruthenium oxide, ruthenium metal, ruthenium chloride, ruthenium nitrosylchloride, ruthenium carbonyl, ruthenium red, ruthenium oxychloride, ruthenocene, chloropentaammineruthenium chloride, hexaammineruthenium chloride, dichlorotricarbonylruthenium, ruthenium carboxylate and combinations thereof.

Embodiment 516: The method of any of embodiments 511-515, wherein the gel is calcined at a temperature of at least 300° C.

Embodiment 517: The method of any of embodiments 511-515, wherein the gel is calcined at a temperature of at least 350° C.

Embodiment 518: The method of any of embodiments 511-517, wherein the gel is calcined for at least 2 hours.

Embodiment 519: The method of any of embodiments 511-517, wherein the gel is calcined for at least 4 hours.

Embodiment 520: The method of any of embodiments 511-519, wherein the mixture has an essential absence of organic solvents other than the organic acid.

Embodiment 521: The method of any of embodiments 511-520, wherein the mixture has an essential absence of citric acid.

Embodiment 522: The method of any of embodiments 511-521, wherein the mixture comprises a combination of glyoxylic and ketoglutaric acid.

Embodiment 523: A composition comprising ruthenium glyoxylate.

Embodiment 524: The composition of embodiment 523, wherein the composition is a solution.

Embodiment 525: The composition of embodiments 523 or 524, wherein the composition is a precursor to make a solid ruthenium containing material.

Embodiment 526: The composition of embodiment 525, wherein the material is a catalyst.

Embodiment 527: A composition comprising ruthenium ketoglutarate.

Embodiment 528: The composition of embodiment 527, wherein the composition is a solution.

Embodiment 529: The composition of embodiments 527 or 528, wherein the composition is a precursor to make a solid ruthenium containing material.

Embodiment 530: The composition of embodiment 529, wherein the material is a catalyst.

Embodiment 531: A method of forming a ruthenium glyoxylate, the method comprising mixing ruthenium hydroxide or ruthenium nitrosylhydroxide with aqueous glyoxylic acid.

Embodiment 532: A method of forming a ruthenium ketoglutarate, the method comprising mixing ruthenium hydroxide or ruthenium nitrosylhydroxide with aqueous ketoglutaric acid.

Embodiment 533: The composition of any of embodiments 410-459, wherein the composition has a cumulative BJH pore volume between 1.7 nm and 300 nm diameter greater than 0.20 ml/g.

Embodiment 534: The composition of embodiment 533, wherein the composition has a cumulative BJH pore volume between 1.7 nm and 300 nm diameter greater than 0.30 ml/g.

Embodiment 535: The composition of embodiment 533, wherein the composition has a cumulative BJH pore volume between 1.7 nm and 300 nm diameter greater than 0.40 ml/g.

Embodiment 536: The composition of embodiment 533, wherein the composition has a cumulative BJH pore volume between 1.7 nm and 300 nm diameter greater than 0.50 ml/g.

### Cerium

In the present invention, cerium compositions having high BET surface areas, high cerium or cerium oxide content, and/or thermal stability are disclosed.

The metal oxides and mixed metal oxides of the invention have important applications as catalysts, catalyst carriers, sorbents, sensors, actuators, pigments, polishing and decolorizing additives, and as coatings and components in the semiconductor, dielectric ceramics, electroceramics, electronics and optics industries.

In general, the cerium/cerium oxide compositions of the invention are novel and inventive as unbound and/or unsupported as well as supported catalysts and as carriers compared to known supported and unsupported cerium and cerium oxide catalyst formulations utilizing large amounts of binders such as silica, alumina, aluminum or chromia. In one embodiment, the compositions of the inventions are superior to known formulations both in terms of activity (compositions of the invention have higher surface area with a higher cerium metal and/or cerium oxide content) and in terms of selectivity (e.g. for hydrogenations, reductions and oxidations). The lower content or the absence of a binder/support (which is often unselective) and the high purity (i.e. high cerium/cerium oxide content and essential absence of Na, S, K and Cl and other impurities, such as nitrates) achievable by methods of the invention provide improvements over state of the art compositions and methods. The productivity in terms of weight of material per volume of solution per unit time is much higher for the method of the invention as compared to present sol-gel or precipitation techniques since highly concentrated solutions ˜1M can be used as starting material. Moreover, no washing or aging steps are required by the method.

The present invention is thus directed to cerium-containing compositions that comprise cerium and/or cerium oxide. Furthermore, the compositions of the present invention may comprise carbon or additional components that act as binders, promoters, stabilizers, or co-metals.

In one embodiment of the invention, the cerium composition comprises Ce metal, Ce oxide (such as CeO₂ or Ce₂O₃), or mixtures thereof. In another embodiment, the compositions of the invention comprise (i) cerium or a cerium-containing compound (e.g., cerium oxide) and (ii) one or more additional metal, oxides thereof, salts thereof, or mixtures of such metals or compounds. In one embodiment, the additional metal is an alkali metal, alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the additional metal is one of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, or a compound containing one or more of such element(s), more specifically Pt, Pd, Rh, Ir, Ag, Mn, Mo, W, Cr, In, Sn, Y, Co, Ru, Ni, Cu, Fe, Zr and more specifically Pt, Pd, Rh, Re, Ir, Ag, Co, Ni, Cu, Fe, Sn, Ru, Zr, Y or a compound containing one or more of such element(s). The concentrations of the additional components are such that the presence of the component would not be considered an impurity. For example, when present, the concentrations of the additional metals or metal containing components (e.g., metal oxides) are at least about 0.1, 0.5, 1, 2, 5, or even 10 molecular percent or more by weight. The major component of the composition typically comprises Ce oxide. The major component of the composition can, however, also include various amounts of elemental Ce and/or Ce -containing compounds, such as Ce salts. The Ce oxide is an oxide of cerium where cerium is in an oxidation state other than the fully-reduced, elemental Ce^{o} state, including oxides of cerium where cerium has an oxidation state of Ce⁺⁴, Ce⁺³, or a partially reduced oxidation state. The total amount of cerium and/or cerium oxide (CeO₂, Ce₂O₃, or a combination) present in the composition is at least about 25% by weight on a molecular basis. More specifically, compositions of the present invention include at least 35% cerium and/or cerium oxide, more specifically at least 50%, more specifically at least 60%, more specifically at least 70%, more specifically at least 75%, more specifically at least 80%, more specifically at least 85%, more specifically at least 90%, and more specifically at least 95% cerium and/or cerium oxide by weight. In one embodiment, the cerium/cerium oxide component of the composition is at least 30% cerium oxide, more specifically at least 50% cerium oxide, more specifically at least 75% cerium oxide, and more specifically at least 90% cerium oxide by weight. As noted below, the cerium/cerium oxide component can also have a support or carrier functionality.

The one or more minor component(s) of the composition preferably comprise an element selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, or a compound containing one or more of such element(s), such as oxides thereof and salts thereof, or mixtures of such elements or compounds. The minor component(s) more specifically comprises of one or more of Pt, Pd, Rh, Ir, Ag, Mn, Mo, W, Cr, In, Sn, Y, Co, Ru, Ni, Cu, Fe, Zr oxides thereof, salts thereof, or mixtures of the same and more specifically Pt, Pd, Rh, Re, Ir, Ag, Co, Ni, Cu, Fe, Sn, Ru, Zr, Y, oxides thereof, salts thereof, or mixtures of the same. In one embodiment, the minor component(s) are preferably oxides of one or more of the minor-component elements, but can, however, also include various amounts of such elements and/or other compounds (e.g., salts) containing such elements. An oxide of such minor-component elements is an oxide thereof where the respective element is in an oxidation state other than the fully-reduced state, and includes oxides having an oxidation states corresponding to known stable valence numbers, as well as to oxides in partially reduced oxidation states. Salts of such minor-component elements can be any stable salt thereof, including, for example, chlorides, nitrates, carbonates and acetates, among others. The amount of the oxide form of the particular recited elements present in one or more of the minor component(s) is at least about 5%, preferably at least about 10%, preferably still at least about 20%, more preferably at least about 35%, more preferably yet at least about 50% and most preferable at least about 60%, in each case by weight relative to total weight of the particular minor component. As noted below, the minor component can also have a support or carrier functionality.

In one embodiment, the minor component consists essentially of one element selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, or a compound containing the element. In another embodiment, the minor component consists essentially of two elements selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, or a compound containing one or more of such elements.

Thus, in one specific embodiment of the compound shown in formula I, the composition of the invention is a material comprising a compound having the formula (VI):

CeₐM²_{b}M³_{c}M⁴_{d}M⁵ₑO_{f} (VI),

where, Ce is cerium, O is oxygen and M², M³, M⁴, M⁵, a, b, c, d, e and f are as described above for formula I, and more specifically below, and can be grouped in any of the various combinations and permutations of preferences.

In formula VI, “M²” “M³” “M⁴” and “M⁵” individually each represent a metal such as an alkali metal, an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically, “M²” “M³” “M⁴”, and “M⁵” individually each represent a metal selected from Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La and Si, and more specifically Pt, Pd, Rh, Ir, Ag, Mn, Mo, W, Cr, In, Sn, Y, Co, Ru, Ni, Cu, Fe and Zr and more specifically Pt, Pd, Rh, Re, Ir, Ag, Co, Ni, Cu, Fe, Sn, Ru, Zr and Y.

In formula VI, a+b+c+d+e=1. The letter “a” represents a number ranging from about 0.2 to about 1.00, specifically from about 0.4 to about 0.90, more specifically from about 0.5 to about 0.9, and even more specifically from about 0.7 to about 0.8 The letters “b” “c” “d” and “e” individually represent a number ranging from about 0 to about 0.5, specifically from about 0.04 to about 0.2, and more specifically from about 0.04 to about 0.1.

In formula VI, “O” represents oxygen, and “f” represents a number that satisfies valence requirements. In general, “f” is based on the oxidation states and the relative atomic fractions of the various metal atoms of the compound of formula VI (e.g., calculated as one-half of the sum of the products of oxidation state and atomic fraction for each of the metal oxide components).

In one mixed-metal oxide embodiment, where, with reference to formula VI, “c” “d” and “e” are zero, the catalyst material can comprise a compound having the formula VI-A:

CeₐM²_{b}O_{f} (VI-A),

where Ce is cerium, O is oxygen, and where “a”, “M²”, “b” and “f” are as defined above.

In another embodiment, where, with reference to formula VI, “b” “c” “d” and “e” are zero, the catalyst material can comprise a compound having the formula VI-B:

CeₐO_{f} (VI-B),

where Ce is cerium, O is oxygen, and where “a” and “f” are as defined above.

In one embodiment, the cerium compositions of the invention can also include carbon. The amount of carbon in the compositions is typically less than 75% by weight. More specifically, the compositions of the invention have between about 0.01% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the compositions of the invention have an essential absence of N, Na, S, K and/or Cl.

In another embodiment, the cerium compositions of the invention contain less than 10%, specifically less than 5%, more specifically less than 3%, and more specifically less than 1% water.

The cerium compositions can include other components as well, such as diluents, binders and/or fillers, as desired in connection with the reaction system of interest.

In one embodiment, the cerium compositions of the invention are typically a high surface area porous solid. Specifically, the BET surface area of the composition is from about 30 m²/g to about 350 m²/g, more specifically from about 50 m²/g to about 300 m²/g , more specifically from about 75 m²/g to about 250 m²/g, and more specifically from about 90 m²/g to about 180 m²/g. In another embodiment, the BET surface area is at least about 30 m²/g, more specifically at least about 40 m²/g, more specifically at least about 50 m²/g, more specifically at least about 60 m²/g, more specifically at least about 70 m²/g, more specifically at least about 80 m²/g, more specifically at least about 90 m²/g, more specifically at least about 100 m²/g, more specifically at least about 110 m²/g, more specifically at least about 120 m²/g, more specifically at least about 130 m²/g, more specifically at least about 140 m²/g, more specifically at least about 150 m²/g, more specifically at least about 160 m²/g, more specifically at least about 170 m²/g, more specifically at least about 200 m²/g, more specifically at least about 220 m²/g, more specifically at least about 250 m²/g, more specifically at least about 275 m²/g, and more specifically at least about 300 m²/g.

In one embodiment, the cerium compositions of the invention are thermally stable.

In one embodiment, the cerium compositions of the invention are porous solids, having a wide range of pore diameters. In one embodiment, at least 10%, more specifically at least 20% and more specifically at least 30% of the pores of the composition of the invention have a pore diameter greater than 10 nm, more specifically greater than 15 nm, and more specifically greater than 20 nm. Additionally, at least 10%, specifically at least 20% and more specifically at least 30% of the pores of the composition have a pore diameter less than 12 nm, specifically less than 10 nm, more specifically less than 8 nm and more specifically less than 6 nm.

In one embodiment, the total pore volume (the cumulative BJH pore volume between 1.7 nm and 300 nm diameter) is greater than 0.10 ml/g, more specifically, greater than 0.15 ml/g, more specifically, greater then 0.175 ml/g, more specifically, greater then 0.20 ml/g, more specifically, greater then 0.25 ml/g, more specifically, greater then 0.30 ml/g, more specifically, greater then 0.35 ml/g, more specifically, greater then 0.40 ml/g, more specifically, greater then 0.45 ml/g, and more specifically, greater then 0.50 ml/g.

In one embodiment, the cerium materials are fairly amorphous. That is, the materials are less than 80% crystalline, specifically, less than 60% crystalline and more specifically, less than 50% crystalline.

In one embodiment, the cerium composition of the invention is a bulk metal or mixed metal oxide material. In another embodiment, the composition is a support or carrier on which other materials are impregnated. In one embodiment, the compositions of the invention have thermal stability and high surface areas with an essential absence of silica, alumina, aluminum or chromia. In still another embodiment, the composition is supported on a carrier, (such as a supported catalyst). In another embodiment, the composition comprises both the support and the catalyst. In embodiments where the composition is a supported catalyst, the support utilized may contain one or more of the metals (or metalloids) of the catalyst, including cerium. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

In embodiments where the cerium composition of the invention is a supported catalyst, the one or more of the aforementioned compounds or compositions can be located on a solid support or carrier. The support can be a porous support, with a pore size typically ranging, without limitation, from about 0.5 nm to about 300 nm and with a surface area typically ranging, without limitation, from about 5 m²/g to about 1500 m²/g. The particular support or carrier material is not narrowly critical, and can include, for example, a material selected from the group consisting of silica, alumina, activated carbon, titania, zirconia, tin oxide, yttria, magnesia, niobia, zeolites and clays, among others, or mixtures thereof. Preferred support materials include titania, zirconia, tin oxide, alumina or silica. In some cases, where the support material itself is the same as one of the preferred components (e.g., Al₂O₃ for Al as a minor component), the support material itself may effectively form a part of the catalytically active material. In other cases, the support can be entirely inert to the reaction of interest.

The cerium compositions of the present invention are made by a novel method that results in high surface area cerium/cerium oxide materials. In one embodiment, method includes mixing a cerium precursor with an organic acid and water to form a mixture, and calcining the mixture. According to one approach for preparing a mixed-metal oxide composition of the invention, the mixture also includes a metal precursor other than a cerium precursor.

The mixture comprises the cerium precursor and the organic acid. In one embodiment, the mixture preferably has an essential absence of any organic solvent other then the organic acid (which may or may not be a solvent for the cerium precursor), such as alcohols. In another embodiment, the mixture preferably has an essential absence of citric acid. In another embodiment, the mixture preferably has an essential absence of citric acid and organic solvents other than the organic acid.

The organic acids used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, or imino, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, and oxalic acid, oxalacetic acid, and more specifically, glyoxylic acid and ketoglutaric acid.

The cerium precursor used in the method of the invention is selected from the group consisting of cerium acetate, cerium hydroxide, cerium carbonate, cerium nitrate, ammonium cerium nitrate, cerium 2,4-pentanedionate, cerium formate, cerium alkoxide, cerium oxide, cerium metal, cerium chloride, cerium perchlorate, cerium oxalate, cerium carboxylate and combinations thereof, specifically, cerium acetate and cerium nitrate and ammonium cerium nitrate and cerium 2,4-pentanedionate. Specific cerium carboxylates include cerium oxalate, cerium ketoglutarate, cerium citrate, cerium tartrate, cerium malate, cerium lactate and cerium glyoxylate.

The ratio of mmols of acid to mmols metal can vary from about 0:1 to about 1:10, more specifically from about 7:1 to about 1:5, more specifically from about 5:1 to about 1:4, and more specifically from about 3:1 to about 1:3.

Mixed-metal oxide compositions can also be made by the methods of the invention by including more than one metal precursor in the mixture.

Water may also be present in the mixtures described above. The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi stage calcination as described below.

In another embodiment, the method includes evaporating the mixture to dryness or providing the dry cerium precursor and calcining the dry component to form a solid cerium oxide. Specifically, the cerium precursor is a cerium carboxylate, more specifically, cerium glyoxylate, cerium ketoglutarate, cerium oxalacetate, or cerium diglycolate.

In another embodiment, high surface area and highly pure cerium materials can be made by precipitation of various cerium precursors with different bases. Cerium (IV) nitrate and ammonium cerium (IV) nitrate precursors, such as Ce(IV)(NO₃)₄ and (NH₄)₂Ce(IV)(NO₃)₆, can be combined with bases such as ammonium or tetraalkylammonium hydroxide or carbonate or carbamate, specifically tetramethylammonium hydroxide and tetramethylammonium carbonate and ammonium carbamate, under precipitation conditions and calcined as described above to achieve high surface area cerium materials that are essentially free of Na, K, Cl, S.

In another embodiment, as an alternative to starting from acidic solutions, cerium precursors can be mixed with bases. Bases such as ammonia, tetraalkylammonium hydroxide, organic amines and aminoalcohols can be used as dispersants. The resulting basic solutions can then be aged at room temperature or by slow evaporation and calcinations (or other means of low temperature detemplation).

In other embodiments, dispersants other than organic acids can be utilized. For example, non-acidic dispersants with at least two functional groups, such as dialdehydes (glyoxal) and ethylene glycol have been found to form pure and/or high surface area cerium -containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

The heating of the resulting mixture is typically a calcination, which may be conducted in an oxygen-containing atmosphere or in the substantial absence of oxygen, e.g., in an inert atmosphere or in vacuo. The inert atmosphere may be any material which is substantially inert, e.g., does not react or interact with the material. Suitable examples include, without limitation, nitrogen, argon, xenon, helium or mixtures thereof. Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 200° C. to 850° C., specifically from 250° C. to 500° C. more specifically from 250° C. to 400° C., more specifically from 300° C. to 400° C., and more specifically from 300° C. to 375° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

In some embodiments it may be desirable to reduce all or a portion of the cerium oxide material to a reduced (elemental) cerium for a reaction of interest. The cerium oxide materials of the invention can be partially or entirely reduced by reacting the cerium oxide containing material with a reducing agent, such as hydrazine or formic acid, or by introducing, a reducing gas, such as, for example, ammonia or hydrogen, during or after calcination. In one embodiment, the cerium oxide material is reacted with a reducing agent in a reactor by flowing a reducing agent through the reactor. This provides a material with a reduced (elemental) cerium surface for carrying out the reaction of interest.

As an alternative to calcination, the material can detemplated by the oxidation of organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The compositions of the invention are typically solid catalysts, and can be used in a reactor, such as a three phase reactor with a packed bed (e.g., a trickle bed reactor), a fixed bed reactor (e.g., a plug flow reactor), a honeycomb, a fluidized or moving bed reactor, a two or three phase batch reactor, or a continuous stirred tank reactor. The compositions can also be used in a slurry or suspension.

Preferred embodiments of the invention, thus, further include:

Embodiment 537: A composition comprising at least about 50% cerium metal or a cerium oxide by weight, the composition being a porous solid composition having a BET surface area of at least 140 square meters per gram and having an essential absence of S and N.

Embodiment 538: A composition comprising at least about 50% cerium metal or a cerium oxide by weight, the composition being a porous solid composition having a BET surface area of at least 100 square meters per gram and having an essential absence of Zr, S and N.

Embodiment 539: A composition comprising at least about 95% cerium metal or a cerium oxide by weight, the composition being a porous solid composition, having a BET surface area of at least 100 square meters per gram and having an essential absence of S and N.

Embodiment 540: A composition consisting essentially of carbon and at least about 50% cerium metal or a cerium oxide, the composition being a porous solid composition having a BET surface area of at least 75 square meters per gram.

Embodiment 541: A composition comprising at least about 50% cerium metal or a cerium oxide by weight, the composition being a porous solid composition having a BET surface area of at least 100 square meters per gram and having a total pore volume greater than 0.20 ml/g.

Embodiment 542: The composition of any of embodiments 537-539 and 541, further comprising a metal other than cerium.

Embodiment 543: The composition of any of embodiments 537, 538 and 540-542, wherein the composition comprises at least 60% cerium metal or the cerium oxide by weight.

Embodiment 544: The composition of any of embodiments 537, 538 and 540-542, wherein the composition comprises at least 70% cerium metal or the cerium oxide by weight.

Embodiment 545: The composition of any of embodiments 537, 538 and 540-542, wherein the composition comprises at least 75% cerium metal or the cerium oxide by weight.

Embodiment 546: The composition of any of embodiments 537, 538 and 540-542, wherein the composition comprises at least 80% cerium metal or the cerium oxide by weight.

Embodiment 547: The composition of any of embodiments 537, 538 and 540-542, wherein the composition comprises at least 85% cerium metal or the cerium oxide by weight.

Embodiment 548: The composition of any of embodiments 537, 538 and 540-542, wherein the composition comprises at least 90% cerium metal or the cerium oxide by weight.

Embodiment 549: The composition of any of embodiments 537, 538 and 540-542, wherein the composition comprises at least 95% cerium metal or the cerium oxide by weight.

Embodiment 550: The composition of embodiment 540, wherein the composition has a BET surface area of at least 100 square meters per gram.

Embodiment 551: The composition of any of embodiments 538-550, wherein the composition has a BET surface area of at least 110 square meters per gram.

Embodiment 552: The composition of any of embodiments 538-551, wherein the BET surface area is between about 110 square meters per gram and 220 square meters per gram.

Embodiment 553: The composition of any of embodiments 538-552, wherein the BET surface area is at least 120 square grams per meter.

Embodiment 554: The composition of any of embodiments 538-552, wherein the BET surface area is at least 130 square meters per gram.

Embodiment 555: The composition of any of embodiments 538-552, wherein the BET surface area is at least 140 square meters per gram.

Embodiment 556: The composition of any of embodiments 537-552, wherein the BET surface area is at least 150 square meters per gram.

Embodiment 557: The composition of any of embodiments 537-552, wherein the BET surface area is at least 155 square meters per gram.

Embodiment 558: The composition of any of embodiments 537-552, wherein the BET surface area is at least 160 square meters per gram.

Embodiment 559: The composition of any of embodiments 537-552, wherein the BET surface area is at least 170 square meters per gram.

Embodiment 560: The composition of any of embodiments 537-552, wherein the BET surface area is at least 175 square meters per gram.

Embodiment 561: The composition of any of embodiments 537-560, comprising between about 0.01% and about 20% carbon by weight.

Embodiment 562: The composition of embodiment 561, wherein the composition comprises between about 0.5% and about 10% carbon by weight.

Embodiment 563: The composition of embodiment 561, wherein the composition comprises between about 1.0% and about 5% carbon by weight.

Embodiment 564: The composition of embodiment 561, wherein the composition comprises between about 0.01% and about 0.5% carbon by weight.

Embodiment 565: The composition of any of embodiments 537-539 and 541-564, wherein the composition has an essential absence of silica, alumina, aluminum or chromia.

Embodiment 566: The composition of any of embodiments 538, 539 and 541-565, wherein the composition has an essential absence of Zr.

Embodiment 567: The composition of any of embodiments 537-539 and 541-566, wherein the composition has an essential absence of Na, K and Cl.

Embodiment 568: The composition of any of embodiments 537-567, wherein the composition is a catalyst.

Embodiment 569: The composition of any of embodiments 537-568, wherein the composition is thermally stable with respect to the BET surface area of the composition decreasing by not more than 10% when heated at 350° C. for 2 hours.

Embodiment 570: The composition of any of embodiments 537-569, wherein the cerium metal or cerium oxide is at least 30% cerium oxide.

Embodiment 571: The composition of embodiment 570, wherein the cerium metal or cerium oxide is at least 50% cerium oxide.

Embodiment 572: The composition of embodiment 570, wherein the cerium metal or cerium oxide is at least 75% cerium oxide.

Embodiment 573: The composition of embodiment 570, wherein the cerium metal or cerium oxide is at least 90% cerium oxide.

Embodiment 574: The composition of any of embodiments 537-539 and 541-573, further comprising a component selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, their oxides, and combinations thereof.

Embodiment 575: The composition of embodiment 540, wherein the metal other than cerium is selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, their oxides, and combinations thereof.

Embodiment 576: The composition of any of embodiments 537-575, wherein the composition is an unsupported material.

Embodiment 577: The composition of any of embodiments 537-575, wherein the composition is on a support.

Embodiment 578: The composition of embodiments 537-575, further comprising a support

Embodiment 579: The composition of any of embodiments 537-578, wherein the composition is a porous solid wherein at least 10% of the pores have a diameter greater than 10 nm.

Embodiment 580: The composition of any of embodiments 537-579, wherein at least 10% of the pores have a diameter greater than 15 nm.

Embodiment 581: The composition of any of embodiments 537-580, wherein at least 10% of the pores have a diameter greater than 20 nm.

Embodiment 582: The composition of any of embodiments 537-581, wherein at least 20% of the pores have a diameter greater than 20 nm.

Embodiment 583: The composition of any of embodiments 537-582, wherein at least 30% of the pores have a diameter greater than 20 nm.

Embodiment 584: The composition of any of embodiments 537-583, wherein at least 10% of the pores have a diameter less than 10 nm.

Embodiment 585: The composition of any of embodiments 537-584, wherein at least 20% of the pores have a diameter less than 10 nm.

Embodiment 586: The composition of any of embodiments 537-585 in a reactor.

Embodiment 587: The composition of embodiment 586, wherein the reactor is a three phase reactor with a packed bed.

Embodiment 588: The composition of embodiment 586, wherein the reactor is a trickle bed reactor.

Embodiment 589: The composition of embodiment 586, wherein the reactor is a fixed bed reactor.

Embodiment 590: The composition of embodiment 586, wherein the reactor is a plug flow reactor.

Embodiment 591: The composition of embodiment 586, wherein the reactor is a fluidized bed reactor.

Embodiment 592: The composition of embodiment 586, where the reactor is a two or three phase batch reactor.

Embodiment 593: The composition of embodiment 586, wherein the reactor is a continuous stirred tank reactor.

Embodiment 594: The composition of any of embodiments 537-585 in a slurry or suspension.

Embodiment 595: The composition of any of embodiments 537-585, made by a process comprising:

mixing a cerium precursor with an organic acid and water to form a mixture; and

calcining the mixture at a temperature of at least 250° C. for a time period sufficient to form a solid.

Embodiment 596: The composition of embodiment 595, wherein the process further comprises evaporating a portion of the mixture for a period of time sufficient for the mixture to form a gel prior to calcination.

Embodiment 597: The composition of embodiment 595, wherein the process further comprises heating the mixture for a period of time sufficient for the mixture to form a gel prior to calcination.

Embodiment 598: The composition of any of embodiments 595-597, wherein in the process, the organic acid comprises a carboxyl group.

Embodiment 599: The composition of any of embodiments 595-598, wherein in the process, the organic acid comprises no more than one carboxylic group and at least one functional group selected from the group consisting of hydroxyl and carbonyl.

Embodiment 600: The composition of any of embodiments 595-599, wherein in the process, the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 601: The composition of any of embodiments 595-600, wherein in the process, the organic acid is ketoglutaric acid.

Embodiment 602: The composition of any of embodiments 595-601, wherein in the process, the organic acid is selected from the group consisting of glyoxylic acid, ketoglutaric acid and combinations thereof.

Embodiment 603: The composition of any of embodiments 595-602, wherein in the process, the cerium precursor is selected from the group consisting of cerium acetate, cerium hydroxide, cerium carbonate, cerium nitrate, ammonium cerium nitrate, cerium 2,4-pentanedionate, cerium formate, cerium oxalate, cerium chloride and combinations thereof.

Embodiment 604: The composition of any of embodiments 595-603, wherein in the process, the mixture is calcined at a temperature of at least 300° C.

Embodiment 605: The composition of any of embodiments 595-603, wherein in the process, the mixture is calcined at a temperature of at least 350° C.

Embodiment 606: The composition of any of embodiments 595-605, wherein in the process, the mixture is calcined for at least 1 hour.

Embodiment 607: The composition of any of embodiments 595-605, wherein in the process, the mixture is calcined for at least 2 hours.

Embodiment 608: The composition of any of embodiments 595-605, wherein in the process, the mixture is calcined for at least 4 hours.

Embodiment 609: The composition of any of embodiments 595-608, wherein in the process, the mixture has an essential absence of organic solvents other than the organic acid.

Embodiment 610: The composition of any of embodiments 595-609, wherein in the process, the mixture has an essential absence of citric acid.

Embodiment 611: A method for making a composition, the method comprising:
mixing a cerium precursor with an organic acid and water to form a mixture, the organic acid comprising no more than one carboxylic group and at least one functional group selected from the group consisting of carbonyl and hydroxyl;
forming a gel; and
calcining the mixture at a temperature of at least 250° C. for a time sufficient to form a solid.

Embodiment 612: The method of embodiment 611, wherein the gel forming step comprises evaporating a portion of the mixture for a period of time sufficient for the mixture to form the gel prior to calcination.

Embodiment 613: The method of embodiment 611, wherein the gel forming step comprises heating the mixture for a period of time sufficient for the mixture to form the gel prior to calcination.

Embodiment 614: The method of any of embodiments 611-613, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 615: The method of embodiment 611-614, wherein the organic acid is glyoxylic acid.

Embodiment 616: The method of any of any of embodiments 611-615, wherein the cerium precursor is selected from the group consisting of cerium acetate, cerium hydroxide, cerium carbonate, cerium nitrate, ammonium cerium nitrate, cerium 2,4-pentanedionate, cerium formate, cerium oxalate, cerium chloride and combinations thereof.

Embodiment 617: The method of any of embodiments 611-616, wherein the mixture is calcined at a temperature of at least 300° C.

Embodiment 618: The method of any of embodiments 611-616, wherein the mixture is calcined at a temperature of at least 350° C.

Embodiment 619: The method of any of embodiments 611-618, wherein the mixture is calcined for at least 1 hour.

Embodiment 620: The method of any of embodiments 611-618, wherein the mixture is calcined for at least 2 hours.

Embodiment 621: The method of any of embodiments 611-618, wherein the mixture is calcined for at least 4 hours.

Embodiment 622: The method of any of embodiments 611-621, wherein the mixture has an essential absence of organic solvents other than the organic acid.

Embodiment 623: The method of any of embodiments 611-622, wherein the mixture has an essential absence of citric acid.

Embodiment 624: A method for making a composition, the method comprising:
mixing a cerium precursor with an organic acid and water to form a mixture, the organic acid comprising two carboxylic groups and a carbonyl group; and
calcining the mixture at a temperature of at least 250° C. for a time sufficient to form a solid.

Embodiment 625: The method of embodiment 624, further comprising evaporating a portion of the mixture for a period of time sufficient for the mixture to form a gel prior to calcination.

Embodiment 626: The method of embodiment 624, further comprising heating the mixture for a period of time sufficient for the mixture to form a gel prior to calcination.

Embodiment 627: The method of any of embodiments 624-626, wherein the organic acid comprises no more than two carboxylic groups.

Embodiment 628: The method of any of embodiments 624-627, wherein the organic acid comprises no more than one carbonyl group.

Embodiment 629: The method of any of embodiments 624-628, wherein the organic acid is ketoglutaric acid.

Embodiment 630: The method of any of embodiments 624-629, wherein the cerium precursor is selected from the group consisting of cerium acetate, cerium hydroxide, cerium carbonate, cerium nitrate, ammonium cerium nitrate, cerium 2,4-pentanedionate, cerium formate, cerium oxalate cerium chloride and combinations thereof.

Embodiment 631: The method of any of embodiments 624-630, wherein the mixture is calcined at a temperature of at least 300° C.

Embodiment 632: The method of any of embodiments 624-630, wherein the mixture is calcined at a temperature of at least 350° C.

Embodiment 633: The method of any of embodiments 624-632, wherein the mixture is calcined for at least 1 hour.

Embodiment 634: The method of any of embodiments 624-632, wherein the mixture is calcined for at least 2 hours.

Embodiment 635: The method of any of embodiments 624-632, wherein the mixture is calcined for at least 4 hours.

Embodiment 636: The method of any of embodiments 624-635, wherein the mixture has an essential absence of organic solvents other than the organic acid.

Embodiment 637: The method of any of embodiments 624-636, wherein the mixture has an essential absence of citric acid.

Embodiment 638: A method for making a composition, the method comprising:
mixing a cerium precursor with an acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture;
forming a gel; and
calcining the gel at a temperature of at least 250° C. for at least 1 hour.

Embodiment 639: The method of embodiment 638, wherein the gel forming step comprises evaporating a portion of the mixture for a period of time sufficient for the mixture to form the gel prior to calcination.

Embodiment 640: The method of embodiment 638, wherein the gel forming step comprises heating the mixture for a period of time sufficient for the mixture to form a gel prior to calcination.

Embodiment 641: The method of any of embodiments 638-640, wherein the mixture comprises water.

Embodiment 642: The method of any of embodiments 638-641, wherein the cerium precursor is selected from the group consisting of cerium acetate, cerium hydroxide, cerium carbonate, cerium nitrate, ammonium cerium nitrate, cerium 2,4-pentanedionate, cerium formate, cerium oxalate, cerium chloride and combinations thereof.

Embodiment 643: The method of any of embodiments 638-642, wherein the gel is calcined at a temperature of at least 300° C.

Embodiment 644: The method of any of embodiments 638-642, wherein the gel is calcined at a temperature of at least 350° C.

Embodiment 645: The method of any of embodiments 638-644, wherein the gel is calcined for at least 2 hours.

Embodiment 646: The method of any of embodiments 638-644, wherein the gel is calcined for at least 4 hours.

Embodiment 647: The method of any of embodiments 638-646, wherein the mixture has an essential absence of organic solvents other than the organic acid.

Embodiment 648: The method of any of embodiments 638-647, wherein the mixture has an essential absence of citric acid.

Embodiment 649: The method of any of embodiments 638-648, wherein the mixture comprises a combination of glyoxylic and ketoglutaric acid.

Embodiment 650: A composition comprising cerium glyoxylate.

Embodiment 651: The composition of embodiment 650, wherein the composition is a solution.

Embodiment 652: The composition of embodiments 650 or 651, wherein the composition is a precursor to make a solid cerium containing material.

Embodiment 653: The composition of embodiment 652, wherein the material is a catalyst.

Embodiment 654: A composition comprising cerium ketoglutarate.

Embodiment 655: The composition of embodiment 654, wherein the composition is a solution.

Embodiment 656: The composition of embodiments 654 or 655, wherein the composition is a precursor to make a solid cerium containing material.

Embodiment 657: The composition of embodiment 656, wherein the material is a catalyst.

Embodiment 658: A method of forming a cerium glyoxylate, the method comprising mixing cerium hydroxide with aqueous glyoxylic acid.

Embodiment 659: A method of forming a cerium ketoglutarate, the method comprising mixing cerium hydroxide with aqueous ketoglutaric acid.

Embodiment 660: The composition of any of embodiments 537-585, wherein the composition has a cumulative BJH pore volume between 1.7 nm and 300 nm diameter greater than 0.20 ml/g.

Embodiment 661: The composition of embodiment 660, wherein the composition has a cumulative BJH pore volume between 1.7 nm and 300 nm diameter greater than 0.30 ml/g.

Embodiment 662: The composition of embodiment 660, wherein the composition has a cumulative BJH pore volume between 1.7 nm and 300 nm diameter greater than 0.40 ml/g.

Embodiment 663: The composition of embodiment 660, wherein the composition has a cumulative BJH pore volume between 1.7 nm and 300 nm diameter greater than 0.50 ml/g.

### Molybdenum

In the present invention, molybdenum compositions having high BET surface areas, high molybdenum or molybdenum oxide content, and/or thermal stability are disclosed.

The metal oxides and mixed metal oxides of the invention have important applications as catalysts, catalyst carriers, sorbents, sensors, actuators, pigments, polishing and decolorizing additives, and as coatings and components in the semiconductor, dielectric ceramics, electroceramics, electronics and optics industries. Other applications are in agriculture, in analytical chemistry, as a corrosion inhibitor, in ceramic glazes, enamels and pigments. For example, Mo—V mixed oxides are core compositions of many oxidation catalysts since V and Mo are the only metals that are known to selectively insert oxygen and form a synergistic pair. For instance, V—Mo—W are core compositions for the oxidation of acrolein to acrylic acid, and V—Mo—Nb for the oxidation of propane to acrylic acid and of ethane to acetic acid and for the dehydrogenation of ethane to ethylene, and V—Mo—Ti—Zr for oxidations and ammoxidations of side chain aromatics. V—Mo and V—Ti are considered to be the two universal systems for selective oxidations. High surface area V—Mo mixed oxides are highly desirable to boost the activity of commercially relevant oxidation processes as higher activity allows a lower reaction temperature thereby gaining selectivity. Bi—Mo are core catalyst compositions for the oxidation of propylene to acrolein. Co—Mo and Ni—Mo are core catalyst compositions for hydrodesulfurization catalysts.

In general, the molybdenum /molybdenum oxide compositions of the invention are novel and inventive as unbound and/or unsupported as well as supported catalysts and as carriers compared to known supported and unsupported molybdenum and molybdenum oxide catalyst formulations utilizing large amounts of binders such as silica, alumina, aluminum or chromia. In one embodiment, the compositions of the inventions are superior to known formulations both in terms of activity (compositions of the invention have higher surface area with a higher molybdenum metal and/or molybdenum oxide content) and in terms of selectivity (e.g. for hydrogenations, reductions and oxidations). The lower content or the absence of a binder/support (which is often unselective) and the high purity (i.e. high molybdenum/molybdenum oxide content and essential absence of Na, S, K and Cl and other impurities, such as nitrates) achievable by methods of the invention provide improvements over state of the art compositions and methods. The productivity in terms of weight of material per volume of solution per unit time is much higher for the method of the invention as compared to present sol-gel or precipitation techniques since highly concentrated solutions ˜1M can be used as starting material. Moreover, no washing or aging steps are required by the method.

The present invention is thus directed to molybdenum -containing compositions that comprise molybdenum and/or molybdenum oxide. Furthermore, the compositions of the present invention may comprise carbon or additional components that act as binders, promoters, stabilizers, or co-metals.

In one embodiment of the invention, the molybdenumcomposition comprises Mo metal, Mo oxide (such as MoO₂ or MoO₃), or mixtures thereof, In another embodiment, the compositions of the invention comprise (i) molybdenum or a molybdenum-containing compound (e.g., molybdenum oxide) and (ii) one or more additional metal, oxides thereof, salts thereof, or mixtures of such metals or compounds. In one embodiment, the additional metal is an alkali metal, alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the additional metal is one of Ti, Pt, Pd, Re, Ir, R, Ag, V, Cr, Cu, Au, Sn, Mn, In, Y, Mg, Ba, Fe, Ta, Nb, Ni, Hf, W, Co, Zn, Zr, Ru, Al, La, Si, Bi, Te or a compound containing one or more of such element(s), more specifically Pt, Pd, Rh, Ir, Ag, Mn, V, W, Nb, Cr, In, Sn, Y, Co, Ru, Ni, Cu, Fe, Zr, Ti, Bi, Te, Mg, and more specifically Pt, Pd, Rh, Re, Ir, Ag, Co, Ni, Cu, Fe, Sn, Ru, Zr, Y, V, W, Nb, Ti, Bi, Te and more specifically V, Co, Ni, Nb, W, Ti, Bi, Te, Fe and even more specifically V, or a compound containing one or more of such element(s). The concentrations of the additional components are such that the presence of the component would not be considered an impurity. For example, when present, the concentrations of the additional metals or metal containing components (e.g., metal oxides) are at least about 0.1, 0.5, 1, 2, 5, or even 10 molecular percent or more by weight.

The major component of the composition typically comprises Mo oxide. The major component of the composition can, however, also include various amounts of elemental Mo and/or Mo-containing compounds, such as Mo salts. The Mo oxide is an oxide of molybdenum where molybdenumis in an oxidation state other than the fully-reduced, elemental Mo^{o} state, including oxides of molybdenum where molybdenum has an oxidation state of Mo⁺², Mo⁺³, Mo⁺⁴, Mo⁺⁵, Mo⁺⁶, or a partially reduced oxidation state. The total amount of molybdenumand/or molybdenum oxide (MoO₂, MoO₃, or a combination) present in the composition is at least about 25% by weight on a molecular basis. More specifically, compositions of the present invention include at least 35% molybdenum and/or molybdenum oxide, more specifically at least 50%, more specifically at least 60%, more specifically at least 70%, more specifically at least 75%, more specifically at least 80%, more specifically at least 85%, more specifically at least 90%, and more specifically at least 95% molybdenum and/or molybdenum oxide by weight. In one embodiment, the molybdenum /molybdenum oxide component of the composition is at least 30% molybdenum oxide, more specifically at least 50% molybdenum oxide, more specifically at least 75% molybdenum oxide, and more specifically at least 90% molybdenum oxide by weight. As noted below, the molybdenum /molybdenum oxide component can also have a support or carrier functionality.

The one or more minor component(s) of the composition preferably comprise an element selected from the group consisting of Ti, Pt, Pd, Re, Ir, R, Ag, V, Cr, Cu, Au, Sn, Mn, In, Y, Mg, Ba, Fe, Ta, Nb, Ni, Hf, W, Co, Zn, Zr, Ru, Al, La, Si, or a compound containing one or more of such element(s), such as oxides thereof and salts thereof, or mixtures of such elements or compounds. The minor component(s) more specifically comprises of one or more of Pt, Pd, Rh, Ir, Ag, Mn, V, W, Cr, In, Sn, Y, Co, Ru, Ni, Cu, Fe, Zr, Ti, Bi, Nb, Mg, Te oxides thereof, salts thereof, or mixtures of the same and more specifically Pt, Pd, Rh, Re, Ir, Ag, Co, Ni, Cu, Fe, Sn, Ru, Zr, Y, V, W, Nb, Ti, Bi, Te, Mg oxides thereof, salts thereof, or mixtures of the same and even more specifically, V, oxides thereof and/or salts thereof. In one embodiment, the minor component(s) are preferably oxides of one or more of the minor-component elements, but can, however, also include various amounts of such elements and/or other compounds (e.g., salts) containing such elements. An oxide of such minor-component elements is an oxide thereof where the respective element is in an oxidation state other than the fully-reduced state, and includes oxides having an oxidation states corresponding to known stable valence numbers, as well as to oxides in partially reduced oxidation states. Salts of such minor-component elements can be any stable salt thereof, including, for example, chlorides, nitrates, carbonates and acetates, among others. The amount of the oxide form of the particular recited elements present in one or more of the minor component(s) is at least about 5%, preferably at least about 10%, preferably still at least about 20%, more preferably at least about 35%, more preferably yet at least about 50% and most preferable at least about 60%, in each case by weight relative to total weight of the particular minor component. As noted below, the minor component can also have a support or carrier functionality.

In one embodiment, the minor component consists essentially of one element selected from the group consisting of Ti, Pt, Pd, Re, Ir, R, Ag, V, Cr, Cu, Au, Sn, Mn, In, Y, Mg, Ba, Fe, Ta, Nb, Ni, Hf, W, Co, Zn, Zr, Ru, Al, La, Si, Te, Bi, or a compound containing the element. In another embodiment, the minor component consists essentially of two elements selected from the group consisting of Ti, Pt, Pd, Re, Ir, R, Ag, V, Cr, Cu, Au, Sn, Mn, In, Y, Mg, Ba, Fe, Ta, Nb, Ni, Hf, W, Co, Zn, Zr, Ru, Al, La, Si, Te, Bi or a compound containing one or more of such elements.

Thus, in one specific embodiment of the compound shown in formula I, the composition of the invention is a material comprising a compound having the formula (VII):

MoₐM²_{b}M³_{c}M⁴_{d}M⁵ₑO_{f} (VII),

where, Mo is molybdenum, O is oxygen and M², M³, M⁴, M⁵, a, b, c, d, e and f are as described above for formula I, and more specifically below, and can be grouped in any of the various combinations and permutations of preferences.

In formula VII, “M²” “M³” “M⁴” and “M⁵” individually each represent a metal such as an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically, “M²” “M³” “M⁴” and “M⁵” individually each represent a metal selected from Ti, Pt, Pd, V, Cr, Cu, Au, Sn, Mn, In, Ru, Mg, Ba, Fe, Ta, Nb, Co, Hf, W, Y, Zn, Zr, Ce, Al, Si and La, and more specifically Mn, V, W, Cr, In, Sn, Ru and Co.

In formula VII, a+b+c+d+e=1. The letter “a” represents a number ranging from about 0.2 to about 1.00, specifically from about 0.3 to about 0.90, more specifically from about 0.5 to about 0.9, and even more specifically from about 0.7 to about 0.8 The letters “b” “c” “d” and “e” individually represent a number ranging from about 0 to about 0.4, specifically from about 0.04 to about 0.3, and more specifically from about 0.04 to about 0.2.

In formula VII, “O” represents oxygen, and “f” represents a number that satisfies valence requirements. In general, “f” is based on the oxidation states and the relative atomic fractions of the various metal atoms of the compound of formula VII (e.g., calculated as one-half of the sum of the products of oxidation state and atomic fraction for each of the metal oxide components).

In one mixed-metal oxide embodiment, where, with reference to formula VII, “c” “d” and “e” are zero, the catalyst material can comprise a compound having the formula VII-A:

MoₐM²_{b}O_{f} (VII-A),

where Mo is molybdenum, O is oxygen, and where “a”, “M²”, “b” and “f” are as defined above. In one specific embodiment, M² is V (vanadium), “a” is from about 0.6 to about 0.9 and “b” is from about 0.1 to about 0.4.

In another embodiment, where, with reference to formula VII, “b” “c” “d” and “e” are zero, the catalyst material can comprise a compound having the formula VII-B:

MOₐO_{f} (VII-B),

where Mo is molybdenum, O is oxygen, and where “a” and “f” are as defined above.

In one embodiment, the compositions of the invention can also include carbon. The amount of carbon in the compositions is typically less than 75% by weight. More specifically, the compositions of the invention have between about 0.01% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the as prepared compositions of the invention have an essential absence of N, Na, S, K and/or Cl.

In another embodiment, the compositions of the invention contain less than 10%, specifically less than 5%, more specifically less than 3%, and more specifically less than 1% water.

The compositions can include other components as well, such as diluents, binders and/or fillers, as desired in connection with the reaction system of interest.

In one embodiment, the compositions of the invention are typically a high surface area porous solid. Specifically, the BET surface area of the composition is from about 5 m²/g to about 50 m²/g, more specifically from about 10 m²/g to about 40 m²/g , more specifically from about 12 m²/g to about 35 m²/g, and more specifically from about 15 m²/g to about 25 m²/g. In another embodiment, the BET surface area is at least about 10 m²/g, more specifically at least about 15 m²/g, more specifically at least about 20 m²/g, more specifically at least about 22 m²/g, more specifically at least about 25 m²/g, more specifically at least about 27 m²/g, more specifically at least about 30 m²/g, more specifically at least about 32 m²/g, more specifically at least about 35 m²/g, more specifically at least about 40 m²/g.

In one embodiment, the compositions of the invention are thermally stable.

In one embodiment, the compositions of the invention are porous solids, having a wide range of pore diameters. In one embodiment, at least 10%, more specifically at least 20% and more specifically at least 30% of the pores of the composition of the invention have a pore diameter greater than 10 nm, more specifically greater than 15 nm, more specifically greater than 20 nm, and more specifically greater than 50 nm. Additionally, at least 2%, specifically at least 3% and more specifically at least 5% of the pores of the composition have a pore diameter less than 12 nm, specifically less than 10 nm, more specifically less than 8 nm and more specifically less than 6 nm.

In one embodiment, the total pore volume (the cumulative BJH pore volume between 1.7 nm and 300 nm diameter) is greater than 0.10 ml/g, more specifically, greater than 0.12 ml/g, more specifically, greater then 0.15 ml/g, more specifically, greater then 0.17 ml/g, and more specifically, greater then 0.19 ml/g.

In one embodiment, the materials are fairly amorphous. That is, the materials are less than 80% crystalline, specifically, less than 60% crystalline and more specifically, less than 50% crystalline.

In one embodiment, the composition of the invention is a bulk metal or mixed metal oxide material. In another embodiment, the composition is a support or carrier on which other materials are impregnated. In one embodiment, the compositions of the invention have thermal stability and high surface areas with an essential absence of silica, alumina, aluminum or chromia. In still another embodiment, the composition is supported on a carrier, (such as a supported catalyst). In another embodiment, the composition comprises both the support and the catalyst. In embodiments where the composition is a supported catalyst, the support utilized may contain one or more of the metals (or metalloids) of the catalyst, including cerium. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

In embodiments where the composition of the invention is a supported catalyst, the one or more of the aforementioned compounds or compositions can be located on a solid support or carrier. The support can be a porous support, with a pore size typically ranging, without limitation, from about 0.5 nm to about 300 nm and with a surface area typically ranging, without limitation, from about 5 m²/g to about 1500 m²/g. The particular support or carrier material is not narrowly critical, and can include, for example, a material selected from the group consisting of silica, alumina, activated carbon, titania, zirconia, tin oxide, yttria, magnesia, niobia, zeolites and clays, among others, or mixtures thereof. Preferred support materials include titania, zirconia, tin oxide, alumina or silica. In some cases, where the support material itself is the same as one of the preferred components (e.g., Al₂O₃ for Al as a minor component), the support material itself may effectively form a part of the catalytically active material. In other cases, the support can be entirely inert to the reaction of interest.

The molybdenum compositions of the present invention are made by a novel method that results in high surface area molybdenum /molybdenum oxide materials. In one embodiment, the method includes mixing a molybdenum precursor with an organic dispersant, such as an organic acid and water to form a mixture, and calcining the mixture. According to one approach for preparing a mixed-metal oxide composition of the invention, the mixture also includes a metal precursor other than a molybdenum precursor.

The mixture comprises the molybdenum precursor and the organic acid. In one embodiment, the mixture preferably has an essential absence of any organic solvent other then the organic acid (which may or may not be a solvent for the molybdenum precursor), such as alcohols. In another embodiment, the mixture preferably has an essential absence of citric acid.

In another embodiment, the mixture preferably has an essential absence of citric acid and organic solvents other than the organic acid.

The organic acids used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, or imino, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, and oxalic acid, oxalacetic acid, and more specifically, glyoxylic acid and ketoglutaric acid.

The molybdenum precursor used in the method of the invention is selected from the group consisting of molybdic acid, ammonium molybdate, ammonium dimolybdate, ammonium heptamolybdate (ammonium paramolybdate), ammonium paramolybdate tetrahydrate, molybdenum acetate, molybdenum 2,4-pentanedionate (molybdenum oxide bis-2,4-pentanedionate), molybdenum alkoxide, molybdenum oxide, molybdenum metal, molybdenum chloride, molybdenum peroxo complexes, molybdophosphoric acid, molybdenum oxalate, molybdenum carboxylate and combinations thereof, specifically, molybdenum acetate, molybdic acid, ammonium molybdates (mono, di or para), molybdenum oxides. Specific molybdenum carboxylates include molybdenum oxalate, molybdenum ketoglutarate, molybdenum citrate, molybdenum tartrate, molybdenum malate, molybdenum lactate and molybdenum glyoxylate and molybdenum glycolate. These compounds can be prepared by dissolving molybdic acid in aqueous carboxylic acid.

The ratio of mmols of acid to mmols metal can vary from about 10:1 to about 1:10, more specifically from about 7:1 to about 1:5, more specifically from about 5:1 to about 1:4, and more specifically from about 3:1 to about 1:3.

Mixed-metal oxide compositions can also be made by the methods of the invention by including more than one metal precursor in the mixture.

Water may also be present in the mixtures described above. The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi-stage calcination as described below.

In another embodiment, the method includes evaporating the mixture to dryness or providing the dry molybdenum precursor and calcining the dry component to form a solid molybdenum oxide. Specifically, the molybdenum precursor is a molybdenum carboxylate, more specifically, molybdenum glyoxylate, molybdenum ketoglutarate, molybdenum oxalacetate, or molybdenum diglycolate.

In another embodiment, as an alternative to starting from acidic solutions, molybdenum precursors can be mixed with bases. Bases such as ammonia, tetraalkylammonium hydroxide, organic amines and aminoalcohols can be used as dispersants. The resulting basic solutions can then be aged at room temperature or by slow evaporation and calcinations (or other means of low temperature detempation).

In other embodiments, dispersants other than organic acids can be utilized. For example, non-acidic dispersants with at least two functional groups, such as dialdehydes (glyoxal) and ethylene glycol have been found to form pure and/or high surface area molybdenum-containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

The heating of the resulting mixture is typically a calcination, which may be conducted in an oxygen-containing atmosphere or in the substantial absence of oxygen, e.g., in an inert atmosphere (e.g., N₂) or in vacuo. The inert atmosphere may be any material which is substantially inert, e.g., does not react or interact with the material. Suitable examples include, without limitation, nitrogen, argon, xenon, helium or mixtures thereof, Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 200° C. to 850° C., specifically from 250° C. to 500° C. more specifically from 250° C. to 400° C., more specifically from 300° C. to 400° C., and more specifically from 300° C. to 375° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

In some embodiments it may be desirable to reduce all or a portion of the molybdenum oxide material to a reduced (elemental) molybdenum for a reaction of interest. The molybdenum oxide materials of the invention can be partially or entirely reduced by reacting the molybdenum oxide containing material with a reducing agent, such as hydrazine or formic acid, or by introducing, a reducing gas, such as, for example, ammonia, hydrogen sulfide, or hydrogen, during or after calcination. In one embodiment, the molybdenum oxide material is reacted with a reducing agent in a reactor by flowing a reducing agent through the reactor. This provides a material with a reduced (elemental) molybdenum surface for carrying out the reaction of interest.

As an alternative to calcination, the material can detemplated by the oxidation of the organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The compositions of the invention are typically solid catalysts, and can be used in a reactor, such as a three phase reactor with a packed bed (e.g., a trickle bed reactor), a fixed bed reactor (e.g., a plug flow reactor), a honeycomb, a fluidized or moving bed reactor, a two or three phase batch reactor, or a continuous stirred tank reactor. The compositions can also be used in a slurry or suspension.

Thus, preferred embodiments of the invention also include:

Embodiment 664: A composition comprising at least about 50% molybdenum metal or a molybdenum oxide by weight, the composition being a porous solid composition having a BET surface area of at least 10 square meters per gram and being thermally stable with respect to the BET surface area of the composition decreasing by not more than 10% when heated at 350° C. for 2 hours.

Embodiment 665: A composition comprising at least about 50% molybdenum metal or a molybdenum oxide by weight, and at least 0.5% carbon by weight, the composition being a porous solid composition having a BET surface area of at least 10 square meters per gram.

Embodiment 666: A composition comprising at least about 50% molybdenum metal or a molybdenum oxide by weight, the composition being a porous solid composition having a BET surface area of at least 10 square meters per gram and having a total pore volume greater than 0.15 ml/g.

Embodiment 667: A composition consisting essentially of carbon and at least about 50% molybdenum metal or a molybdenum oxide, the composition being a porous solid composition having a BET surface area of at least 10 square meters per gram.

Embodiment 668: The composition of any of embodiments 664-666, further comprising a metal other than molybdenum.

Embodiment 669: The composition of embodiment 668, wherein the metal other then molybdenum is vanadium.

Embodiment 670: The composition of any of embodiments 664-669, wherein the composition comprises at least 60% molybdenum metal or the molybdenum oxide by weight.

Embodiment 671: The composition of any of embodiments 664-669, wherein the composition comprises at least 70% molybdenum metal or the molybdenum oxide by weight.

Embodiment 672: The composition of any of embodiments 664-669, wherein the composition comprises at least 75% molybdenum metal or the molybdenum oxide by weight.

Embodiment 673: The composition of any of embodiments 664-669, wherein the composition comprises at least 80% molybdenum metal or the molybdenum oxide by weight.

Embodiment 674: The composition of any of embodiments 664-669, wherein the composition comprises at least 85% molybdenum metal or the molybdenum oxide by weight

Embodiment 675: The composition of any of embodiments 664-669, wherein the composition comprises at least 90% molybdenum metal or the molybdenum oxide by weight

Embodiment 676: The composition of any of embodiments 664-669, wherein the composition comprises at least 95% molybdenum metal or the molybdenum oxide by weight

Embodiment 677: The composition of embodiment 664-676, wherein the composition has a BET surface area of at least 12 square meters per gram.

Embodiment 678: The composition of embodiment 664-676, wherein the composition has a BET surface area of at least 15 square meters per gram.

Embodiment 679: The composition of any of embodiments 664-678, wherein the BET surface area is between about 10 square meters per gram and 40 square meters per gram.

Embodiment 680: The composition of any of embodiments 664-679, wherein the BET surface area is at least 17 square grams per meter.

Embodiment 681: The composition of any of embodiments 664-679, wherein the BET surface area is at least 20 square meters per gram.

Embodiment 682: The composition of any of embodiments 664-679, wherein the BET surface area is at least 22 square meters per gram.

Embodiment 683: The composition of any of embodiments 664-679, wherein the BET surface area is at least 25 square meters per gram.

Embodiment 684: The composition of any of embodiments 664-679, wherein the BET surface area is at least 27 square meters per gram.

Embodiment 685: The composition of any of embodiments 664-679, wherein the BET surface area is at least 30 square meters per gram.

Embodiment 686: The composition of any of embodiments 664-679, wherein the BET surface area is at least 32 square meters per gram.

Embodiment 687: The composition of any of embodiments 664-679, wherein the BET surface area is at least 35 square meters per gram.

Embodiment 688: The composition of any of embodiments 664-687, comprising between about 0.01% and about 20% carbon by weight.

Embodiment 689: The composition of embodiment 688, wherein the composition comprises between about 0.5% and about 10% carbon by weight.

Embodiment 690: The composition of embodiment 688, wherein the composition comprises between about 1.0% and about 5% carbon by weight.

Embodiment 691: The composition of embodiment 688, wherein the composition comprises between about 0.01% and about 0.5% carbon by weight.

Embodiment 692: The composition of any of embodiments 664-666 and 668-691, wherein the composition has an essential absence of silica, alumina, aluminum or chromia.

Embodiment 693: The composition of any of embodiments 664-666 and 668-692, wherein the composition has an essential absence of Zr.

Embodiment 694: The composition of any of embodiments 1664-666 and 668-693, wherein the composition has an essential absence of Na, K and Cl.

Embodiment 695: The composition of any of embodiments 664-694, wherein the composition is a catalyst.

Embodiment 696: The composition of any of embodiments 665-695, wherein the composition is thermally stable with respect to the BET surface area of the composition decreasing by not more than 10% when heated at 350° C. for 2 hours.

Embodiment 697: The composition of any of embodiments 664-696, wherein the molybdenum metal or molybdenum oxide is at least 30% molybdenum oxide.

Embodiment 698: The composition of any of embodiments 664-696, wherein the molybdenum metal or molybdenum oxide is at least 50% molybdenum oxide.

Embodiment 699: The composition of any of embodiments 664-696, wherein the molybdenum metal or molybdenum oxide is at least 75% molybdenum oxide.

Embodiment 700: The composition of any of embodiments 664-696, wherein the molybdenum metal or molybdenum oxide is at least 90% molybdenum oxide.

Embodiment 701: The composition of any of embodiments 664-666 and 668-700, further comprising a component selected from the group consisting of Ti, Pt, Pd, Re, Ir, R, Ag, Cr, Cu, Au, Sn, Mn, In, Y, Mg, Ba, Fe, Ta, Nb, Ni, Hf, W, Co, Zn, Zr, Ru, Al, La, Si, their oxides, and combinations thereof.

Embodiment 702: The composition of embodiment 701 wherein the metal other than molybdenum is selected from the group consisting of Ti, Pt, Pd, Re, Ir, R, Ag, Cr, Cu, Au, Sn, Mn, In, Y, Mg, Ba, Fe, Ta, Nb, Ni, Hf, W, Co, Zn, Zr, Ru, Al, La, Si, their oxides, and combinations thereof,

Embodiment 703: The composition of any of embodiments 664-702, wherein the composition is an unsupported material.

Embodiment 704: The composition of any of embodiments 664-702, wherein the composition is on a support.

Embodiment 705: The composition of embodiments 664-666 and 667-702, further comprising a support

Embodiment 706: The composition of any of embodiments 664-705, wherein the composition is a porous solid wherein at least 10% of the pores have a diameter greater than 10 nm.

Embodiment 707: The composition of any of embodiments 664-705, wherein at least 10% of the pores have a diameter greater than 15 nm.

Embodiment 708: The composition of any of embodiments 664-705, wherein at least 10% of the pores have a diameter greater than 20 nm.

Embodiment 709: The composition of any of embodiments 664-705, wherein at least 20% of the pores have a diameter greater than 20 nm.

Embodiment 710: The composition of any of embodiments 664-705, wherein at least 30% of the pores have a diameter greater than 20 nm.

Embodiment 711: The composition of any of embodiments 664-705, wherein at least 10% of the pores have a diameter less than 10 nm.

Embodiment 712: The composition of any of embodiments 664-705, wherein at least 20% of the pores have a diameter less than 10 nm.

Embodiment 713: The composition of any of embodiments 664-712 in a reactor.

Embodiment 714: The composition of embodiment 713, wherein the reactor is a three phase reactor with a packed bed.

Embodiment 715: The composition of embodiment 713, wherein the reactor is a trickle bed reactor.

Embodiment 716: The composition of embodiment 713, wherein the reactor is a fixed bed reactor.

Embodiment 717: The composition of embodiment 713, wherein the reactor is a plug flow reactor.

Embodiment 718: The composition of embodiment 713, wherein the reactor is a fluidized bed reactor.

Embodiment 719: The composition of embodiment 713, where the reactor is a two or three phase batch reactor.

Embodiment 720: The composition of embodiment 713, wherein the reactor is a continuous stirred tank reactor.

Embodiment 721: The composition of any of embodiments 644-712 in a slurry or suspension.

Embodiment 722: The composition of any of embodiments 644-712, made by a process comprising:

mixing a molybdenum precursor with an organic acid and water to form a mixture; and

calcining the mixture at a temperature of at least 250° C. for a time period sufficient to form a solid.

Embodiment 723: The composition of embodiment 722, wherein the process further comprises evaporating a portion of the mixture for a period of time sufficient for the mixture to form a gel prior to calcination.

Embodiment 724: The composition of embodiment 722, wherein the process further comprises heating the mixture for a period of time sufficient for the mixture to form a gel prior to calcination.

Embodiment 725: The composition of any of embodiments 722-724, wherein in the process, the organic acid comprises a carboxyl group.

Embodiment 726: The composition of any of embodiments 722-725, wherein in the process, the organic acid comprises no more than one carboxylic group and at least one functional group selected from the group consisting of hydroxyl and carbonyl.

Embodiment 727: The composition of any of embodiments 722-726, wherein in the process, the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 728: The composition of any of embodiments 722-727, wherein in the process, the organic acid is ketoglutaric acid.

Embodiment 729: The composition of any of embodiments 722-727, wherein in the process, the organic acid is selected from the group consisting of glyoxylic acid, ketoglutaric acid and combinations thereof.

Embodiment 730: The composition of any of embodiments 722-728, wherein in the process, the molybdenum precursor is selected from the group consisting of molybdenum oxide, molybdenum acetate, molybdic acid, ammonium molybdates, molybdenum oxide 2,4-pentanedionate, molybdenum oxalate, molybdenum chloride and combinations thereof.

Embodiment 731: The composition of any of embodiments 722-730, wherein in the process, the mixture is calcined at a temperature of at least 300° C.

Embodiment 732: The composition of any of embodiments 722-730, wherein in the process, the mixture is calcined at a temperature of at least 350° C.

Embodiment 733: The composition of any of embodiments 722-732, wherein in the process, the mixture is calcined for at least 1 hour.

Embodiment 734: The composition of any of embodiments 722-732, wherein in the process, the mixture is calcined for at least 2 hours.

Embodiment 735: The composition of any of embodiments 722-732, wherein in the process, the mixture is calcined for at least 4 hours.

Embodiment 736: The composition of any of embodiments 722-735, wherein in the process, the mixture has an essential absence of organic solvents other than the organic acid.

Embodiment 737: The composition of any of embodiments 722-735, wherein in the process, the mixture has an essential absence of citric acid.

Embodiment 738: A method for making a composition, the method comprising:
mixing a molybdenum precursor with an organic acid and water to form a mixture, the organic acid comprising no more than one carboxylic group and at least one functional group selected from the group consisting of carbonyl and hydroxyl;
forming a gel; and
calcining the mixture at a temperature of at least 250° C. for a time sufficient to form a solid.

Embodiment 739: The method of embodiment 738, wherein the gel forming step comprises evaporating a portion of the mixture for a period of time sufficient for the mixture to form the gel prior to calcination.

Embodiment 740: The method of embodiment 738, wherein the gel forming step comprises heating the mixture for a period of time sufficient for the mixture to form the gel prior to calcination.

Embodiment 741: The method of any of embodiments 738-740, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 742: The method of embodiment 738-740, wherein the organic acid is glyoxylic acid.

Embodiment 743: The method of any of any of embodiments 738-742, wherein the molybdenum precursor is selected from the group consisting of molybdenum oxide, molybdenum acetate, molybdic acid, ammonium molybdates, molybdenum oxide 2,4-pentanedionate, molybdenum oxalate, molybdenum chloride and combinations thereof.

Embodiment 744: The method of any of embodiments 738-743, wherein the mixture is calcined at a temperature of at least 300° C.

Embodiment 745: The method of any of embodiments 738-743, wherein the mixture is calcined at a temperature of at least 350° C.

Embodiment 746: The method of any of embodiments 738-745, wherein the mixture is calcined for at least 1 hour.

Embodiment 747: The method of any of embodiments 738-745, wherein the mixture is calcined for at least 2 hours.

Embodiment 748: The method of any of embodiments 738-745, wherein the mixture is calcined for at least 4 hours.

Embodiment 749: The method of any of embodiments 738-748, wherein the mixture has an essential absence of organic solvents other than the organic acid.

Embodiment 750: The method of any of embodiments 738-749, wherein the mixture has an essential absence of citric acid.

Embodiment 751: A method for making a composition, the method comprising:
mixing a molybdenum precursor with an organic acid and water to form a mixture, the organic acid comprising two carboxylic groups and a carbonyl group; and
calcining the mixture at a temperature of at least 250° C. for a time sufficient to form a solid.

Embodiment 752: The method of embodiment 751, further comprising evaporating a portion of the mixture for a period of time sufficient for the mixture to form a gel prior to calcination.

Embodiment 753: The method of embodiment 751, further comprising heating the mixture for a period of time sufficient for the mixture to form a gel prior to calcination.

Embodiment 754: The method of any of embodiments 751-753, wherein the organic acid comprises no more than two carboxylic groups.

Embodiment 755: The method of any of embodiments 751-754, wherein the organic acid comprises no more than one carbonyl group.

Embodiment 756: The method of any of embodiments 751-755, wherein the organic acid is ketoglutaric acid.

Embodiment 757: The method of any of embodiments 751-756, wherein the molybdenum precursor is selected from the group consisting of molybdenum oxide, molybdenum acetate, molybdic acid, ammonium molybdates, molybdenum oxide 2,4-pentanedionate, molybdenum oxalate, molybdenum chloride and combinations thereof.

Embodiment 758: The method of any of embodiments 751-757, wherein the mixture is calcined at a temperature of at least 300° C.

Embodiment 759: The method of any of embodiments 751-757, wherein the mixture is calcined at a temperature of at least 350° C.

Embodiment 760: The method of any of embodiments 751-759, wherein the mixture is calcined for at least 1 hour.

Embodiment 761: The method of any of embodiments 751-759, wherein the mixture is calcined for at least 2 hours.

Embodiment 762: The method of any of embodiments 751-759, wherein the mixture is calcined for at least 4 hours.

Embodiment 763: The method of any of embodiments 751-762, wherein the mixture has an essential absence of organic solvents other than the organic acid.

Embodiment 764: The method of any of embodiments 751-762, wherein the mixture has an essential absence of citric acid.

Embodiment 765: A method for making a composition, the method comprising:
mixing a molybdenumprecursor with an acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture;
forming a gel; and
calcining the gel at a temperature of at least 250° C. for at least 1 hour.

Embodiment 766: The method of embodiment 765, wherein the gel forming step comprises evaporating a portion of the mixture for a period of time sufficient for the mixture to form the gel prior to calcination.

Embodiment 767: The method of embodiment 765, wherein the gel forming step comprises heating the mixture for a period of time sufficient for the mixture to form a gel prior to calcination.

Embodiment 768: The method of any of embodiments 765-767, wherein the mixture comprises water.

Embodiment 769: The method of any of embodiments 765-768, wherein the molybdenum precursor is selected from the group consisting of molybdenum oxide, molybdenum acetate, molybdic acid, ammonium molybdates, molybdenum oxide 2,4-pentanedionate, molybdenum oxalate, molybdenum chloride and combinations thereof.

Embodiment 770: The method of any of embodiments 765-769, wherein the gel is calcined at a temperature of at least 300° C.

Embodiment 771: The method of any of embodiments 765-769, wherein the gel is calcined at a temperature of at least 350° C.

Embodiment 772: The method of any of embodiments 765-771, wherein the gel is calcined for at least 2 hours.

Embodiment 773: The method of any of embodiments 765-771, wherein the gel is calcined for at least 4 hours.

Embodiment 774: The method of any of embodiments 765-773, wherein the mixture has an essential absence of organic solvents other than the organic acid.

Embodiment 775: The method of any of embodiments 765-774, wherein the mixture has an essential absence of citric acid.

Embodiment 776: The method of any of embodiments 765-775, wherein the mixture comprises a combination of glyoxylic and ketoglutaric acid.

Embodiment 777: A composition comprising molybdenum glyoxylate.

Embodiment 778: The composition of embodiment 777, wherein the composition is a solution.

Embodiment 779: The composition of embodiments 776 or 777, wherein the composition is a precursor to make a solid molybdenum containing material.

Embodiment 780: The composition of embodiment 777, wherein the material is a catalyst.

Embodiment 781: A composition comprising molybdenum ketoglutarate.

Embodiment 782: The composition of embodiment 781, wherein the composition is a solution.

Embodiment 783: The composition of embodiments 781 or 782, wherein the composition is a precursor to make a solid molybdenum containing material.

Embodiment 784: The composition of embodiment 783, wherein the material is a catalyst.

Embodiment 785: A method of forming a molybdenum glyoxylate, the method comprising mixing molybdic acid or ammonium paramolybdate with aqueous glyoxylic acid.

Embodiment 786: A method of forming a molybdenum ketoglutarate, the method comprising mixing molybdic acid or ammonium paramolybdate with aqueous ketoglutaric acid.

Embodiment 787: A composition comprising at least about 60% molybdenum metal or a molybdenum oxide by weight, and at least about 20% vanadium metal or a vanadium oxide by weight the composition being a porous solid composition having a BET surface area of at least 20 square meters per gram.

Embodiment 788: The composition of embodiment 787, wherein the composition is thermally stable with respect to the BET surface area of the composition decreasing by not more than 10% when heated at 350° C. for 2 hours.

Embodiment 789: The composition of embodiments 787-788, wherein the composition has a BET surface area of at least 30 square meters per gram.

Embodiment 790: The composition of embodiments 787-789, wherein the composition is at least 70% molybdenum metal or a molybdenum oxide by weight.

### Vanadium

In the present invention, vanadium compositions having high BET surface areas, high vanadium or vanadium oxide content, and/or thermal stability are disclosed.

The metal oxides and mixed metal oxides of the invention have important applications as catalysts, catalyst carriers, sorbents, sensors, actuators, pigments, polishing and decolorizing additives, and as coatings and components in the semiconductor, dielectric ceramics, electroceramics, electronics and optics industries. Other applications are in refractories, as a ceramics colorant, and as dyes. For example, Mo—V mixed oxides are core compositions of many oxidation catalysts since V and Mo are the only metals that are known to selectively insert oxygen and form a synergistic pair. V—Mo and V—Ti are considered to be the two universal systems for selective oxidations. High surface area V—Mo mixed oxides are highly desirable to boost the activity of commercially relevant oxidation processes as higher activity allows a lower reaction temperature thereby gaining selectivity. V—Mo—W and V—Mo—Nb are core compositions for hydrocarbon oxidations and ammoxidations (e.g. acrylic acid, acetic acid). V—Ti is a core composition for the oxidation of ortho xylene to phthaliuc anhydride and V-W—Ti is applied to emissiosn control (SCR-DeNOx).

In general, the vanadium /vanadium oxide compositions of the invention are novel and inventive as unbound and/or unsupported as well as supported catalysts and as carriers compared to known supported and unsupported vanadium and vanadium oxide catalyst formulations utilizing large amounts of binders such as silica, alumina, aluminum or chromia. In one embodiment, the compositions of the inventions are superior to known formulations both in terms of activity (compositions of the invention have higher surface area with a higher vanadium metal and/or vanadium oxide content) and in terms of selectivity (e.g. for hydrogenations, reductions and oxidations). The lower content or the absence of a binder/support (which is often unselective) and the high purity (i.e. high vanadium /vanadium oxide content and essential absence of Na, S, K and Cl and other impurities, such as nitrates) achievable by methods of the invention provide improvements over state of the art compositions and methods. The productivity in terms of weight of material per volume of solution per unit time is much higher for the method of the invention as compared to present sol-gel or precipitation techniques since highly concentrated solutions ˜1M can be used as starting material. Moreover, no washing or aging steps are required by the method.

The present invention is thus directed to vanadium -containing compositions that comprise vanadium and/or vanadium oxide. Furthermore, the compositions of the present invention may comprise carbon or additional components that act as binders, promoters, stabilizers, or co-metals.

In one embodiment of the invention, the vanadiumcomposition comprises V metal, V oxide (such as VO, V₂O₃ or V₂O₄ or V₆O₁₃ or V₂O₅), or mixtures thereof. In another embodiment, the compositions of the invention comprise (i) vanadium or a vanadium-containing compound (e.g., vanadium oxide) and (ii) one or more additional metal, oxides thereof, salts thereof, or mixtures of such metals or compounds. In one embodiment, the additional metal is an alkali metal, alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically the additional metal is one of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, Nb, Bi, Sb or a compound containing one or more of such element(s), more specifically Ti, Pt, Pd, Rh, Ir, Ag, Mn, Mo, W, Cr, In, Sn, Y, Co, Ru, Ni, Cu, Fe, Zr, Nb, Mg and more specifically Pt, Pd, Rh, Re, Ir, Ag, Co, Ni, Cu, Fe, Sn, Ru, Zr, Y, Mo, Ti, W, Nb, Mg and even more specifically Mo, Ti, W, Nb or a compound containing one or more of such element(s). The concentrations of the additional components are such that the presence of the component would not be considered an impurity. For example, when present, the concentrations of the additional metals or metal containing components (e.g., metal oxides) are at least about 0.1, 0.5, 1, 2, 5, or even 10 molecular percent or more by weight.

The major component of the composition typically comprises V oxide. The major component of the composition can, however, also include various amounts of elemental V and/or V-containing compounds, such as V salts. The V oxide is an oxide of vanadium where vanadiumis in an oxidation state other than the fully-reduced, elemental V^{o} state, including oxides of vanadium where vanadium has an oxidation state of V⁺², V⁺³, V⁺⁴, V⁺⁵ or a mixed oxide such as Vanadium (IV, V) oxide V₆O₁₃ or a partially reduced oxidation state. The total amount of vanadiumand/or vanadium oxide (V₂O₃, V₂O₄, V₂O₅, or a combination) present in the composition is at least about 25% by weight on a molecular basis. More specifically, compositions of the present invention include at least 35% vanadium and/or vanadium oxide, more specifically at least 50%, more specifically at least 60%, more specifically at least 70%, more specifically at least 75%, more specifically at least 80%, more specifically at least 85%, more specifically at least 90%, and more specifically at least 95% vanadium and/or vanadium oxide by weight. In one embodiment, the vanadium /vanadium oxide component of the composition is at least 30% vanadium oxide, more specifically at least 50% vanadium oxide, more specifically at least 75% vanadium oxide, and more specifically at least 90% vanadium oxide by weight. As noted below, the vanadium /vanadium oxide component can also have a support or carrier functionality.

The one or more minor component(s) of the composition preferably comprise an element selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, or a compound containing one or more of such element(s), such as oxides thereof and salts thereof, or mixtures of such elements or compounds. The minor component(s) more specifically comprises of one or more of Pt, Pd, Rh, Ir, Ag, Mn, Mg, Mo, Ti, W, Cr, In, Sn, Y, Co, Ru, Ni, Cu, Fe, Zr, Nb, Bi, Sb oxides thereof, salts thereof, or mixtures of the same and more specifically Pt, Pd, Rh, Re, Ir, Ag, Co, Ni, Cu, Fe, Sn, Ru, Zr, Y, Mo, Mg, Ti, W, Nb oxides thereof, salts thereof, or mixtures of the same and even more specifically, Mo, Ti, W, Nb oxides thereof and/or salts thereof. In one embodiment, the minor component(s) are preferably oxides of one or more of the minor-component elements, but can, however, also include various amounts of such elements and/or other compounds (e.g., salts) containing such elements. An oxide of such minor-component elements is an oxide thereof where the respective element is in an oxidation state other than the fully-reduced state, and includes oxides having an oxidation states corresponding to known stable valence numbers, as well as to oxides in partially reduced oxidation states. Salts of such minor-component elements can be any stable salt thereof, including, for example, chlorides, nitrates, carbonates and acetates, among others. The amount of the oxide form of the particular recited elements present in one or more of the minor component(s) is at least about 5%, preferably at least about 10%, preferably still at least about 20%, more preferably at least about 35%, more preferably yet at least about 50% and most preferable at least about 60%, in each case by weight relative to total weight of the particular minor component. As noted below, the minor component can also have a support or carrier functionality.

In one embodiment, the minor component consists essentially of one element selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, or a compound containing the element. In another embodiment, the minor component consists essentially of two elements selected from the group consisting of Ti, Pt, Pd, Re, Ir, R, Ag, Mo, Cr, Cu, Au, Sn, Mn, Mg, In, Y, Mg, Ba, Fe, Ta, Nb, Ni, Hf, W, Co, Zn, Zr, Ru, Al, La, Si, or a compound containing one or more of such elements.

Thus, in one specific embodiment of the compound shown in formula I, the composition of the invention is a material comprising a compound having the formula (VIII):

VₐM²_{b}M³_{c}M⁴_{d}M⁵ₑO_{f} (VIII),

where, V is vanadium, O is oxygen and M², M³, M⁴, M⁵, a, b, c, d, e and f are as described above for formula I, and more specifically below, and can be grouped in any of the various combinations and permutations of preferences.

In formula VIII, “M²” “M³” “M⁴” and “M⁵” individually each represent a metal such as an alkali earth metal, a main group metal (i.e., Al, Ga, In, Tl, Sn, Pb, or Bi), a transition metal, a metalloid (i.e., B, Si, Ge, As, Sb, Te), or a rare earth metal (i.e., lanthanides). More specifically, “M²” “M³” “M⁴” and “M⁵” individually each represent a metal selected from Ti, Pt, Pd, Mo, Cr, Cu, Au, Sn, Mn, In, Ru, Mg, Ba, Fe, Ta, Nb, Co, Hf, W, Y, Zn, Zr, Ce, Al, Si and La, and more specifically Mn, Mo, Ti, W, Cr, In, Sn, Ru and Co.

In formula VIII, a+b+c+d+e=1. The letter “a” represents a number ranging from about 0.2 to about 1.00, specifically from about 0.3 to about 0.90, more specifically from about 0.5 to about 0.9, and even more specifically from about 0.7 to about 0.8 The letters “b” “c” “d” and “e” individually represent a number ranging from about 0 to about 0.4, specifically from about 0.04 to about 0.3, and more specifically from about 0.04 to about 0.2.

In formula VIII, “O” represents oxygen, and “f” represents a number that satisfies valence requirements. In general, “f” is based on the oxidation states and the relative atomic fractions of the various metal atoms of the compound of formula VIII (e.g., calculated as one-half of the sum of the products of oxidation state and atomic fraction for each of the metal oxide components).

In one mixed-metal oxide embodiment, where, with reference to formula VIII, “c” “d” and “e” are zero, the catalyst material can comprise a compound having the formula VIII-A:

VₐM²_{b}O_{f} (VIII-A),

where V is vanadium, O is oxygen, and where “a”, “M²”, “b” and “f” are as defined above.

In another embodiment, where, with reference to formula VIII, “b” “c” “d” and “e” are zero, the catalyst material can comprise a compound having the formula VIII-B:

VₐO_{f} (III-B),

where V is vanadium, O is oxygen, and where “a” and “f” are as defined above.

In one embodiment, the compositions of the invention can also include carbon. The amount of carbon in the compositions is typically less than 75% by weight. More specifically, the compositions of the invention have between about 0.01% and about 20% carbon by weight, more specifically between about 0.5% and about 10% carbon by weight, and more specifically between about 1.0% and about 5% carbon by weight. In other embodiments the compositions of the invention have between about 0.01% and about 0.5% carbon by weight.

In one embodiment, the compositions of the invention have an essential absence of N, P Na, S, K and/or Cl.

In another embodiment, the compositions of the invention contain less than 10%, specifically less than 5%, more specifically less than 3%, and more specifically less than 1% water.

The compositions can include other components as well, such as diluents, binders and/or fillers, as desired in connection with the reaction system of interest.

In one embodiment, the compositions of the invention are typically a high surface area porous solid. Specifically, the BET surface area of the composition is from about 5 m²/g to about 150 m²/g, more specifically from about 10 m²/g to about 100 m²/g , more specifically from about 15 m²/g to about 90 m²/g, and more specifically from about 30 m²/g to about 75 m²/g. In another embodiment, the BET surface area is at least about 10 m²/g, more specifically at least about 15 m²/g, more specifically at least about 20 m²/g, more specifically at least about 25 m²/g, more specifically at least about 30 m²/g, more specifically at least about 35 m²/g, more specifically at least about 40 m²/g, more specifically at least about 45 m²/g, more specifically at least about 50 m²/g, more specifically at least about 55 m²/g, more specifically at least about 60 m²/g, more specifically at least about 65 m²/g, more specifically at least about 70 m²/g, more specifically at least about 75 m²/g, more specifically at least about 80 m²/g, more specifically at least about 85 m²/g, and more specifically at least about 90 m²/g.

In one embodiment, the compositions of the invention are thermally stable.

In one embodiment, the compositions of the invention are porous solids, having a wide range of pore diameters. In one embodiment, at least 10%, more specifically at least 20% and more specifically at least 30% of the pores of the composition of the invention have a pore diameter greater than 10 nm, more specifically greater than 15 nm, and more specifically greater than 20 nm. Additionally, at least 10%, specifically at least 20% and more specifically at least 30% of the pores of the composition have a pore diameter less than 12 nm, specifically less than 10 nm, more specifically less than 8 nm and more specifically less than 6 nm.

In one embodiment, the total pore volume (the cumulative BJH pore volume between 1.7 nm and 300 nm diameter) is greater than 0.10 ml/g, more specifically, greater than 0.12 ml/g, more specifically, greater then 0.15 ml/g, more specifically, greater than 0.2 ml/g, and more specifically, greater than 0.3 ml/g.

In one embodiment, the materials are fairly amorphous. That is, the materials are less than 80% crystalline, specifically, less than 60% crystalline and more specifically, less than 50% crystalline.

In one embodiment, the composition of the invention is a bulk metal or mixed metal oxide material. In another embodiment, the composition is a support or carrier on which other materials are impregnated. In one embodiment, the compositions of the invention have thermal stability and high surface areas with an essential absence of silica, alumina, aluminum or chromia. In still another embodiment, the composition is supported on a carrier, (such as a supported catalyst). In another embodiment, the composition comprises both the support and the catalyst. In embodiments where the composition is a supported catalyst, the support utilized may contain one or more of the metals (or metalloids) of the catalyst, including cerium. The support may contain sufficient or excess amounts of the metal for the catalyst such that the catalyst may be formed by combining the other components with the support. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

In embodiments where the composition of the invention is a supported catalyst, the one or more of the aforementioned compounds or compositions can be located on a solid support or carrier. The support can be a porous support, with a pore size typically ranging, without limitation, from about 0.5 nm to about 300 nm and with a surface area typically ranging, without limitation, from about 5 m²/g to about 1500 m²/g. The particular support or carrier material is not narrowly critical, and can include, for example, a material selected from the group consisting of silica, alumina, activated carbon, titania, zirconia, tin oxide, yttria, magnesia, niobia, zeolites and clays, among others, or mixtures thereof. Preferred support materials include titania, zirconia, tin oxide, alumina or silica. In some cases, where the support material itself is the same as one of the preferred components (e.g., Al₂O₃ for Al as a minor component), the support material itself may effectively form a part of the catalytically active material. In other cases, the support can be entirely inert to the reaction of interest.

The vanadium compositions of the present invention are made by a novel method that results in high surface area vanadium /vanadium oxide materials. In one embodiment, the method includes mixing a vanadium precursor with an organic dispersant, such as an organic acid and water to form a mixture, and calcining the mixture. According to one approach for preparing a mixed-metal oxide composition of the invention, the mixture also includes a metal precursor other than a vanadium precursor.

The mixture comprises the vanadium precursor and the organic acid. In one embodiment, the mixture preferably has an essential absence of any organic solvent other then the organic acid (which may or may not be a solvent for the vanadium precursor), such as alcohols. In another embodiment, the mixture preferably has an essential absence of citric acid. In another embodiment, the mixture preferably has an essential absence of citric acid and organic solvents other than the organic acid.

The organic acids used in methods of the invention have at least two functional groups. In one embodiment, the organic acid is a bidentate chelating agent, specifically a carboxylic acid. Specifically, the carboxylic acid has one or two carboxylic groups and one or more functional groups, specifically carboxyl, carbonyl, hydroxyl, amino, or imino, more specifically, carboxyl, carbonyl or hydroxyl. In another embodiment the organic acid is selected from the group consisting of glyoxylic acid, ketoglutaric acid, diglycolic acid, tartaric acid, oxamic acid, oxalic acid, oxalacetic acid, pyruvic acid, citric acid, malic acid, lactic acid, malonic acid, glutaric acid, succinic acid, glycolic acid, glutamic acid, gluconic acid, nitrilotriacetic acid, aconitic acid, tricarballylic acid, methoxyacetic acid, iminodiacetic acid, butanetetracarboxylic acid, fumaric acid, maleic acid, suberic acid, salicylic acid, tartronic acid, mucic acid, benzoylformic acid, ketobutyric acid, keto-gulonic acid, glycine, amino acids and combinations thereof, more specifically, glyoxylic acid, ketoglutaric acid, diglycolic acid, tartaric acid, and oxalic acid, oxalacetic acid, and more specifically, glyoxylic acid and ketoglutaric acid.

The vanadium precursor used in the method of the invention is selected from the group consisting of ammonium metavanadate, vanadyl acetate, vanadium 2,4-pentanedionate, vanadium oxide 2,4-pentanedionate, vanadium formate, vanadium nitrate, vanadium alkoxide, vanadium oxide, vanadium metal, vanadium chloride, vanadium oxalate, vanadium carboxylate and combinations thereof, specifically, vanadium oxides and vanadium carboxylates. Specific vanadium carboxylates include vanadium oxalate, vanadium ketoglutarate, vanadium citrate, vanadium tartrate, vanadium malate, vanadium lactate and vanadium glyoxylate and vanadium glycolate.

The ratio of mmols of acid to mmols metal can vary from about 0:1 to about 1:10, more specifically from about 7:1 to about 1:5, more specifically from about 5:1 to about 1:4, and more specifically from about 3:1 to about 1:3.

Mixed-metal oxide compositions can also be made by the methods of the invention by including more than one metal precursor in the mixture.

Water may also be present in the mixtures described above. The inclusion of water in the mixture in the embodiments described above can be either as a separate component or present in an aqueous organic acid, such as ketoglutaric acid or glyoxylic acid.

In some embodiments, the mixtures may instantly form a gel or may be solutions, suspensions, slurries or a combination. Prior to calcination, the mixtures can be aged at room temperature for a time sufficient to evaporate a portion of the mixture so that a gel forms, or the mixtures can be heated at a temperature sufficient to drive off a portion of the mixture so that a gel forms. In one embodiment, the heating step to drive off a portion of the mixture is accomplished by having a multi-stage calcination as described below.

In another embodiment, the method includes evaporating the mixture to dryness or providing the dry vanadium precursor and calcining the dry component to form a solid vanadium oxide. Specifically, the vanadium precursor is a vanadium carboxylate, more specifically, vanadium glyoxylate, vanadium ketoglutarate, vanadium oxalacetate, or vanadium diglycolate.

In another embodiment, as an alternative to starting from acidic solutions, vanadium precursors can be mixed with bases. Bases such as ammonia, tetraalkylammonium hydroxide, organic amines and aminoalcohols can be used as dispersants. The resulting basic solutions, slurries, and/or suspensions can then be aged at room temperature or by slow evaporation and calcinations (or other means of low temperature detemplation).

In other embodiments, dispersants other than organic acids can be utilized. For example, non-acidic dispersants with at least two functional groups, such as dialdehydes (glyoxal) and ethylene glycol have been found to form pure and/or high surface area vanadium-containing materials when combined with appropriate precursors. Glyoxal, for example, is a large scale commodity chemical, and 40% aqueous solutions are commercially available, non-corrosive, and typically cheaper than many of the organic acids used within the scope of the invention, such as glyoxylic acid.

The heating of the resulting mixture is typically a calcination, which may be conducted in an oxygen-containing atmosphere or in the substantial absence of oxygen, e.g., in an inert atmosphere or in vacuo. The inert atmosphere may be any material which is substantially inert, e.g., does not react or interact with the material. Suitable examples include, without limitation, nitrogen, argon, xenon, helium or mixtures thereof. Preferably, the inert atmosphere is argon or nitrogen. The inert atmosphere may flow over the surface of the material or may not flow thereover (a static environment). When the inert atmosphere does flow over the surface of the material, the flow rate can vary over a wide range, e.g., at a space velocity of from 1 to 500 hr⁻¹.

The calcination is usually performed at a temperature of from 200° C. to 850° C., specifically from 250° C. to 500° C. more specifically from 250° C. to 400° C., more specifically from 300° C. to 400° C., and more specifically from 300° C. to 375° C. The calcination is performed for an amount of time suitable to form the metal oxide composition. Typically, the calcination is performed for from 1 minute to about 30 hours, specifically for from 0.5 to 25 hours, more specifically for from 1 to 15 hours, more specifically for from 1 to 8 hours, and more specifically for from 2 to 5 hours to obtain the desired metal oxide material.

In one embodiment, the mixture is placed in the desired atmosphere at room temperature and then raised to a first stage calcination temperature and held there for the desired first stage calcination time. The temperature is then raised to a desired second stage calcination temperature and held there for the desired second stage calcination time.

In some embodiments it may be desirable to reduce all or a portion of the vanadium oxide material to a reduced (elemental) vanadium for a reaction of interest. The vanadium oxide materials of the invention can be partially or entirely reduced by reacting the vanadium oxide containing material with a reducing agent, such as hydrazine or formic acid, or by introducing, a reducing gas, such as, for example, ammonia or hydrogen, during or after calcination. In one embodiment, the vanadium oxide material is reacted with a reducing agent in a reactor by flowing a reducing agent through the reactor. This provides a material with a reduced (elemental) vanadium surface for carrying out the reaction of interest.

As an alternative to calcination, the material can detemplated by the oxidation of organics by aqueous H₂O₂ (or other strong oxidants) or by microwave irradiation, followed by low temperature drying (such as drying in air from about 70° C.-250° C., vacuum drying, from about 40° C.-90° C., or by freeze drying).

Finally, the resulting composition can be ground, pelletized, pressed and/or sieved, or wetted and optionally formulated and extruded or spray dried to ensure a consistent bulk density among samples and/or to ensure a consistent pressure drop across a catalyst bed in a reactor. Further processing and or formulation can also occur.

The compositions of the invention are typically solid catalysts, and can be used in a reactor, such as a three phase reactor with a packed bed (e.g., a trickle bed reactor), a fixed bed reactor (e.g., a plug flow reactor), a honeycomb, a fluidized or moving bed reactor, a two or three phase batch reactor, or a continuous stirred tank reactor. The compositions can also be used in a slurry or suspension.

Thus, preferred embodiments of the invention also include:

Embodiment 791: A composition comprising at least about 50% vanadium metal or a vanadium oxide by weight, the composition being a porous solid composition having a BET surface area of at least 10 square meters per gram and having an essential absence of S and N.

Embodiment 792: A composition comprising at least about 50% vanadium metal or a vanadium oxide by weight, the composition being a porous solid composition having a BET surface area of at least 10 square meters per gram and comprising less than 1% water.

Embodiment 793: A composition comprising at least about 50% vanadium metal or a vanadium oxide by weight, the composition being a porous solid composition having a BET surface area of at least 10 square meters per gram and having an essential absence of S and P.

Embodiment 794: A composition consisting essentially of carbon and at least about 50% vanadium metal or a vanadium oxide, the composition being a porous solid composition having a BET surface area of at least 10 square meters per gram.

Embodiment 795: A composition comprising at least about 50% vanadium metal or a vanadium oxide by weight, the composition being a porous solid composition having a BET surface area of at least 10 square meters per gram and having a total pore volume greater than 0.20 ml/g.

Embodiment 796: The composition of any of embodiments 791-793 and 805, further comprising a metal other than vanadium.

Embodiment 797: The composition of any of embodiments 791-796, wherein the composition comprises at least 60% vanadium metal or the vanadium oxide by weight.

Embodiment 798: The composition of any of embodiments 791-796, wherein the composition comprises at least 70% vanadium metal or the vanadium oxide by weight.

Embodiment 799: The composition of any of embodiments 791-796, wherein the composition comprises at least 75% vanadium metal or the vanadium oxide by weight.

Embodiment 800: The composition of any of embodiments 791-796, wherein the composition comprises at least 80% vanadium metal or the vanadium oxide by weight.

Embodiment 801: The composition of any of embodiments 791-796, wherein the composition comprises at least 85% vanadium metal or the vanadium oxide by weight.

Embodiment 802: The composition of any of embodiments 791-796, wherein the composition comprises at least 90% vanadium metal or the vanadium oxide by weight.

Embodiment 803: The composition of any of embodiments 791-796, wherein the composition comprises at least 95% vanadium metal or the vanadium oxide by weight.

Embodiment 804: The composition of any of embodiments 791-803, wherein the composition has a BET surface area of at least 15 square meters per gram.

Embodiment 805: The composition of any of embodiments 791-803, wherein the composition has a BET surface area of at least 20 square meters per gram.

Embodiment 806: The composition of any of embodiments 791-803, wherein the BET surface area is between about 15 square meters per gram and 90 square meters per gram.

Embodiment 807: The composition of any of embodiments 791-803, wherein the BET surface area is at least 30 square meters per gram.

Embodiment 808: The composition of any of embodiments 791-803, wherein the BET surface area is at least 35 square meters per gram.

Embodiment 809: The composition of any of embodiments 791-803, wherein the BET surface area is at least 40 square meters per gram.

Embodiment 810: The composition of any of embodiments 791-803, wherein the BET surface area is at least 50 square meters per gram.

Embodiment 811: The composition of any of embodiments 791-803, wherein the BET surface area is at least 60 square meters per gram.

Embodiment 812: The composition of any of embodiments 791-803, wherein the BET surface area is at least 70 square meters per gram.

Embodiment 813: The composition of any of embodiments 791-803, wherein the BET surface area is at least 80 square meters per gram.

Embodiment 814: The composition of any of embodiments 791-803, wherein the BET surface area is at least 90 square meters per gram.

Embodiment 815: The composition of any of embodiments 791-814, comprising between about 0.01% and about 20% carbon by weight.

Embodiment 816: The composition of embodiment 815, wherein the composition comprises between about 0.5% and about 10% carbon by weight.

Embodiment 817: The composition of embodiment 815, wherein the composition comprises between about 1.0% and about 5% carbon by weight.

Embodiment 818: The composition of embodiment 815, wherein the composition comprises between about 0.01% and about 0.5% carbon by weight.

Embodiment 819: The composition of any of embodiments 791-793 and 795-818, wherein the composition has an essential absence of silica, alumina, aluminum or chromia.

Embodiment 820: The composition of any of embodiments 792, 793 and 795-819, wherein the composition has an essential absence of N.

Embodiment 821: The composition of any of embodiments 791-793 and 795-820, wherein the composition has an essential absence of Na, K and Cl.

Embodiment 822: The composition of any of embodiments 791-821, wherein the composition is a catalyst.

Embodiment 823: The composition of any of embodiments 791-822, wherein the composition is thermally stable with respect to the BET surface area of the composition decreasing by not more than 10% when heated at 350° C. for 2 hours.

Embodiment 824: The composition of any of embodiments 791-823, wherein the vanadium metal or vanadium oxide is at least 55% vanadium oxide.

Embodiment 825: The composition of embodiment 824, wherein the vanadium metal or vanadium oxide is at least 60% vanadium oxide.

Embodiment 826: The composition of embodiment 824, wherein the vanadium metal or vanadium oxide is at least 75% vanadium oxide.

Embodiment 827: The composition of embodiment 824, wherein the vanadium metal or vanadium oxide is at least 90% vanadium oxide.

Embodiment 828: The composition of any of embodiments 791-793 and 795-827, further comprising a component selected from the group consisting of Ti, Pt, Pd, Re, Ir, R, Ag, Mo, Cr, Cu, Au, Sn, Mn, In, Y, Mg, Ba, Fe, Ta, Nb, Ni, Hf, W, Co, Zn, Zr, Ru, Al, La, Si, their oxides, and combinations thereof.

Embodiment 829: The composition of any of embodiments 791, 793 and 795-828, wherein the composition comprises less than 1% water.

Embodiment 830: The composition of any of embodiments 791-829, wherein the composition is an unsupported material.

Embodiment 831: The composition of any of embodiments 791-829, wherein the composition is on a support.

Embodiment 832: The composition of embodiments 791-829, further comprising a support

Embodiment 833: The composition of any of embodiments 791-832, wherein the composition is a porous solid wherein at least 10% of the pores have a diameter greater than 10 nm.

Embodiment 834: The composition of any of embodiments 791-833, wherein at least 10% of the pores have a diameter greater than 15 nm.

Embodiment 835: The composition of any of embodiments 791-834, wherein at least 10% of the pores have a diameter greater than 20 nm.

Embodiment 836: The composition of any of embodiments 791-835, wherein at least 20% of the pores have a diameter greater than 20 nm.

Embodiment 837: The composition of any of embodiments 791-836, wherein at least 30% of the pores have a diameter greater than 20 nm.

Embodiment 838: The composition of any of embodiments 791-837, wherein at least 10% of the pores have a diameter less than 10 nm.

Embodiment 839: The composition of any of embodiments 791-838, wherein at least 20% of the pores have a diameter less than 10 nm.

Embodiment 840: The composition of any of embodiments 791-739 in a reactor.

Embodiment 841: The composition of embodiment 840, wherein the reactor is a three phase reactor with a packed bed.

Embodiment 842: The composition of embodiment 840, wherein the reactor is a trickle bed reactor.

Embodiment 843: The composition of embodiment 840, wherein the reactor is a fixed bed reactor.

Embodiment 844: The composition of embodiment 840, wherein the reactor is a plug flow reactor.

Embodiment 845: The composition of embodiment 840, wherein the reactor is a fluidized bed reactor.

Embodiment 846: The composition of embodiment 840, where the reactor is a two or three phase batch reactor.

Embodiment 847: The composition of embodiment 840, wherein the reactor is a continuous stirred tank reactor.

Embodiment 848: The composition of any of embodiments 791-839 in a slurry or suspension.

Embodiment 849: The composition of any of embodiments 791-839, made by a process comprising:

mixing a vanadium precursor with an organic acid and water to form a mixture; and

calcining the mixture at a temperature of at least 250° C. for a time period sufficient to form a solid.

Embodiment 850: The composition of embodiment 849, wherein the process further comprises evaporating a portion of the mixture for a period of time sufficient for the mixture to form a gel prior to calcination.

Embodiment 851: The composition of embodiment 849, wherein the process further comprises heating the mixture for a period of time sufficient for the mixture to form a gel prior to calcination.

Embodiment 852: The composition of any of embodiments 849-851, wherein in the process, the organic acid comprises a carboxyl group.

Embodiment 853: The composition of any of embodiments 849-852, wherein in the process, the organic acid comprises no more than one carboxylic group and at least one functional group selected from the group consisting of hydroxyl and carbonyl.

Embodiment 854: The composition of any of embodiments 849-853, wherein in the process, the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 855: The composition of any of embodiments 849-854, wherein in the process, the organic acid is ketoglutaric acid.

Embodiment 856: The composition of any of embodiments 849-855, wherein in the process, the organic acid is selected from the group consisting of glyoxylic acid, ketoglutaric acid and combinations thereof.

Embodiment 857: The composition of any of embodiments 849-856, wherein in the process, the vanadium precursor is selected from the group consisting of ammonium metavanadate, vanadium oxide, vanadium acetate, vanadium nitrate, vanadium 2,4-pentanedionate and vanadium oxi pentanedionate, vanadium formate, vanadium oxalate, vanadium chloride and combinations thereof.

Embodiment 858: The composition of any of embodiments 849-857, wherein in the process, the mixture is calcined at a temperature of at least 300° C.

Embodiment 859: The composition of any of embodiments 849-857, wherein in the process, the mixture is calcined at a temperature of at least 350° C.

Embodiment 860: The composition of any of embodiments 849-859, wherein in the process, the mixture is calcined for at least 1 hour.

Embodiment 861: The composition of any of embodiments 849-859, wherein in the process, the mixture is calcined for at least 2 hours.

Embodiment 862: The composition of any of embodiments 849-859, wherein in the process, the mixture is calcined for at least 4 hours.

Embodiment 863: The composition of any of embodiments 849-862, wherein in the process, the mixture has an essential absence of organic solvents other than the organic acid.

Embodiment 864: The composition of any of embodiments 849-863, wherein in the process, the mixture has an essential absence of citric acid.

Embodiment 865: A method for making a composition, the method comprising:

mixing a vanadium precursor with an organic acid and water to form a mixture, the organic acid comprising no more than one carboxylic group and at least one functional group selected from the group consisting of carbonyl and hydroxyl;

forming a gel; and

calcining the mixture at a temperature of at least 250° C. for a time sufficient to form a solid.

Embodiment 866: The method of embodiment 865, wherein the gel forming step comprises evaporating a portion of the mixture for a period of time sufficient for the mixture to form the gel prior to calcination.

Embodiment 867: The method of embodiment 865, wherein the gel forming step comprises heating the mixture for a period of time sufficient for the mixture to form the gel prior to calcination.

Embodiment 868: The method of any of embodiments 865-867, wherein the organic acid is selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof.

Embodiment 869: The method of embodiment 865-867, wherein the organic acid is glyoxylic acid.

Embodiment 870: The method of any of any of embodiments 865-869, wherein the vanadium precursor is selected from the group consisting of ammonium metavanadate, vanadium oxide, vanadium acetate, vanadium nitrate, vanadium 2,4-pentanedionate and vanadium oxi pentanedionate, vanadium formate, vanadium oxalate, vanadium chloride and combinations thereof.

Embodiment 871: The method of any of embodiments 865-870, wherein the mixture is calcined at a temperature of at least 300° C.

Embodiment 872: The method of any of embodiments 865-871, wherein the mixture is calcined at a temperature of at least 350° C.

Embodiment 873: The method of any of embodiments 865-872, wherein the mixture is calcined for at least 1 hour.

Embodiment 874: The method of any of embodiments 865-872, wherein the mixture is calcined for at least 2 hours.

Embodiment 875: The method of any of embodiments 865-872, wherein the mixture is calcined for at least 4 hours.

Embodiment 876: The method of any of embodiments 865-875, wherein the mixture has an essential absence of organic solvents other than the organic acid.

Embodiment 877: The method of any of embodiments 865-876, wherein the mixture has an essential absence of citric acid.

Embodiment 878: A method for making a composition, the method comprising:

mixing a vanadium precursor with an organic acid and water to form a mixture, the organic acid comprising two carboxylic groups and a carbonyl group; and

calcining the mixture at a temperature of at least 250° C. for a time sufficient to form a solid.

Embodiment 879: The method of embodiment 878, further comprising evaporating a portion of the mixture for a period of time sufficient for the mixture to form a gel prior to calcination.

Embodiment 880: The method of embodiment 878, further comprising heating the mixture for a period of time sufficient for the mixture to form a gel prior to calcination.

Embodiment 881: The method of any of embodiments 878-880, wherein the organic acid comprises no more than two carboxylic groups.

Embodiment 882: The method of any of embodiments 878-881, wherein the organic acid comprises no more than one carbonyl group.

Embodiment 883: The method of any of embodiments 878-882, wherein the organic acid is ketoglutaric acid.

Embodiment 884: The method of any of embodiments 878-883, wherein the vanadium precursor is selected from the group consisting of ammonium metavanadate, vanadium oxide, vanadium acetate, vanadium nitrate, vanadium 2,4-pentanedionate and vanadium oxi pentanedionate, vanadium formate, vanadium oxalate, vanadium chloride and combinations thereof.

Embodiment 885: The method of any of embodiments 878-884, wherein the mixture is calcined at a temperature of at least 300° C.

Embodiment 886: The method of any of embodiments 878-885, wherein the mixture is calcined at a temperature of at least 350° C.

Embodiment 887: The method of any of embodiments 878-886, wherein the mixture is calcined for at least 1 hour.

Embodiment 888: The method of any of embodiments 878-887, wherein the mixture is calcined for at least 2 hours.

Embodiment 889: The method of any of embodiments 878-888, wherein the mixture is calcined for at least 4 hours.

Embodiment 890: The method of any of embodiments 878-889, wherein the mixture has an essential absence of organic solvents other than the organic acid.

Embodiment 891: The method of any of embodiments 878-890, wherein the mixture has an essential absence of citric acid.

Embodiment 892: A method for making a composition, the method comprising:

mixing a vanadium precursor with an acid selected from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture;

forming a gel; and

calcining the gel at a temperature of at least 250° C. for at least 1 hour.

Embodiment 893: The method of embodiment 892, wherein the gel forming step comprises evaporating a portion of the mixture for a period of time sufficient for the mixture to form the gel prior to calcination.

Embodiment 894: The method of embodiment 892, wherein the gel forming step comprises heating the mixture for a period of time sufficient for the mixture to form a gel prior to calcination.

Embodiment 895: The method of any of embodiments 892-894, wherein the mixture comprises water.

Embodiment 896: The method of any of embodiments 892-895, wherein the vanadium precursor is selected from the group consisting of ammonium metavanadate, vanadium oxide, vanadium acetate, vanadium nitrate, vanadium 2,4-pentanedionate and vanadium oxi pentanedionate, vanadium formate, vanadium oxalate, vanadium chloride and combinations thereof.

Embodiment 897: The method of any of embodiments 892-896, wherein the gel is calcined at a temperature of at least 300° C.

Embodiment 898: The method of any of embodiments 892-896, wherein the gel is calcined at a temperature of at least 350° C.

Embodiment 899: The method of any of embodiments 892-898, wherein the gel is calcined for at least 2 hours.

Embodiment 900: The method of any of embodiments 892-898, wherein the gel is calcined for at least 4 hours.

Embodiment 901: The method of any of embodiments 892-898, wherein the mixture has an essential absence of organic solvents other than the organic acid.

Embodiment 902: The method of any of embodiments 892-901, wherein the mixture has an essential absence of citric acid.

Embodiment 903: The method of any of embodiments 892-902, wherein the mixture comprises a combination of glyoxylic and ketoglutaric acid.

Embodiment 904: A composition comprising vanadium glyoxylate.

Embodiment 905: The composition of embodiment 904, wherein the composition is a solution.

Embodiment 906: The composition of embodiments 904 or 905, wherein the composition is a precursor to make a solid vanadium containing material.

Embodiment 907: The composition of embodiment 906, wherein the material is a catalyst.

Embodiment 908: A composition comprising vanadium ketoglutarate.

Embodiment 909: The composition of embodiment 908, wherein the composition is a solution.

Embodiment 910: The composition of embodiments 908 or 909, wherein the composition is a precursor to make a solid vanadium containing material.

Embodiment 911: The composition of embodiment 910, wherein the material is a catalyst.

Embodiment 912: A method of forming a vanadium glyoxylate, the method comprising mixing ammonium metavanadate or a vanadium oxide with aqueous glyoxylic acid.

Embodiment 913: A method of forming a vanadium ketoglutarate, the method comprising mixing ammonium metavanadate or a vanadium oxide with aqueous ketoglutaric acid.

Embodiment 914: The composition of any of embodiments 791-839, wherein the composition has a cumulative BJH pore volume between 1.7 nm and 300 nm diameter greater than 0.20 ml/g.

Embodiment 915: The composition of embodiment 914, wherein the composition has a cumulative BJH pore volume between 1.7 nm and 300 nm diameter greater than 0.25 ml/g.

Embodiment 916: The composition of embodiment 914, wherein the composition has a cumulative BJH pore volume between 1.7 nm and 300 nm diameter greater than 0.30 ml/g.

Embodiment 917: The composition of embodiment 914, wherein the composition has a cumulative BJH pore volume between 1.7 nm and 300 nm diameter greater than 0.40 ml/g.

The following examples illustrate the principles and advantages of the invention.

### EXAMPLES

### Nickel

### Example 1

2 g of Ni(II) hydroxide Ni(OH)₂ (Alfa 12517) was dissolved in 60 ml of 2.5M aqueous ketoglutaric acid (acetone-1,3-dicarboxylic acid) (Alfa, catalog number A13742) in an open beaker by stirring at RT. The mixture was aged for 4 days at room temperature and formed a green glassy gel. The resulting gel was then calcined at 350° C. for 4 hours using the following heat up protocol: The oven temperature was ramped up from 45° C. to 120° C. over a 4 hour period. The temperature was then held at 120° C. for 4 hours. The oven temperature was then ramped up to 350° C. over a 1.5 hour period. Upon reaching 350° C., the temperature was held for 4 hours. The resulting material was isolated and found to yield 1.65 g.

The BET surface area of the resulting material was measured by Aveka Inc., Woodbury, Minn., on an SA-6201 Horiba surface area analyzer. The average BET surface area over 4 runs, and an outgassing pretreatment of 200° C. for 2 hours, was found to be 210.3 m²/g with a standard deviation of 4.4%.

### Example 2

0.75 g of Ni(II) hydroxide Ni(OH)₂ (Alfa 12517) was dissolved in 10 ml of 25% aqueous glyoxylic acid (Aldrich, catalog number 26,015-0) in an open 20 ml scintillation vial by stirring at room temperature. The mixture was aged for 4 days at room temperature and formed a clear green solution. The resulting solution was then calcined at 300° C. for 4 h using the following heat up protocol: The oven temperature was ramped up from 45° C. to 120° C. over a 4 hour period. The temperature was then held at 120° C. for 4 hours. The oven temperature was then ramped up to 300° C. over a 1.5 hour period. Upon reaching 300° C., the temperature was held for 4 hours. The resulting material was isolated and found to yield 626 mg.

The BET surface area of the resulting material was measured by Aveka Inc., Woodbury, Minn., on an SA-6201 Horiba surface area analyzer. The average BET surface area over 4 runs, and an outgassing pretreatment of 200° C. for 2 hours, was found to be 202.5 m²/g with a standard deviation of 1.5%.

### Example 3

500 mg of Ni(II) hydroxide Ni(OH)₂ (Alfa 12517) was dissolved in 10 ml of 12.5% aqueous glyoxylic acid in an open beaker by stirring at RT, resulting in a green solution. The mixture was then calcined at 320° C. for 2 hours using the following heat up protocol: The oven temperature was ramped up from 45° C. to 120° C. over a 4 hour period. The temperature was then held at 120° C. for 4 hours. The oven temperature was then ramped up to 320° C. over a 2 hour period and held at 320° C. for 2 hours. The resulting material was isolated and found to yield 412 mg.

The BET surface area of the resulting material was measured on a Beckman Coulter, Inc., (Fullerton, Calif.) model SA3100 surface area analyzer after outgassing the samples at 110° C. The BET surface area was found to be 309 m²/g.

Pore size distribution analysis of the composition (derived from the adsorption branch of the isotherm) was analyzed on a Beckman Coulter, Inc., (Fullerton, Calif.) SA3100 surface area analyzer. Results are shown in Table 1.

TABLE 1

| Pore Diameter Range (nm) | Pore Volume (ml/g) | % |
|---|---|---|
| Under 6 | 0.07367 | 25.17 |
| 6-8 | 0.02530 | 8.64 |
| 8-10 | 0.01391 | 4.75 |
| 10-12 | 0.01509 | 5.16 |
| 12-16 | 0.01761 | 6.01 |
| 16-20 | 0.02012 | 6.87 |
| 20-80 | 0.09635 | 32.91 |
| Over 80 | 0.03068 | 10.48 |
| Total | 0.29274 | 100.00 |

### Examples 4-21

Multiple reactions in which metal precursors were mixed with different organic acids under various reaction conditions are shown below with results in Table 2. Samples were calcined and analyzed for BET surface area either on a Coulter SA3100 or on a Micromeritics Tristar surface area analyzer after outgassing the samples at 110° C.

In Examples 4-11, the oven temperature was ramped up from 45° C. to 120° C. over a 150 minute period. The temperature was then held at 120° C. for 6 hours. The oven temperature was then ramped up to 200° C. over a 160 minute period and held at 200° C. for 2 hours. The temperature was then ramped up to 325° C. over a 65 minute period. Upon reaching 325° C., the temperature was held for 4 hours.

In Examples 12-15, the oven temperature was ramped up from 45° C. to 120° C. over a 4 hour period. The temperature was then held at 120° C. for 4 hours. The oven temperature was then ramped up to 325° C. over a 2 hour period. Upon reaching 325° C., the temperature was held for 4 hours.

In Examples 16-18, the oven temperature was ramped up from 45° C. to 120° C. over a 4 hour period. The temperature was then held at 120° C. for 4 hours. The oven temperature was then ramped up to 300° C. over a 2 hour period. Upon reaching 300° C., the temperature was held for 4 hours.

In Examples 19 and 20, the oven temperature was ramped up from 45° C. to 120° C. over a 4 hour period. The temperature was then held at 120° C. for 4 hours. The oven temperature was then ramped up to 285° C. over a 2 hour period. Upon reaching 285° C., the temperature was held for 4 hours.

In Example 21, the oven temperature was ramped up from 45° C. to 120° C. over a 4 hour period. The temperature was then held at 120° C. for 4 hours. The oven temperature was then ramped up to 290° C. over a 2 hour period. Upon reaching 290° C., the temperature was held for 6 hours.

TABLE 2

| | | | Aging | | | BET Surface |
|---|---|---|---|---|---|---|
| Example | Precursor | Acid | Time | Observation | Calcination | Area (m²/g) |
| 4 | 500 mg Ni(OH)₂ | 10 ml 12.5% | 1 day | Green solution | 325° C./4 hours | 162 |
| | | glyoxylic | | | | |
| | | acid | | | | |
| 5 | 500 mg Ni(OH)₂ | 10 ml 1M | 1 day | Green solution | 325° C./4 hours | 149 |
| | | malic acid | | | | |
| 6 | 500 mg Ni(OH)₂ | 10 ml 4M | 1 day | Green solution | 325° C./4 hours | 185 |
| | | tartaric acid | | | | |
| 7 | 500 mg Ni(OH)₂ | 10 ml 1M | 1 day | Blue precipitate | 325° C./4 hours | 185 |
| | | oxalic acid | | | | |
| 8 | 500 mg Ni(OH)₂ | 15 ml 1M | 1 day | Green solution | 325° C./4 | 108 |
| | | lactic acid | | | hours | |
| 9 | 500 mg Ni(OH)₂ | 8 ml 1.375M | 2 days | Blue precipitate | 325° C./4 | 104 |
| | | malonic acid | | | hours | |
| 10 | 500 mg Ni(OH)₂ | 10 ml 1M | 2 days | Green solution | 325° C./4 | 112 |
| | | glutaric acid | | | hours | |
| 11 | 500 mg Ni(OH)₂ | 10 ml 2M | 2 days | Green solution | 325° C./4 | 104 |
| | | citric acid | | | hours | |
| 12 | 500 mg Ni(OH)₂ | 10 ml 2M | 1 day | Green solution | 325° C./4 | 153 |
| | | citric acid | | | hours | |
| 13 | 500 mg Ni(OH)₂ | 10 ml 3M | 1 day | Green solution | 325° C./4 | 128 |
| | | citric acid | | | hours | |
| 14 | 500 mg Ni(OH)₂ | 10 ml 4M | 1 day | Green solution | 325° C./4 | 80 |
| | | glutaric acid | | | hours | |
| | | | | | Recalcined | 168 |
| | | | | | 350° C./4 | |
| | | | | | hours | |
| 15 | 500 mg Ni(OH)₂ | 2 g diglycolic | none | Green slurry | 325° C./4 | 239 |
| | | acid/10 ml | | | hours | |
| | | H2O | | | | |
| 16 | 1 g Ni(OH)₂ | 10 ml 12.5% | 1 day | Green solution | 300° C./4 | 236 |
| | | glyoxylic | | (cloudy) | hours | |
| | | acid in H₂0 | | | | |
| 17 | 500 mg Ni(OH)₂ | 15 ml 12.5% | 1 day | Green solution | 300° C./4 | 297 |
| | | glyoxylic | | | hours | |
| | | acid in H₂0 | | | | |
| 18 | 500 mg Ni(OH)₂ | 10 ml 6.25% | 1 day | Green solution | 300° C./4 | 272 |
| | | glyoxylic | | | hours | |
| | | acid in H₂0 | | | | |
| 19 | 500 mg Ni(OH)₂ | 10 ml 12.5% | none | Green solution | 285° C./4 | Not |
| | | glyoxylic | | | hours | determined |
| | | acid in H₂0 | | | | |
| | | | | | Recalcined | 329 |
| | | | | | 300° C./2 | |
| | | | | | hours | |
| 20 | 500 mg Ni(OH)₂ | 10 ml 6.25% | 1 day | Green solution | 285° C./4 | 224 |
| | | glyoxylic | | (foggy) | hours | |
| | | acid in H₂0 | | | | |
| 21 | 500 mg Ni(OH)₂ | 10 ml 12.5% | none | Green solution | 290° C./6 | 337 |
| | | glyoxylic | | | hours | |
| | | acid in H₂0 | | | | |
| | | | | | Re-calcined | 322 |
| | | | | | 290° C./1 hour | |

### Example 22

500 mg of Ni(II) hydroxide Ni(OH)₂ (Alfa, catalog number 12517) and 100 mg of Mn(OAc)₂*4H2O (Alfa, catalog number 12351) were dissolved in 7 ml of 3M ketoglutaric acid in an open beaker by stirring at RT. The formed a green solution. The resulting gel was then calcined at 350° C. for 4 hours using the following heat up protocol: The oven temperature was ramped up from 45° C. to 120° C. over a 4 hour period. The temperature was then held at 120° C. for 4 hours. The oven temperature was then ramped up to 350° C. over a 1.5 hour period. Upon reaching 350° C., the temperature was held for 4 hours. The resulting material was isolated and found to yield 427 mg.

The BET surface area of the resulting material was measured on a Beckman Coulter, Inc., (Fullerton, Calif.) SA3100 surface area analyzer. The BET surface area was found to be 149 m²/g.

### Example 23

1 g of Ni(II) hydroxide Ni(OH)₂ (Alfa 12517) and 100 mg of Mn(OAc)₂*4H2O (Alfa, catalog number 12351) were dissolved in 15 ml of 3M ketoglutaric acid in an open beaker by stirring at RT. The mixture was aged at room temperature for 3 weeks and formed a green gel. The resulting gel was then calcined at 350° C. for 4 hours using the following heat up protocol: The oven temperature was ramped up from 45° C. to 120° C. over a 4 hour period. The temperature was then held at 120° C. for 4 hours. The oven temperature was then ramped up to 350° C. over a 1.5 hour period. Upon reaching 350° C., the temperature was held for 4 hours. The resulting material was isolated and found to yield 863 mg.

The BET surface area of the resulting material was measured on a Beckman Coulter, Inc., (Fullerton, Calif.) SA3100 surface area analyzer. The BET surface area was found to be 170 m²/g.

### Example 24

500 mg of Ni(II) hydroxide Ni(OH)₂ (Alfa 12517) was dissolved in 6 ml of 10% aqueous glyoxylic acid by stirring at room temperature overnight. 310 mg of Fe(II) acetate (Alfa, catalog number 31140) were then added and the resulting solution was calcined in a static calcinations oven at 300° C. for 4 hours using the following heat up protocol: The oven temperature was ramped up from 55° C. to 120° C. over a 4 hour period. The temperature was then held at 120° C. for 4 hours. The oven temperature was then ramped up to 300° C. over a 1.5 hour period. Upon reaching 300° C., the temperature was held for 4 hours. The resulting material was isolated and found to yield 863 mg.

The BET surface area of the resulting material was measured on a Beckman Coulter, Inc., (Fullerton, Calif.) SA3100 surface area analyzer. The BET surface area was found to be 401 m²/g.

### Example 25

250 mg of Ni(II) hydroxide Ni(OH)₂ (Alfa 12517) was combined with 5 ml of 25% NMe₄OH by stirring at room temperature. The mixture was aged for 2 days at room temperature. The resulting green slurry was calcined in a static calcinations oven at 300° C. for 4 hours using the following heat up protocol: The oven temperature was ramped up from 55° C. to 120° C. over a 4 hour period. The temperature was then held at 120° C. for 4 hours. The oven temperature was then ramped up to 300° C. over a 1.5 hour period. Upon reaching 300° C., the temperature was held for 4 hours. The resulting material was isolated and found to yield 213 mg.

The BET surface area of the resulting material was measured on a Beckman Coulter, Inc., (Fullerton, Calif.) SA3100 surface area analyzer. The BET surface area was found to be 153 m²/g.

### Example 26

500 mg of Nickel hydroxyacetate (Alfa 39456) was calcined in a static calcination oven at 300° C. for 4 hours using the following heat up protocol: The oven temperature was ramped up from 55° C. to 120° C. over a 4 hour period. The temperature was then held at 120° C. for 4 hours. The oven temperature was then ramped up to 300° C. over a 1.5 hour period. Upon reaching 300° C., the temperature was held for 4 hours. The resulting material was isolated and found to yield 180 mg.

The BET surface area of the resulting material was measured on a Beckman Coulter, Inc., (Fullerton, Calif.) SA3100 surface area analyzer. The BET surface area was found to be 173 m²/g.

### Example 27

500 mg of Nickel acac (Alfa 12529) was combined with 10 ml of 20% aqueous glyoxal by dilution of 40% aqueous solution (Alfa A16144) in a 50 ml vial. The green solution was aged for 24 hours and calcined in a static calcination oven at 300° C. for 4 hours using the following heat up protocol: The oven temperature was ramped up from 55° C. to 120° C. over a 4 hour period. The temperature was then held at 120° C. for 4 hours. The oven temperature was then ramped up to 300° C. over a 1.5 hour period. Upon reaching 300° C., the temperature was held for 4 hours. The resulting material was isolated and found to yield 807 mg.

The BET surface area of the resulting material was measured on a Beckman Coulter, Inc., (Fullerton, Calif.) SA3100 surface area analyzer. The BET surface area was found to be 9 m²/g.

The resulting material was then re-calcined at 350° C. for 2 hours using the following heat up protocol: The oven temperature was ramped up from 55° C. to 120° C. over a 4 hour period. The temperature was then held at 120° C. for 4 hours. The oven temperature was then ramped up to 350° C. over a 1.5 hour period. Upon reaching 350° C., the temperature was held for 2 hours. The resulting material was isolated and found to yield 588 mg.

The resulting material was then re-calcined at 375° C. for 2 hours using the following heat up protocol: The oven temperature was ramped up from 55° C. to 120° C. over a 4 hour period. The temperature was then held at 120° C. for 4 hours. The oven temperature was then ramped up to 375° C. over a 1.5 hour period. Upon reaching 375° C., the temperature was held for 2 hours.

The resulting material was isolated and found to yield 378 mg.

The BET surface area of the resulting material was measured on a Beckman Coulter, Inc., (Fullerton, Calif.) SA3100 surface area analyzer. The BET surface area was found to be 206 m²/g.

### Example 28

500 mg of Nickel lactate (Alfa B23643) was combined with 10 ml of 20% aqueous glyoxal by dilution of 40% aqueous solution (Alfa A16144) in a 50 ml vial. The green slurry was aged for 24 hours and calcined in a static calcination oven at 300° C. for 4 hours using the following heat up protocol: The oven temperature was ramped up from 55° C. to 120° C. over a 4 hour period. The temperature was then held at 120° C. for 4 hours. The oven temperature was then ramped up to 300° C. over a 1.5 hour period. Upon reaching 300° C., the temperature was held for 4 hours. The resulting material was isolated and found to yield 158 mg.

The BET surface area of the resulting material was measured on a Beckman Coulter, Inc., (Fullerton, Calif.) SA3100 surface area analyzer. The BET surface area was found to be 109 m²/g.

### Example 29

500 mg of Nickel nitrate (Aldrich 30, 401-8) was combined with 10 ml of 14% aqueous glyoxal by dilution of 40% aqueous solution (Alfa A16144) in a 50 ml vial. The green solution was calcined in a static calcination oven at 300° C. for 4 hours using the following heat up protocol: The oven temperature was ramped up from 55° C. to 120° C. over a 4 hour period. The temperature was then held at 120° C. for 4 hours. The oven temperature was then ramped up to 300° C. over a 1.5 hour period. Upon reaching 300° C., the temperature was held for 4 hours. The resulting material was isolated and found to yield 53 mg (there was spillover out of the vial due to excessive foaming).

The BET surface area of the resulting material was measured on a Beckman Coulter, Inc., (Fullerton, Calif.) SA3100 surface area analyzer. The BET surface area was found to be 106 m²/g.

### Cobalt

In the examples below, the BET surface area of the materials was measured on a Beckman Coulter, Inc., (Fullerton, Calif.) model SA3100 surface area analyzer after outgassing the samples at 110° C.

### Example 30

500 mg of cobalt oxalate CoC₂O₄*2H₂O (Alfa 87758) dry powder was calcined at 275° C. for 2 hours using the following heat up protocol: The oven temperature was ramped up from 110° C. to 275° C. over a 1 hour period. The temperature was then held at 275° C. for 2 hours. The resulting material was isolated and found to yield 219 mg.

The BET surface area was found to be 100 m²/g.

### Example 31

500 mg of cobalt oxalate CoC₂O₄*2H₂O (Alfa 87758) dry powder was calcined at 275° C. for 1 hour using the following heat up protocol: The oven temperature was ramped up from 110° C. to 275° C. over a 1 hour period. The temperature was then held at 275° C. for 1 hour. The resulting material was isolated and found to yield 224 mg.

The BET surface area was found to be 121 m²/g.

### Example 32

500 mg of cobalt oxalate CoC₂O₄*2H₂O (Alfa 87758) dry powder was calcined at 250° C. for 3 hours using the following heat up protocol: The oven temperature was ramped up from 110° C. to 250° C. over a 1 hour period. The temperature was then held at 250° C. for 3 hours. The resulting material was isolated and found to yield 223 mg.

The BET surface area was found to be 131 m²/g.

### Example 33

838 mg of cobalt citrate (Pfaltz & Bauer C23830) dry pink powder was calcined at 250° C. for 4 hours using the following heat up protocol: The oven temperature was ramped up from 55° C. to 120° C. over a 1 hour period. The temperature was then held at 120° C. for 1 hour. The oven temperature was ramped up from 120° C. to 250° C. over a 1 hour period then held at 250° C. for 4 hours. The resulting material was isolated and found to yield 425 mg.

The BET surface area was found to be 77.7 m²/g.

The black Co oxide powder was then re-calcined at 255° C. over a 2 hour period using the following protocol: The oven temperature was ramped up from 55° C. to 255° C. over a 1 hour period. The temperature was then held at 255° C. for 2 hours. The resulting material was isolated and found to yield 281 mg of a black powder.

The BET surface area was found to be 206.7 m²/g.

### Example 34

787 mg of cobalt formate dry pink powder was calcined at 170° C. for 4 hours using the following heat up protocol: The oven temperature was ramped up from 55° C. to 120° C. over a 1 hour period. The temperature was then held at 120° C. for 1 hour. The oven temperature was ramped up from 120° C. to 170° C. over a 1 hour period then held at 170° C. for 4 hours. The resulting material was isolated and found to yield 364 mg of a black powder.

The BET surface area was found to be 207.2 m²/g.

### Example 35

7047 mg of cobalt citrate (Pfaltz & Bauer C23830) dry pink powder was calcined at 250° C. for 6 hours using the following heat up protocol: The oven temperature was ramped up from 55° C. to 120° C. over a 1 hour period. The temperature was then held at 120° C. for 1 hour. The oven temperature was ramped up from 120° C. to 250° C. over a 1 hour period then held at 250° C. for 6 hours. The resulting material was isolated and found to yield 226 mg.

The BET surface area was found to be 199.6 m²/g.

### Examples 36-45

Multiple reactions in which metal precursors were mixed with different organic acids under various reaction conditions are shown below with results in Table 3.

The samples were calcined as follows: The oven temperature was ramped up from 55° C. to 120° C. over a 4 hour period. The temperature was then held at 120° C. for 4 hours. The temperature was then ramped up from 120° C. to the calcinations temperature shown in Table 3 over a 1 hour period and held at the calcinations temperature for the time period shown in Table 3. After calcinations, the temperature was ramped down to 110° C. over a 30 minute period and held at 110° C. until the BET surface area measurement was taken.

TABLE 3

| | | | | | | BET |
|---|---|---|---|---|---|---|
| | | | | | | Surface |
| | | | Aging | | | Area |
| Example | Precursor | Acid | Time | Observation | Calcination | (m²/g) |
| 36 | 500 mg | 10 ml | 5 | Whitish gel | 280° C./4 hours | 104 |
| | Co(OH)₂ | 12.5% | weeks | | | |
| | | glyoxylic | | | | |
| | | acid | | | | |
| 37 | 1 g | 15 ml 3M | 1 day | red solution | 325° C./4 hours | 131 |
| | Co(OH)₂ | ketoglutaric | | | | |
| | | acid | | | | |
| 38 | 500 mg | 5 ml 3M | 1 day | red solution | 300° C./4 hours | 134 |
| | Co(OH)₂ | ketoglutaric | | | | |
| | | acid | | | | |
| 39 | 500 mg | 3 ml 3M | 1 day | red solution | 300° C./4 hours | 155 |
| | Co(OH)₂ | ketoglutaric | | | | |
| | | acid | | | | |
| 40 | 500 mg | 3 ml 3M | 2 days | red solution | 280° C./4 hours | 154 |
| | Co(OH)₂ | ketoglutaric | | | | |
| | | acid | | | | |
| 41 | 500 mg | 2 g | 10 days | Pink slurry | 300° C./2 hours | Still |
| | Co(OH)₂ | diglycolic | | | | slurry |
| | | acid/10 ml | | | | |
| | | H₂O | | | | |
| | | | | | Recalcined | 128 |
| | | | | | 300° C./2 hours | |
| 42 | 1 g | 10 ml | none | red solution | 300° C./3 hours | 132 |
| | Co(OAc)₂ | 12.5% | | | | |
| | | glyoxylic | | | | |
| | | acid | | | | |
| 43 | 5 ml 1M | 10 ml | none | red solution | 300° C./3 hours | 96 |
| | aq. | 12.5% | | | | |
| | Co(NO₃)₂ | glyoxylic | | | | |
| | | acid | | | | |
| 44 | 500 mg | 10 ml | none | red solution | 300° C./4 hours | 116 |
| | Co | 12.5% | | | | |
| | formate | glyoxylic | | | | |
| | | acid | | | | |
| 45 | 1 g Co | 10 ml | none | red solution | 300° C./4 hours | 119 |
| | formate | 12.5% | | | | |
| | | glyoxylic | | | | |
| | | acid | | | | |
| | | | | | Recalcined | 168 |
| | | | | | 350° C./4 hours | |

### Examples 46-49

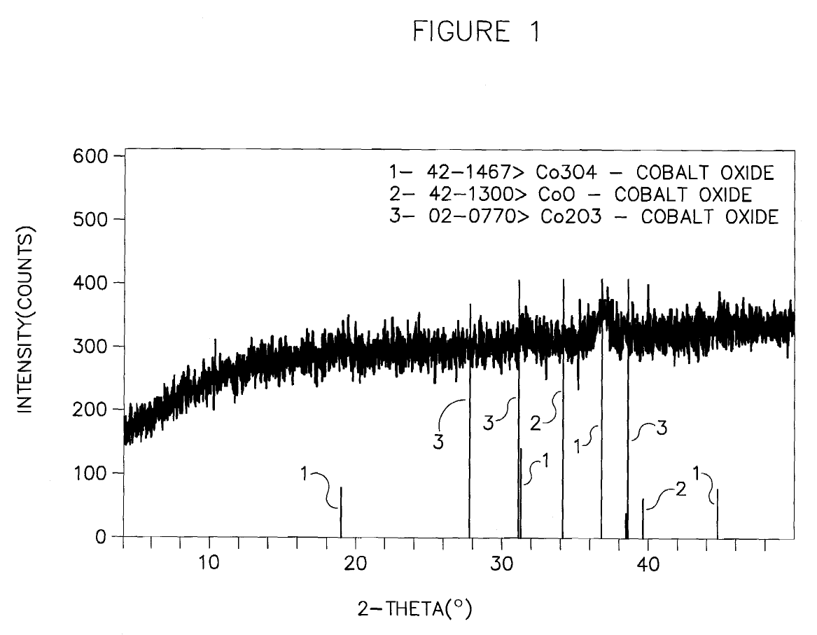

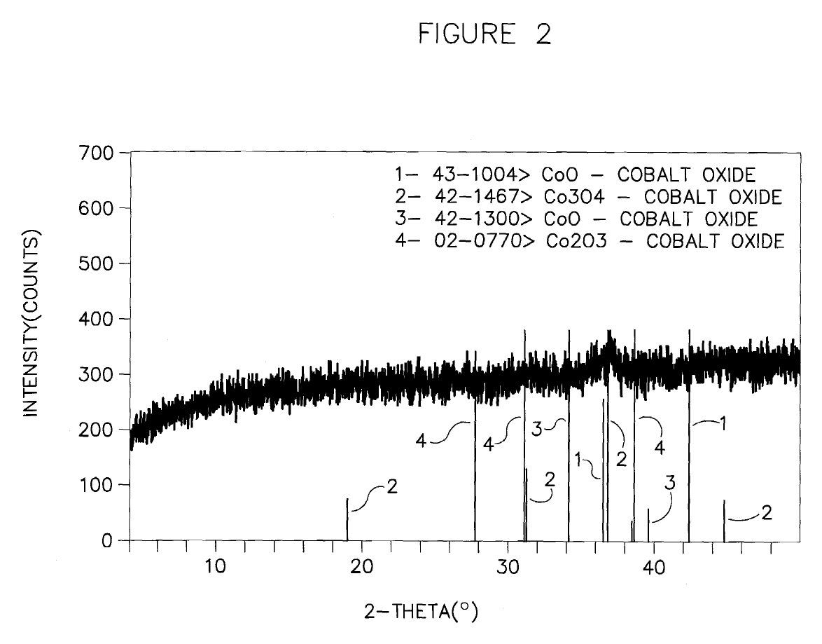

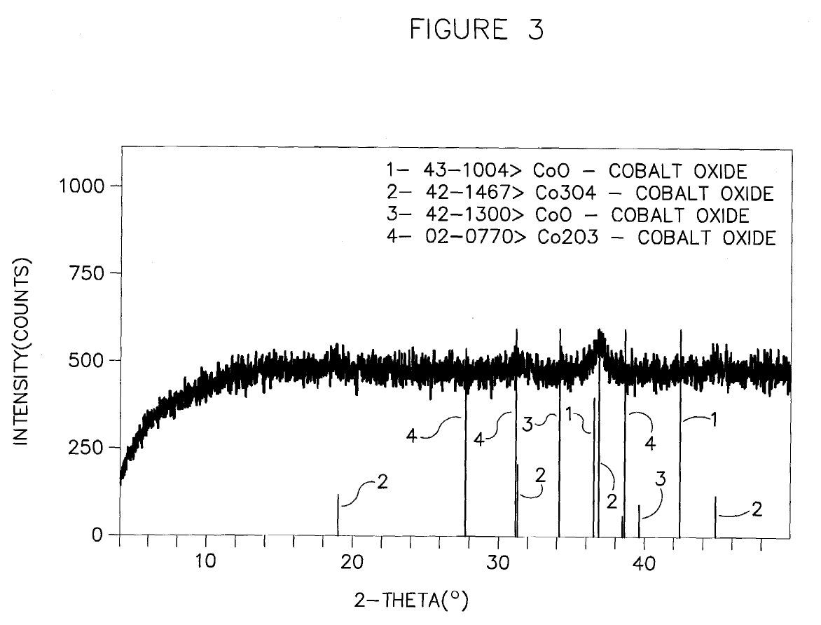

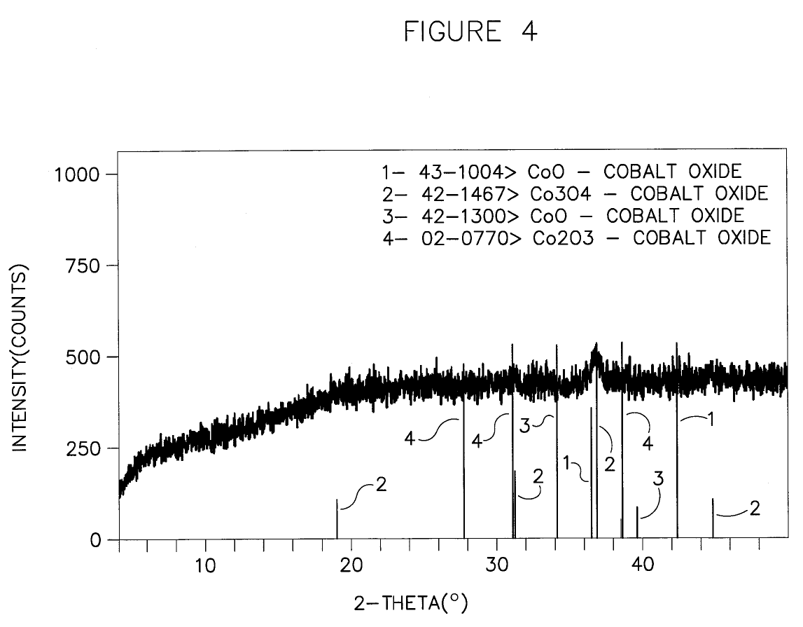

Examples 46-40 were prepared as described below. X-ray powder diffraction (XRD) patterns for the samples were collected on a Philips PW3040-Pro using CuKα radiation with an alpha 1 monochromator. The samples were scanned at 2-theta from 4° to 50° using a scan rate of 0.1° 2-Theta per second for approximately 7.5 minutes. The samples were loaded on a silicon disk and rotated at 0.5 rotations/second during data collection. The data is shown in FIGS. 1-4. FIG. 1 shows the XRD data on the sample made in Example 46. FIG. 2 shows the XRD data on the sample made in Example 47. FIG. 3 shows the XRD data on the sample made in Example 48. FIG. 4 shows the XRD data on the sample made in Example 49. Reference patterns for CoO, CO₂O₃ and CO₃O₄ are included in the Figures.

### Example 46

1 g Co(OH)₂ was combined with 2 g of ketoglutaric acid in 5 ml water and calcined as follows: The temperature was ramped up 45° C. to 120° C. over a 4 hour period. The temperature was then held at 120° C. for 4 hours. The temperature was then ramped up from 120° C. to 320° C. over a 1 hour period and held at 320° C. for 2 hours.

The BET surface area was found to be 83 m²/g.

### Example 47

1 g Co(OH)₂ was combined with 2.54 g of ketoglutaric acid in 5 ml water and calcined as follows: The temperature was ramped up 45° C. to 120° C. over a 150 minute period. The temperature was then held at 120° C. for 6 hours. The temperature was then ramped up from 120° C. to 200° C. over a 160 minute period and held at 200° C. for 2 hours. The temperature was then ramped up from 200° C. to 290° C. over a 450 minute period and held at 290° C. for 4 hours.

The BET surface area was found to be 121 m²/g.

### Example 48

1 g Co(OAc)₂ was combined with 10 ml of 12.5% aqueous glyoxylic acid and calcined as follows: The temperature was ramped up 45° C. to 120° C. over a 4 hour period. The temperature was then held at 120° C. for 4 hours. The temperature was then ramped up from 120° C. to 300° C. over a 2 hour period and held at 300° C. for 3 hours.

The BET surface area was found to be 132 m²/g.

### Example 49

500 mg Co(OH)₂ was combined with 750 mg of glycolic acid in 10 ml water and calcined as follows: The temperature was ramped up 45° C. to 120° C. over a 4 hour period. The temperature was then held at 120° C. for 4 hours. The temperature was then ramped up from 120° C. to 300° C. over a 2 hour period and held at 300° C. for 4 hours.

The BET surface area was found to be 89 m²/g.

### Examples 50-55

Cobalt materials were made as discussed below in Examples 50-55. Pore size distribution analysis of the compositions (derived from the adsorption branch of the isotherm) was analyzed on a Micromeretics, Inc., (Atlanta, Ga.) Micromeretics TriStar 3000. Results are shown in Tables 4-9.

### Example 50

500 mg of Co(OH)₂ was combined with 10 ml of water and 1572 mg of ketoglutaric acid such that there was 2 mols of ketoglutaric acid to each mol of cobalt. The mixture was then calcined using the following protocol: The oven temperature was ramped up from 55° C. to 120° C. over a 4 hour period. The temperature was then held at 120° C. for 4 hours. The oven temperature was then ramped up from 120° C. to 285° C. over a 1 hour period and held at 285° C. for 4 hours.

The BET surface area was found to be 137 m²/g. The total pore volume was found to be 0.507634 cm³/g. The pore distribution data is shown below in Table 4.

TABLE 4

| Average Diameter | Incremental Pore Volume | |
|---|---|---|
| (nm) | (cm³/g) | Volume Fraction |
| 252.1 | 0.008544 | 1.68% |
| 229.1 | 0.006124 | 1.21% |
| 144.2 | 0.00877 | 1.73% |
| 114.6 | 0.010608 | 2.09% |
| 103 | 0.011088 | 2.18% |
| 92.4 | 0.011541 | 2.27% |
| 81.4 | 0.012049 | 2.37% |
| 74.5 | 0.005624 | 1.11% |
| 66.9 | 0.014353 | 2.83% |
| 62.3 | 0.004199 | 0.83% |
| 56.5 | 0.014811 | 2.92% |
| 49.1 | 0.016022 | 3.16% |
| 43.5 | 0.015401 | 3.03% |
| 38.1 | 0.018333 | 3.61% |
| 33.8 | 0.014621 | 2.88% |
| 30.1 | 0.01772 | 3.49% |
| 26.8 | 0.016215 | 3.19% |
| 24 | 0.016828 | 3.31% |
| 21.2 | 0.017504 | 3.45% |
| 18.9 | 0.01668 | 3.29% |
| 16.6 | 0.019275 | 3.80% |
| 14.9 | 0.014394 | 2.84% |
| 13.2 | 0.019809 | 3.90% |
| 11.7 | 0.017504 | 3.45% |
| 10.7 | 0.013529 | 2.67% |
| 9.5 | 0.028215 | 5.56% |
| 8.3 | 0.026897 | 5.30% |
| 7.2 | 0.024832 | 4.89% |
| 6.1 | 0.025996 | 5.12% |
| 5.2 | 0.01473 | 2.90% |
| 4.6 | 0.010875 | 2.14% |
| 4.1 | 0.008421 | 1.66% |
| 3.6 | 0.007052 | 1.39% |
| 3.2 | 0.005117 | 1.01% |
| 2.9 | 0.00442 | 0.87% |
| 2.6 | 0.003737 | 0.74% |
| 2.3 | 0.002932 | 0.58% |
| 2.1 | 0.002076 | 0.41% |
| 1.9 | 0.000529 | 0.10% |
| 1.8 | 0.000259 | 0.05% |

### Example 51

500 mg of Co(OH)₂ was combined with 10 ml of water and 786 mg of ketoglutaric acid such that there was 1 mol of ketoglutaric acid to each mol of cobalt. The mixture was then calcined using the following protocol: The oven temperature was ramped up from 55° C. to 120° C. over a 4 hour period. The temperature was then held at 120° C. for 4 hours. The oven temperature was then ramped up from 120° C. to 285° C. over a 1 hour period and held at 285° C. for 4 hours.

The BET surface area was found to be 131 m²/g. The total pore volume was found to be 0.394586 cm³/g. The pore distribution data is shown below in Table 5.

TABLE 5

| | Incremental | |
|---|---|---|
| Average | Pore Volume | |
| Diameter (nm) | (cm³/g) | Volume Fraction |
| 266.1 | 0.0076 | 1.93% |
| 244.2 | 0.005383 | 1.36% |
| 163.9 | 0.00522 | 1.32% |
| 127.5 | 0.007609 | 1.93% |
| 111.8 | 0.006225 | 1.58% |
| 99.4 | 0.006321 | 1.60% |
| 86.9 | 0.008035 | 2.04% |
| 76.4 | 0.006659 | 1.69% |
| 68.8 | 0.005313 | 1.35% |
| 61.4 | 0.00739 | 1.87% |
| 54 | 0.008725 | 2.21% |
| 48.1 | 0.007898 | 2.00% |
| 42.9 | 0.007352 | 1.86% |
| 37.6 | 0.00984 | 2.49% |
| 33.6 | 0.00705 | 1.79% |
| 30 | 0.009359 | 2.37% |
| 26.9 | 0.007833 | 1.99% |
| 24 | 0.008926 | 2.26% |
| 21.3 | 0.009183 | 2.33% |
| 18.8 | 0.011108 | 2.82% |
| 16.5 | 0.01017 | 2.58% |
| 15 | 0.007512 | 1.90% |
| 13.3 | 0.013271 | 3.36% |
| 11.7 | 0.014717 | 3.73% |
| 10.6 | 0.013798 | 3.50% |
| 9.5 | 0.023028 | 5.84% |
| 8.3 | 0.027656 | 7.01% |
| 7.3 | 0.027874 | 7.06% |
| 6.2 | 0.030259 | 7.67% |
| 5.3 | 0.022303 | 5.65% |
| 4.6 | 0.013275 | 3.36% |
| 4 | 0.009522 | 2.41% |
| 3.6 | 0.007313 | 1.85% |
| 3.2 | 0.006255 | 1.59% |
| 2.8 | 0.004535 | 1.15% |
| 2.6 | 0.003894 | 0.99% |
| 2.3 | 0.003008 | 0.76% |
| 2 | 0.00229 | 0.58% |
| 1.9 | 0.000503 | 0.13% |
| 1.8 | 0.000328 | 0.08% |
| 1.7 | 0.000046 | 0.01% |

### Example 52

500 mg of Co(OH)₂ was combined with 10 ml of water and 1179 mg of ketoglutaric acid such that there was 1.5 mol of ketoglutaric acid to each mol of cobalt. The mixture was then calcined using the following protocol: The oven temperature was ramped up from 55° C. to 120° C. over a 4 hour period. The temperature was then held at 120° C. for 4 hours. The oven temperature was then ramped up from 120° C. to 285° C. over a 1 hour period and held at 285° C. for 4 hours.

The BET surface area was found to be 129 m²/g. The total pore volume was found to be 0.427644 cm³/g. The pore distribution data is shown below in Table 6.

TABLE 6

| | Incremental | |
|---|---|---|
| Average | Pore Volume | |
| Diameter (nm) | (cm³/g) | Volume Fraction |
| 256 | 0.006457 | 1.51% |
| 167.2 | 0.008092 | 1.89% |
| 132 | 0.009382 | 2.19% |
| 120 | 0.006 | 1.40% |
| 106.7 | 0.01 | 2.34% |
| 96.5 | 0.006523 | 1.53% |
| 85.5 | 0.010823 | 2.53% |
| 76.4 | 0.006726 | 1.57% |
| 68.4 | 0.00994 | 2.32% |
| 62.3 | 0.00503 | 1.18% |
| 55.1 | 0.013207 | 3.09% |
| 48.1 | 0.011309 | 2.64% |
| 42.5 | 0.011712 | 2.74% |
| 37.8 | 0.010776 | 2.52% |
| 33.8 | 0.01064 | 2.49% |
| 30.1 | 0.011227 | 2.63% |
| 27 | 0.010359 | 2.42% |
| 24.2 | 0.011211 | 2.62% |
| 21.5 | 0.011346 | 2.65% |
| 19.3 | 0.010866 | 2.54% |
| 16.7 | 0.015626 | 3.65% |
| 14.8 | 0.010049 | 2.35% |
| 13.2 | 0.014029 | 3.28% |
| 11.7 | 0.016307 | 3.81% |
| 10.6 | 0.015688 | 3.67% |
| 9.4 | 0.025511 | 5.97% |
| 8.2 | 0.024723 | 5.78% |
| 7.2 | 0.023105 | 5.40% |
| 6.1 | 0.02504 | 5.86% |
| 5.2 | 0.015871 | 3.71% |
| 4.6 | 0.011948 | 2.79% |
| 4.1 | 0.00921 | 2.15% |
| 3.6 | 0.007413 | 1.73% |
| 3.2 | 0.006515 | 1.52% |
| 2.9 | 0.004699 | 1.10% |
| 2.6 | 0.004004 | 0.94% |
| 2.3 | 0.003064 | 0.72% |
| 2.1 | 0.002258 | 0.53% |
| 1.9 | 0.000562 | 0.13% |
| 1.8 | 0.000325 | 0.08% |
| 1.7 | 0.000073 | 0.02% |

### Example 53

790 mg of Co(OH)₂ was combined with 10 ml of water and 620 mg of ketoglutaric acid. The mixture was then calcined using the following protocol: The oven temperature was ramped up from 55° C. to 120° C. over a 4 hour period. The temperature was then held at 120° C. for 4 hours. The oven temperature was then ramped up from 120° C. to 280° C. over a 1 hour period and held at 280° C. for 4 hours.

The BET surface area was found to be 126 m²/g. The total pore volume was found to be 0.558015 cm³/g. The pore distribution data is shown below in Table 7.

TABLE 7

| | Incremental | |
|---|---|---|
| Average | Pore Volume | |
| Diameter (nm) | (cm³/g) | Volume Fraction |
| 152 | 0.011401 | 2.04% |
| 127.4 | 0.030711 | 5.50% |
| 116.6 | 0.012789 | 2.29% |
| 109.2 | 0.00979 | 1.75% |
| 101.2 | 0.020104 | 3.60% |
| 92.9 | 0.017394 | 3.12% |
| 85.1 | 0.021764 | 3.90% |
| 77.9 | 0.018843 | 3.38% |
| 70.8 | 0.023576 | 4.22% |
| 64.7 | 0.017464 | 3.13% |
| 59.1 | 0.021711 | 3.89% |
| 55.8 | 0.010149 | 1.82% |
| 50.8 | 0.025827 | 4.63% |
| 45.4 | 0.017394 | 3.12% |
| 41.4 | 0.016708 | 2.99% |
| 37.1 | 0.016436 | 2.95% |
| 32.9 | 0.016665 | 2.99% |
| 29.2 | 0.015625 | 2.80% |
| 26.5 | 0.009934 | 1.78% |
| 24.6 | 0.009584 | 1.72% |
| 22 | 0.015835 | 2.84% |
| 19.3 | 0.010116 | 1.81% |
| 17.3 | 0.011082 | 1.99% |
| 15.2 | 0.015804 | 2.83% |
| 13.3 | 0.012125 | 2.17% |
| 11.8 | 0.013602 | 2.44% |
| 10.6 | 0.01275 | 2.28% |
| 9.4 | 0.016498 | 2.96% |
| 8.3 | 0.012307 | 2.21% |
| 7.2 | 0.01579 | 2.83% |
| 6.2 | 0.016479 | 2.95% |
| 5.3 | 0.010511 | 1.88% |
| 4.7 | 0.010691 | 1.92% |
| 4.1 | 0.00782 | 1.40% |
| 3.6 | 0.006789 | 1.22% |
| 3.3 | 0.00595 | 1.07% |
| 2.9 | 0.005355 | 0.96% |
| 2.6 | 0.005147 | 0.92% |
| 2.3 | 0.004375 | 0.78% |
| 2.1 | 0.003102 | 0.56% |
| 1.9 | 0.000898 | 0.16% |
| 1.8 | 0.000711 | 0.13% |
| 1.7 | 0.000409 | 0.07% |

### Example 54

500 mg of Co(OAc)₂ was combined with 10 ml of 12.5% aqueous glyoxylic acid. The mixture was then calcined using the following protocol: The oven temperature was ramped up from 55° C. to 120° C. over a 4 hour period. The temperature was then held at 120° C. for 4 hours. The oven temperature was then ramped up from 120° C. to 300° C. over a 1 hour period and held at 300° C. for 3 hours.

The BET surface area was found to be 119 m²/g. The total pore volume was found to be 0.384412 cm³/g. The pore distribution data is shown below in Table 8.

TABLE 8

| | Incremental | |
|---|---|---|
| Average | Pore Volume | |
| Diameter (nm) | (cm³/g) | Volume Fraction |
| 228 | 0.0055220 | 1.44% |
| 155.4 | 0.0067690 | 1.76% |
| 127.1 | 0.0077990 | 2.03% |
| 117.1 | 0.0079950 | 2.08% |
| 109 | 0.0082280 | 2.14% |
| 102.3 | 0.0083630 | 2.18% |
| 95.9 | 0.0085680 | 2.23% |
| 88.8 | 0.0087320 | 2.27% |
| 81.3 | 0.0090460 | 2.35% |
| 76.5 | 0.0047920 | 1.25% |
| 69.5 | 0.0102780 | 2.67% |
| 62.4 | 0.0095080 | 2.47% |
| 55.8 | 0.0106510 | 2.77% |
| 49.2 | 0.0100390 | 2.61% |
| 42.8 | 0.0117020 | 3.04% |
| 37.4 | 0.0103630 | 2.70% |
| 33.2 | 0.0095620 | 2.49% |
| 30 | 0.0071630 | 1.86% |
| 27 | 0.0086780 | 2.26% |
| 23.9 | 0.0098070 | 2.55% |
| 21.3 | 0.0080910 | 2.10% |
| 18.8 | 0.0099980 | 2.60% |
| 16.7 | 0.0091180 | 2.37% |
| 15.1 | 0.0072320 | 1.88% |
| 13.2 | 0.0130980 | 3.41% |
| 11.6 | 0.0098770 | 2.57% |
| 10.6 | 0.0079080 | 2.06% |
| 9.4 | 0.0138330 | 3.60% |
| 8.3 | 0.0138970 | 3.62% |
| 7.2 | 0.0204390 | 5.32% |
| 6.2 | 0.0203310 | 5.29% |
| 5.3 | 0.0213990 | 5.57% |
| 4.6 | 0.0137930 | 3.59% |
| 4.1 | 0.0102530 | 2.67% |
| 3.6 | 0.0078330 | 2.04% |
| 3.2 | 0.0064030 | 1.67% |
| 2.9 | 0.0056960 | 1.48% |
| 2.6 | 0.0042320 | 1.10% |
| 2.3 | 0.0032480 | 0.84% |
| 2.1 | 0.0026410 | 0.69% |
| 1.9 | 0.0007430 | 0.19% |
| 1.8 | 0.0005330 | 0.14% |
| 1.7 | 0.0002520 | 0.07% |

### Example 55

500 mg of Co(OH)₂ was combined with 5 ml of 3M ketoglutaric acid. The mixture was then calcined using the following protocol: The oven temperature was ramped up from 55° C. to 120° C. over a 4 hour period. The temperature was then held at 120° C. for 4 hours. The oven temperature was then ramped up from 120° C. to 290° C. over a 1 hour period and held at 290° C. for 4 hours.

The BET surface area was found to be 142 m²/g. The total pore volume was found to be 0.231291 cm³/g. The pore distribution data is shown below in Table 9.

TABLE 9

| | Incremental | |
|---|---|---|
| Average | Pore Volume | |
| Diameter (nm) | (cm³/g) | Volume Fraction |
| 294.3 | 0.003298 | 1.43% |
| 233.8 | 0.002329 | 1.01% |
| 188.3 | 0.000203 | 0.09% |
| 169 | 0.000185 | 0.08% |
| 150.4 | 0.000203 | 0.09% |
| 130 | 0.00022 | 0.10% |
| 115.9 | 0.000174 | 0.08% |
| 102.9 | 0.000183 | 0.08% |
| 91.3 | 0.000166 | 0.07% |
| 80.5 | 0.000173 | 0.07% |
| 71.8 | 0.000149 | 0.06% |
| 64.8 | 0.000146 | 0.06% |
| 57.9 | 0.000179 | 0.08% |
| 51.2 | 0.000162 | 0.07% |
| 44.9 | 0.000178 | 0.08% |
| 39.7 | 0.000172 | 0.07% |
| 35.2 | 0.000188 | 0.08% |
| 31.4 | 0.000179 | 0.08% |
| 28.1 | 0.000187 | 0.08% |
| 25 | 0.000251 | 0.11% |
| 22.1 | 0.000274 | 0.12% |
| 19.4 | 0.000447 | 0.19% |
| 16.8 | 0.00064 | 0.28% |
| 14.9 | 0.000744 | 0.32% |
| 13.4 | 0.001202 | 0.52% |
| 11.8 | 0.00378 | 1.63% |
| 10.5 | 0.00394 | 1.70% |
| 9.3 | 0.012838 | 5.55% |
| 8.2 | 0.014745 | 6.38% |
| 7.2 | 0.029364 | 12.70% |
| 6.2 | 0.030877 | 13.35% |
| 5.3 | 0.028806 | 12.45% |
| 4.6 | 0.023928 | 10.35% |
| 4 | 0.019297 | 8.34% |
| 3.6 | 0.014264 | 6.17% |
| 3.2 | 0.010401 | 4.50% |
| 2.9 | 0.008449 | 3.65% |
| 2.6 | 0.006726 | 2.91% |
| 2.3 | 0.005321 | 2.30% |
| 2 | 0.003634 | 1.57% |
| 1.9 | 0.001153 | 0.50% |
| 1.8 | 0.000888 | 0.38% |
| 1.7 | 0.000649 | 0.28% |

### Example 56

2.5 ml of 1 M Co acetate, 1.25 ml of 1M Ce(NO₃)₃ and 44 mg of Sn(IV) acetate were combined with 5 ml of 50% aqueous glyoxylic acid in an open beaker by stirring at room temperature.

The resulting mixture was then calcined at 325° C. for 4 hours using the following heat up protocol: The oven temperature was ramped up from 60° C. to 120° C. over a 2 hour period. The temperature was then held at 120° C. for 2 hours. The oven temperature was then ramped up to 200° C. over a 1 hour period and held at 200° C. for 2 hours. The temperature was then ramped up to 325° C. over a 1 hour period. Upon reaching 325° C., the temperature was held for 4 hours. The mixed metal oxide composition had a theoretical ratio of metals of Ce_{0.25}Sn_{0.25}CO_{0.50}.

The BET surface area was found to be 137 m²/g.

### Yttrium

The BET surface area of the resulting materials was measured on a Beckman Coulter, Inc., (Fullerton, Calif.) model SA3100 surface area analyzer after outgassing the samples at 110° C.

### Example 57

1 g of yttrium acetate hydrate, Y(OAc)₃*xH₂O, (Aldrich 32, 604-6) was combined with 10 ml of 2.66M aqueous ketoglutaric acid by shaking at room temperature for 1 h and was calcined at 400° C. for 5 hours using the following heat up protocol: The oven temperature was ramped up from 45° C. to 120° C. over a 4 hour period. The temperature was then held at 120° C. for 6 hours. The temperature was then ramped up from 120° C. to 400° C. over a 2 hour period. Upon reaching 400° C., the temperature was held for 5 hours.

The BET surface area was found to be 87 m²/g.

### Example 58

1 g of yttrium acetate hydrate, Y(OAc)₃*xH₂O, (Aldrich 32, 604-6) was combined with 4 ml of 3M aqueous ketoglutaric acid by shaking at room temperature for 1 h to produce a brown solution and was calcined at 400° C. for 4 hours using the following heat up protocol: The oven temperature was ramped up from 45° C. to 120° C. over a 150 minute period. The temperature was then held at 120° C. for 6 hours. The temperature was then ramped up from 120° C. to 200° C. over a 160 minute period and held at 200° C. for 2 hours. The temperature was then ramped up from 200° C. to 400° C. over a 100 minute period. Upon reaching 400° C., the temperature was held for 4 hours.

After calcination, the yield was found to be 378 mg. The BET surface area was found to be 101 m²/g.

### Example 59

1 g of yttrium acetate hydrate was combined with 2 g of ketoglutaric acid in 10 ml of water by shaking at room temperature and aged for 16 days to produce a brown oil and was calcined at 400° C. for 4 hours using the following heat up protocol: The oven temperature was ramped up from 45° C. to 120° C. over a 4 hour period. The temperature was then held at 120° C. for 4 hours. The temperature was then ramped up from 120° C. to 400° C. over a 2 hour period. Upon reaching 400° C., the temperature was held for 4 hours.

After calcination, the yield was found to be 401 mg. The BET surface area was found to be 140 m²/g.

### Example 60

1 g of yttrium acetate hydrate was combined with 10 ml of 3M ketoglutaric acid by shaking at room temperature and aged for 17 days to produce a yellow oil and was calcined at 400° C. for 4 hours using the heat up protocol from Example 59.

After calcination, the yield was found to be 401 mg. The BET surface area was found to be 150 m²/g.

### Example 61

1 g of yttrium acetate hydrate was combined with in 10 ml of 2.77M ketoglutaric acid and 10 ml water by shaking at room temperature for 1 h and was calcined at 400° C. for 5 hours using the following heat up protocol: The oven temperature was ramped up from 45° C. to 120° C. at a rate of 0.5 degrees/minute. The temperature was then held at 120° C. for 6 hours. The temperature was then ramped up from 120° C. to 200° C. at a rate of 0.5 degrees/minute. The temperature was then held at 200° C. for 2 hours. The temperature was then ramped up from 200° C. to 400° C. at a rate of 2 degrees/minute. Upon reaching 400° C., the temperature was held for 5 hours.

The BET surface area was found to be 215 m²/g.

### Example 62

1 g of yttrium acetate hydrate was combined with in 10 ml of 2.66M ketoglutaric acid by shaking at room temperature and was calcined at 400° C. for 5 hours using the same heat up protocol as in Example 61.

The BET surface area was found to be 188 m²/g.

### Examples 63-72

Multiple reactions in which a solution of yttrium acetate was mixed with solutions of tin acetate and cobalt acetate and different organic acids in various ratios are shown below with results in Table 10.

10 ml water, 100 mg Co(II) acetate, 250 mg Sn(IV) acetate and 1000 mg Y(III) acetate. were combined with the acids in an open beaker by stirring at room temperature for one hour with the metal-acid-ratios as given in Table 10.

Samples were calcined at 400° C. for 4 hours using the following heat up protocol: The oven temperature was ramped up from 55° C. to 120° C. over a 4 hour period. The temperature was then held at 120° C. for 4 hours. The temperature was then ramped up from 120° C. to 400° C. over a 1 hour period. Upon reaching 400° C., the temperature was held for 4 hours to produce a solid composition having the formula:

Y₇₀Sn₁₇Co₁₃

TABLE 10

| | | Ratio of acid | Ratio of acid | BET |
|---|---|---|---|---|
| | | (mg) to metal | (mmol) to | Surface Area |
| Example | acid | (mmol) | metal (mmol) | (m²/g) |
| 63 | Ketoglutaric | 118.2 | 0.8 | 148.8 |
| | acid | | | |
| 64 | Ketoglutaric | 236.5 | 1.6 | 145.9 |
| | acid | | | |
| 65 | Ketoglutaric | 354.7 | 2.4 | 148.8 |
| | acid | | | |
| 66 | oxalacetic | 118.2 | 0.9 | 191.1 |
| | acid | | | |
| 67 | oxalacetic | 236.5 | 1.8 | 83.7 |
| | acid | | | |
| 68 | oxalacetic | 70.9 | 0.5 | 199.8 |
| | acid | | | |
| 69 | oxalacetic | 94.6 | 0.7 | 192.2 |
| | acid | | | |
| 70 | oxalacetic | 141.9 | 1.1 | 180.9 |
| | acid | | | |
| 71 | Diglycolic | 118.2 | 0.9 | 71.0 |
| | acid | | | |
| 72 | Gloxylic | 147.8 | 1.6 | 74.6 |
| | acid | | | |

### Ruthenium

The BET surface area of the resulting materials was measured on a Beckman Coulter, Inc., (Fullerton, Calif.) model SA3100 surface area analyzer after outgassing the samples at 110° C.

### Example 73

500 mg of ruthenium (Ru(III)) acac, (Alfa 10568) was combined with 14 ml of acac (Aldrich P775-4) and 10 ml of 1.7 M ketoglutaric acid by shaking at room temperature for 1 hour and was calcined at 350° C. for 5 hours using the following heat up protocol: The oven temperature was ramped up from 45° C. to 120° C. over a 4 hour period. The temperature was then held at 120° C. for 4 hours. The temperature was then ramped up from 120° C. to 350° C. over a 1 hour period. Upon reaching 350° C., the temperature was held for 5 hours.

The BET surface area was found to be 99 m²/g.

### Example 74

500 mg of ruthenium (Ru(III)) acac, (Alfa 10568) was combined with 1 ml of formic acid (Fluka 06450) and 5 ml of water by shaking at room temperature for 1 hour and was calcined at 325° C. for 4 hours using the following heat up protocol: The oven temperature was ramped up from 45° C. to 120° C. over a 4 hour period. The temperature was then held at 120° C. for 4 hours. The temperature was then ramped up from 120° C. to 325° C. over a 1 hour period. Upon reaching 325° C., the temperature was held for 4 hours.

After calcinations, the yield was found to be 115 mg. The BET surface area was found to be 19 m²/g.

### Example 75

500 mg of ruthenium (Ru(III)) acac, (Alfa 10568) was combined with 1 ml of formic acid (Fluka 06450) and 5 ml of 3M ketoglutaric acid by shaking at room temperature for 1 hour and was calcined at 325° C. for 4 hours using the same heating protocol used in Example 74.

After calcinations, the yield was found to be 135 mg. The BET surface area was found to be 69 m²/g.

### Example 76

500 mg of ruthenium (Ru(III)) acac, (Alfa 10568) was combined with 1 ml of formic acid (Fluka 06450) andl 0 ml of water by shaking at room temperature for 1 hour and was calcined at 325° C. for 4 hours using the same heating protocol used in Example 74.

After calcinations, the yield was found to be 136 mg. The BET surface area was found to be 9 m²/g.

### Example 77

500 mg of ruthenium (Ru(III)) acac, (Alfa 10568) was combined with 1 ml of formic acid (Fluka 06450) and 10 ml of 3M ketoglutaric acid by shaking at room temperature for 1 hour and was calcined at 325° C. for 4 hours using the same heating protocol used in Example 74.

After calcinations, the yield was found to be 136 mg. The BET surface area was found to be 29 m²/g.

### Example 78

500 mg of ruthenium (Ru(III)) acac, (Alfa 10568) was combined with 10 ml of 3M ketoglutaric acid by shaking at room temperature for 1 hour and was calcined at 325° C. for 4 hours using the same heating protocol used in Example 74. After calcinations, the yield was found to be 148 mg. The BET surface area was found to be 67 m²/g.

### Examples 79-85

500 mg of RuCl₃*xH₂O (Alfa 11043) was combined with 10 ml H₂O and ketoglutaric acid in the amounts shown below in Table 11. The samples were then calcined and analyzed for surface area. Results are shown in Table 11.

Calcination was as follows: The oven temperature was ramped up from 55° C. to 120° C. over a 4 hour period. The temperature was then held at 120° C. for 4 hours. The temperature was then ramped up from 120° C. to the final temperatures shown in Table 11 over a 1 hour period. Upon reaching the final temperature, the temperature was held for 4 hours.

TABLE 11

| | Ketoglutaric acid | | | BET surface |
|---|---|---|---|---|
| Sample | (g) | Aging | Calcination | area (m²/g) |
| 79 | 2 | none | 350° C./4 hours | 105 |
| 80 | 3 | none | 350° C./4 hours | 102 |
| 81 | 4 | 1 day | 350° C./4 hours | 94 |
| 82 | 1.5 | 1 day | 325° C./4 hours | 143 |
| 83 | 2.25 | 1 day | 325° C./4 hours | 166 |
| 84 | 2.9 | 1 day | 325° C./4 hours | 161 |
| 85 | 1.9 | 1 day | 300° C./4 hours | 176 |

Pore size distribution analysis of the composition of samples 79 and 80 (derived from the adsorption branch of the isotherm) were analyzed on a Micromeretics, Inc., (Atlanta, Ga.) Micromeretics TriStar 3000. The total pore volume for sample 79 was found to be 0.326375 cm³/g. Results are shown in Table 12. The total pore volume for sample 80 was found to be 0.310695 cm³/g. Results are shown in Table 13.

TABLE 12

| Average Diameter | Incremental Pore | |
|---|---|---|
| (nm) | Volume (cm³/g) | Volume Fraction |
| 231.8 | 0.005553 | 1.70% |
| 212.1 | 0.004028 | 1.23% |
| 140.6 | 0.004525 | 1.39% |
| 112.2 | 0.003807 | 1.17% |
| 98.8 | 0.004216 | 1.29% |
| 86.9 | 0.003734 | 1.14% |
| 76.8 | 0.00356 | 1.09% |
| 68.4 | 0.003268 | 1.00% |
| 61.8 | 0.002721 | 0.83% |
| 55.4 | 0.003146 | 0.96% |
| 48.6 | 0.003833 | 1.17% |
| 42.7 | 0.003876 | 1.19% |
| 37.8 | 0.004049 | 1.24% |
| 33.7 | 0.00428 | 1.31% |
| 30.3 | 0.005337 | 1.64% |
| 27 | 0.008181 | 2.51% |
| 24 | 0.010373 | 3.18% |
| 22 | 0.007667 | 2.35% |
| 19.2 | 0.027726 | 8.50% |
| 16.7 | 0.023311 | 7.14% |
| 15.1 | 0.019162 | 5.87% |
| 13.6 | 0.026293 | 8.06% |
| 12 | 0.022822 | 6.99% |
| 10.7 | 0.018968 | 5.81% |
| 9.5 | 0.017433 | 5.34% |
| 8.4 | 0.014529 | 4.45% |
| 7.2 | 0.016149 | 4.95% |
| 6.2 | 0.011818 | 3.62% |
| 5.3 | 0.008794 | 2.69% |
| 4.7 | 0.006431 | 1.97% |
| 4.1 | 0.005238 | 1.60% |
| 3.7 | 0.004425 | 1.36% |
| 3.3 | 0.004113 | 1.26% |
| 2.9 | 0.002999 | 0.92% |
| 2.6 | 0.002925 | 0.90% |
| 2.4 | 0.00243 | 0.74% |
| 2.1 | 0.002335 | 0.72% |
| 2 | 0.000807 | 0.25% |
| 1.9 | 0.000781 | 0.24% |
| 1.8 | 0.000733 | 0.22% |

TABLE 13

| Average | Incremental Pore Volume | Volume |
|---|---|---|
| Diameter (nm) | (cm³/g) | Fraction |
| 253.2 | 0.005948 | 1.91% |
| 224.6 | 0.006048 | 1.95% |
| 199.1 | 0.004012 | 1.29% |
| 123 | 0.004526 | 1.46% |
| 98.9 | 0.003058 | 0.98% |
| 87 | 0.004577 | 1.47% |
| 77.6 | 0.002706 | 0.87% |
| 69.1 | 0.00389 | 1.25% |
| 62.1 | 0.002773 | 0.89% |
| 55.5 | 0.003656 | 1.18% |
| 48.8 | 0.003761 | 1.21% |
| 43 | 0.003961 | 1.27% |
| 38 | 0.003998 | 1.29% |
| 34.2 | 0.003806 | 1.22% |
| 30.2 | 0.006618 | 2.13% |
| 26.8 | 0.007176 | 2.31% |
| 24.5 | 0.005783 | 1.86% |
| 22 | 0.012955 | 4.17% |
| 19.3 | 0.022077 | 7.11% |
| 17.3 | 0.018103 | 5.83% |
| 15.2 | 0.033239 | 10.70% |
| 13.5 | 0.017528 | 5.64% |
| 11.9 | 0.023959 | 7.71% |
| 10.7 | 0.012398 | 3.99% |
| 9.5 | 0.016273 | 5.24% |
| 8.3 | 0.013655 | 4.39% |
| 7.2 | 0.011999 | 3.86% |
| 6.2 | 0.010267 | 3.30% |
| 5.4 | 0.007842 | 2.52% |
| 4.7 | 0.006268 | 2.02% |
| 4.2 | 0.005253 | 1.69% |
| 3.7 | 0.004834 | 1.56% |
| 3.3 | 0.003654 | 1.18% |
| 3 | 0.003035 | 0.98% |
| 2.7 | 0.003046 | 0.98% |
| 2.4 | 0.002624 | 0.84% |
| 2.2 | 0.002593 | 0.83% |
| 2 | 0.000956 | 0.31% |
| 1.9 | 0.000934 | 0.30% |
| 1.8 | 0.000906 | 0.29% |

### Cerium

The BET surface area of the resulting materials was measured on a Beckman Coulter, Inc., (Fullerton, Calif.) model SA3100 surface area analyzer or a Micromeretics, Inc., (Atlanta, Ga.) Micromeretics TriStar 3000 analyzer after outgassing the samples at 110° C.

### Example 86

5 ml of 0.5M cerium (III) nitrate was combined with 5 ml of 12.5% aqueous glyoxylic acid by stirring at room temperature and was calcined at 300° C. for 2 hours using the following heat up protocol: The oven temperature was ramped up from 55° C. to 120° C. over a 4 hour period. The temperature was then held at 120° C. for 4 hours. The temperature was then ramped up from 120° C. to 300° C. over a 1 hour period. Upon reaching 300° C., the temperature was held for 2 hours.

The BET surface area was found to be 110 m²/g. Pore size distribution analysis of the composition (derived from the adsorption branch of the isotherm) were analyzed on a Micromeretics, Inc., (Atlanta, Ga.) Micromeretics TriStar 3000. The total pore volume was found to be 0.114542 cm³/g. Results are shown in Table 14.

TABLE 14

| | | Pore |
|---|---|---|
| Average Pore | Incremental Pore Volume | Volume |
| Diameter (nm) | (cm³/g) | Fraction |
| 255 | 0.004751 | 4.15% |
| 150.8 | 0.002598 | 2.27% |
| 117.5 | 0.002914 | 2.54% |
| 106 | 0.002098 | 1.83% |
| 94.9 | 0.002467 | 2.15% |
| 84 | 0.002374 | 2.07% |
| 75.1 | 0.002194 | 1.92% |
| 68.4 | 0.001646 | 1.44% |
| 61.6 | 0.002049 | 1.79% |
| 55.2 | 0.001949 | 1.70% |
| 49 | 0.002015 | 1.76% |
| 43.3 | 0.001978 | 1.73% |
| 38.6 | 0.001743 | 1.52% |
| 34.4 | 0.001662 | 1.45% |
| 30.8 | 0.00148 | 1.29% |
| 27.4 | 0.001624 | 1.42% |
| 24.3 | 0.001548 | 1.35% |
| 21.8 | 0.001392 | 1.22% |
| 19.3 | 0.001699 | 1.48% |
| 17 | 0.001512 | 1.32% |
| 15.2 | 0.001412 | 1.23% |
| 13.5 | 0.001607 | 1.40% |
| 12 | 0.001438 | 1.26% |
| 10.8 | 0.001464 | 1.28% |
| 9.5 | 0.002005 | 1.75% |
| 8.4 | 0.002028 | 1.77% |
| 7.3 | 0.002645 | 2.31% |
| 6.3 | 0.003362 | 2.94% |
| 5.5 | 0.003661 | 3.20% |
| 4.8 | 0.004008 | 3.50% |
| 4.3 | 0.004458 | 3.89% |
| 3.8 | 0.004899 | 4.28% |
| 3.4 | 0.0054 | 4.71% |
| 3.1 | 0.005868 | 5.12% |
| 2.8 | 0.00574 | 5.01% |
| 2.6 | 0.006395 | 5.58% |
| 2.3 | 0.007284 | 6.36% |
| 2.2 | 0.002957 | 2.58% |
| 2.1 | 0.003069 | 2.68% |
| 2 | 0.003148 | 2.75% |

### Example 87

Cerium oxalate powder was calcined at 355° C. for 90 minutes using the following heat up protocol: The oven temperature was ramped up from 55° C. to 120° C. over a 4 hour period. The temperature was then held at 120° C. for 4 hours. The temperature was then ramped up from 120° C. to 355° C. over a 1 hour period. Upon reaching 355° C., the temperature was held for 90 minutes.

The BET surface area was found to be 131 m²/g. Pore size distribution analysis of the composition (derived from the adsorption branch of the isotherm) were analyzed on a Micromeretics, Inc., (Atlanta, Ga.) Micromeretics TriStar 3000. The total pore volume was found to be 0.091241 cm³/g. Results are shown in Table 15.

TABLE 15

| Average Pore Diameter | Incremental Pore | Pore Volume |
|---|---|---|
| (nm) | Volume (cm³/g) | Fraction |
| 205 | 0.001806 | 1.98% |
| 169.2 | 0.001553 | 1.70% |
| 153.3 | 0.000864 | 0.95% |
| 136.5 | 0.001309 | 1.43% |
| 122.4 | 0.000778 | 0.85% |
| 108.9 | 0.001135 | 1.24% |
| 97.6 | 0.000809 | 0.89% |
| 86.9 | 0.001074 | 1.18% |
| 77 | 0.000973 | 1.07% |
| 69.4 | 0.000856 | 0.94% |
| 62.8 | 0.000809 | 0.89% |
| 56.2 | 0.001042 | 1.14% |
| 49.9 | 0.001042 | 1.14% |
| 44 | 0.001173 | 1.29% |
| 39 | 0.001054 | 1.16% |
| 34.7 | 0.001176 | 1.29% |
| 31.1 | 0.001062 | 1.16% |
| 28 | 0.001145 | 1.25% |
| 24.9 | 0.001335 | 1.46% |
| 22.2 | 0.001278 | 1.40% |
| 19.6 | 0.001633 | 1.79% |
| 17.1 | 0.001615 | 1.77% |
| 15.2 | 0.001463 | 1.60% |
| 13.5 | 0.001708 | 1.87% |
| 12 | 0.001639 | 1.80% |
| 10.8 | 0.001658 | 1.82% |
| 9.5 | 0.00227 | 2.49% |
| 8.4 | 0.002247 | 2.46% |
| 7.3 | 0.002892 | 3.17% |
| 6.3 | 0.003476 | 3.81% |
| 5.5 | 0.003497 | 3.83% |
| 4.8 | 0.003584 | 3.93% |
| 4.3 | 0.003742 | 4.10% |
| 3.8 | 0.003854 | 4.22% |
| 3.5 | 0.004081 | 4.47% |
| 3.1 | 0.004459 | 4.89% |
| 2.8 | 0.004598 | 5.04% |
| 2.6 | 0.005933 | 6.50% |
| 2.3 | 0.005372 | 5.89% |
| 2.2 | 0.002812 | 3.08% |
| 2.1 | 0.00308 | 3.38% |
| 2 | 0.003357 | 3.68% |

### Example 87

1 g of cerium (III) acetate was combined with 10 ml of water and 500 mg of ketoglutaric acid by stirring at room temperature for 1 hour and was calcined at 280° C. for 2 hours using the following heat up protocol: The oven temperature was ramped up from 55° C. to 120° C. over a 4 hour period. The temperature was then held at 120° C. for 4 hours. The temperature was then ramped up from 120° C. to 280° C. over a 1 hour period. Upon reaching 280° C., the temperature was held for 2 hours.

The BET surface area was found to be 161 m²/g. Pore size distribution analysis of the composition (derived from the adsorption branch of the isotherm) were analyzed on a Micromeretics, Inc., (Atlanta, Ga.) Micromeretics TriStar 3000. The total pore volume was found to be 0.226443 cm³/g. Results are shown in Table 16.

TABLE 16

| Average Pore Diameter | Incremental Pore | Pore Volume |
|---|---|---|
| (nm) | Volume (cm³/g) | Fraction |
| 269.8 | 0.006048 | 2.67% |
| 239.6 | 0.004267 | 1.88% |
| 153.7 | 0.002354 | 1.04% |
| 124 | 0.001833 | 0.81% |
| 110 | 0.002452 | 1.08% |
| 96.8 | 0.002586 | 1.14% |
| 85.4 | 0.002664 | 1.18% |
| 75.8 | 0.002425 | 1.07% |
| 68.7 | 0.002035 | 0.90% |
| 62.4 | 0.002211 | 0.98% |
| 55.3 | 0.003198 | 1.41% |
| 49.1 | 0.002922 | 1.29% |
| 43 | 0.004008 | 1.77% |
| 37.9 | 0.003794 | 1.68% |
| 33.9 | 0.003781 | 1.67% |
| 30.3 | 0.004179 | 1.85% |
| 27.2 | 0.004544 | 2.01% |
| 24.3 | 0.005591 | 2.47% |
| 21.6 | 0.006613 | 2.92% |
| 19 | 0.008803 | 3.89% |
| 16.8 | 0.008151 | 3.60% |
| 15 | 0.007979 | 3.52% |
| 13.3 | 0.009331 | 4.12% |
| 11.9 | 0.008978 | 3.96% |
| 10.7 | 0.008289 | 3.66% |
| 9.6 | 0.008905 | 3.93% |
| 8.5 | 0.010926 | 4.83% |
| 7.4 | 0.011382 | 5.03% |
| 6.4 | 0.010824 | 4.78% |
| 5.5 | 0.008751 | 3.86% |
| 4.9 | 0.007676 | 3.39% |
| 4.3 | 0.006842 | 3.02% |
| 3.8 | 0.006769 | 2.99% |
| 3.4 | 0.005611 | 2.48% |
| 3.1 | 0.005403 | 2.39% |
| 2.8 | 0.004534 | 2.00% |
| 2.6 | 0.005463 | 2.41% |
| 2.3 | 0.006272 | 2.77% |
| 2.2 | 0.002514 | 1.11% |
| 2.1 | 0.002684 | 1.19% |
| 2 | 0.002849 | 1.26% |

### Example 88

21 ml of 2M tetramethylammonium hydroxide (NMe₄OH) was added to a 0.2M cerium (IV) nitrate (Ce(NO₃)₄) solution until the pH reached 0.96. The precipitation was carried out by simultaneous addition of this 0.2M Ce(NO3)4 solution (pH 0.96) and 2M tetramethylammonium hydroxide solution at pH 7.4 at 60 C within 2 h. The precipitate was aged overnight at 80° C. until the pH reached 6.4. The precipitate was isolated by centrifugation and washed twice. The precipitate was then calcined at 300° C. for 2 hours.

The BET surface area was found to be 167 m²/g.

### Example 89

0.2 M of (NH₄)₂Ce(NO₃)₆ was dissolved in 50 ml of water. 23 ml of 12.5% tetramethylammonium carbonate solution was added to the mixture to bring the pH to 1.5. This mixture was added simultaneously with 12.5% tetramethylammonium carbonate solution to a beaker under pH control at 60° C. within 2 hours. After precipitation, the pH was 9.3 The precipitate was aged at 80° C. overnight and the precipitate was centrifuged and washed twice. The precipitate was then calcined at 300° C. for 2 hours.

The BET surface area was found to be 146 m²/g.

### Example 90

120 mL of a 1 M aqueous solution of NMe₄OH was added to 270 ml of an aqueous solution of NMe₄OH (0.44 M) and Ce(NO₃)₄ (0.11 M) (pH 0.98) drop wise to 200 mL of nanopure water stirred at 60° C. The dropping speed was adjusted to maintain a pH of 7-7.5. The mixture was stirred for 2 hours at 60° C. and at 80° C. over night. The precipitate was isolated by centrifugation and washed two times with water and then dried and calcined according to the temperature ramp shown in Table 17. The composition had a BET surface area of 188 m²/g.

TABLE 17

| Temperature [° C.] | Duration/Rate |
|---|---|
| 25 → 110 | 1° C./min |
| 110 | 10 h |
| 110 → 300 | 5° C./min |
| 300 | 2 h |

### Example 91

Ce(NO₃)₄ solution (1.5 N) was purchased (Alfa Aesar) and used as received. NaOH solution (50 wt %) was purchased (VWR) and used as received. NH₄OH solution (28 wt % NH₃) was purchased (Aldrich) and used as received.

In an ice bath, Ce(NO₃)₄ solution (300 mL, 1.5M) was placed in a beaker with a magnetic stir bar. To this solution, NH₄OH (175 mL, 28 wt % NH₃ in H₂O) was added dropwise with stirring over the course of 15 minutes. The solution lightened from dark orange to yellow over the course of the addition and some precipitate formed. After the addition was complete, the solution was allowed to warm to room temperature while stirring at which point the solution was homogeneous. The resulting solution was diluted to 900 mL with deionized water to afford a Ce concentration of 0.5 M.

In a plastic beaker NaOH solution (50 wt %) was diluted to 2.0 M concentration using deionized water.

In a 75 mL Teflon vial equipped with a magnetic stir bar was placed 7 mL of the prepared Ce(NO₃)₄ solution and 15 mL deionized water. A pH probe and thermocouple were added and the solution was heated to 85° C. The starting pH of this mixture was 1.17. Over the course of approximately 17 minutes, 24.9 mL of 2M NaOH solution was added at a constant rate of 1.5 mL/min. The titration went through 2 endpoints, the first a pH ca. 4.5 and the second at pH ca. 9. The maximum pH was 9.64 reached after 7 minutes and the final pH after completion of the addition was 9.16. The sample was aged with stirring at 85° C. for 16 hours at which time the stirring was stopped and the mixture was cooled. The light yellow slurry was subjected to 9 cycles of centrifugation followed by decantation of the supernatant and resuspension of the solid in deionized water.

Following this, the sample was dried overnight at 85° C. The sample was then crushed affording 610 mg of a chalky, light yellow powder. The sample was calcined at 300° C. for 2 hours using the following temperature program: The oven temperature was ramped from 55° C. to 120° C. over a 4 hour period. The temperature was then held at 120° C. for 4 hours. The temperature was then ramped from 120° C. to 300° C. over a 1 hour period. Upon reaching 300° C., the temperature was held for 2 hours and then cooled to 110° C. The BET surface area of the resulting material was measured using a Micromeretics, Inc. (Atlanta, Ga.) Micromeretics TriStar 3000 analyzer after outgassing the samples at 1110° C. The surface area of the sample was found to be 300.9 m²/g.

### Cerium/Cobalt/Ruthenium/Yttrium

The BET surface area of the resulting materials was measured on a Beckman Coulter, Inc., (Fullerton, Calif.) model SA3100 surface area analyzer or a Micromeretics, Inc., (Atlanta, Ga.) Micromeretics TriStar 3000 analyzer after outgassing the samples at 110° C.

### Examples 92-98

Multiple reactions in which yttrium nitrate (Y(NO₃)₃) was mixed with Ce nitrate (Ce(NO₃)₃) and cobalt nitrate (Co(NO₃)₂) and Ruthenium nitrosyl nitrate (Ru(NO)(NO₃)₃) precursors and glyoxylic acid in various ratios are shown below with results in Table 18. The samples were calcined using the following protocol: The oven temperature was ramped up from 60° C. to 120° C. over a 2 hour period. The temperature was then held at 120° C. for 2 hours. The temperature was then ramped up from 120° C. to 200° C. over a 1 hour period. The temperature was then held at 200° C. for 2 hours. The temperature was then ramped up from 200° C. to 350° C. over a 1 hour period. Upon reaching 350° C., the temperature was held for 4 hours.

TABLE 18

| | Glyoxylic | Ce(NO₃)₃ | Co(NO₃)₂ | Y(NO₃)₃ | | | BET |
|---|---|---|---|---|---|---|---|
| | acid 50% | 1.5M | 1M | 2M | Ru(NO)(NO₃)₃ | Composition by | SA |
| sample | [ml] | [ml] | [ml] | [ml] | 7% [ml] | weight | [m²/g] |
| 92 | 10 | 2.38 | 7.64 | 0 | 0.713 | Ce_{0.5}Co_{0.45}Ru_{0.05} | 71 |
| 93 | 10 | 1.98 | 7.64 | 0.468 | 0.713 | Ce_{0.42}Y_{0.08}Co_{0.45}Ru_{0.05} | 89 |
| 94 | 10 | 1.59 | 7.64 | 0.937 | 0.713 | Ce_{0.33}Y_{0.17}Co_{0.45}Ru_{0.05} | 86 |
| 95 | 10 | 1.19 | 7.64 | 1.406 | 0.713 | Ce_{0.25}Y_{0.25}Co_{0.45}Ru_{0.05} | 67 |
| 96 | 10 | 0.79 | 7.64 | 1.874 | 0.713 | Ce_{0.17}Y_{0.33}Co_{0.45}Ru_{0.05} | 68 |
| 97 | 10 | 0.40 | 7.64 | 2.343 | 0.713 | Ce_{0.08}Y_{0.42}Co_{0.45}Ru_{0.05} | 71 |
| 98 | 10 | 0 | 7.64 | 2.812 | 0.713 | Y_{0.5}Co_{0.45}Ru_{0.05} | 58 |

### Molybdenum

The BET surface area of the resulting materials was measured on a Beckman Coulter, Inc., (Fullerton, Calif.) model SA3100 surface area analyzer or a Micromeretics, Inc., (Atlanta, Ga.) Micromeretics TriStar 3000 analyzer after outgassing the samples at 110° C.

### Example 99

966.5 mg of Mo(II) acetate dimer (Alfa 18239) was combined with 10 ml of water and 2910 μl of 50 wt % aqueous glyoxylic acid in water, by stirring at room temperature for 30 minutes. The resulting slurry was calcined at 300° C. for 4.5 hours using the following heat up protocol: The oven temperature was ramped up from 55° C. to 120° C. over a 4 hour period. The temperature was then held at 120° C. for 4 hours. The temperature was then ramped up from 120° C. to 300° C. over a 1 hour period. Upon reaching 300° C., the temperature was held for 4.5 hours.

The BET surface area was found to be 23.9 m²/g.

### Example 100

650 mg of MoO₃ (Alfa 36687) was combined with 1566 mg of oxalic acid and 10 ml of water by stirring at room temperature for 30 minutes. The resulting slurry was calcined at 300° C. for 2 hours using the following heat up protocol: The oven temperature was ramped up from 55° C. to 120° C. over a 4 hour period. The temperature was then held at 120° C. for 4 hours. The temperature was then ramped up from 120° C. to 300° C. over a 1 hour period. Upon reaching 300° C., the temperature was held for 2 hours.

The BET surface area was found to be 23.2 m²/g.

### Example 101

192 mg of NH₄VO₃ (Alfa 36213) and 551 mg of MoO₃ (Alfa 36687) were combined with 1723 mg of oxalic acid and 10 ml of water by stirring at 100 C for 1 hour. The resulting solution was calcined at 280° C. for 2.5 hours using the following heat up protocol: The oven temperature was ramped up from 55° C. to 120° C. over a 4 hour period. The temperature was then held at 120° C. for 4 hours. The temperature was then ramped up from 120° C. to 280° C. over a 1 hour period. Upon reaching 280° C., the temperature was held for 2.5 hours.

The BET surface area was found to be 36.5 m²/g.

### Example 102

192 mg of NH₄VO₃ (Alfa 36213) and 551 mg of MoO₃ (Alfa 36687) were combined with 1723 mg of oxalic acid and 10 ml of water by stirring at room temperature for 30 minutes. The resulting slurry was calcined at 300° C. for 2 hours in air using the following heat up protocol: The oven temperature was ramped up from 55° C. to 120° C. over a 4 hour period. The temperature was then held at 120° C. for 4 hours. The temperature was then ramped up from 120° C. to 300° C. over a 1 hour period. Upon reaching 300° C., the temperature was held for 2 hours.

The BET surface area was found to be 34.2 m²/g.

### Examples 103-108

Molybdenum materials were made as discussed below in Examples 103-108. Pore size distribution analysis of the compositions (derived from the adsorption branch of the isotherm) was analyzed on a Micromeretics, Inc., (Atlanta, Ga.) Micromeretics TriStar 3000. Results are shown in Tables 19-24.

### Example 103

650 mg of MoO₃ was combined with oxalic acid so that the ratio of acid in mmol to metal in mmol was 3. The mixture was then calcined using the following protocol: The oven temperature was ramped up from 55° C. to 120° C. over a 4 hour period. The temperature was then held at 120° C. for 4 hours. The oven temperature was then ramped up from 120° C. to 300° C. over a 1 hour period and held at 300° C. for 3 hours.

The BET surface area was found to be 22.4 m²/g. The total pore volume was found to be 0.195599 cm³/g. The pore distribution data is shown below in Table 19.

TABLE 19

| AVERAGE | INCREMENTAL PORE | % VOLUME |
|---|---|---|
| DIAMETER (nm) | VOLUME (cm³/g) | FRACTION |
| 206.66 | 0.003102 | 1.585897678 |
| 136.72 | 0.003853 | 1.969846472 |
| 113.89 | 0.009183 | 4.694809278 |
| 109.11 | 0.009355 | 4.782744288 |
| 101.32 | 0.014323 | 7.322634574 |
| 92.44 | 0.019911 | 10.1794999 |
| 84.99 | 0.015476 | 7.91210589 |
| 79.16 | 0.010672 | 5.456060614 |
| 71.07 | 0.027865 | 14.24598285 |
| 63.71 | 0.016892 | 8.636035972 |
| 58.01 | 0.013387 | 6.84410452 |
| 53.47 | 0.006797 | 3.474966641 |
| 49.39 | 0.006634 | 3.391632882 |
| 45.15 | 0.005746 | 2.93764283 |
| 40.83 | 0.004577 | 2.339991513 |
| 36.72 | 0.003732 | 1.907985215 |
| 33.23 | 0.003097 | 1.583341428 |
| 30.07 | 0.002457 | 1.256141391 |
| 27.15 | 0.002034 | 1.039882617 |
| 24.29 | 0.001802 | 0.921272604 |
| 21.67 | 0.001437 | 0.734666333 |
| 19.13 | 0.001432 | 0.732110082 |
| 16.92 | 0.001075 | 0.549593812 |
| 15.10 | 0.008490 | 4.340512988 |
| 13.40 | 0.000825 | 0.421781297 |
| 11.91 | 0.000629 | 0.321576286 |
| 10.68 | 0.000530 | 0.27096253 |
| 9.42 | 0.000593 | 0.303171284 |
| 8.29 | 0.000493 | 0.252046278 |
| 7.22 | 0.000564 | 0.288345032 |
| 6.19 | 0.000665 | 0.339981288 |
| 5.34 | 0.000571 | 0.291923783 |
| 4.67 | 0.000414 | 0.211657524 |
| 4.12 | 0.000276 | 0.141105016 |
| 3.67 | 0.000203 | 0.103783762 |
| 3.28 | 0.000209 | 0.106851262 |
| 2.94 | 0.000294 | 0.150307517 |
| 2.64 | 0.000644 | 0.329245037 |
| 2.36 | 0.001317 | 0.673316326 |
| 2.12 | 0.001291 | 0.660023824 |
| 1.97 | 0.000272 | 0.139060016 |
| 1.88 | 0.000121 | 0.061861257 |

### Example 104

650 mg of MoO₃ was combined with oxalic acid so that the ratio of acid in mmol to metal in mmol was 2.5. The mixture was then calcined using the following protocol: The oven temperature was ramped up from 55° C. to 120° C. over a 4 hour period. The temperature was then held at 120° C. for 4 hours. The oven temperature was then ramped up from 120° C. to 300° C. over a 1 hour period and held at 300° C. for 3 hours.

The BET surface area was found to be 22.5 m²/g. The total pore volume was found to be 0.192489 cm³/g. The pore distribution data is shown below in Table 20.

TABLE 20

| AVERAGE | INCREMENTAL | |
|---|---|---|
| DIAMETER | PORE VOLUME | |
| (nm) | (cm³/g) | % VOLUME FRACTION |
| 229.69 | 0.004589 | 2.384032334 |
| 219.16 | 0.003286 | 1.707110536 |
| 133.79 | 0.004620 | 2.400137151 |
| 108.85 | 0.011480 | 5.963977162 |
| 101.25 | 0.017621 | 9.154289336 |
| 92.94 | 0.012143 | 6.308412429 |
| 85.85 | 0.012628 | 6.560374879 |
| 77.55 | 0.026396 | 13.71299139 |
| 69.82 | 0.020358 | 10.57618877 |
| 65.04 | 0.008348 | 4.336871198 |
| 61.46 | 0.009904 | 5.145229078 |
| 57.54 | 0.009392 | 4.879239853 |
| 50.44 | 0.014679 | 7.625890311 |
| 44.42 | 0.005470 | 2.841720826 |
| 40.43 | 0.004501 | 2.338315436 |
| 37.01 | 0.003680 | 1.911797557 |
| 33.64 | 0.002952 | 1.533594127 |
| 30.23 | 0.002481 | 1.288904821 |
| 27.14 | 0.002175 | 1.129934698 |
| 24.31 | 0.001826 | 0.948625636 |
| 21.70 | 0.001491 | 0.774589717 |
| 19.19 | 0.001412 | 0.733548411 |
| 16.97 | 0.001040 | 0.540290614 |
| 15.13 | 0.000849 | 0.441064165 |
| 13.42 | 0.000825 | 0.42859592 |
| 11.93 | 0.000634 | 0.32936947 |
| 10.70 | 0.000501 | 0.260274613 |
| 9.45 | 0.000553 | 0.287289144 |
| 8.31 | 0.000459 | 0.238455184 |
| 7.24 | 0.000530 | 0.275340409 |
| 6.20 | 0.000600 | 0.311706123 |
| 5.35 | 0.000515 | 0.267547756 |
| 4.68 | 0.000368 | 0.191179756 |
| 4.13 | 0.000218 | 0.113253225 |
| 3.68 | 0.000148 | 0.07688751 |
| 3.29 | 0.000148 | 0.07688751 |
| 2.96 | 0.000238 | 0.123643429 |
| 2.65 | 0.000570 | 0.296120817 |
| 2.38 | 0.001242 | 0.645231676 |
| 2.13 | 0.001261 | 0.655102369 |
| 1.99 | 0.000258 | 0.134033633 |
| 1.89 | 0.000103 | 0.053509551 |

### Example 105

650 mg of MoO₃ was combined with oxalic acid so that the ratio of acid in mmol to metal in mmol was 2.0. The mixture was then calcined using the following protocol: The oven temperature was ramped up from 55° C. to 120° C. over a 4 hour period. The temperature was then held at 120° C. for 4 hours. The oven temperature was then ramped up from 120° C. to 300° C. over a 1 hour period and held at 300° C. for 3 hours.

The BET surface area was found to be 20.5 m²/g. The total pore volume was found to be 0.169133 cm³/g. The pore distribution data is shown below in Table 21.

TABLE 21

| AVERAGE | INCREMENTAL PORE | % VOLUME |
|---|---|---|
| DIAMETER (nm) | VOLUME (cm³/g) | FRACTION |
| 230.20 | 0.005722 | 3.383136348 |
| 213.91 | 0.004115 | 2.432996518 |
| 115.70 | 0.005822 | 3.442261416 |
| 92.51 | 0.015182 | 8.976367711 |
| 85.19 | 0.015734 | 9.302738082 |
| 77.23 | 0.024623 | 14.55836531 |
| 70.11 | 0.016806 | 9.936558803 |
| 65.67 | 0.009830 | 5.811994111 |
| 61.88 | 0.009839 | 5.817315367 |
| 57.79 | 0.010414 | 6.157284504 |
| 52.84 | 0.009840 | 5.817906618 |
| 45.59 | 0.011418 | 6.750900179 |
| 40.41 | 0.004421 | 2.613919223 |
| 36.83 | 0.003462 | 2.046909828 |
| 33.40 | 0.002847 | 1.683290665 |
| 30.29 | 0.002327 | 1.375840315 |
| 27.31 | 0.001979 | 1.170085081 |
| 24.42 | 0.001779 | 1.051834946 |
| 21.83 | 0.001415 | 0.836619702 |
| 19.31 | 0.001375 | 0.812969675 |
| 17.06 | 0.001018 | 0.601893185 |
| 15.22 | 0.000806 | 0.476548042 |
| 13.50 | 0.000781 | 0.461766775 |
| 12.00 | 0.000605 | 0.357706657 |
| 10.76 | 0.000482 | 0.284982824 |
| 9.51 | 0.000524 | 0.309815352 |
| 8.37 | 0.000431 | 0.25482904 |
| 7.30 | 0.000505 | 0.29858159 |
| 6.26 | 0.000549 | 0.324596619 |
| 5.40 | 0.000447 | 0.264289051 |
| 4.73 | 0.000305 | 0.180331455 |
| 4.19 | 0.000163 | 0.09637386 |
| 3.73 | 0.000086 | 0.050847558 |
| 3.34 | 0.000083 | 0.049073806 |
| 3.01 | 0.000175 | 0.103468868 |
| 2.70 | 0.000505 | 0.29858159 |
| 2.43 | 0.001165 | 0.688807034 |
| 2.19 | 0.001224 | 0.723690823 |
| 2.04 | 0.000240 | 0.141900161 |
| 1.94 | 0.000091 | 0.053803811 |

### Example 106

650 mg of MoO₃ was combined with oxalic acid so that the ratio of acid in mmol to metal in mmol was 2.0. The mixture was then calcined using the following protocol: The oven temperature was ramped up from 55° C. to 120° C. over a 4 hour period. The temperature was then held at 120° C. for 4 hours. The oven temperature was then ramped up from 120° C. to 300° C. over a 1 hour period and held at 300° C. for 2 hours.

The BET surface area was found to be 21.6 m²/g. The total pore volume was found to be 0.194597 cm³/g. The pore distribution data is shown below in Table 22.

TABLE 22

| AVERAGE | | |
|---|---|---|
| DIAMETER | INCREMENTAL PORE | % VOLUME |
| (nm) | VOLUME (cm³/g) | FRACTION |
| 165.50 | 0.023903 | 12.28333428 |
| 128.52 | 0.016308 | 8.380396409 |
| 119.63 | 0.006825 | 3.507248313 |
| 114.32 | 0.013858 | 7.121384194 |
| 103.32 | 0.024790 | 12.73914809 |
| 92.68 | 0.018441 | 9.47650786 |
| 84.59 | 0.015271 | 7.847500218 |
| 78.57 | 0.007891 | 4.055047097 |
| 70.04 | 0.016230 | 8.340313571 |
| 64.05 | 0.004666 | 2.397775916 |
| 60.45 | 0.004618 | 2.373109555 |
| 56.07 | 0.004707 | 2.4188451 |
| 51.08 | 0.004678 | 2.403942507 |
| 45.83 | 0.004280 | 2.199417257 |
| 41.33 | 0.003663 | 1.882351732 |
| 37.21 | 0.002991 | 1.537022667 |
| 33.41 | 0.002561 | 1.316053177 |
| 30.03 | 0.002157 | 1.108444632 |
| 27.07 | 0.001844 | 0.947599398 |
| 24.30 | 0.001558 | 0.800628992 |
| 21.66 | 0.001377 | 0.707616253 |
| 19.18 | 0.001287 | 0.661366825 |
| 16.96 | 0.001019 | 0.523646305 |
| 15.13 | 0.000838 | 0.430633566 |
| 13.45 | 0.000789 | 0.405453321 |
| 11.97 | 0.000622 | 0.319634938 |
| 10.74 | 0.000515 | 0.264649506 |
| 9.50 | 0.000556 | 0.28571869 |
| 8.37 | 0.000463 | 0.237927615 |
| 7.30 | 0.000536 | 0.27544104 |
| 6.27 | 0.000608 | 0.312440582 |
| 5.42 | 0.000493 | 0.253344091 |
| 4.75 | 0.000316 | 0.162386882 |
| 4.21 | 0.000166 | 0.085304501 |
| 3.76 | 0.000085 | 0.043680016 |
| 3.37 | 0.000082 | 0.042138368 |
| 3.04 | 0.000184 | 0.094554387 |
| 2.73 | 0.000564 | 0.289829751 |
| 2.45 | 0.001322 | 0.679352714 |
| 2.21 | 0.001236 | 0.635158815 |
| 2.07 | 0.000232 | 0.119220749 |
| 1.98 | 0.000067 | 0.03443013 |

### Example 107

650 mg of MoO₃ was combined with oxalic acid so that the ratio of acid in mmol to metal in mmol was 3.0. The mixture was then calcined using the following protocol: The oven temperature was ramped up from 55° C. to 120° C. over a 4 hour period. The temperature was then held at 120° C. for 4 hours. The oven temperature was then ramped up from 120° C. to 300° C. over a 1 hour period and held at 300° C. for 2 hours.

The BET surface area was found to be 19.4 m²/g. The total pore volume was found to be 0.154624 cm³/g. The pore distribution data is shown below in Table 23

TABLE 23

| AVERAGE | | |
|---|---|---|
| DIAMETER | INCREMENTAL PORE | % VOLUME |
| (nm) | VOLUME (cm³/g) | FRACTION |
| 168.18 | 0.016465 | 10.64841163 |
| 129.58 | 0.024762 | 16.01433154 |
| 117.55 | 0.012863 | 8.318889694 |
| 106.52 | 0.019732 | 12.76127897 |
| 98.08 | 0.006584 | 4.258071192 |
| 93.55 | 0.006751 | 4.366075124 |
| 88.18 | 0.006823 | 4.412639694 |
| 82.80 | 0.007118 | 4.603425083 |
| 76.52 | 0.007201 | 4.657103684 |
| 69.87 | 0.005977 | 3.865506002 |
| 63.86 | 0.005087 | 3.289916184 |
| 58.03 | 0.004543 | 2.938094992 |
| 52.30 | 0.004013 | 2.595328022 |
| 46.98 | 0.003476 | 2.24803394 |
| 42.24 | 0.002921 | 1.889098717 |
| 37.94 | 0.002416 | 1.5625 |
| 34.04 | 0.002046 | 1.323209851 |
| 30.59 | 0.001698 | 1.098147765 |
| 27.57 | 0.001451 | 0.938405422 |
| 24.66 | 0.001380 | 0.892487583 |
| 22.07 | 0.001098 | 0.710109685 |
| 19.50 | 0.001142 | 0.738565811 |
| 17.21 | 0.000913 | 0.590464611 |
| 15.37 | 0.000723 | 0.467585886 |
| 13.64 | 0.000714 | 0.461765315 |
| 12.14 | 0.000556 | 0.359581954 |
| 10.90 | 0.000456 | 0.29490894 |
| 9.64 | 0.000524 | 0.338886589 |
| 8.50 | 0.000416 | 0.269039735 |
| 7.43 | 0.000464 | 0.300082781 |
| 6.39 | 0.000509 | 0.329185637 |
| 5.54 | 0.000399 | 0.258045323 |
| 4.86 | 0.000254 | 0.164269454 |
| 4.32 | 0.000120 | 0.077607616 |
| 3.86 | 0.000052 | 0.033629967 |
| 3.48 | 0.000044 | 0.028456126 |
| 3.14 | 0.000123 | 0.079547806 |
| 2.84 | 0.000418 | 0.270333195 |
| 2.57 | 0.001056 | 0.68294702 |
| 2.32 | 0.001090 | 0.704935844 |
| 2.17 | 0.000198 | 0.128052566 |
| 2.08 | 0.000047 | 0.030396316 |

### Example 108

650 mg of MoO₃ was combined with oxalic acid so that the ratio of acid in mmol to metal in mmol was 2.75. The mixture was then calcined using the following protocol: The oven temperature was ramped up from 55° C. to 120° C. over a 4 hour period. The temperature was then held at 120° C. for 4 hours. The oven temperature was then ramped up from 120° C. to 300° C. over a 1 hour period and held at 300° C. for 2 hours.

The BET surface area was found to be 23.2 m²/g. The total pore volume was found to be 0.179588 cm³/g. The pore distribution data is shown below in Table 24.

TABLE 24

| AVERAGE | | |
|---|---|---|
| DIAMETER | INCREMENTAL PORE | % VOLUME |
| (nm) | VOLUME (cm³/g) | FRACTION |
| 148.89 | 0.005470 | 3.045860525 |
| 118.31 | 0.014225 | 7.920907856 |
| 110.25 | 0.007270 | 4.048154665 |
| 103.62 | 0.014864 | 8.276722275 |
| 93.76 | 0.023009 | 12.81210326 |
| 83.11 | 0.023923 | 13.32104595 |
| 75.35 | 0.016336 | 9.09637615 |
| 69.77 | 0.008388 | 4.670690692 |
| 65.20 | 0.009208 | 5.127291356 |
| 60.53 | 0.008545 | 4.758113014 |
| 55.31 | 0.007109 | 3.958505023 |
| 50.22 | 0.006190 | 3.446778181 |
| 45.71 | 0.005220 | 2.906653006 |
| 41.42 | 0.004227 | 2.353720739 |
| 37.36 | 0.003512 | 1.955587233 |
| 33.66 | 0.002980 | 1.659353632 |
| 30.33 | 0.002526 | 1.406552776 |
| 27.29 | 0.002148 | 1.196071007 |
| 24.46 | 0.001856 | 1.033476624 |
| 21.87 | 0.001544 | 0.85974564 |
| 19.34 | 0.001533 | 0.853620509 |
| 17.10 | 0.001120 | 0.623649687 |
| 15.27 | 0.000885 | 0.492794619 |
| 13.56 | 0.000841 | 0.468294095 |
| 12.06 | 0.000645 | 0.3591554 |
| 10.82 | 0.000521 | 0.29010847 |
| 9.58 | 0.000541 | 0.301245072 |
| 8.44 | 0.000412 | 0.229413992 |
| 7.37 | 0.000464 | 0.258369156 |
| 6.33 | 0.000488 | 0.271733078 |
| 5.47 | 0.000370 | 0.206027129 |
| 4.80 | 0.000179 | 0.099672584 |
| 4.26 | 0.000017 | 0.009466111 |
| 3.09 | 0.000009 | 0.005011471 |
| 2.79 | 0.000378 | 0.210481769 |
| 2.52 | 0.001199 | 0.667639263 |
| 2.27 | 0.001243 | 0.692139787 |
| 2.12 | 0.000191 | 0.106354545 |
| 20.30 | 0.000005 | 0.00278415 |

### Vanadium

The BET surface area of the resulting materials was measured on a Beckman Coulter, Inc., (Fullerton, Calif.) model SA3100 surface area analyzer or a Micromeretics, Inc., (Atlanta, Ga.) Micromeretics TriStar 3000 analyzer after outgassing the samples at 110° C.

### Example 109

700 mg of NH₄VO₃ (Alfa 36213) was dissolved in 4.407 ml of 50 weight % aqueous glyoxylic acid and 10 ml of water by stirring at room temperature for 30 minutes. The color changed from yellow to blue within about 15 minutes and the reduction from V(V) to V(IV) was accompanied by gas evolution (bubble formation was observed). This V precursor can be calcined to produce vanadia materials having high surface areas.

### Example 110

700 mg of NH₄VO₃ (Alfa 36213) was combined with oxalic acid so that the ratio of acid in mmol to metal in mmol was 2.5 by stirring at room temperature. The resulting solution was calcined at 280° C. for 2.5 hours in air using the following heat up protocol: The oven temperature was ramped up from 55° C. to 120° C. over a 4 hour period. The temperature was then held at 120° C. for 4 hours. The temperature was then ramped up from 120° C. to 280° C. over a 1 hour period. Upon reaching 280° C., the temperature was held for 2.5 hours.

The BET surface area was found to be 44.8 m²/g and was orange.

### Example 111

700 mg of NH₄VO₃ (Alfa 36213) was combined with 593 mg of oxalateic acid in 10 ml of water by stirring at room temperature for 35 minutes. The resulting solution was calcined at 350° C. for 1 hour in air using the following heat up protocol: The oven temperature was ramped up from 55° C. to 120° C. over a 4 hour period. The temperature was then held at 120° C. for 4 hours. The temperature was then ramped up from 120° C. to 350° C. over a 1 hour period. Upon reaching 350° C., the temperature was held for 1 hour.

The BET surface area was found to be 90 m²/g and was black.

### Example 112

700 mg of NH₄VO₃ (Alfa 36213) was combined with 395 mg of oxalateic acid in 10 ml of water by stirring at room temperature for 35 minutes. The resulting solution was calcined at 350° C. for 1 hour in air using the following heat up protocol: The oven temperature was ramped up from 55° C. to 120° C. over a 4 hour period. The temperature was then held at 120° C. for 4 hours. The temperature was then ramped up from 120° C. to 350° C. over a 1 hour period. Upon reaching 350° C., the temperature was held for 1 hour.

The BET surface area was found to be 71 m²/g and was black.

### Example 113

700 mg of NH₄VO₃ (Alfa 36213) was combined with 1866 mg of oxalacetic acid in 10 ml of water by stirring at room temperature for 35 minutes. The resulting green solution was calcined at 300° C. for 2 hours in air using the following heat up protocol: The oven temperature was ramped up from 55° C. to 120° C. over a 4 hour period. The temperature was then held at 120° C. for 4 hours. The temperature was then ramped up from 120° C. to 300° C. over a 1 hour period. Upon reaching 300° C., the temperature was held for 2 hours.

The BET surface area was found to be 35 m²/g and was orange.

### Examples 114-116

Vanadium materials were made as discussed below in Examples 114-116. Pore size distribution analysis of the compositions (derived from the adsorption branch of the isotherm) was analyzed on a Micromeretics, Inc., (Atlanta, Ga.) Micromeretics TriStar 3000. Results are shown in Tables 25-27.

### Example 114

900 mg of NH₄VO₃ (Alfa 36213) was combined with 2.4 g of oxalic acid in 10 ml of water by stirring at room temperature. The mixture was calcined at 280° C. for 2.5 hours in air using the following heat up protocol: The oven temperature was ramped up from 55° C. to 120° C. over a 4 hour period. The temperature was then held at 120° C. for 4 hours. The temperature was then ramped up from 120° C. to 280° C. over a 1 hour period. Upon reaching 280° C., the temperature was held for 2.5 hours. The material was then re-calcined at 280° C. for 1 hour in air using the following heat up protocol: The oven temperature was ramped up from 55° C. to 120° C. over a 4 hour period. The temperature was then held at 120° C. for 4 hours. The temperature was then ramped up from 120° C. to 280° C. over a 1 hour period. Upon reaching 280° C., the temperature was held for 1 hour.

The BET surface area was found to be 43 m²/g. The total pore volume was found to be 0.401717 cm³/g. The pore distribution data is shown below in Table 25.

TABLE 25

| AVERAGE | | |
|---|---|---|
| DIAMETER | INCREMENTAL PORE | % VOLUME |
| (nm) | VOLUME (cm³/g) | FRACTION |
| 258.70 | 0.005494 | 1.367629451 |
| 136.50 | 0.014624 | 3.640373696 |
| 110.80 | 0.008678 | 2.160227225 |
| 102.40 | 0.035654 | 8.875402335 |
| 92.70 | 0.036757 | 9.149973738 |
| 85.30 | 0.028594 | 7.117946216 |
| 78.20 | 0.039576 | 9.851711528 |
| 70.60 | 0.041104 | 10.2320788 |
| 64.50 | 0.033639 | 8.37380544 |
| 60.40 | 0.017044 | 4.242787833 |
| 55.10 | 0.028767 | 7.161011359 |
| 49.90 | 0.015631 | 3.891047678 |
| 43.80 | 0.022050 | 5.48893873 |
| 39.10 | 0.008614 | 2.144295611 |
| 35.80 | 0.007256 | 1.806246686 |
| 32.50 | 0.006265 | 1.559555608 |
| 29.30 | 0.005590 | 1.391526871 |
| 26.40 | 0.004940 | 1.229721421 |
| 23.60 | 0.004363 | 1.086087967 |
| 21.20 | 0.003630 | 0.903621206 |
| 18.80 | 0.003274 | 0.815001606 |
| 16.80 | 0.002531 | 0.63004553 |
| 15.00 | 0.002137 | 0.531966534 |
| 13.30 | 0.002143 | 0.533460122 |
| 11.90 | 0.001737 | 0.432393949 |
| 10.70 | 0.001553 | 0.38659056 |
| 9.40 | 0.001794 | 0.446583042 |
| 8.30 | 0.001543 | 0.384101245 |
| 7.20 | 0.001733 | 0.431398223 |
| 6.20 | 0.001680 | 0.418204856 |
| 5.40 | 0.001380 | 0.343525417 |
| 4.70 | 0.001264 | 0.314649368 |
| 4.20 | 0.001288 | 0.320623723 |
| 3.70 | 0.001433 | 0.356718785 |
| 3.30 | 0.001676 | 0.41720913 |
| 3.00 | 0.001855 | 0.461767861 |
| 2.70 | 0.001758 | 0.43762151 |
| 2.40 | 0.001402 | 0.349001909 |
| 2.20 | 0.000855 | 0.2128364 |
| 2.00 | 0.000216 | 0.053769196 |
| 2.00 | 0.000134 | 0.033356816 |
| 1.90 | 0.000062 | 0.015433751 |

### Example 115

1424 mg of vanadium acetate (Pfaltz & Bauer V00610) was combined with 5668 μl of 50% aqueous glyoxylic acid and 8 ml of water by stirring at room temperature. The mixture was calcined at 350° C. for 3 hours in air using the following heat up protocol: The oven temperature was ramped up from 55° C. to 120° C. over a 4 hour period. The temperature was then held at 120° C. for 4 hours. The temperature was then ramped up from 120° C. to 350° C. over a 1 hour period. Upon reaching 350° C., the temperature was held for 3 hours.

The BET surface area was found to be 32 m²/g. The total pore volume was found to be 0.110737 cm³/g. The pore distribution data is shown below in Table 26.

TABLE 26

| AVERAGE | | |
|---|---|---|
| DIAMETER | INCREMENTAL PORE | % VOLUME |
| (nm) | VOLUME (cm³/g) | FRACTION |
| 158.40 | 0.003291 | 2.971906409 |
| 123.00 | 0.003610 | 3.25997634 |
| 108.50 | 0.003315 | 2.993579382 |
| 96.70 | 0.002799 | 2.527610464 |
| 85.60 | 0.003205 | 2.894244923 |
| 74.90 | 0.003367 | 3.04053749 |
| 65.90 | 0.003173 | 2.865347625 |
| 58.20 | 0.003333 | 3.009834111 |
| 52.50 | 0.002709 | 2.446336816 |
| 47.10 | 0.003321 | 2.998997625 |
| 41.70 | 0.003535 | 3.1922483 |
| 37.40 | 0.002994 | 2.703703369 |
| 33.40 | 0.003634 | 3.281649313 |
| 329.80 | 0.003146 | 2.840965531 |
| 26.90 | 0.003065 | 2.767819247 |
| 24.10 | 0.003171 | 2.863541544 |
| 21.50 | 0.003238 | 2.92404526 |
| 18.90 | 0.003809 | 3.439681407 |
| 16.70 | 0.003538 | 3.194957422 |
| 15.00 | 0.003462 | 3.126326341 |
| 13.30 | 0.005109 | 4.613634106 |
| 11.90 | 0.004717 | 4.259642215 |
| 10.80 | 0.004290 | 3.874043906 |
| 9.40 | 0.007670 | 6.926320923 |
| 8.20 | 0.004641 | 4.191011134 |
| 7.20 | 0.004134 | 3.733169582 |
| 6.20 | 0.003289 | 2.970100328 |
| 5.30 | 0.002193 | 1.980367899 |
| 4.70 | 0.001597 | 1.442155738 |
| 4.10 | 0.001212 | 1.094485131 |
| 3.70 | 0.001041 | 0.9400652 |
| 3.30 | 0.000955 | 0.862403713 |
| 3.00 | 0.000939 | 0.847955065 |
| 2.70 | 0.000929 | 0.838924659 |
| 2.40 | 0.000920 | 0.830797294 |
| 2.20 | 0.000721 | 0.651092228 |
| 2.00 | 0.000259 | 0.233887499 |
| 1.90 | 0.000215 | 0.194153716 |
| 1.80 | 0.000194 | 0.175189864 |

### Example 116

5 ml of 1M vanadium oxalate solution was calcined at 300° C. for 6 hours in air using the following heat up protocol: The oven temperature was ramped up from 55° C. to 120° C. over a 4 hour period. The temperature was then held at 120° C. for 4 hours. The temperature was then ramped up from 120° C. to 300° C. over a 1 hour period. Upon reaching 300° C., the temperature was held for 6 hours.

The BET surface area was found to be 31 m²/g. The total pore volume was found to be 0.12999 cm³/g. The pore distribution data is shown below in Table 27.

TABLE 27

| AVERAGE | | |
|---|---|---|
| DIAMETER | INCREMENTAL PORE | % VOLUME |
| (nm) | VOLUME (cm³/g) | FRACTION |
| 78.80 | 0.008550 | 6.577378434 |
| 63.90 | 0.010971 | 8.439815064 |
| 56.90 | 0.013721 | 10.55534614 |
| 50.50 | 0.015498 | 11.92236386 |
| 44.00 | 0.019373 | 14.90333946 |
| 39.30 | 0.008303 | 6.387365279 |
| 35.80 | 0.007146 | 5.497303659 |
| 32.50 | 0.006360 | 4.892646414 |
| 39.60 | 0.005504 | 4.234139287 |
| 26.70 | 0.005021 | 3.862575101 |
| 24.00 | 0.004495 | 3.457931703 |
| 21.50 | 0.003776 | 2.904816487 |
| 19.00 | 0.003473 | 2.671723427 |
| 16.90 | 0.002568 | 1.975521382 |
| 15.10 | 0.001947 | 1.497796001 |
| 13.40 | 0.001765 | 1.357786308 |
| 12.00 | 0.001342 | 1.032379165 |
| 10.70 | 0.001046 | 0.804671093 |
| 9.50 | 0.001090 | 0.83851959 |
| 8.40 | 0.000877 | 0.674662092 |
| 7.30 | 0.000870 | 0.669277104 |
| 6.30 | 0.000837 | 0.643890731 |
| 5.40 | 0.000657 | 0.505419606 |
| 4.70 | 0.000521 | 0.400796978 |
| 4.20 | 0.000477 | 0.366948481 |
| 3.70 | 0.000482 | 0.370794901 |
| 3.40 | 0.000508 | 0.390796286 |
| 3.00 | 0.000572 | 0.440030464 |
| 2.70 | 0.000656 | 0.504650322 |
| 2.40 | 0.000702 | 0.540037387 |
| 2.20 | 0.000541 | 0.416182659 |
| 2.00 | 0.000155 | 0.119239024 |
| 2.00 | 0.000111 | 0.085390527 |
| 1.90 | 0.000075 | 0.057696302 |

### Lanthanides/Rare Earth Oxides

The BET surface area of the resulting materials was measured on a Beckman Coulter, Inc., (Fullerton, Calif.) model SA3100 surface area analyzer or a Micromeretics, Inc., (Atlanta, Ga.) Micromeretics TriStar 3000 analyzer after outgassing the samples at 110° C.

Several examples above describe the synthesis of cerium and yttrium materials. The examples below, are for rare earths and lanthanides, which include cerium and yttrium.

### Examples 117-141

Table 25 shows dry decomposition information for Ce and Y. The calcinations protocol was as follows: The oven temperature was ramped up from 55° C. to 120° C. over a 4 hour period. The temperature was then held at 120° C. for 4 hours. The temperature was then ramped up from 120° C. to the temperature shown in Table 25 over a 1 hour period. Upon reaching the temperature, the temperature was held for the time shown in Table 28.

TABLE 28

| | | | | BET surface | Yield/ |
|---|---|---|---|---|---|
| Example | Precursor | Appearance | Calcination | area (m²/g) | appearance |
| 117 | 1 g Ce oxalate | white pwd | 280 C./4 h | 110 | 509 mg yellow |
| 118 | 1 g Ce oxalate | white pwd | 290 C./4 h | 113.8 | 503 mg |
| 119 | 1 g Ce oxalate | white pwd | 290 C./4 h | 116.5 | 512 mg |
| 120 | 1 g Ce oxalate | white pwd | 300 C./4 h | 121 | 501 mg yellow |
| 121 | 1 g Ce oxalate | white pwd | 300 C./4 h | 115 | 505 mg |
| 122 | 1 g Ce oxalate | white pwd | 310 C./4 h | 113.1 | 497 mg yellow |
| 123 | 1 g Ce oxalate | white pwd | 325 C./4 h | 116.6 | 501 mg yellow |
| 124 | 1 g Ce oxalate | white pwd | 325 C./4 h | 122.8 | 501 mg |
| 125 | 1 g Ce oxalate | white pwd | 325 C./4 h | 114.9 | 504 mg |
| 126 | 1 g Ce oxalate | white pwd | 325 C./2 h | 124.9 | 655 mg yellow |
| 127 | 1.3 g Ce oxalate | white pwd | 400 C./4 h | 111.7 | 549 mg yellow |
| 128 | 1.2 g Ce oxalate | white pwd | 375 C./4 h | 117.2 | 564 mg yellow |
| 129 | 1.11 g Ce acetate | white pwd | 270 C./4 h | 146.1 | 515 mg yellow |
| 130 | 1.02 g Ce acetate | white pwd | 280 C./4 h | 165.5 | 506 mg yellow |
| 131 | 1.08 g Ce acetate | white pwd | 300 C./4 h | 112 | 527 mg |
| 132 | 1.06 g Ce acetate | white pwd | 300 C./4 h | 128.8 | 514 mg yellow |
| 133 | 1.16 g Ce acetate | white pwd | 280 C./3 h | 167.6 | 564 mg yellow |
| 134 | 1.02 g Ce acetate | white pwd | 280 C./2 h | 153.9 | 515 mg yellow |
| 135 | 1.12 g Y acetate | white pwd | 370 C./4 h | 194.2 | 450 mg white |
| 136 | 0.95 g Y acetate | white pwd | 375 C./4 h | 191.6 | 380 mg white |
| 137 | 1.21 g Y acetate | white pwd | 380 C./4 h | 199.2 | 461 mg |
| 138 | 1.35 g Y acetate | white pwd | 400 C./4 h | 182.6 | 506 mg |
| 139 | 1.14 g Y acetate | white pwd | 425 C./4 h | 167.2 | 428 mg white |
| 140 | 1.04 g Y acac | white pwd | 450 C./4 h | 103.6 | 279 mg white |
| 141 | 961 mg Y acac | white pwd | 500 C./4 h | 71.9 | 261 mg white |

### Examples 142-153

Table 29 shows the synthesis of Sm materials using malonic acid. The calcinations protocol was as follows: The oven temperature was ramped up from 55° C. to 120° C. over a 4 hour period. The temperature was then held at 120° C. for 4 hours. The temperature was then ramped up from 120° C. to the temperature shown in Table 29 over a 1 hour period. Upon reaching the temperature, the temperature was held for the time shown in Table 29.

TABLE 29

| | | | | BET | |
|---|---|---|---|---|---|
| | | | | surface | |
| | | | | area | |
| Example | Precursor | Dispersant | Calcination | (m²/g) | Yield/appearance |
| 142 | 1 g Sm carbonate | 5.5 ml 1M | 325 C./4 h | 85 | 410 mg whitish |
| | | malonic | | | |
| | | acid | | | |
| 143 | 1 g Sm carbonate | 6.5 ml 1M | 325 C./4 h | 80.4 | 379 mg whitish |
| | | malonic | | | |
| | | acid | | | |
| 144 | 1 g Sm carbonate | 7.50 ml 1M | 325 C./4 h | 75.9 | 387 mg whitish |
| | | malonic | | | |
| | | acid | | | |
| 145 | 1 g Sm carbonate | 5.0 ml 1M | 325 C./4 h | 80.5 | 412 mg whitish |
| | | malonic | | | |
| | | acid | | | |
| 146 | 1 g Sm carbonate | 5.75 ml 1M | 325 C./4 h | 88.4 | 411 mg whitish |
| | | malonic | | | |
| | | acid | | | |
| 147 | 1 g Sm carbonate | 6.0 ml 1M | 325 C./4 h | 86.5 | 411 mg whitish |
| | | malonic | | | |
| | | acid | | | |
| 148 | 1 g Sm carbonate | 5.5 ml 1M | 300 C./4 h | 86.9 | 427 mg whitish |
| | | malonic | | | |
| | | acid | | | |
| 149 | 1 g Sm carbonate | 5.75 ml 1M | 300 C./4 h | 99.6 | 467 mg whitish |
| | | malonic | | | |
| | | acid | | | |
| 150 | 1 g Sm carbonate | 6.0 ml 1M | 300 C./4 h | 86.1 | 427 mg whitish |
| | | malonic | | | |
| | | acid | | | |
| 151 | 1 g Sm carbonate | 5.6 ml 1M | 290 C./4 h | 69.5 | 424 mg whitish |
| | | malonic | | | |
| | | acid | | | |
| 152 | 1 g Sm carbonate | 5.75 ml 1M | 290 C./4 h | 103.5 | 390 mg whitish |
| | | malonic | | | |
| | | acid | | | |
| 153 | 1 g Sm carbonate | 5.9 ml 1M | 290 C./4 h | 87.6 | 476 mg whitish |
| | | malonic | | | |
| | | acid | | | |

### Examples 154-173

Table 30 shows the synthesis of Ho materials using dry decomposition. The calcinations protocol was as follows: The oven temperature was ramped up from 55° C. to 120° C. over a 4 hour period. The temperature was then held at 120° C. for 4 hours. The temperature was then ramped up from 120° C. to the temperature shown in Table 30 over a 1 hour period. Upon reaching the temperature, the temperature was held for the time shown in Table 30.

TABLE 30

| | | | | BET | |
|---|---|---|---|---|---|
| | | | | surface | |
| | | | | area | |
| Example | Precursor | Dispersant | Calcination | (m²/g) | Yield/appearance |
| 154 | 939 mg Ho acetate | pink pwd | 325 C./4 h | 133.5 | 520 mg pink |
| 155 | 1.1 g Ho acetate | pink pwd | 335 C./4 h | 131.1 | 616 mg pink |
| 156 | 1.17 g Ho acetate | pink pwd | 350 C./4 h | 133 | 640 mg pink |
| 157 | 1.026 g Ho acetate | pink pwd | 375 C./4 h | 119 | 562 mg pink |
| 158 | 1.01 g Ho acetate | pink pwd | 400 C./4 h | 113.8 | 545 mg pink |
| 159 | 1.1 g Ho acetate | pink pwd | 450 C./4 h | 98.8 | 581 mg pink |
| 160 | 807 mg Ho acetate | pink pwd | 500 C./4 h | 70.1 | 400 mg pink |
| 161 | 970 mg Ho acetate | pink pwd | 360 C./2 h | 140.6 | 533 mg pink |
| 162 | 969 mg Ho acetate | pink pwd | 350 C./2 h | 137.6 | 550 mg pink |
| | | recalcined | 350 C./1 h | 136.8 | 528 mg pink |
| 163 | 988 mg Ho acetate | pink pwd | 370 C./1 h | 125 | 565 mg pink |
| 164 | 866 mg Ho acetate | pink pwd | 275 C./4 h | 133.2 | 487 mg pink |
| 165 | 904 mg Ho acetate | pink pwd | 300 C./4 h | 134 | 499 mg pink |
| 166 | 836 mg Ho carbonate | pink pwd | 350 C./4 h | 26.9 | 433 mg pink |
| 167 | 1 g Ho carbonate | pink pwd | 350 C./4 h | 31 | 517 mg pink |
| 168 | 1 g Ho carbonate | pink pwd | 375 C./4 h | 26.5 | 513 mg pink |
| 169 | 1 g Ho carbonate | pink pwd | 375 C./4 h | 41.5 | 463 mg pink |
| 170 | 1 g Ho carbonate | pink pwd | 400 C./4 h | 37.2 | 494 mg pink |
| 171 | 1 g Ho carbonate | pink pwd | 425 C./4 h | 40.7 | 474 mg pink |
| 172 | 1 g Ho carbonate | pink pwd | 450 C./4 h | 44.3 | 461 mg pink |
| 173 | 1 g Ho carbonate | pink pwd | 500 C./4 h | 39.7 | 460 mg pink |

### Example 174

911 mg of Dysprosium acetate was calcined at 300° C. for 4 hours in air using the following heat up protocol: The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours. The resulting material was isolated and found to yield 497 mg.

The BET surface area was found to be 106.9 m²/g.

### Example 175

1 g of Dysprosium (III) carbonate tetrahydrate Dy₂(CO₃)₃*4H₂0 (white powder as supplied by Alfa 15286) was combined with 6.75 ml of aqueous malonic acid in a tall 40 ml vial by stirring at room temperature for 30 minutes. The resulting viscous white slurry was calcined at 300 C for 4 hours in air using the following heat up protocol: The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours. The resulting material was isolated and found to yield 607 mg.

The BET surface area was found to be 111.5 m²/g.

### Examples 176-193

Table 31 shows the synthesis of Er materials using dry decomposition. The calcinations protocol was as follows: The oven temperature was ramped up from 55° C. to 120° C. over a 4 hour period. The temperature was then held at 120° C. for 4 hours. The temperature was then ramped up from 120° C. to the temperature shown in Table 31 over a 1 hour period. Upon reaching the temperature, the temperature was held for the time shown in Table 31.

TABLE 31

| | | | | BET | |
|---|---|---|---|---|---|
| | | | | surface | |
| | | | | area | |
| Example | Precursor | Appearance | Calcination | (m²/g) | Yield/appearance |
| 176 | 1.2 g Er acetate | pink pwd | 300 C./4 h | 135.5 | 600 mg pink |
| 177 | 1 g Er acetate | pink pwd | 325 C./4 h | 127.4 | 464 mg pink |
| 178 | 1.1 g Er acetate | pink pwd | 325 C./4 h | 126.5 | 577 mg pink |
| 179 | 1.14 g Er acetate | pink pwd | 350 C./4 h | 133.5 | 535 mg pink |
| 180 | 1.28 g Er acetate | pink pwd | 350 C./4 h | 141.5 | 633 mg pink |
| 181 | 1.18 g Er acetate | pink pwd | 375 C./4 h | 132.8 | 550 mg pink |
| 182 | 1 g Er acetate | pink pwd | 375 C./4 h | 124.2 | |
| 183 | 1.26 g Er acetate | pink pwd | 400 C./4 h | 81.5 | 563 mg pink |
| 184 | 1.07 g Er acetate | pink pwd | 450 C./4 h | 75 | 478 mg pink |
| 185 | 1.01 g Er acetate | pink pwd | 500 C./4 h | 69.9 | 451 mg pink |
| 186 | 1.07 g Er acetate | pink pwd | 500 C./4 h | 65.4 | 478 mg pink |
| 187 | 1.01 g Er acetate | pink pwd | 550 C./4 h | 48.6 | 450 mg pink |
| 188 | 1.15 g Er acetate | pink pwd | 575 C./4 h | 31.7 | 501 mg pink |
| 189 | 1.02 g Er acetate | pink pwd | 375 C./2 h | 136.3 | 487 mg pink |
| 190 | 1.18 g Er acetate | pink pwd | 365 C./2 h | 144.6 | 584 mg pink |
| 191 | 921 mg Er acetate | pink pwd | 360 C./2 h | 147.5 | 453 mg pink |
| 192 | 1034 mg Er acetate | pink pwd | 350 C./2 h | 145.9 | 520 mg pink |
| | | recalcined | 350 C./1 h | 144 | |
| 193 | 934 mg Er acetate | pink pwd | 370 C./1 h | 131.5 | 469 mg pink |

### Example 194

1 g of Erbium (III) carbonate hydrate (pink powder as supplied by Alfa 17209) was combined with 6 ml of 1M aqueous malonic acid in a tall 40 ml vial by stirring at room temperature for 30 minutes. The resulting viscous pink slurry was calcined at 300° C. for 4 hours in air using the following heat up protocol: The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours. The resulting material was isolated and found to yield 629 mg.

The BET surface area was found to be 132.2 m²/g.

### Example 195

1 g of Gd carbonate was combined with 7.75 ml of 1M aqueous malonic acid in a tall 40 ml vial by stirring at room temperature. The resulting white slurry was calcined at 325° C. for 4 hours in air using the following heat up protocol: The oven temperature was ramped up from 55° C. to 120° C. over a 4 hour period. The temperature was then held at 120° C. for 4 hours. The oven temperature was then ramped up to 325° C. over a 1 hour period. Upon reaching 325° C., the temperature was held for 4 hours. The resulting material was isolated and found to yield 656 mg.

The BET surface area was found to be 65.2 m²/g.

### Example 196

1 g of Tb carbonate was combined with 4.5 ml of 1M aqueous malonic acid in a tall 40 ml vial by stirring at room temperature. The resulting white slurry was calcined at 300° C. for 4 hours in air using the following heat up protocol: The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours. The resulting material was isolated and found to yield 466 mg.

The BET surface area was found to be 54.3 m²/g.

### Example 197

910 mg of Tm acetate was calcined at 360° C. for 2 hours in air using the following heat up protocol: The oven temperature was ramped up from 55° C. to 120° C. over a 4 hour period. The temperature was then held at 120° C. for 4 hours. The oven temperature was then ramped up to 360° C. over a 1 hour period. Upon reaching 360° C., the temperature was held for 2 hours. The resulting material was isolated and found to yield 465 mg.

The BET surface area was found to be 151.6 m²/g.

### Other

The BET surface area of the resulting materials was measured on a Beckman Coulter, Inc., (Fullerton, Calif.) model SA3100 surface area analyzer or a Micromeretics, Inc., (Atlanta, Ga.) Micromeretics TriStar 3000 analyzer after outgassing the samples at 110° C.

### Example 198

500 mg of Cu(OH)₂ (Aldrich 28, 978-7) was combined with 2 g of diglycolic acid in 10 ml of water, by stirring at room temperature for 24 hours. The resulting blue slurry was calcined at 300° C. for 1 hour. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 1 hour.

The yield was 432 mg, and the BET surface area was found to be 88 m²/g.

### Example 199

1 g of Cu hydroxylcarbonate (Aldrich 20, 789-6) was combined with 2.5 ml of 25% glyoxylic acid in water and 5 ml of ketoglutaric acid, by stirring at room temperature for 30 min. The mixture was then aged for 51 days. The resulting green foam was calcined at 350° C. for 2 hours. The oven temperature was ramped up from 55° C. to 120° C. over a 4 hour period. The temperature was then held at 120° C. for 4 hours. The oven temperature was then ramped up to 350° C. over a 1 hour period. Upon reaching 350° C., the temperature was held for 2 hours.

The yield was 1112 mg, and the BET surface area was found to be 20 m²/g. The powder was re-calcined at 375° C. for 2 hours. The oven temperature was ramped up from 55° C. to 120° C. over a 4 hour period. The temperature was then held at 120° C. for 4 hours. The oven temperature was then ramped up to 375° C. over a 1 hour period. Upon reaching 375° C., the temperature was held for 2 hours.

The yield dropped to 858 mg (it is believed due to the burn off of coke), and the BET surface area was found to be 71 m²/g.

### Example 200

5 ml of 1M Cu nitrate solution (Aldrich 22, 339-5) was combined with 5 ml of 12.5% glyoxylic acid acid in water, by stirring at room temperature. The resulting clear blue solution was calcined at 280° C. for 2 hours. The oven temperature was ramped up from 55° C. to 120° C. over a 4 hour period. The temperature was then held at 120° C. for 4 hours. The oven temperature was then ramped up to 280° C. over a 1 hour period. Upon reaching 280° C., the temperature was held for 2 hours.

The yield was 432 mg, and the BET surface area was found to be 57 m²/g.

### Example 201

531 mg of Cu(OH)₂ (Aldrich 28, 978-7) was combined with 1583 mg of diglycolic acid in 10 ml of water, by stirring at room temperature for 30 minutes. The resulting blue slurry was calcined at 300° C. for 1 hour. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 1 hour.

The BET surface area was found to be 73 m²/g.

### Example 202

562 mg of Cu(OH)₂ (Aldrich 28, 978-7) was combined with 2011 mg of diglycolic acid in 10 ml of water, by stirring at room temperature for 30 minutes. The resulting blue slurry was calcined at 300° C. for 1 hour. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 1 hour.

The yield was 457 mg, and the BET surface area was found to be 70 m²/g.

### Example 203

885 mg of Cu(OH)₂ (Aldrich 28, 978-7) was combined with 575 mg of ketoglutaric acid in 10 ml of water, by stirring at room temperature for 30 minutes. The resulting blue slurry was calcined at 280° C. for 2 hours. The oven temperature was ramped up from 55° C. to 120° C. over a 4 hour period. The temperature was then held at 120° C. for 4 hours. The oven temperature was then ramped up to 280° C. over a 1 hour period. Upon reaching 280° C., the temperature was held for 2 hours.

The BET surface area was found to be 68 m²/g.

### Example 204

700 mg of Sn (IV) acetate was combined with 5 ml of 2-methoxyethanol in an open 50 ml vial. The mixture formed a white gel that was observed to shrink to a white, well-defined pill/tablet in the center of the vial surrounded by the 2-methoxyethanol solvent within 2 days upon standing in a hood. The 2-methoxyethanol solvent was recovered from the system by decantation to isolate the white gel. The gel was then calcined at 300° C. for 4 hours. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours.

The BET surface area was found to be 161 m²/g.

### Example 205

500 mg of Sn (IV) acetate was combined with 2.5 ml of 2-methoxyethanol in an open 50 ml vial. The mixture formed a white gel that was observed to shrink to a white, well-defined pill/tablet in the center of the vial surrounded by the 2-methoxyethanol solvent within 2 days upon standing in a hood. The 2-methoxyethanol solvent was recovered from the system by decantation to isolate the white gel. The gel was then calcined at 275° C. for 2 hours. The oven temperature was ramped up from 55° C. to 120° C. over a 4 hour period. The temperature was then held at 120° C. for 4 hours. The oven temperature was then ramped up to 275° C. over a 1 hour period. Upon reaching 275° C., the temperature was held for 2 hours.

The BET surface area was found to be 214.9 m²/g.

### Example 206

700 mg of Sn (IV) acetate was combined with 2.36 ml of 50% aqueous glyoxylic acid and 1.16 ml of water by stirring at room temperature. The resulting clear solution was calcined at 285° C. for 4 hours. The oven temperature was ramped up from 55° C. to 120° C. over a 4 hour period. The temperature was then held at 120° C. for 4 hours. The oven temperature was then ramped up to 285° C. over a 1 hour period. Upon reaching 285° C., the temperature was held for 4 hours.

The BET surface area was found to be 231.1 m²/g.

### Example 207

700 mg of Sn (IV) acetate was combined with 2.5 ml of methanol by stirring at room temperature. 1 ml of water was added to the solution, forming a gel. The mixture was aged for 1 day and was calcined at 270° C. for 2 hours. The oven temperature was ramped up from 55° C. to 120° C. over a 4 hour period. The temperature was then held at 120° C. for 4 hours. The oven temperature was then ramped up to 270° C. over a 1 hour period. Upon reaching 270° C., the temperature was held for 2 hours.

The BET surface area was found to be 231 m²/g.

### Example 208

1 g of In(OAc)₃ was calcined at 300° C. for 4 hours in air using the following heat up protocol: The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours. The resulting material was isolated and found to yield 498 mg.

The BET surface area was found to be 99.5 m²/g.

### Example 209

1 g of In(OH)₃ was calcined at 200° C. for 4 hours in air using the following heat up protocol: The oven temperature was ramped up from 55° C. to 120° C. over a 4 hour period. The temperature was then held at 120° C. for 4 hours. The oven temperature was then ramped up to 200° C. over a 1 hour period. Upon reaching 200° C., the temperature was held for 4 hours. The resulting material was isolated and found to yield 903 mg mg.

The BET surface area was found to be 72.3 m²/g.

The material was then re-calcined at 220° C. for 4 hours in air using the following heat up protocol: The oven temperature was ramped up from 55° C. to 120° C. over a 4 hour period. The temperature was then held at 120° C. for 4 hours. The oven temperature was then ramped up to 220° C. over a 1 hour period. Upon reaching 220° C., the temperature was held for 4 hours. The resulting material was isolated and found to yield 835 mg.

The BET surface area was found to be 103.3 m²/g.

### Example 210

1.15 g of(NH₄)₃Fe(ox)₃ was calcined at 280° C. for 3 hours in air using the following heat up protocol: The oven temperature was ramped up from 55° C. to 120° C. over a 4 hour period. The temperature was then held at 120° C. for 4 hours. The oven temperature was then ramped up to 280° C. over a 1 hour period. Upon reaching 280° C., the temperature was held for 3 hours. The resulting material was isolated and found to yield 227 mg.

The BET surface area was found to be 213.9 m²/g.

### Example 211

500 mg of Sn (IV) acetate was combined with 1 ml of 20% aqueous glyoxal by stirring at room temperature. The resulting clear solution was calcined at 300° C. for 4 hours. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours.

The yield was 547 mg and the BET surface area was found to be 0.03 m²/g.

The material was then re-calcined at 325° C. for 4 hours. The oven temperature was ramped up from 55° C. to 120° C. over a 4 hour period. The temperature was then held at 120° C. for 4 hours. The oven temperature was then ramped up to 325° C. over a 1 hour period. Upon reaching 325° C., the temperature was held for 4 hours.

The yield was 416 mg and the BET surface area was found to be 3.1 m²/g.

The material was then re-calcined at 350° C. for 4 hours. The oven temperature was ramped up from 55° C. to 120° C. over a 4 hour period. The temperature was then held at 120° C. for 4 hours. The oven temperature was then ramped up to 350° C. over a 1 hour period. Upon reaching 350° C., the temperature was held for 4 hours.

The yield was 243 mg and the BET surface area was found to be 221.3 m²/g.

The material was then re-calcined at 375° C. for 1 hour. The oven temperature was ramped up from 55° C. to 120° C. over a 4 hour period. The temperature was then held at 120° C. for 4 hours. The oven temperature was then ramped up to 375° C. over a 1 hour period. Upon reaching 375° C., the temperature was held for 1 hour.

The yield was 213 mg and the BET surface area was found to be 122.3 m²/g.

### Example 212

700 mg of In (OAc)₃ acetate was combined with 10 ml of 20% aqueous glyoxal by stirring at room temperature for 24 hours. An additional 1 ml of 40% aqueous glyoxal was then added by stirring at room temperature. The resulting clear solution was calcined at 325° C. for 4 hours. The oven temperature was ramped up from 55° C. to 120° C. over a 4 hour period. The temperature was then held at 120° C. for 4 hours. The oven temperature was then ramped up to 325° C. over a 1 hour period. Upon reaching 325° C., the temperature was held for 4 hours.

The yield was 383 mg and the BET surface area was found to be 70.3 m²/g.

### Example 213

500 mg of Ni acac was combined with 10 ml of 20% aqueous glyoxal by stirring at room temperature for 24 hours. The resulting green solution was calcined at 300° C. for 4 hours. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours.

The yield was 807 mg and the BET surface area was found to be 9 m²/g.

The material was then re-calcined at 350° C. for 2 hours. The oven temperature was ramped up from 55° C. to 120° C. over a 4 hour period. The temperature was then held at 120° C. for 4 hours. The oven temperature was then ramped up to 350° C. over a 1 hour period. Upon reaching 350° C., the temperature was held for 2 hours.

The yield was 588 mg.

The material was then re-calcined at 375° C. for 2 hours. The oven temperature was ramped up from 55° C. to 120° C. over a 4 hour period. The temperature was then held at 120° C. for 4 hours. The oven temperature was then ramped up to 375° C. over a 1 hour period. Upon reaching 375° C., the temperature was held for 2 hours.

The yield was 378 mg and the BET surface area was found to be 206 m²/g.

### Example 214

500 mg of Ni lactate was combined with 10 ml of 20% aqueous glyoxal by stirring at room temperature for 24 hours. The resulting green slurry was calcined at 300° C. for 4 hours. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours.

The yield was 158 mg and the BET surface area was found to be 109 m²/g.

### Example 215

500 mg of Ni nitrate was combined with 10 ml of 14% aqueous glyoxal by stirring at room temperature. The resulting green solution was calcined at 300° C. for 4 hours. The oven temperature was ramped up from 55° C. to 120° C. over a 4 hour period. The temperature was then held at 120° C. for 4 hours. The oven temperature was then ramped up to 300° C. over a 1 hour period. Upon reaching 300° C., the temperature was held for 4 hours.

The yield was 158 mg and the BET surface area was found to be 106 m²/g.

### Example 216

To a 1 L flask was added oxalic acid (63.04 g) and 400 mL water. With stirring the mixture was heated to 60° C. to dissolve the oxalic acid. To the solution was added niobic acid (32.30 g) and the slurry was stirred for 14 h. The mixture was allowed to cool to room temperature and was filtered. The clear filtrate was diluted to 500.0 mL. The resulting solution had an Nb concentration of 0.362M. A vial was charged with 10.90 mL of the resulting Nb oxalate solution. With stirring, NH₄OH (30%) was added dropwise until the pH of the mixture reached 11. The mixture was centrifuged and the supernatant liquid decanted from the white precipitate. The precipitate was washed three times by slurrying in distilled water, centrifuging and decanting. The wet precipitate was suspended in 10 mL water and glycolic acid (0.913 g) was added. The mixture was heated and stirred for 24 h to produce a slightly opalescent solution. The final Nb concentration was 0.184M.

### Example 217

5 ml of the Nb precursor solution prepared in Example 216 (Nb=0.18M, ratio of acid to Nb=3) was calcined at 350° C. for 4 hours. The oven temperature was ramped up from 55° C. to 120° C. over a 4 hour period. The temperature was then held at 120° C. for 4 hours. The oven temperature was then ramped up to 350° C. over a 1 hour period. Upon reaching 350° C., the temperature was held for 4 hours.

The yield was 136.8 mg, and the BET surface area was found to be 153.2 m²/g.

### Example 218

A niobium oxalate stock solution was prepared by adding oxalic acid (155.6 g) and 800 mL water to a 2 L flask. With stirring the mixture was heated to 60° C. to dissolve the oxalic acid. To the solution was added niobic acid (66.44 g) and the slurry was stirred for 14 h. The mixture was allowed to cool to room temperature and was filtered. The clear filtrate was diluted to 1000.0 mL. The resulting solution had a Nb concentration of 0.483M. A flask was charged with 82.8 mL of the Nb oxalate stock solution. With stirring, NH₄OH (30%) was added portionwise until the pH of the mixture reached 11. The precipitate was collected on a filter by vacuum filtration and washed with water until the wash water pH was less than 8. The wet precipitate was suspended in 80 mL water and glyoxylic acid (17.8 mL of a 50 wt % solution) was added. The mixture was heated at 60° C. and stirred for 24 h to produce a clear solution. The solution was cooled and diluted to 100 mL. The final Nb concentration was 0.402M.

### Example 219

5 ml of the Nb glyoxylate solution prepared in Example 218 (Nb=0.402M, ratio of acid to Nb=4) was calcined at 450° C. for 4 hours. The oven temperature was ramped up from 55° C. to 120° C. over a 4 hour period. The temperature was then held at 120° C. for 4 hours. The oven temperature was then ramped up to 450° C. over a 1 hour period. Upon reaching 450° C., the temperature was held for 4 hours.

The yield was 270 mg, and the BET surface area was found to be 53.2 m²/g.

### Example 220

A niobium oxalate stock solution was prepared by adding oxalic acid (155.6 g) and 800 mL water to a 2 L flask. With stirring the mixture was heated to 60° C. to dissolve the oxalic acid. To the solution was added niobic acid (66.44 g) and the slurry was stirred for 14 h. The mixture was allowed to cool to room temperature and was filtered. The clear filtrate was diluted to 1000.0 mL. The resulting solution had a Nb concentration of 0.483M. A flask was charged with 82.8 mL of the Nb oxalate stock solution. With stirring, NH₄OH (30%) was added portionwise until the pH of the mixture reached 11. The precipitate was collected on a filter by vacuum filtration and washed with water until the wash water pH was less than 8. The wet precipitate was suspended in 80 mL water and glycolic acid (12.17 g) was added. The mixture was heated at 60° C. and stirred for 24 h to produce a clear solution. The solution was cooled and diluted to 100 mL. The final Nb concentration was 0.403M.

### Example 221

5 ml of the Nb glycolate solution prepared in Example 220 (Nb=0.403M, ratio of acid to Nb=4) was calcined at 325° C. for 4 hours. The oven temperature was ramped up from 55° C. to 120° C. over a 4 hour period. The temperature was then held at 120° C. for 4 hours. The oven temperature was then ramped up to 325° C. over a 1 hour period. Upon reaching 325° C., the temperature was held for 4 hours.

The yield was 334 mg, and the BET surface area was found to be 187.0 m²/g.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention.

I claim:

1. A composition comprising at least about 50% yttrium oxide by weight, the composition being a porous solid composition having a BET surface area of at least 100 square meters per gram.

2. The composition of claim 1, wherein at least 10% of the pores have a diameter greater than 10 nm.

3. The composition of claim 1, further comprising a metal other than yttrium.

4. The composition of claim 1, wherein the composition comprises at least 60% yttrium oxide by weight.

5. The composition of claim 1, wherein the BET surface area is between about 110 square meters per gram and 220 square meters per gram.

6. The composition of claim 1, comprising between about 0.01% and about 20% carbon by weight.

7. The composition of claim 1, wherein the composition has an essential absence of S, Na, K, europium, silica, alumina, aluminum and/or chromia.

8. The composition of claim 1, wherein the composition is a catalyst.

9. The composition of claim 1, wherein the composition is thermally stable with respect to the BET surface area of the composition decreasing by not more than 10% when heated at 400° C. for 2 hours.

10. The composition of claim 1, wherein the yttrium metal or yttrium oxide is at least 50% yttrium oxide.

11. The composition of claim 1, further comprising a component selected from the group consisting of Mg, Al, Ba, Cr, Mn, Fe, Ni, Co, Cu, Zr, Nb, Mo, Ru, Pd, In, Sn, Ta, W, Pt, Au, Ce, rare earth metals, their oxides, and combinations thereof.

12. The composition of claim 1, wherein the composition is a porous solid wherein at least 10% of the pores have a diameter greater than 15 nm.

13. The composition of claim 1, consisting essentially of carbon and at least about 50% yttrium oxide by weight.

14. A method for making a composition, the method comprising:
mixing a ytrium precursor with an organic acid and, optionally, water, to form a mixture, the organic acid comprising either (i) no more than one carboxylic group and at least one functional group selected from the group consisting of carbonyl and hydroxyl or (ii) two carboxylic groups and a carbonyl group;
optionally forming a gel; and
calcining the mixture at a temperature of at least 250° C. for a time sufficient to form a solid.

15. The method of claim 14, wherein the organic acid from the group consisting of ketoglutaric acid, glyoxylic acid, pyruvic acid, lactic acid, glycolic acid, oxalacetic acid, diglycolic acid, oxalic acid, tartaric acid, malonic acid, succinic acid, glutaric acid and combinations thereof, to form a mixture.

16. The method of claim 14, wherein the water is included.

17. The method of claim 14, wherein the calcining step is at a temperature of between about 250° C. and 500° C.

18. The method of claim 14, wherein the mixture has an essential absence of organic solvents other than the organic acid.

19. The method of claim 14, wherein the mixture has an essential absence of citric acid.

20. The method of claim 14, wherein the calcining time is at least two hours.

21. The method of claim 14, further comprising a reducing step.

22. A composition comprising yttrium glyoxylate or yttrium ketoglutarate.

23. A method of forming a yttrium glyoxylate or yttrium ketoglutarate, the method comprising mixing yttrium hydroxide or yttrium acetate with aqueous glyoxylic acid or with aqueous ketoglutaric acid, respectively.
